(19) United States
(12) Patent Application Publication
(10) Pub. No.: US 2022/0057362 A1
(43) Pub. Date: Feb. 24, 2022

(54) Auxiliary Electrodes and Methods for Using and Manufacturing the Same

(71) Applicant: Meso Scale Technologies, LLC, Rockville, MD (US)

(72) Inventors: Mark Billadeau, Knoxville, MD (US); Nicholas Carbone, Newton, MA (US); Charles Clinton, Clarksburg, MD (US); Scott Dowdell, Cascade, MD (US); Manish Kochar, Rockville, MD (US); Nicholas Fox-Lyon, Bethesda, MD (US); Bandele Jeffrey-Coker, Darnestown, MD (US); Alexander Tucker-Schwartz, Bethesda, MD (US); George Sigal, Rockville, MD (US); Gisbert Spieles, Bethesda, MD (US); Jules Vandersarl, Gaithersburg, MD (US); Jacob Wohlstadter, Potomac, MD (US)

(21) Appl. No.: 17/407,667

(22) Filed: Aug. 20, 2021

Related U.S. Application Data
(60) Provisional application No. 63/118,463, filed on Nov. 25, 2020.
(60) Provisional application No. 63/068,981, filed on Aug. 21, 2020.

(51) Int. Cl. G01N 27/49; G01N 27/327

(52) U.S. Cl. CPC G01N 27/49; G01N 27/3277; G01N 27/3273; G01N 27/3272

(57) ABSTRACT

An electrochemical cell includes a plurality of working electrode zones disposed, and defining a pattern, on a surface of the cell and at least one auxiliary electrode disposed on the surface. The auxiliary electrode may have a defined interfacial potential.

### RELATED MATTERS

This application claims priority to U.S. Provisional Application No. 63/068,981, filed on Aug. 21, 2020 and to U.S. Provisional Application No. 63/118,463, filed on Nov. 25, 2020, each of which is incorporated herein in its entirety.

### FIELD

Embodiments hereof relate to systems, devices, and methods employing auxiliary electrodes in the performance of chemical, biochemical, and biological assays and analysis, and methods for manufacturing the same.

### BACKGROUND

An assay is an investigative (analytic) procedure in chemistry, laboratory medicine, pharmacology, environmental biology, molecular biology, etc. for qualitatively assessing or quantitatively measuring the presence, amount, or functional activity of a target entity (e.g., an analyte). An assay system may use electrochemical properties and procedures to assess a target entity qualitatively and quantitatively. For example, the assay system may assess a target entity by measuring electrical potential, electrical current, and/or luminance in a sample area containing the target entity that are caused by electrochemical process and by performing various analytical procedures (e.g., potentiometry, coulometry, voltammetry, optical analysis, etc.) on the measured data.

An assay system, utilizing electrochemical properties and procedures, may include sample areas (e.g., a well, wells in a multi-well plates, etc.) that have one or more electrodes (e.g., working electrodes, counter electrodes, and references electrodes) for initiating and controlling the electrochemical processes and for measuring the resultant data. Depending on the design and configuration of the electrodes, assay systems may be classified as referenced and unreferenced systems. For example, the working electrode is the electrode in the assay system on which the reaction of interest is occurring. The working electrode is used in conjunction with the counter electrode to establish potential differences, current flow, and/or electric fields in the sample area. The potential difference may be split between interfacial potentials at the working and counter electrodes. In an unreferenced system, an interfacial potential (the force that drives the reactions at an electrode) applied to the working electrode is not controlled or known. In the referenced system, the sample area includes a reference electrode, which is separate from the working and counter electrode. The reference electrode has a known potential (e.g., reduction potential), which can be referenced during reactions occurring in the sample area.

One example of these assay systems is an electrochemiluminescence (ECL) immunoassay. ECL immunoassay involves a process that uses ECL labels designed to emit light when electrochemically stimulated. Light generation occurs when a voltage is applied to an electrode, located in a sample area that holds a material under testing. The voltage triggers a cyclical oxidation and reduction reaction, which causes light generation and emission. In ECL, the electrochemical reactions responsible for ECL are driven by applying a potential difference between the working and counter electrodes.

Currently, both referenced and unreferenced assay systems have drawbacks in the measurement and analysis of a target entity. For an unreferenced assay system, the unknown nature of the interfacial potentials introduces a lack of control in the electrochemical processes, which may be further affected by the design of the assay system. For example, for an ECL immunoassay, the interfacial potential applied at the working electrode may be affected by electrode areas (working and/or counter), composition of the solution, and any surface treatment of the electrodes (e.g., plasma treatments). This lack of control has previously been addressed by choosing to ramp the potential difference from before the onset of ECL generation to after the end of ECL generation. For a referenced system, while the potential may be known and controllable, the addition of the reference electrode increases the cost, complexity, size, etc. of the assay system. Further, the addition of the reference electrode may limit the design and placement of the working and/or counter electrode in the sample area due to the need to accommodate the extra electrode. Additionally, both the referenced and unreferenced assay system may have slow read times due to voltage signals required to operate the systems. The reference systems may have a higher cost due to fabricating both the counter and reference electrode.

These and other drawbacks exist with conventional assay systems, devices, and instruments. What is needed, therefore, are systems, devices and methods that provide the controllable potential of a referenced system while reducing the cost, complexity, and size introduced by having a reference electrode. These drawbacks are addressed by embodiments described herein.

### BRIEF SUMMARY

Embodiments of the present disclosure include systems, devices, and methods for electrochemical cells including an auxiliary electrode design and electrochemical analysis apparatuses and devices including the electrochemical cells.

In one aspect, the present disclosure provides an electrochemical cell for performing electrochemical analysis. The electrochemical cell includes a plurality of working electrode zones disposed, and defining a pattern, on a surface of the cell and at least one auxiliary electrode disposed on the surface. The at least one auxiliary electrode has a redox couple confined to its surface. The at least one auxiliary electrode is disposed at an approximate equal distance from at least two of the plurality of working electrode zones.

In another aspect, an electrochemical cell for performing electrochemical analysis. The electrochemical cell includes a plurality of working electrode zones disposed, and defining a pattern, on a surface of the cell and at least one auxiliary electrode disposed on the surface, the auxiliary electrode having a redox couple confined to its surface. The redox couple provides a quantifiable amount of coulombs per unit of the at least one auxiliary electrode's surface area throughout a redox reaction of the redox couple.

In another aspect, an electrochemical cell for performing electrochemical analysis. The electrochemical cell includes a plurality of working electrode zones disposed, and defining a pattern, on a surface of the cell and at least one auxiliary electrode disposed on the surface and formed of a chemical mixture comprising an oxidizing agent. The at least one auxiliary electrode has a redox couple confined to its surface. An amount of the oxidizing agent is sufficient to maintain the defined potential throughout an entire redox reaction of the redox couple.

In another aspect, an electrochemical cell for performing electrochemical analysis. The electrochemical cell includes a plurality of working electrode zones disposed, and defining a pattern, on a surface of the cell and at least one auxiliary electrode disposed on the surface. The auxiliary electrode having a defined interfacial potential.

In another aspect, an electrochemical cell for performing electrochemical analysis. The electrochemical cell includes a plurality of working electrode zones disposed, and defining a pattern, on a surface of the cell and at least one auxiliary electrode disposed on the surface, the at least one auxiliary electrode comprising a first substance and a second substance. The second substance is a redox couple of the first substance.

In another aspect, an electrochemical cell for performing electrochemical analysis, the electrochemical cell includes a plurality of working electrode zones disposed, and defining a pattern, on a surface of the cell and at least one auxiliary electrode disposed on the surface, the at least one auxiliary electrode having a redox couple confined to its surface. When an applied potential is introduced to the cell during the electrochemical analysis, a reaction of a species in the redox couple is a predominate redox reaction occurring at the auxiliary electrode.

In another embodiment, an apparatus for performing electrochemical analysis is provided. the apparatus includes a plate with a plurality of wells defined therein, at least one well from the plurality of wells comprising: a plurality of working electrode zones disposed, and defining a pattern, on a surface of the cell; and at least one auxiliary electrode disposed on the surface and formed of a chemical mixture comprising an oxidizing agent, the at least one auxiliary electrode having a redox couple confined to its surface, wherein an amount of the oxidizing agent is sufficient to maintain the defined potential throughout an entire redox reaction of the redox couple.

In another embodiment, a method for electrochemical analysis is provided. The method includes applying a voltage pulse to one or more working electrode zones and at least one auxiliary electrode located in at least one well of a multi-well plate, wherein: the one or more working electrode zones define a pattern on a surface of the at least one well, the at least one auxiliary electrode is disposed on the surface and has a redox couple confined to its surface, and the redox couple is reduced at least during a period for which the voltage pulse is applied.

In another embodiment, an apparatus for performing electrochemical analysis in a well, the apparatus comprising: a plurality of working electrode zones disposed on a surface adapted to form a bottom portion of the well; and an auxiliary electrode disposed on the surface, the auxiliary electrode having a potential defined by a redox couple confined to its surface, wherein one of the plurality of working electrode zones is disposed at an approximate equal distance from each sidewall of the well.

In another embodiment, a method for performing electrochemical analysis is provided. The method includes applying a first voltage pulse to one or more working electrode zones or a counter electrode in a well of an apparatus, the first voltage pulse causing a first redox reaction to occur in the well; capturing first luminescence data from the first redox reaction over a first period of time; applying a second voltage pulse to the one or more working electrode zones or the counter electrode in the well, the second voltage pulse causing a second redox reaction to occur in the well; and capturing second luminescence data from the second redox reaction over a second period of time.

### BRIEF DESCRIPTION OF DRAWINGS

The foregoing and other features and advantages of the present invention will be apparent from the following description of embodiments hereof as illustrated in the accompanying drawings. The accompanying drawings, which are incorporated herein and form a part of the specification, further serve to explain the principles of various embodiments described herein and to enable a person skilled in the pertinent art to make and use various embodiments described herein. The drawings are not necessarily drawn to scale.

FIGS. 1A-1C illustrate several views of an electrochemical cell, according to embodiments disclosed herewith.

FIG. 2A illustrates a top view of a multi-well plate including multiple sample areas, according to embodiments disclosed herewith.

FIG. 2B illustrates a multi-well plate for use in an assay device including multiple sample areas, according to embodiments disclosed herewith.

FIG. 2C illustrates a side view of a sample area of the multi-well plate of FIG. 1C, according to embodiments disclosed herewith.

FIGS. 3A-3F, 4A-4F, 5A-5C, 6A-6F, 7A-7F, and 8A-8D illustrate several examples of designs of electrodes for use in the electrochemical cell of FIGS. 1A-1C or the multi-well plate of FIGS. 2A-2C, according to embodiments disclosed herewith.

FIGS. 9A and 9B illustrate an example of an assay apparatus, according to embodiments disclosed herewith.

FIGS. 10A and 10B illustrate decay times for an auxiliary electrode, according to embodiments.

FIG. 11 illustrates a process of performing an electrochemical analysis and procedures using pulsed waveforms, according to embodiments disclosed herewith.

FIGS. 12A and 12B illustrate examples of a pulsed waveform, according to embodiments disclosed herewith.

FIG. 13 illustrates a process of performing an ECL analysis and procedures using pulsed waveforms, according to embodiments disclosed herewith.

FIGS. 14A-14C 15A-15L, 16 and 17 illustrate ECL test results performed using pulsed waveforms, according to embodiments disclosed herewith.

FIG. 18 illustrates a process of performing an ECL analysis using pulsed waveforms, according to embodiments disclosed herewith.

FIG. 19 illustrates a process of performing an ECL analysis using pulsed waveforms, according to embodiments disclosed herewith.

FIG. 20 illustrates a process of manufacturing a well, according to embodiments disclosed herewith.

FIGS. 21A-21F and 22A illustrates exemplary stages in a process of manufacturing a well, according to embodiments disclosed herewith.

FIG. 22B illustrates embodiments of a well according to the present disclosure.

FIGS. 23A-23D illustrate several examples of electrode configuration in which tests were performed, according to embodiments disclosed herewith.

FIGS. 24A-24C, 25A-25C, 26A-26D, 27A-27C, and 28 illustrate test results performed on various multi-well plates, according to embodiments disclosed herewith.

FIGS. 29, 30, 31A, 31B, 32A, 32B, 33A, 33B, 34A, 34B, 35, 36A, 36B, 37A, and 37B illustrate tests performed to optimize waveforms for coating of plasma-treated electrodes versus standard electrodes, according to embodiments disclosed herewith.

FIGS. 38A-39E illustrate examples of electrochemical cells consistent with embodiments hereof.

### DETAILED DESCRIPTION

Specific embodiments of the present invention are now described with reference to the figures. The following detailed description is merely exemplary in nature and is not intended to limit the present invention or the application and uses thereof. Furthermore, there is no intention to be bound by any expressed or implied theory presented in the preceding technical field, background, brief summary or the following detailed description.

Embodiments of the present disclosure are directed to electrochemical cells including an auxiliary electrode design and electrochemical analysis apparatuses and devices including the electrochemical cells. In embodiments, the auxiliary electrodes are designed to include a redox couple (e.g., Ag/AgCl) that provides a stable interfacial potential. In certain embodiments, materials, compounds, etc., can be doped to create a redox couple, although other manners of creating redox couples are contemplated as well. The auxiliary electrodes with a reduction-oxidation couple that defines a stable interfacial potential allows the auxiliary electrodes to serve as dual-function electrodes. That is, the one or more auxiliary electrodes operate concurrently as a counter electrode and a reference electrode. Because the auxiliary electrodes operate as dual-function electrodes, the space occupied by the auxiliary electrodes in an electrochemical cell is reduced thereby allowing additional configurations and numbers of working electrode zones to be included in the electrochemical cell.

In embodiments, the utilization of the one or more auxiliary electrodes also improves read times for electrochemical analysis apparatuses and devices during electrochemical analysis processes, for example, ECL processes. While it is common in conventional unreferenced ECL systems to employ slow voltage ramps that pass through the voltage that provides maximum ECL to provide tolerance to variability in the potential at the auxiliary electrode, the use of the auxiliary electrodes of the inventions, such as auxiliary electrode comprising a redox couple, provides improved control over this potential and enables the use of more efficient and faster waveforms such as short voltage pulses or fast voltage ramps.

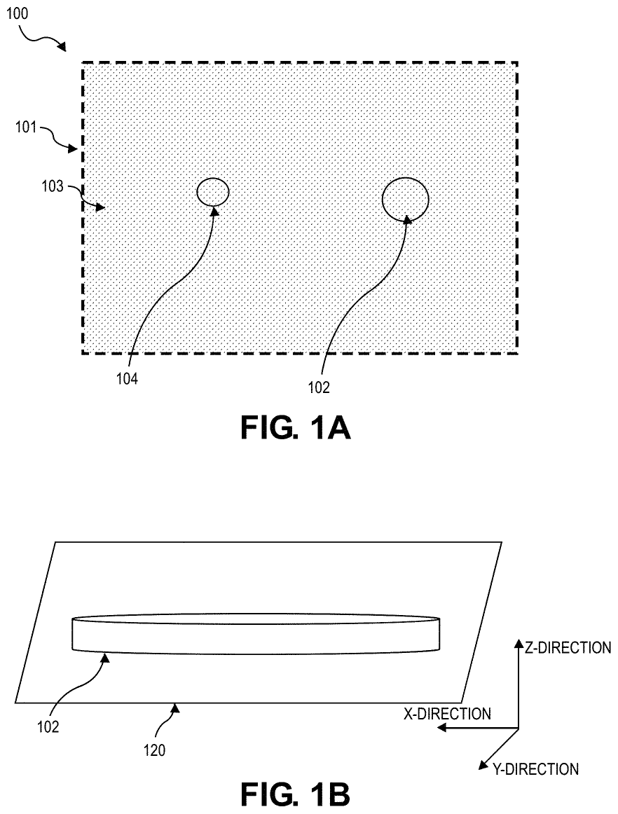

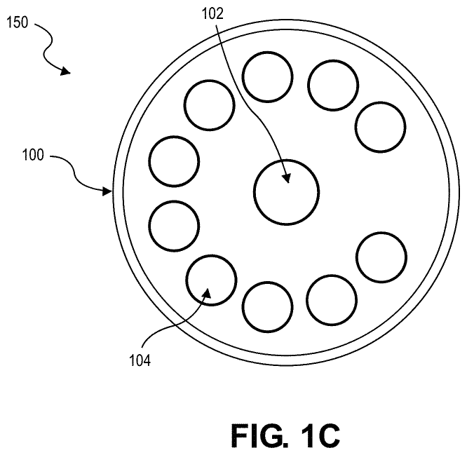

FIG. 1A illustrates an example of an electrochemical cell 100 in accordance with an embodiment hereof. As illustrated in FIG. 1A, the electrochemical cell 100 defines a working space 101 in which electrical energy is utilized to cause one or more chemical reactions. Within the working space (or sample area) 101, the electrochemical cell 100 may include one or more auxiliary electrodes 102 and one or more working electrode zones 104. The auxiliary electrode 102 and the working electrode zone 104 may be in contact with an ionic medium 103. The electrochemical cell 100 can operate through reduction-oxidation (redox) reactions caused by introducing electrical energy via the auxiliary electrode 102 and the working electrode zone 104. In some embodiments, the ionic medium 103 may include an electrolyte solution such as water or other solvent in which ions are dissolved, such as salts. In some embodiments, as described below in further detail, the ionic medium 103 or a surface of working electrode 102 may include luminescent species that generate and emit photons during the redox reaction. During operation of the electrochemical cell 100, an external voltage may be applied to one or more of auxiliary electrode 102 and the working electrode zone 104 to cause redox reactions to occur at these electrodes.

As described herein, when in use an auxiliary electrode will have an electrode potential that may be defined by the redox reactions occurring at the electrode. The potential may be defined, according to certain non-limiting embodiments, by: (i) a reduction-oxidation (redox) couple confined to the surface of the electrode or (ii) a reduction-oxidation (redox) couple in solution. As described herein, a redox couple includes a pair of elements, chemical substances, or compounds that interconvert through redox reactions, e.g., one element, chemical substance, or compound that is an electron donor and one element, chemical substance, or compound that is an electron acceptor. Auxiliary electrodes with a reduction-oxidation couple that defines a stable interfacial potential can serve as a dual-function electrodes. That is, the one or more auxiliary electrodes 102 may provide the functionality associated with both the counter and reference electrodes in a three electrode electrochemical system by providing high current flow (the function of the counter electrode in the three electrode system) while providing the ability to define and control the potential at the working electrodes (the function of the reference electrode in the three electrode system). The one or more auxiliary electrodes 102 may operate as a counter electrode by providing a potential difference with one or more of the one or more working electrode zones 104 during redox reactions that occur in the electrochemical cell 100 in which the one or more auxiliary electrodes 102 are located. Based on a chemical structure and composition of the one or more auxiliary electrodes 102, the one or more auxiliary electrodes 102 may also operate as a reference electrode for determining a potential difference with one or more of the working electrode zones 104.

In embodiments, the auxiliary electrode 102 may be formed of a chemical mixture of elements and alloys with a chemical composition permitting the auxiliary electrode 102 to function as a reference electrode. The chemical mixture (e.g., the ratios of elements and alloys in the chemical composition of the auxiliary electrode) can provide a stable interfacial potential during a reduction or oxidization of the chemical mixture, such that a quantifiable amount of charge is generated throughout the reduction-oxidation reactions occurring in the electrochemical cell 100. Although certain reactions described herein may be referred to as reduction or oxidation reactions, it is understood that the electrodes described herein can support both reduction and oxidation reactions, depending on the voltages applied. Specific descriptions of reduction or oxidation reactions do not limit the functionality of the electrodes to a specific type of reaction. In some embodiments, the chemical mixture of the one or more auxiliary electrodes 102 may include an oxidizing agent that provides a stable interfacial potential during a reduction of the chemical mixture, and an amount of the oxidizing agent in the chemical mixture may be greater than or equal to an amount of oxidizing agent required to provide for the entirety of the reduction-oxidation reactions in the electrochemical cell that occur during electrochemical reactions. In embodiments, the auxiliary electrode 102 is formed of a chemical mixture that provides a interfacial potential during a reduction of the chemical mixture, such that a quantifiable amount of charge is generated throughout the reduction-oxidation reactions occurring in the electrochemical cell 100. The chemical mixture of an auxiliary electrode 102 includes an oxidizing agent that supports redox reactions during operations of the electrochemical cell 100, e.g., during biological, chemical, and/or biochemical assays and/or analysis, such as, ECL generation and analysis.

In an embodiment, an amount of an oxidizing agent in a chemical mixture of the one or more auxiliary electrodes 102 is greater than or equal to an amount of oxidizing agent required for an entirety of a redox reaction that is to occur in the electrochemical cell 100, e.g., during one or more biological, chemical, and/or biochemical assays and/or analysis, such as ECL generation. For example, a sufficient amount of the chemical mixture in the one or more auxiliary electrodes 102 will still remain after a redox reaction occurs for an initial biological, chemical, and/or biochemical assays and/or analysis, thus allowing one or more additional redox reactions to occur throughout subsequent biological, chemical, and/or biochemical assays and/or analysis.

In some embodiments, an amount of an oxidizing agent in a chemical mixture of the one or more auxiliary electrodes 102 is based at least in part on a ratio of an exposed surface area (also referred to as areal surface area) of each of the one or more working electrode zones 104 to an exposed surface area of the one or more auxiliary electrode 102. As described herein, exposed surface area (also referred to as areal surface area) of the one or more auxiliary electrodes 102 refers to a two-dimensional (2D) cross-sectional area of the one or more auxiliary electrodes 102 that is exposed to the ionic medium 103. That is, as illustrated in FIG. 1B, an auxiliary electrode 102 may be formed in a three-dimensional (3D) shape that extends from a bottom surface of the electrochemical cell 100 in the Z-direction. The exposed surface area of the auxiliary electrode 102 may correspond to a 2D cross-sectional area taken in the X-Y plane. In embodiments, the 2D cross-sectional area may be taken at any point of the auxiliary electrode 102, for example, at the interface with the bottom surface 120. While FIG. 1B illustrates the auxiliary electrode 102 being a regularly shaped cylinder, the auxiliary electrode 102 may have any shape whether regular or irregular. Likewise, the exposed surface area of the one or more working electrode zones 104 refers to a 2D cross-sectional area of the one or more auxiliary electrode zones 104 that is exposed to the ionic medium 103, for example, similar to the 2D cross-sectional area of the auxiliary electrode 102 described in FIG. 1B. In certain embodiments, the areal surface area (exposed surface area) can be distinguished from the true surface area, which would include the actual surface of the electrode, accounting for any height or depth in the z-dimension. Using these examples, the areal surface area is less than or equal to the true surface area.

In embodiments, the one or more auxiliary electrodes 102 may be formed of a chemical mixture that includes a redox couple that provides an interfacial potential that is at or near the standard reduction potential for the redox couple. In some embodiments, the one or more auxiliary electrodes 102 may including a mixture of silver (Ag) and silver chloride (AgCl), or other suitable metal/metal halide couples. In some embodiments, the one or more auxiliary electrodes 102, formed of a mixture of Ag/AgCl can provide an interfacial potential that is at or near the standard reduction potential for Ag/AgCl, approximately 0.22 V. Other examples of chemical mixtures may include metal oxides with multiple metal oxidation states, e.g., manganese oxide, or other metal/metal oxide couples, e.g., silver/silver oxide, nickel/nickel oxide, zinc/zinc oxide, gold/gold oxide, copper/copper oxide, platinum/platinum oxide, etc.) In some embodiments, the chemical mixture may provide an interfacial potential that ranges from approximately 0.1 V to approximately 3.0 V. Table 1 lists examples of reduction potentials of redox couples for chemical mixtures, which may be included in the one or more auxiliary electrodes 102. One skilled in the art will realize that the examples of reduction potentials are approximate values and may vary by, for example, +/−5.0% based on chemical composition, temperature, impurities in the chemical mixture, or other conditions.

TABLE 1
Reduction Potential at approximately 25 degrees Celsius

| Redox Couple | Approximate Reduction Potential (V) |
|---|---|
| Ag - AgCl | 0.22 |
| Ag - Ag₂O | 1.17 |
| Ag - Ag₂O₃ | 1.67 |
| Ag - AgO | 1.77 |
| Mn - MnO₂ | 1.22 |
| Ni - NiO₂ | 1.59 |
| Fe - Fe₂O₃ | 0.22 |
| Au - AuCl₂ | 1.15 |
| Pt - PtCl₆ | 0.73 |
| Au - AuCl₄ | 0.93 |
| Pt - PtCl₄ | 0.73 |

In embodiments, the chemical mixture of the redox couple in the one or more auxiliary electrodes can be based on a molar ratio of the redox couple that falls within a specified range. In some embodiments, the chemical mixture has a molar ratio of Ag to AgCl within a specified range, for example, approximately equal to or greater than 1. In some embodiments, the one or more auxiliary electrodes 102 may maintain a controlled interfacial potential until all of one or more chemical moieties, involved in the redox reaction, have been oxidized or reduced.

In some embodiments, the one or more auxiliary electrodes 102 may include a redox couple that maintains an interface potential of between −0.15 V to −0.5 V while passing a charge of approximately 1.56×10⁻⁵ to 5.30×10⁻⁴ C/mm² of electrode surface area. In some embodiments, the one or more auxiliary electrodes 102 may include a redox couple that passes approximately 0.5 mA to 4.0 mA of current throughout a redox reaction of the redox couple to generate ECL at a range of approximately 1.4 V to 2.6 V. In some embodiments, the one or more auxiliary electrodes 102 may include a redox couple that passes an average current of approximately 2.39 mA throughout a redox reaction to generate ECL at a range of approximately 1.4 V to 2.6 V.

In embodiments, the one or more auxiliary electrodes 102 may an amount of an oxidizing agent in the redox couple is greater than or equal to an amount of charge required to pass through the auxiliary electrode to complete the electrochemical analysis. In some embodiments, the one or more auxiliary electrodes 102 may include approximately 3.07×10⁻⁷ to 3.97×10⁻⁷ moles of oxidizing agent. In some embodiments, the one or more auxiliary electrodes 102 may include between approximately 1.80×10⁻⁷ to 2.32×10⁻⁷ moles of oxidizing agent per mm² (1.16×10⁻⁷ to 1.5×10⁻⁴ moles/in²) of exposed surface area. In some embodiments, the one or more auxiliary electrodes 102 may include at least approximately 3.7×10⁻⁹ moles of oxidizing agent per mm² (2.39×10⁻⁶ moles/in²) of total (or aggregate) exposed surface area of the one or more working electrode zones 104. In some embodiments, the one or more auxiliary electrodes may include at least approximately 5.7×10⁻⁹ moles of oxidizing agent per mm² (3.69×10⁻⁶ moles/in²) of total (or aggregate) exposed surface area of the one or more working electrode zones 104.

In embodiments, the one or more auxiliary electrodes 102 may include a redox couple where, when a voltage or potential is applied, a reaction of a species in the redox couple is a predominate redox reaction occurring at the one or more auxiliary electrodes 102. In some embodiments, the applied potential is less than a defined potential required to reduce water or perform electrolysis of water. In some embodiments, less than 1 percent of current is associated with the reduction of water. In some embodiments, less than 1 of current per unit area (exposed surface area) of the one or more auxiliary electrodes 102 is associated with the reduction of water.

In embodiments, the one or more auxiliary electrodes 102 (and the one or more working electrode zones 104) may be formed using any type of manufacturing process, e.g., printing, deposition, lithography, etching etc. In embodiments, a form of the chemical mixture of metal/metal halide can depend on the manufacturing process. For example, if one or more auxiliary electrodes 102 (and the one or more working electrode zones 104) are printed, the chemical mixture may be in the form of an ink or paste.) In some embodiments, one or more additional substances may be added to the one or more auxiliary electrodes 102 and/or the one or more working electrode zones 104 utilizing a doping process.

The working electrode zones 104 may be locations on an electrode on which a reaction of interest can occur. Reactions of interest may be chemical, biological, biochemical, electrical in nature (or any combination of two or more of these types of reactions). As described herein, an electrode (auxiliary electrode and/or working electrode) may be a continuous/contiguous area for which a reaction can occur, and an electrode “zone” may be a portion (or the whole) of the electrode on which a particular reaction of interest occurs. In certain embodiments, a working electrode zone 104 may comprise an entire electrode, and in other embodiments, more than one working electrode zone 104 may be formed within and/or on a single electrode. For example, the working electrode zones 104 may be formed by individual working electrodes. In this example, the working electrode zones 104 may be configured as a single electrode formed of one or more conducting materials. In another example, the working electrode zones 104 may be formed by isolating portions of a single working electrode. In this example, a single working electrode may be formed of one or more conducting materials, and the working electrode zones may be formed by electrically isolating areas (“zones”) of the single working electrode using insulating materials such as a dielectric to create electrically isolated working electrode zones. In any embodiment, the working electrode zones 104 may be formed of any type of conducting materials such as metals, metal alloys, carbon compounds, doped metals, etc. and combinations of conducting and insulating materials.

In embodiments, the working electrode zones 104 may be formed of a conductive material. For example, the working electrode zones 104 may include a metal such as gold, silver, platinum, nickel, steel, iridium, copper, aluminum, a conductive alloy, or the like. In some embodiments, the working electrode zones 104 may include oxide coated metals (e.g., aluminum oxide coated aluminum). In some embodiments, the working electrode zones 104 may be formed of carbon-based materials such as carbon, carbon black, graphitic carbon, carbon nanotubes, carbon fibrils, graphite, carbon fibers and mixtures thereof. In some embodiments, the working electrode zones 104 may be formed of conducting carbon-polymer composites, conducting particles dispersed in a matrix (e.g., carbon inks, carbon pastes, metal inks), and/or conducting polymers. In some embodiments, as disclosed below in further detail, the working electrode zones 104 may be formed of carbon and silver layers fabricated using screen printing of carbon inks and silver inks. In some embodiments, the working electrode zones 104 may be formed of semiconducting materials (e.g., silicon, germanium) or semi-conducting films such as indium tin oxide (ITO), antimony tin oxide (ATO) and the like.

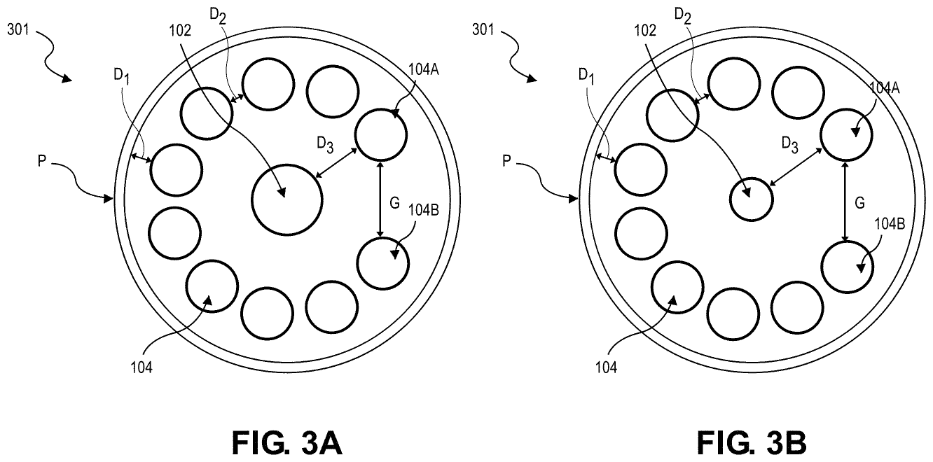

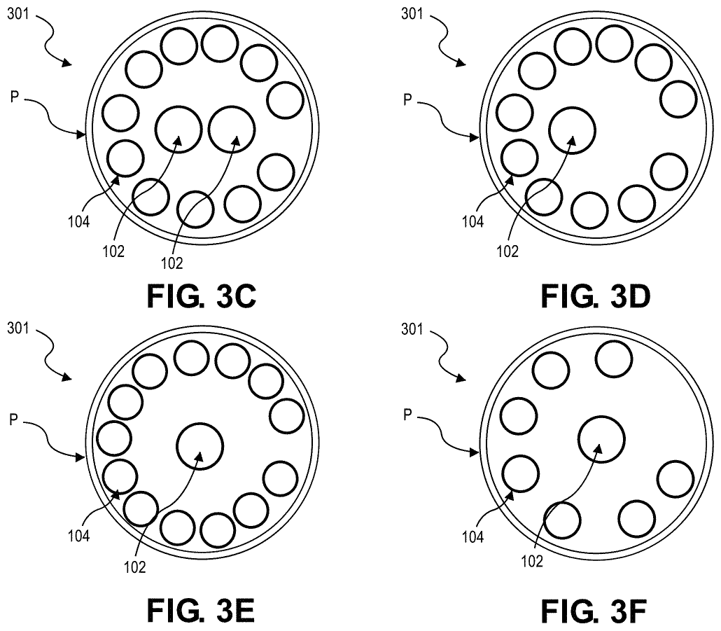

In embodiments, as described below in further detail, the one or more auxiliary electrodes 102 and the one or more working electrode zones 104 may be formed in different electrode designs (e.g., different sizes and/or shapes, different numbers of auxiliary electrodes 102 and working electrode zones 104, different positioning and patterns within the electrochemical cell 100, etc.) to improve electrochemical properties and analysis (e.g., ECL analysis) performed by apparatus and devices containing the electrochemical cell. FIG. 1C illustrates one example of an electrode design 150 for the electrochemical cell 100 including multiple working electrode zones. As illustrated in FIG. 1C, the electrochemical cell 100 may include ten (10) working electrode zones 104 and a single auxiliary electrode 102. Various other examples of the electrode design are discussed below in reference to FIGS. 3A-3F, 4A-4F, 5A-5C, 6A-6F, 7A-7F, and 8A-8D.

In embodiments, a configuration and placement of the working electrodes zones 104 within the electrochemical cell 100 may be defined according to an adjacency between the working electrode zones 104 and/or adjacency between the working electrode zones 104 and the one or more auxiliary electrodes 102. In some embodiments, adjacency can be defined as a relative number of neighboring working electrode zones 104 and/or the one or more auxiliary electrodes 102. In some embodiments, adjacency can be defined as a relative distance between the working electrode zones 104 and/or the one or more auxiliary electrodes 102. In some embodiments, adjacency can be defined as a relative distance from the working electrode zones 104 and/or the one or more auxiliary electrodes 102 to other features of the electrochemical cell 100 such as a perimeter of the electrochemical cell.

In embodiments in accordance herewith, for example, the one or more auxiliary electrodes 102 and the one or more working electrode zones 104 of a respective electrochemical cell 100 may be formed to have respective sizes such that a ratio of an aggregate of exposed surface area of the one or more working electrode zones 104 to an exposed surface area of the one or more auxiliary electrodes 102 is greater than 1, although other ratios are contemplated as electrochemical cell 100 (e.g., ratios equal to or less than or greater than 1). In some embodiments in accordance herewith, for example, each of the one or more auxiliary electrodes 102 and/or the one or more working electrode zones 104 may be formed in a circular shape having surface area that substantially defines a circle, although other shapes (e.g., rectangles, squares, ovals, clovers, or any other regular or irregular geometric shape).

In embodiments in accordance herewith, for example, the one or more auxiliary electrodes 102 and/or the one or more working electrode zones 104 may be formed in a wedge shape having a wedged-shape surface area, also referred to herein as a trilobe shape. That is, the one or more auxiliary electrodes 102 and/or the one or more working electrode zones 104 may be formed having two opposing boundaries that have different dimensions, and two side boundaries that connect the two opposing boundaries. For example, the two opposing boundaries may include a wide boundary and a narrow boundary, where the wide boundary has a length that is longer than the narrow boundary. In some embodiments, the wide boundary and/or the narrow boundary may be blunt, e.g., rounded corners at a connection to the side boundaries. In some embodiments, the wide boundary and/or the narrow boundary may be sharp, e.g., angular corner at a connection to the side boundaries. In embodiments, the wedge shape described herein may be generally trapezoidal, with rounded or angular corners. In embodiments, the wedge shape described herein may be generally triangular with a flattened or rounded apex and rounded or angular corners. In embodiments, the wedge shape may be utilized to maximize the available area at the bottom surface 120 of the electrochemical cell. For example, if the working area 101 of the electrochemical cell is circular, one or more working electrode zones 104, with the wedge shape, can be arranged such that the wide boundary is adjacent to an outer perimeter of the working area 101 and the narrow boundary is adjacent to a center of the working area 101.

In embodiments, the electrochemical cell 100 may be included in an apparatus or device for performing electrochemical analysis. In some embodiments, the electrochemical cell 100 can form a portion of a well for an assay device that performs electrochemical analysis, such as an ECL immunoassay, as described below. In some embodiments, the electrochemical cell 100 may form a flow cell in a cartridge that is used in an analysis device or apparatus, e.g., ECL cartridges (such as, for example, those provided in U.S. Pat. Nos. 10,184,884 and 10,935,547), flow cytometers, etc. One skilled in the art will realize that the electrochemical cell 100 may be utilized in any type of apparatus or device in which a controlled redox reaction is performed.

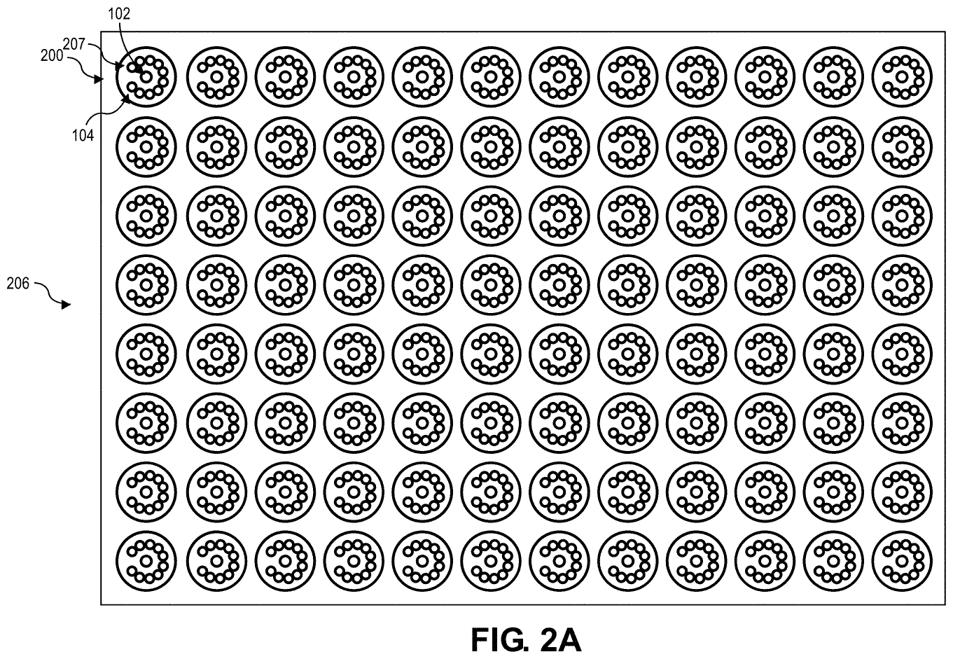

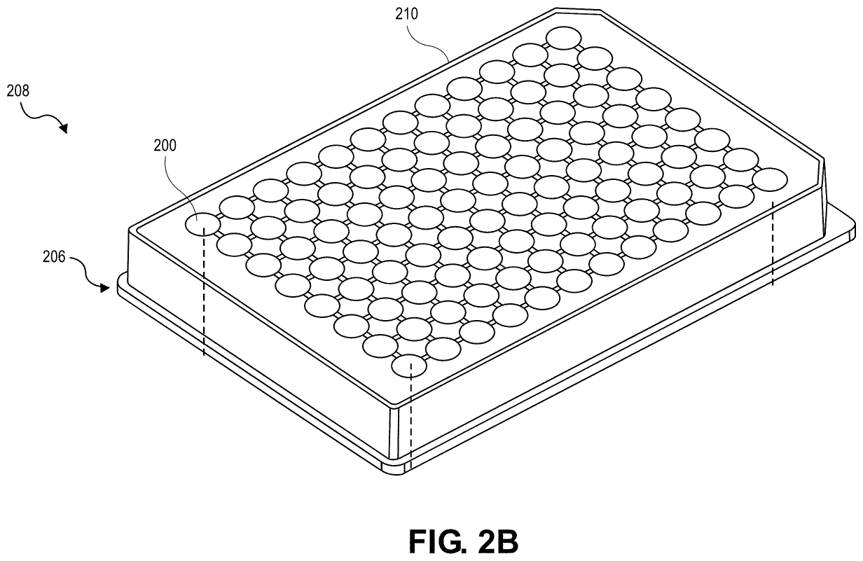

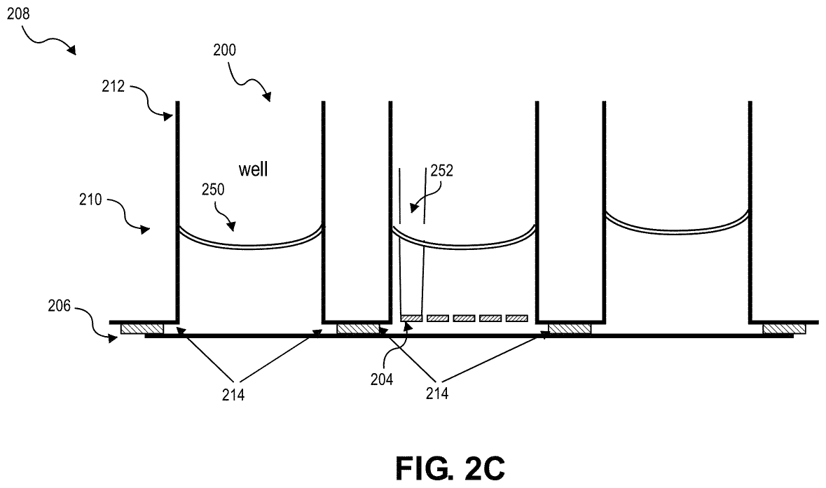

FIGS. 2A-2C illustrate several views of a sample area (“well”) 200 including an electrochemical cell (e.g., electrochemical cell 100), including an auxiliary electrode design, for use in an assay device for biological, chemical, and/or biochemical analysis in accordance with an embodiment hereof. One skilled in the art will realize that FIGS. 2A-2C illustrate one example of wells in an assay device and that existing components illustrated in FIGS. 2A-2C may be removed and/or additional components may be added without departing from the scope of embodiments described herein.

As illustrated in FIG. 2A, which is a top view, a base plate 206 of a multi-well plate 208 (illustrated in FIG. 2B) may include multiple wells 200. The base plate 206 may include a surface that forms a bottom portion of each well 200 and may include one or more auxiliary electrodes 102 and one or more working electrode zones 104 disposed on and/or within the surface of the base plate 206 of the multi-well plate 208. As illustrated in FIG. 2B, which is a perspective view, the multi-well plate 208 may include a top plate 210 and the base plate 206. The top plate 210 may define the wells 200 that extend from a top surface of the top plate 210 to the base plate 206, where the base plate 206 forms a bottom surface 207 of each well 200. In operation, light generation occurs when a voltage is applied across the one or more working electrode zones 104 and the one or more auxiliary electrodes 102 located in a well 200 that holds a material under testing. The applied voltage triggers a cyclical oxidation and reduction reaction, which causes photon (light) generation and emission. The emitted photon may then be measured to analyze the material under testing.

Depending on whether the reaction occurring at a working electrode zone 104 is accepting or supplying electrons, the reaction at the working electrode zone 104 is a reduction or an oxidation, respectively. In embodiments, the working electrode zones 104 may be derivatized or modified, for example, to immobilize assay reagents such as binding reagents on electrodes. For example, the working electrode zones 104 may be modified to attach antibodies, fragments of antibodies, proteins, enzymes, enzyme substrates, inhibitors, cofactors, antigens, haptens, lipoproteins, liposaccharides, bacteria, cells, sub-cellular components, cell receptors, viruses, nucleic acids, antigens, lipids, glycoproteins, carbohydrates, peptides, amino acids, hormones, protein-binding ligands, pharmacological agents, and/or combinations thereof. Likewise, for example, the working electrode zones 104 may be modified to attach non-biological entities such as, but not limited to polymers, elastomers, gels, coatings, ECL tags, redox active species (e.g., tripropylamine, oxalates), inorganic materials, chemical functional groups, chelating agents, linkers etc. Reagents may be immobilized on the one or more working electrode zones 104 by a variety of methods including passive adsorption, specific binding and/or through the formation of covalent bonds to functional groups present on the surface of the electrode.

For example, ECL species may be attached to the working electrode zones 104 that may be induced to emit ECL for analytical measurements to determine the presence of a substance of interest in a fluid in the well 200. For example, species that may be induced to emit ECL (ECL-active species) have been used as ECL labels. Examples of ECL labels include: (i) organometallic compounds where the metal is from, for example, the noble metals that are resistant to corrosion and oxidation, including Ru-containing and Os-containing organometallic compounds such as the tris-bipyridyl-ruthenium (RuBpy) moiety and ii) luminol and related compounds. Species that participate with the ECL label in the ECL process are referred to herein as ECL coreactants. Commonly used coreactants include tertiary amines such as triisopropylamine (TPA), oxalate, and persulfate for ECL from RuBpy and hydrogen peroxide for ECL from luminol. The light generated by ECL labels may be used as a reporter signal in diagnostic procedures. For instance, an ECL label may be covalently coupled to a binding agent such as an antibody or nucleic acid probe; the participation of the binding reagent in a binding interaction may be monitored by measuring ECL emitted from the ECL label. Alternatively, the ECL signal from an ECL-active compound may be indicative of the chemical environment.

In embodiments, the working electrode zones 104 and/or the auxiliary electrodes 102 (or other components of the well 200) may also be treated (e.g., pretreated) with materials and/or processes that improve attachment (e.g., absorption) of materials, used in the electrochemical processes (e.g., reagents, ECL species, labels, etc.), to the surface of the working electrode zones 104 and/or the auxiliary electrodes. In some embodiments, the working electrode zones 104 and/or the auxiliary electrodes 102 (or other components of the well 200) may be treated using a process (e.g., plasma treatment) that causes a surface of the working electrode zones 104 and/or the auxiliary electrodes 102 (or other components of the well 200) to exhibit hydrophilic properties (also referred to herein as “High Bind” or “HB”). In some embodiments, the working electrode zones 104 and/or the auxiliary electrodes 102 (or other components of the well 200) may be untreated or treated using a process that causes a surface of the working electrode zones 104 and/or the auxiliary electrodes 102 (or other components of the well 200) to exhibit hydrophobic properties (also referred to herein as “Standard” or “Std”).

As illustrated in FIG. 2C, which is a side sectional view of a portion of the multi-well plate 208 of FIG. 2B, a number of the wells 200 may be included on the multi-well plate 208—three of which are shown in FIG. 2C. Each well 200 may be formed by the top plate 210 that includes one or more sidewalls 212 that form a boundary of the electrochemical cell 100. The one or more sidewalls 212 that extend from a bottom surface of the top plate 210 to the top surface of the top plate 210. The wells 200 may be adapted to hold one or more fluids 250, such as an ionic medium as described above. In certain embodiments, one or more wells 200 may be adapted to hold gases and/or solids in place of or in addition to the one or more fluids 250. In embodiments, the top plate 210 may be secured to the base plate 206 with an adhesive 214 or other connection material or device.

The multi-well plate 208 may include any number of the wells 200. For example, as illustrated in FIGS. 2A and 2B, the multi-well plate 208 may include 96 wells 200. One skilled in the art will realize that the multi-well plate 208 may include any of number of the wells 200 such as 6 wells, 24, 384, 1536, etc., formed in a regular or irregular pattern. In other embodiments, the multi-well plates 208 may be replaced by a single-well plate or any other apparatus suitable for conducting biological, chemical, and/or biochemical analysis and/or assays. Although wells 200 are depicted in FIGS. 2A-2C in a circular configuration (thus forming cylinders) other shapes are contemplated as well, including ovals, squares, and/or other regular or irregular polygons. Further, the shape and configuration of multi-well plate 108 can take multiple forms and are not necessarily limited to a rectangular array as illustrated in these figures.

In some embodiments, as discussed above, the working electrode zones 104 and/or the auxiliary electrodes 102 used in the multi-well plate 108 may be non-porous (hydrophobic). In some embodiments, the working electrode zones 104 and/or the auxiliary electrodes 102 may be porous electrodes (e.g., mats of carbon fibers or fibrils, sintered metals, and metals films deposited on filtration membranes, papers or other porous substrates). When configured as porous electrodes, the working electrode zones 104 and/or the auxiliary electrodes 102 can employ filtration of solutions through the electrode so as to: i) increase mass transport to the electrode surface (e.g., to increase the kinetics of binding of molecules in solution to molecules on the electrode surface); ii) capture particles on the electrode surface; and/or iii) remove liquid from the well.

In embodiments as discussed above, each of the auxiliary electrodes 102 in the wells 200 is formed of a chemical mixture that provides a defined potential during a reduction of the chemical mixture, such that a quantifiable amount of charge is generated throughout the reduction-oxidation reactions occurring in the well 200. The chemical mixture of an auxiliary electrode 102 includes an oxidizing agent that supports reduction-oxidation reaction, which can be used during biological, chemical, and/or biochemical assays and/or analysis, such as, for example, ECL generation and analysis. In an embodiment, an amount of an oxidizing agent in a chemical mixture of an auxiliary electrode 102 is greater than or equal to an amount of oxidizing agent required for the amount of charge that will pass through the auxiliary electrode, and/or the amount of charge needed to drive the electrochemical reactions at the working electrodes in the at least one well 200 during one or more biological, chemical, and/or biochemical assays and/or analysis, such as ECL generation. In this regard, a sufficient amount of the chemical mixture in the auxiliary electrode 102 will still remain after a redox reaction occurs for an initial biological, chemical, and/or biochemical assays and/or analysis, thus allowing one or more additional redox reactions to occur throughout subsequent biological, chemical, and/or biochemical assays and/or analysis. In another embodiment, an amount of an oxidizing agent in a chemical mixture of an auxiliary electrode 102 is at least based in part on a ratio of an exposed surface area of each of the plurality of working electrode zones to an exposed surface area of the auxiliary electrode.

In embodiments, the one or more auxiliary electrodes 102 of the well 200 may be formed of a chemical mixture that includes a redox couple, as discussed above. In some embodiments, the one or more auxiliary electrodes 102 of the well 200 may be formed of a chemical mixture that includes a mixture of silver (Ag) and silver chloride (AgCl), or other suitable metal/metal halide couples. Other examples of chemical mixtures can include metal oxides with multiple metal oxidation states, e.g., manganese oxide, or other metal/metal oxide couples, e.g., silver/silver oxide, nickel/nickel oxide, zinc/zinc oxide, gold/gold oxide, copper/copper oxide, platinum/platinum oxide, etc.) In embodiments, the auxiliary electrodes 102 (and the working electrode zones 104) may be formed using any type of manufacturing process, e.g., printing, deposition, lithography, etching etc. In embodiments, the form of the chemical mixture of metal/metal halide may depend on the manufacturing process. For example, if the auxiliary electrodes are printed, the chemical mixture may be in the form of an ink or paste.

For certain applications, such as ECL generation, various embodiments of the auxiliary electrodes 102 could be adapted to prevent polarization of the electrode throughout ECL measurements by including a sufficiently high concentration of accessible redox species. The auxiliary electrodes 102 may be formed by printing the auxiliary electrodes 102 on the multi-well plate 208 using an Ag/AgCl chemical mixture (e.g., ink, paste, etc.) that has a defined ratio of Ag to AgCl. In an embodiment, an amount of oxidizing agent in a chemical mixture of an auxiliary electrode is at least based in part of a ratio of Ag to AgCl in the chemical mixture of the auxiliary electrode. In an embodiment, a chemical mixture of an auxiliary electrode having Ag and AgCl comprises approximately 50 percent or less AgCl, for example, 34 percent, 10 percent, etc.

In some embodiments, the one or more auxiliary electrodes 102 in a well 200 may include at least approximately 3.7×10⁻⁹ moles of oxidizing agent per mm² of total working electrode area in the well 200. In some embodiments, the one or more auxiliary electrodes 102 in a well 200 may include at least approximately 5.7×10⁻⁹ moles of oxidizing agent per mm² of total working electrode area in the well.

In various embodiments, the one or more auxiliary electrodes 102 and the working electrode zones 104 may be formed in different electrode designs (e.g., different sizes and/or shapes, different numbers of auxiliary electrodes 102 and working electrode zones 104, different positioning and patterns within the well, etc.) to improve electrochemical analysis (e.g., ECL analysis) performed by an assay device including one or more of the wells 200, examples of which are discussed below in reference to FIGS. 3A-3F, 4A-4F, 5A-5C, 6A-6F, 7A-7F, and 8A-8D. In embodiments in accordance herewith, for example, the one or more auxiliary electrodes 102 and the one or more working electrode zones 104 of a respective well 200 may be formed to have respective sizes such that a ratio of an aggregate of exposed surface area of the working electrode zones 104 to an exposed surface area of the auxiliary electrodes 102 is greater than 1, although other ratios are contemplated as well (e.g., ratios equal to or less than or greater than 1). In embodiments in accordance herewith, for example, each of the auxiliary electrodes 102 and/or the working electrode zones 104 may be formed in a circular shape having surface area that substantially defines a circle, although other shapes (e.g., rectangles, squares, ovals, clovers, or any other regular or irregular geometric shape). In embodiments in accordance herewith, for example, the auxiliary electrodes 102 and/or the working electrode zones 104 may be formed in a wedge shape having a wedged-shape surface area, where a first side or end of the wedged-shape surface area, adjacent to a sidewall of the well 200, is greater than a second side or end of the wedged-shape surface area, adjacent a center of the well 200. In other embodiments the second side or end of the wedged-shape surface area is greater than the first side or end of the wedged-shape surface. For example, the auxiliary electrodes 102 and the working electrode zones 104 may be formed in a pattern that maximizes space available for the auxiliary electrodes 102 and the working electrode zones 104.

In some embodiments, the one or more auxiliary electrodes 102 and/or the one or more working electrode zones 104 may be formed having a wedge shape, where two opposing boundaries that have different dimensions, and two side boundaries that connect the two opposing boundaries. For example, the two opposing boundaries may include a wide boundary and a narrow boundary, where the wide boundary has a length that is longer than the narrow boundary. In some embodiments, the wide boundary and/or the narrow boundary may be blunt, e.g., rounded corners at a connection to the side boundaries. In some embodiments, the wide boundary and/or the narrow boundary may be sharp, e.g., angular corner at a connection to the side boundaries. In embodiments, the wedge shape may be utilized to maximize the available area at the bottom surface 120 of the electrochemical cell. For example, if the working area 101 of the electrochemical cell is circular, one or more working electrode zones 104, with the wedge shape, can be arranged such that the wide boundary is adjacent to an outer perimeter of the working area 101 and the narrow boundary is adjacent to a center of the working area 101.

In embodiments in accordance herewith, auxiliary electrodes 102 and one or more working electrode zones 104 of a respective well 200 may be formed in the bottom of a well 200 according to different positioning configurations or patterns. The different positioning configuration or patterns may improve electrochemical analysis (e.g., ECL analysis) performed by an assay device including one or more of the wells 200, examples of which are discussed below in reference to FIGS. 3A-3F, 4A-4F, 5A-5C, 6A-6F, 7A-7F, and 8A-8D. The auxiliary electrodes 102 and the working electrode zones 104 may be positioned within the well according to a desired geometric pattern. For example, the auxiliary electrodes 102 and the working electrode zones 104 may be formed in a pattern that minimizes the number of working electrode zones 104 that are adjacent to one another for each of the working electrode zones 104 among the total number of working electrode zones 104. This may allow for more working electrode zones to be positioned adjacent to an auxiliary electrode 102. For instance, as illustrated in FIGS. 3A-3F and described in detail below, the working electrode zones 104 may be formed in a circular or semicircular shape that minimizes the number of working electrode zones 104 that are adjacent to one another.

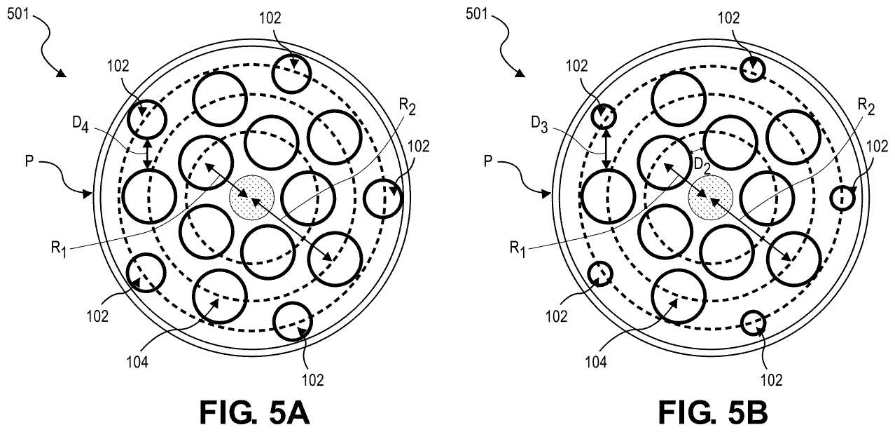

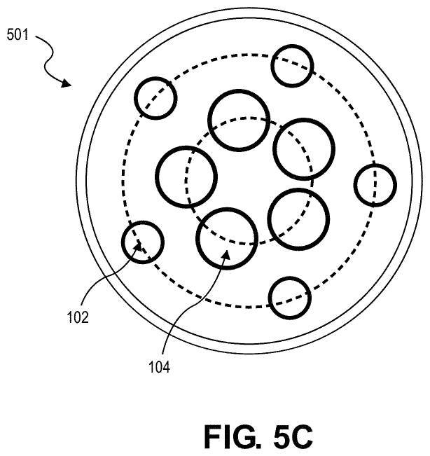

In another example, as illustrated in FIGS. 3A-3F, the auxiliary electrodes 102 and the working electrode zones 104 of a respective well 200 may be formed in a pattern where a number of the working electrode zones 104 that are adjacent to one another is no greater than two. For example, the working electrode zones 104 may be formed in a circular or semi-circular pattern adjacent to a parameter of a well (e.g., the sidewalls 212) such that at most two working electrode zones 104 are adjacent. In this example, the working electrode zones 104 form an incomplete circle such that two of the working electrode zones 104 have only one adjacent or neighboring working electrode zone 104. In another example, an auxiliary electrodes 102 and the working electrode zones 104 of a respective well 200 may be formed in a pattern where at least one of the working electrode zones 104 is adjacent to three or more other working electrode zones 104 among the total number of working electrode zones 104. For instance, as illustrated in FIGS. 5A-5C described in detail below, the auxiliary electrode 102 and the working electrode zones 104 may be formed in a star-shaped pattern where the number of adjacent the auxiliary electrodes 102 and/or the working electrode zones 104 is dependent on the number of points in the star-shaped pattern.

In an embodiment in accordance herewith, an auxiliary electrodes 102 and one or more working electrode zones 104 of a respective well 200 may be formed in a pattern where the pattern is configured to improve mass transport of a substance to each of the working electrode zones 104. For example, during orbital or rotational shaking or mixing, mass transport of substances to a zone at the center of the well 200 may be relatively slow compared to zone away from the center, and the pattern may be configured to improve mass transport by minimizing or eliminating the number of the working electrode zones 104 disposed at a center of a well 200. That is, during operations, the wells 200 may undergo orbital motion or “shaking” in order to mix or combine fluids contained within the wells 200. The orbital motion may cause a vortex to occur within the wells 200, e.g., leading to more liquid and faster liquid motion near the sidewalls 212 (perimeter) of the wells 200. For instance, as illustrated in FIGS. 2A-2F, 3A-3F, 5A-5F, 6A-6F, and 7A-7D describe in detail below, the working electrode zones 104 may be formed in a circular or semicircular shape and located near a perimeter of the well 200. Furthermore, due to the orbital shaking motion, any variations in substance concentration within the well may depend on a radial distance from the center of the well. In a concentric arrangement, the working electrode zones 104 are each approximately a same distance from a center of the well and may therefore have a similar substance concentration, even if the substance concentration is not uniform throughout the well.

In an embodiment in accordance herewith, auxiliary electrodes 102 and one or more working electrode zones 104 of respective wells 200 may be formed in a pattern where the pattern is configured to reduce meniscus effects caused by introducing liquid into one or more of the wells 200 of the multi-well plate 108. For example, as illustrated in FIG. 2C, the fluid 250 in the well 200 may form a curved upper surface or meniscus 152 within the well 200. The curved upper surface may be caused by several factors, such as surface tension, electrostatic effects, and fluid motion (e.g., due to orbital shaking), and the like. Due to the meniscus effects, photons (light) emitted during luminescence undergoes different optical effects (e.g., refraction, diffusion, scattering, etc.) based on the photons optical path through the liquid. That is, as light is emitted from the substances in the well 200, the different levels of the liquid may cause different optical effects (e.g., refraction, diffusion, scattering, etc.) in the emitted light that is dependent on where the light travels through and exits the liquid. The pattern may mitigate meniscus effects by disposing each of the working electrode zones 104 at an approximate equal distance from each sidewall 212 of the well 200. As such, photons emitted from the working electrode zones 104 travel a similar optical path through the liquid. In other words, the pattern ensures that all working electrode zones 104 are equally affected by meniscus effects, e.g., minimizes potential disparate effects of the meniscus. Thus, if the working electrode zones 104 are positioned at difference locations relative to the level of the liquid in the well 200, the emitted light may undergo differing optical distortions. For instance, as illustrated in FIGS. 3A-3F, 4A-4F, 6A-6F, 7A-7F, and 8A-8D describe in detail below, the working electrode zones 104 may be formed in a circular or semicircular shape and located near a perimeter of the well 200. As such, light emitted at the working electrode zones 104 may undergo the same optical distortion and be equally addressed.

In an embodiment in accordance herewith, an auxiliary electrode 102 and one or more working electrode zones 104 of respective wells 200 may be formed in a pattern configured to minimize the mass transport differences (e.g., provide more uniform mass transport) to working electrode zones during mixing of liquids (e.g., vortices formed in cylindrical wells using an orbital shaker) in one or more of the wells 200 of the multi-well plate 208. For example, the pattern may be configured to reduce vortex effects by minimizing or eliminating the number of working electrode zones 104 disposed at or near the center of a respective well 200. For instance, as illustrated in FIGS. 2A-2F, 3A-3F, 5A-5F, 6A-6F, 7A-7D, and 8A describe in detail below, the working electrode zones 104 may be formed in a circular or semicircular shape and located near a perimeter of the well 200.

In an embodiment in accordance herewith, an auxiliary electrode 102 and one or more working electrode zones 104 of a respective well 200 may be formed in a geometric pattern. For example, the geometric pattern may include a circular or semi-circular pattern of working electrode zones 104, wherein each of the working electrode zones 104 may be disposed at an approximately equal distance from a sidewall of the well 200, and an auxiliary electrodes 102 that may be disposed within a perimeter (either the entire perimeter or just a portion of it) defined by the circular or the semi-circular pattern of the working electrode zones 104, although other shapes and/or patterns are contemplated as well. For example, when well 200 is embodied as a square-shaped well, the working electrode zones 104 may be arranged in a square- or rectangular-shaped ring pattern around the entire or just a portion of the perimeter of the well 200.

In another embodiment, for example, a geometric pattern may include a pattern where the working electrode zones 104 define a star-shaped pattern, wherein an auxiliary electrode 102 may be disposed between two adjacent working electrode zones 104 that define two adjacent points of the star-shaped pattern. For example, the star-shaped pattern may be formed with the auxiliary electrodes 102 forming the “points” of the star-shaped pattern and the working electrode zones 104 forming the inner structure of the star-shaped pattern. For instance, in a five point star pattern, the auxiliary electrodes 102 may form the five “points” of the star-shaped pattern and the working electrode zones 104 may form the inner “pentagon” structure, as illustrated in FIG. 5A-5C described below in further detail. In some embodiment, the star pattern may also be defined as one or more concentric circles, where the one or more working electrodes 104 and/or the one or more auxiliary electrodes may be placed in a circular pattern around the one or more concentric circles, as illustrated in FIG. 5A-5C described below in further detail.

FIGS. 3A and 3B illustrate embodiments of an electrode design 301 of a well 200 that has circular-shaped working electrode zones 104 disposed in an open ring pattern. According to the exemplary, non-limiting embodiment illustrated in FIG. 3A, a bottom 207 of the well 200 may include a single auxiliary electrode 102. In other embodiments, more than one (1) auxiliary electrode 102 may be included in well 200 (e.g., 2, 3, 4, 5, etc.) In embodiments, the auxiliary electrode 102 may be formed to have an approximate circular shape. In other embodiments, the auxiliary electrode 102 may be formed to have other shapes (e.g., rectangles, squares, ovals, clovers, or any other regular or irregular geometric shape).

In embodiments, the well 200 may include ten (10) working electrode zones 104. In other embodiments, fewer or more than ten working electrode zones 104 may be included in well 200 (e.g., 1, 2, 3, 4, etc.) In embodiments, the working electrode zones 104 may be formed to have an approximate circular shape. In other embodiments, the working electrode zones 104 may be formed to have other shapes (e.g., rectangles, squares, ovals, clovers, or any other regular or irregular geometric shape).

The working electrode zones 104 may be positioned with respect to each other in a semi-circular or substantially “C-shaped” pattern adjacent to a perimeter “P” of the well 200 at a distance “D₁.” In some embodiments, the distance, D₁, may be a minimum distance between a boundary of the working electrode zones 104 and the perimeter, P. That is, each of the working electrode zones 104 may be positioned an equal distance, D₁, from the perimeter, P, of the well 200 and each of the working electrode zones 104 is equally spaced from another by a distance, “D₂,” (also referred to as working electrode (WE-WE) pitch). In some embodiments, the distance, D₂, may be a minimum distance between a boundary of two adjacent working electrode zones 104. In some embodiments, two working electrode zones 104A, 104B may be spaced apart from each other a sufficient distance so as to form a gap “G.” The gap “G” may provide a greater pitch distance between two working electrode zones than the remainder of the pitch distance between the remainder of the working electrode zones. In certain embodiments, the gap, G, may allow electrical traces or contacts to be electrically coupled to the auxiliary electrode 102 without electrically interfering with the working electrode zones 104, thereby maintaining electrical isolation of the auxiliary electrode 102 and the working electrode zones 104. For example, the gap, G, may be formed with a sufficient distance to allow an electrical trace to be formed between adjacent working electrode zones 104 while remaining electrically isolated. The size of the gap G, therefore, may be determined at least partially by a selection of manufacturing methods in building the electrochemical cell. Accordingly, in embodiments, the greater pitch distance of gap “G” may be at least 10%, at least 30%, at least 50%, or at least 100% larger than the pitch distance D₂ between a remainder of the working electrode zones 104.

In certain embodiments, distance D₁ may not be equal between one or more working electrode zones 104 and perimeter P of well 200. In further embodiments, distance, D₂, may not be equal between two or more of the working electrode zones 104. The auxiliary electrode 102 may be positioned in a center of the C-shaped pattern at an equal distance, “D₃,” (also referred to as WE-AUXILIARY pitch) from each of the working electrode zones 104, although in other embodiments, distance D₃ may vary for one or more of the working electrode zones 104 as measured to the auxiliary electrode 102. In certain embodiments, as illustrated, the distance, D₁, the distance, D₂, the distance, D₃, and the distance, G, may be measured from a closest relative point on a perimeter of the respective feature (e.g., working electrode zone 104, auxiliary electrode 102, or perimeter P). In some embodiments, the distance, D₃, may be a minimum distance between a boundary of a working electrode zones 104 and a boundary of an auxiliary electrode. One skilled in the art will realize that the distances may be measured from any relative point on a feature in order to produce a repeatable pattern, for example, a geometric pattern.

Although these figures depict a single auxiliary electrode 102, more than one may be included as well, as illustrated in FIG. 3C. Further, although auxiliary electrode 102 is depicted in these figures as being disposed at an approximate (or true) center of well 200, auxiliary electrode 102 may be disposed at other locations of the well 200 as well, as illustrated in FIG. 3D. Additionally, while these figures illustrate ten (10) working electrode zones 104, greater or fewer number of working electrode zones 104 may be included, as illustrated in FIGS. 3E and 3F.

The electrochemical cells illustrated in FIGS. 3A-3F may include electrodes of Ag, Ag/AgCl, carbon, carbon composites and/or other carbon-based materials, and/or of any other electrode material as discussed herein.

In embodiments, the size of the auxiliary electrode 102 and/or the working electrode zones 104 may be varied. For example, the size of each of the working electrode zones 104 may be equal, and the size of the auxiliary electrode 102 may be varied such as by varying a diameter thereof, as shown in Table 2A. One skilled in the art will realize that the dimensions included in Table 2A are approximate values and may vary by, for example, +/−5.0% based on conditions such as manufacturing tolerances.

TABLE 2A
Exemplary dimensions for working electrode zones 104 and auxiliary electrode 102
according to certain embodiments with ten (10) working electrode zones

| | | | | Auxiliary | | | |
|---|---|---|---|---|---|---|---|
| | WE Zone | | | Electrode | | | |
| | Exposed | Total WE | Auxiliary | Exposed | | | |
| WE Zone | Surface | Spot Area | Electrode | Surface | WE/Auxiliary | Spot Edge | |
| Diameter | Area | (10 spots - | Diameter | Area | Electrode | to Plate | |
| (in) | (sq in) | sq in) | (in) | (sq in) | Area Ratio | Wall (in) | D₂ (in) |
| 0.037 | 0.00106 | 0.0106 | 0.048 | 0.00181 | 5.85 | 0.0200 | 0.0120 |
| 0.037 | 0.00106 | 0.0106 | 0.044 | 0.00152 | 6.96 | 0.0200 | 0.0120 |
| 0.037 | 0.00106 | 0.0106 | 0.040 | 0.00126 | 8.42 | 0.0200 | 0.0120 |
| 0.037 | 0.00106 | 0.0106 | 0.036 | 0.00102 | 10.39 | 0.0200 | 0.0120 |
| 0.037 | 0.00106 | 0.0106 | 0.032 | 0.00080 | 13.16 | 0.0200 | 0.0120 |
| 0.037 | 0.00106 | 0.0106 | 0.028 | 0.00062 | 17.18 | 0.0200 | 0.0120 |
| 0.020 | 0.00031 | 0.0031 | 0.040 | 0.00126 | 2.50 | 0.0280 | 0.0290 |
| 0.020 | 0.00031 | 0.0031 | 0.060 | 0.00283 | 1.11 | 0.0280 | 0.0290 |
| 0.020 | 0.00031 | 0.0031 | 0.080 | 0.00503 | 0.62 | 0.0280 | 0.0290 |
| 0.020 | 0.00031 | 0.0031 | 0.100 | 0.00785 | 0.40 | 0.0280 | 0.0290 |
| 0.020 | 0.00031 | 0.0031 | 0.120 | 0.01131 | 0.28 | 0.0280 | 0.0290 |
| 0.020 | 0.00031 | 0.0031 | 0.140 | 0.01539 | 0.20 | 0.0280 | 0.0290 |
| 0.028 | 0.00062 | 0.0074 | 0.125 | 0.01227 | 0.60 | 0.0200 | 0.0150 |
| 0.028 | 0.00062 | 0.0074 | 0.100 | 0.00785 | 0.94 | 0.0200 | 0.0150 |
| 0.028 | 0.00062 | 0.0074 | 0.060 | 0.00283 | 2.61 | 0.0200 | 0.0150 |
| 0.028 | 0.00062 | 0.0074 | 0.040 | 0.00126 | 5.88 | 0.0200 | 0.0150 |
| 0.028 | 0.00062 | 0.0074 | 0.030 | 0.00071 | 10.46 | 0.0200 | 0.0150 |
| 0.028 | 0.00062 | 0.0074 | 0.025 | 0.00049 | 15.05 | 0.0200 | 0.0150 |

Table 2A above provides example values for well geometry. As discussed above, e.g., at paragraph [0051], Ag/AgCl electrodes consistent with embodiments hereof may include approximately 3.07×10⁻⁷ moles to 3.97×10⁻⁷ moles of oxidizing agent contained therein. In addition to the geometry presented above, electrodes, both working and auxiliary, may be approximately 10 microns (3.937×10⁻⁴ inches) thick. Table 2B provides approximate values and ranges for moles of oxidizing agent in the auxiliary electrode per auxiliary electrode area and volume. Table 2C provides approximate values and ranges for moles of oxidizing agent in the auxiliary electrode per working electrode area and volume. The values and ranges presented in Tables 2B and 2C are provided using inches as units. A person of skill in the art will recognize that these values may be converted to mm.

TABLE 2B
Exemplary concentrations of oxidizing agent for auxiliary electrodes according to
certain embodiments with ten (10) working electrode zones

| | Auxiliary Electrode | Moles/in\hat{ }2 | | Moles/in\hat{ }3 of | |
|---|---|---|---|---|---|
| Aux Electrode | Exposed Surface | of Auxiliary | | Auxiliary Electrode, | |
| Diameter (in) | Area (in\hat{ }2) | Electrode, Range | | Range | |
| 0.048 | 0.00181 | 1.697E−04 | 2.194E−04 | 4.309 | 5.573 |
| 0.044 | 0.001521 | 2.019E−04 | 2.611E−04 | 5.128 | 6.632 |
| 0.04 | 0.001257 | 2.443E−04 | 3.159E−04 | 6.205 | 8.024 |
| 0.036 | 0.001018 | 3.016E−04 | 3.900E−04 | 7.661 | 9.907 |
| 0.032 | 0.000804 | 3.817E−04 | 4.936E−04 | 9.696 | 12.538 |
| 0.028 | 0.000616 | 4.986E−04 | 6.447E−04 | 12.664 | 16.376 |
| 0.06 | 0.002827 | 1.086E−04 | 1.404E−04 | 2.758 | 3.566 |
| 0.08 | 0.005027 | 6.108E−05 | 7.898E−05 | 1.551 | 2.006 |
| 0.1 | 0.007854 | 3.909E−05 | 5.055E−05 | 0.993 | 1.284 |
| 0.12 | 0.01131 | 2.714E−05 | 3.510E−05 | 0.689 | 0.892 |
| 0.14 | 0.015394 | 1.994E−05 | 2.579E−05 | 0.507 | 0.655 |
| 0.125 | 0.012272 | 2.502E−05 | 3.235E−05 | 0.635 | 0.822 |
| 0.03 | 0.000707 | 4.343E−04 | 5.616E−04 | 11.032 | 14.266 |
| 0.025 | 0.000491 | 6.254E−04 | 8.088E−04 | 15.886 | 20.543 |

TABLE 2C
Exemplary concentrations of oxidizing agent for working electrodes according to
certain embodiments with ten (10) working electrode zones

| | | | | Moles/in\hat{ }3 of | |
|---|---|---|---|---|---|
| WE Zone | Total WE Spot Area | Moles/in\hat{ }2 of aggregate | | aggregate working | |
| Diameter (in) | (10 spots -in\hat{ }2) | working electrode area, range | | electrode volume, range | |
| 0.037 | 0.0106 | 2.896E−05 | 3.745E−05 | 0.736 | 0.951 |
| 0.020 | 0.0031 | 9.903E−05 | 1.281E−04 | 2.515 | 3.253 |
| 0.028 | 0.0074 | 4.149E−05 | 5.365E−05 | 1.054 | 1.363 |

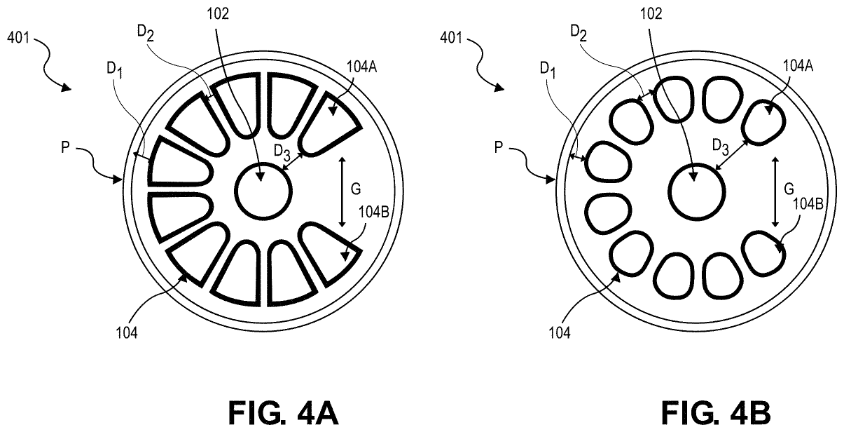

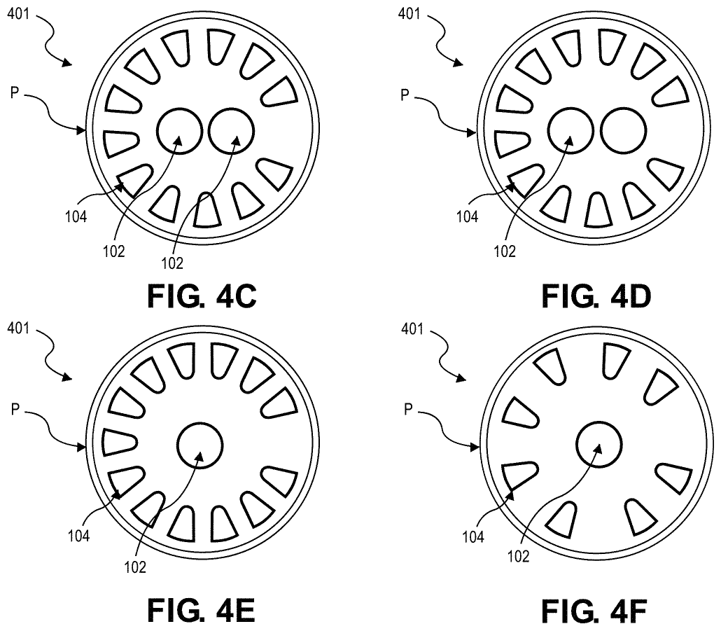

FIGS. 4A and 4B illustrate non-limiting, exemplary embodiments of an electrode design 401 of a well 200 that has noncircular-shaped working electrode zones 104 disposed in the well in an open ring pattern, as similarly described above with reference to FIGS. 3A and 3B. The noncircular-shaped working electrode zones 104 illustrated in FIGS. 4A and 4B (and FIGS. 4C-4F) may be wedge shaped or trilobe shaped. In embodiments, the noncircular-shaped working electrode zones 104 may allow for improved usage of the area within the well 200. The use of the noncircular-shaped working electrode zones 104 may allow larger working electrode zones 104 to be formed within the well 200 and/or more working electrode zones 104 to be formed within the well 200. By forming these non-circular shapes, the working electrode zones 104 may be packed in more tightly within a well 200. As such, the ratios of the working electrode zones 104 to the auxiliary electrode 102 may be maximized. Additionally, because the working electrode zones 104 may be formed larger, the working electrode zones 104 may be more reliably manufactured, e.g., more reliably printed.

As illustrated in FIG. 4A, the well 200 may include a single auxiliary electrode 102. In other embodiments, more than one (1) auxiliary electrode 102 may be included in well 200 (e.g., 2, 3, 4, 5, etc.) In embodiments, the auxiliary electrode 102 may be formed to have an approximate circular shape. In other embodiments, the auxiliary electrode 102 may be formed to have other shapes (e.g., rectangles, squares, ovals, clovers, or any other regular or irregular geometric shape).

In embodiments, the well 200 may include ten (10) working electrode zones 104. In other embodiments, fewer or more than ten working electrode zones 104 may be included in well 200 (e.g., 1, 2, 3, 4, etc.) Each of the working electrode zones 104 may be formed to have a noncircular shape, for example, a wedge shape or a triangular shape with one or more rounded or radiused corners, although in other embodiments, the corners are not rounded, thus forming polygon shapes, such as triangles.

The working electrode zones 104 may be positioned with respect to each other in a semi-circular or substantially “C-shaped” pattern adjacent to a perimeter “P” of the well 200 at a distance “D₁.” In some embodiments, the distance, D₁, may be a minimum distance between a boundary of the working electrode zones 104 and the perimeter, P. That is, each of the working electrode zones 104 may be positioned an equal distance, D₁, from the perimeter P of the well 200 and each of the working electrode zones 104 is equally spaced from another by a distance, “D₂.” In some embodiments, the distance, D₂, may be a minimum distance between a boundary of two adjacent working electrode zones 104. In some embodiments, two working electrode zones 104A, 104B may be spaced apart from each other a sufficient distance so as to form a gap “G.” In certain embodiments, distance D₁ may not be equal between one or more working electrode zones 104 and perimeter P of well 200. In further embodiments, distance, D₂, may not be equal between two or more of the working electrode zones 104. The auxiliary electrode 102 may be positioned in a center of the C-shaped pattern at an equal distance, “D₃,” from each of the working electrode zones 104, although in other embodiments, distance D₃ may vary for one or more of the working electrode zones 104 as measured to the auxiliary electrode 102. In certain embodiments, as illustrated, the distance, D₁, the distance, D₂, the distance, D₃, and the distance, G, may be measured from a closest point on a perimeter of the respective feature (e.g., working electrode zone 104, auxiliary electrode 102, or perimeter P). In some embodiments, the distance, D₃, may be a minimum distance between a boundary of a working electrode zones 104 and a boundary of an auxiliary electrode One skilled in the art will realize that the distances may be measured from any relative point on a feature in order to produce a repeatable pattern, for example, a geometric pattern.

Although these figures depict a single auxiliary electrode 102, more than one may be included as well, as illustrated in FIGS. 4C and 4D. Further, although auxiliary electrode 102 is depicted in these figures as being disposed at an approximate (or true) center of well 200, auxiliary electrode 102 may be disposed at other locations of the well 200 as well, as illustrated in FIG. 4D. Additionally, while these figures illustrate ten (10) working electrode zones 104, greater or fewer number of working electrode zones 104 may be included, as illustrated in FIGS. 4E and 4F.

In certain embodiments, the size of the auxiliary electrode 102 and/or the working electrode zones 104 may be equal. In other embodiments, the size of the auxiliary electrode 102 and/or the working electrode zones 104 may be varied. In one example, the size of the auxiliary electrode 102 may be constant, and the size of the working electrode zones 104 may be varied such as by varying the radius of the auxiliary electrode 102. Table 3A includes examples of dimensions for the working electrode zones 104 and the auxiliary electrodes 102 for the embodiments including wedge shaped or trilobe shaped working electrode zones 104 illustrated in FIGS. 4A-4F. One skilled in the art will realize that the dimensions included in Table 3 are approximate values and may vary by, for example, +/−5.0% based on conditions such as manufacturing tolerances.

The electrochemical cells illustrated in FIGS. 4A-4F may include electrodes of Ag, Ag/AgCl, carbon, carbon composites and/or other carbon-based materials, and/or of any other electrode material as discussed herein.

TABLE 3A
Exemplary dimensions for working electrode zones 104 and auxiliary electrode 102
according to certain embodiments with ten (10) working electrode zones

| | WE Zone | | | Auxiliary | | | |
|---|---|---|---|---|---|---|---|
| WE | Exposed | Total WE | Auxiliary | Electrode | | | |
| Zone | Surface | Spot Area | Electrode | Exposed | WE/Auxiliary | Spot Edge | |
| Diameter | Area | (10 spots - | Diameter | Surface | Electrode | to Plate | |
| (in) | (sq in) | sq in) | (in) | Area (sq in) | Area Ratio | Wall (in) | D₂ (in) |
| — | 0.00158 | 0.0158 | 0.048 | 0.00181 | 8.73 | 0.0200 | 0.0120 |
| — | 0.00156 | 0.0156 | 0.048 | 0.00181 | 8.63 | 0.0200 | 0.0120 |
| — | 0.00154 | 0.0154 | 0.048 | 0.00181 | 8.49 | 0.0200 | 0.0120 |
| — | 0.00139 | 0.0139 | 0.048 | 0.00181 | 7.68 | 0.0200 | 0.0120 |
| — | 0.00114 | 0.0114 | 0.048 | 0.00181 | 6.29 | 0.0200 | 0.0120 |
| — | 0.00114 | 0.0114 | 0.100 | 0.00785 | 1.45 | 0.0200 | 0.0120 |
| — | 0.00114 | 0.0114 | 0.080 | 0.00503 | 2.27 | 0.0200 | 0.0120 |
| — | 0.00114 | 0.0114 | 0.060 | 0.00283 | 4.03 | 0.0200 | 0.0120 |
| — | 0.00114 | 0.0114 | 0.050 | 0.00196 | 5.80 | 0.0200 | 0.0120 |
| — | 0.00114 | 0.0114 | 0.040 | 0.00126 | 9.06 | 0.0200 | 0.0120 |
| — | 0.00114 | 0.0114 | 0.035 | 0.00096 | 11.84 | 0.0200 | 0.0120 |
| — | 0.00114 | 0.0114 | 0.030 | 0.00071 | 16.11 | 0.0200 | 0.0120 |

Table 3A above provides example values for trilobe electrode well geometry. As discussed above, e.g., at paragraph [0051], Ag/AgCl electrodes consistent with embodiments hereof may include approximately 3.07×10⁻⁷ moles to 3.97×10⁻⁷ moles of oxidizing agent contained therein. In addition to the geometry presented above, electrodes, both working and auxiliary, may be approximately 10 microns (3.937×10⁻⁴ inches) thick. Table 3B provides approximate values and ranges for moles of oxidizing agent in the auxiliary electrode per auxiliary electrode area and volume. Table 3C provides approximate values and ranges for moles of oxidizing agent in the auxiliary electrode per working electrode area and volume. The values and ranges presented in Tables 3B and 3C are provided using inches as units. A person of skill in the art will recognize that these values may be converted to mm.

TABLE 3B
Exemplary concentrations of oxidizing agent for auxiliary electrodes
according to certain embodiments with ten (10) working
electrode zones

| | Auxiliary | | | | |
|---|---|---|---|---|---|
| Aux | Electrode | | | | |
| Electrode | Exposed | | | Moles/in\hat{ }3 of | |
| Diameter | Surface | Moles/in\hat{ }2 of Auxiliary | | Auxiliary | |
| (in) | Area (in\hat{ }2) | Electrode, Range | | Electrode, Range | |
| 0.048 | 0.00181 | 1.697E−04 | 2.194E−04 | 4.309 | 5.573 |
| 0.1 | 0.007854 | 3.909E−05 | 5.055E−05 | 0.993 | 1.284 |
| 0.08 | 0.005027 | 6.108E−05 | 7.898E−05 | 1.551 | 2.006 |
| 0.06 | 0.002827 | 1.086E−04 | 1.404E−04 | 2.758 | 3.566 |
| 0.05 | 0.001963 | 1.564E−04 | 2.022E−04 | 3.971 | 5.136 |
| 0.04 | 0.001257 | 2.443E−04 | 3.159E−04 | 6.205 | 8.024 |
| 0.035 | 0.000962 | 3.191E−04 | 4.126E−04 | 8.105 | 10.481 |
| 0.03 | 0.000707 | 4.343E−04 | 5.616E−04 | 11.032 | 14.266 |

TABLE 3C
Exemplary concentrations of oxidizing agent for working electrodes
according to certain embodiments with ten (10) working
electrode zones

| | | Moles/in\hat{ }2 | | Moles/in\hat{ }3 of | |
|---|---|---|---|---|---|
| | Total WE | of aggregate | | aggregate | |
| WE Zone | Spot Area | working electrode | | working electrode | |
| Diameter (in) | (10 spots -in\hat{ }2) | area, range | | volume, range | |
| | 0.0158 | 1.943E−05 | 2.513E−05 | 0.494 | 0.638 |
| | 0.0156 | 1.968E−05 | 2.545E−05 | 0.500 | 0.646 |
| | 0.0154 | 1.994E−05 | 2.578E−05 | 0.506 | 0.655 |
| | 0.0139 | 2.209E−05 | 2.856E−05 | 0.561 | 0.725 |
| | 0.0114 | 2.693E−05 | 3.482E−05 | 0.684 | 0.885 |

FIGS. 5A and 5B illustrate non-limiting, exemplary embodiments of an electrode design 401 of a well 200 that has working electrode zones 104 disposed in a star-shaped pattern (also referred to herein as a penta pattern) with the working electrode zones 104 being circular-shaped. As illustrated in FIG. 5A, the well 200 may include five (5) auxiliary electrodes 102, and each of the auxiliary electrodes 102 may be formed in an approximate circular shape (although other numbers of auxiliary electrodes, different shapes, etc. are contemplated as well). In this example, the well 200 may also include ten (10) working electrode zones 104, and each of the working electrode zones 104 may be formed in an approximate circular shape. The star-shaped pattern may be created by a plurality of working electrode zones 104 being positioned in one of an inner circle and an outer circle relative to each other, wherein each working electrode zone 110 positioned in the outer circle is disposed at an angular midpoint relative to two adjacent working electrode zones 104 positioned in the inner circle. Each of the working electrode zones 104 in the inner circle may be spaced a distance, “R₁,” from the center of the well 200. Each of the working electrode zones 104 in the outer circle may be spaced a distance, “R₂,” from the center of the well 200. In the star-shaped pattern, each auxiliary electrode 102 may be positioned at an equal distance, “D₄,” relative to two of the working electrode zones 104 positioned in the outer circle.

In certain embodiments, as illustrated, the distance, R₁, the distance, R₂, and the distance, D₄, may be measured from a closest point on a perimeter of the respective feature (e.g., working electrode zone 104, auxiliary electrode 102, or perimeter P). One skilled in the art will realize that the distances may be measured from any relative point on a feature in order to produce a repeatable geometric pattern.

While these figures illustrate ten (10) working electrode zones 104, greater or fewer number of working electrodes zones 104 may be included, as illustrated in FIG. 5C. Additionally, while FIGS. 5A-5C illustrate circular shaped working electrode zones 104, the working electrode zones 104 may be formed to have other shapes (e.g., rectangles, squares, ovals, clovers, or any other regular or irregular geometric shape). Other embodiments can include hybrid designs of electrode configurations, such as, for example, a star shape pattern that includes wedge-shaped working electrode zones and/or auxiliary electrodes, etc.

The electrochemical cells illustrated in FIGS. 5A-5F may include electrodes of Ag, Ag/AgCl, carbon, carbon composites and/or other carbon-based materials, and/or of any other electrode material as discussed herein.

In certain embodiments, the size of the auxiliary electrode 102 and/or the working electrode zones 104 may be equal. In other embodiments, a size of the auxiliary electrode 102 and/or the working electrode zones 104 may be varied. In one example, the size of the working electrode zones 104 may be constant, and the size of the auxiliary electrode 102 may be varied such as varying the diameter, as shown in Table 4A. One skilled in the art will realize that the dimensions included in Table 4A are approximate values and may vary by, for example, +/−5.0% based on conditions such as manufacturing tolerances.

TABLE 4A
Exemplary dimensions for working electrode zones 104 and auxiliary electrode 102
according to certain embodiments with ten (10) working electrode zones

| | WE Zone | | | Auxiliary | | | |
|---|---|---|---|---|---|---|---|
| WE | Exposed | Total WE | Auxiliary | Electrode | | | |
| Zone | Surface | Spot Area | Electrode | Exposed | WE/Auxiliary | Spot Edge | |
| Diameter | Area | (10 spots - | Diameter | Surface | Electrode | to Plate | |
| (in) | (sq in) | sq in) | (in) | Area (sq in) | Area Ratio | Wall (in) | D₂ (in) |
| 0.0420 | 0.00139 | 0.01385 | 0.030 | 0.000707 | 1.960 | 0.0200 | 0.0125 |
| 0.0420 | 0.00139 | 0.01385 | 0.027 | 0.000573 | 2.420 | 0.0200 | 0.0125 |
| 0.0420 | 0.00139 | 0.01385 | 0.024 | 0.000452 | 3.063 | 0.0200 | 0.0125 |
| 0.0420 | 0.00139 | 0.01385 | 0.021 | 0.000346 | 4.000 | 0.0200 | 0.0125 |
| 0.0420 | 0.00139 | 0.01385 | 0.018 | 0.000254 | 5.444 | 0.0200 | 0.0125 |
| 0.0420 | 0.00139 | 0.01385 | 0.015 | 0.000177 | 7.840 | 0.0200 | 0.0125 |

Table 4A above provides example values for a 10 spot penta electrode well geometry. As discussed above, e.g., at paragraph [0051], Ag/AgCl electrodes consistent with embodiments hereof may include approximately 3.07×10⁻⁷ moles to 3.97×10⁻⁷ moles of oxidizing agent contained therein. In addition to the geometry presented above, electrodes, both working and auxiliary, may be approximately 10 microns (3.937×10⁻⁴ inches) thick. Table 4B provides approximate values and ranges for moles of oxidizing agent in the auxiliary electrode per auxiliary electrode area and volume. Table 4C provides approximate values and ranges for moles of oxidizing agent in the auxiliary electrode per working electrode area and volume. The values and ranges presented in Tables 4B and 4C are provided using inches as units. A person of skill in the art will recognize that these values may be converted to mm.

TABLE 4B
Exemplary concentrations of oxidizing agent for auxiliary electrodes
according to certain embodiments with ten (10) working
electrode zones

| | Auxiliary | | | | |
|---|---|---|---|---|---|
| Aux | Electrode | | | | |
| Electrode | Exposed | | | Moles/in\hat{ }3 of | |
| Diameter | Surface | Moles/in\hat{ }2 of Auxiliary | | Auxiliary | |
| (in) | Area (in\hat{ }2) | Electrode, Range | | Electrode, Range | |
| 0.03 | 0.000707 | 4.343E−04 | 5.616E−04 | 11.032 | 14.266 |
| 0.027 | 0.000573 | 5.362E−04 | 6.934E−04 | 13.619 | 17.612 |
| 0.024 | 0.000452 | 6.786E−04 | 8.776E−04 | 17.237 | 22.290 |
| 0.021 | 0.000346 | 8.864E−04 | 1.146E−03 | 22.514 | 29.114 |
| 0.018 | 0.000254 | 1.206E−03 | 1.560E−03 | 30.643 | 39.627 |
| 0.015 | 0.000177 | 1.737E−03 | 2.247E−03 | 44.127 | 57.063 |

TABLE 4C
Exemplary concentrations of oxidizing agent for working electrodes
according to certain embodiments with ten (10) working
electrode zones

| | | Moles/in\hat{ }2 | | Moles/in\hat{ }3 of | |
|---|---|---|---|---|---|
| | Total WE | of aggregate | | aggregate | |
| WE Zone | Spot Area | working electrode | | working electrode | |
| Diameter (in) | (10 spots -in\hat{ }2) | area, range | | volume, range | |
| 0.042 | 0.01385 | 2.217E−05 | 2.866E−05 | 0.563 | 0.728 |

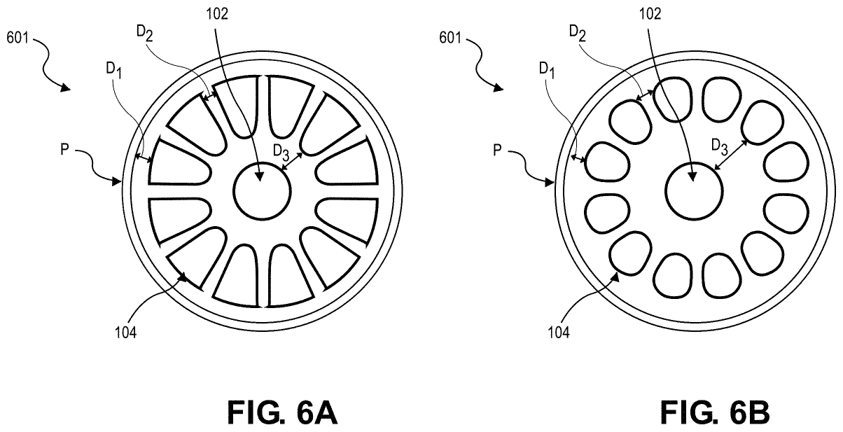

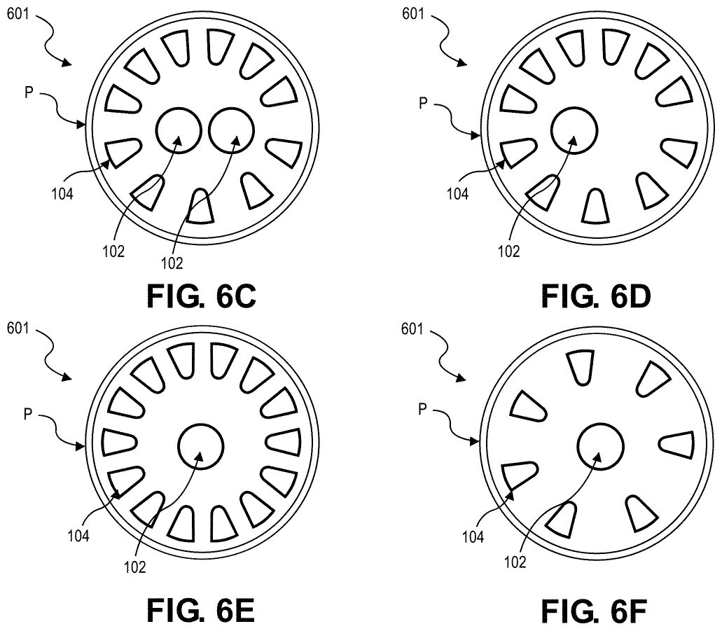

FIGS. 6A and 6B illustrate exemplary, non-limiting embodiments of an electrode design 601 of a well 200 that has noncircular-shaped (e.g., trilobe or wedge shaped) working electrode zones 104 disposed in a closed ring pattern. As illustrated in FIG. 6A, the well 200 may include a single auxiliary electrode 102. In other embodiments, more than one (1) auxiliary electrode 102 may be included in well 200 (e.g., 2, 3, 4, 5, etc.) In embodiments, the auxiliary electrode 102 may be formed to have an approximate circular shape. In other embodiments, the auxiliary electrode 102 may be formed to have other shapes (e.g., rectangles, squares, ovals, clovers, or any other regular or irregular geometric shape).

In embodiments, the well 200 may also include ten (10) working electrode zones 104, or more, or fewer. For example, FIGS. 6A and 6B illustrate embodiments having 12 working electrode zones 104, FIGS. 6C and 6D illustrate embodiments having 11 working electrode zones 104, FIG. 6E illustrates an embodiment having 14 working electrode zones 104, and FIG. 6F illustrates an embodiment having 7 working electrode zones 104 The working electrode zones 104 may be formed to have a noncircular shape, for example, a wedge shape or a triangular shape with one or more rounded or radiused corners also referred to as a trilobe shape. In the closed ring pattern, the working electrode zones 104 may be positioned in a circular shape around the perimeter of the well 200 such that each is at pattern adjacent to a perimeter “P” of the well 200 at a distance “D₁.” In some embodiments, the distance, D₁, may be a minimum distance between a boundary of the working electrode zones 104 and the perimeter, P. That is, each of the working electrode zones 104 may be positioned an equal distance, D₁, from the perimeter P of the well 200 and each of the working electrode zones 104 may be equally spaced from another by a distance, “D₂.” In some embodiments, the distance, D₂, may be a minimum distance between a boundary of two adjacent working electrode zones 104. In certain embodiments, distance D₁ may not be equal between one or more working electrode zones 104 and perimeter P of well 200. The auxiliary electrode 102 may be positioned in a center of the C-shaped pattern at an equal distance, “D₃,” from each of the working electrode zones 104, although in other embodiments, distance D₃ may vary for one or more of the working electrode zones 104 as measured to the auxiliary electrode 102. In some embodiments, the distance, D₃, may be a minimum distance between a boundary of a working electrode zones 104 and a boundary of an auxiliary electrode. In certain embodiments, as illustrated, the distance, D₁, the distance, D₂, and the distance, D₃, may be measured from a closest point on a perimeter of the respective feature (e.g., working electrode zone 104, auxiliary electrode 102, or perimeter P). One skilled in the art will realize that the distances may be measured from any relative point on a feature in order to produce a repeatable pattern, for example, a geometric pattern.

Although these figures depict a single auxiliary electrode 102, more than one may be included as well, as illustrated in FIG. 6C. Further, although auxiliary electrode 102 is depicted in these figures as being disposed at an approximate (or true) center of well 200, auxiliary electrode 102 may be disposed at other locations of the well 200 as well, as illustrated in FIG. 6D. Additionally, while these figures illustrate ten (10) working electrode zones 104, greater or fewer number of working electrodes zones 104 may be included, as illustrated in FIGS. 6E and 6F.

The electrochemical cells illustrated in FIGS. 6A-6F may include electrodes of Ag, Ag/AgCl, carbon, carbon composites and/or other carbon-based materials, and/or of any other electrode material as discussed herein.

In certain embodiments, the size of the auxiliary electrode 102 and/or the working electrode zones 104 may be equal. In other embodiments, the size of the auxiliary electrode 102 and/or the working electrode zones 104 may be varied. In one example, the size of the auxiliary electrode 102 may be constant, and the size of the working electrode zones 104 may be varied such as varying the radius of the auxiliary electrode 102. Table 5A includes examples of dimensions for the working electrode zones 104 and the auxiliary electrodes 102 for the embodiments illustrated in FIGS. 6A-6F. One skilled in the art will realize that the dimensions included in Table 5A are approximate values and may vary by, for example, +/−5.0% based on conditions such as manufacturing tolerances.

TABLE 55A
Exemplary dimensions for working electrode zones 104 and auxiliary electrode 102
according to certain embodiments with ten (10) working electrode zones

| | WE Zone | | | Auxiliary | | | |
|---|---|---|---|---|---|---|---|
| | Exposed | Total WE | | Electrode | | | |
| WE Zone | Surface | Spot Area | Auxiliary | Exposed | WE/Auxiliary | Spot Edge | |
| Diameter | Area | (10 spots - | Electrode | Surface | Electrode | to Plate | |
| (in) | (sq in) | sq in) | Diameter (in) | Area (sq in) | Area Ratio | Wall (in) | D₂ (in) |
| — | 0.00219 | 0.0219 | 0.048 | 0.00181 | 12.08 | 0.0200 | 0.0120 |
| — | 0.00218 | 0.0218 | 0.048 | 0.00181 | 12.06 | 0.0200 | 0.0120 |
| — | 0.00217 | 0.0217 | 0.048 | 0.00181 | 11.98 | 0.0200 | 0.0120 |
| — | 0.00214 | 0.0214 | 0.048 | 0.00181 | 11.83 | 0.0200 | 0.0120 |
| — | 0.00202 | 0.0202 | 0.048 | 0.00181 | 11.17 | 0.0200 | 0.0120 |
| — | 0.00182 | 0.0182 | 0.048 | 0.00181 | 10.04 | 0.0200 | 0.0120 |
| — | 0.00182 | 0.0182 | 0.082 | 0.00528 | 3.44 | 0.0200 | 0.0120 |
| — | 0.00182 | 0.0182 | 0.075 | 0.00442 | 4.11 | 0.0200 | 0.0120 |
| — | 0.00182 | 0.0182 | 0.068 | 0.00363 | 5.00 | 0.0200 | 0.0120 |
| — | 0.00182 | 0.0182 | 0.055 | 0.00238 | 7.65 | 0.0200 | 0.0120 |
| — | 0.00182 | 0.0182 | 0.040 | 0.00126 | 14.46 | 0.0200 | 0.0120 |
| — | 0.00182 | 0.0182 | 0.030 | 0.00071 | 25.70 | 0.0200 | 0.0120 |

Table 5A above provides example values for a closed trilobe electrode well geometry. As discussed above, e.g., at paragraph [0051], Ag/AgCl electrodes consistent with embodiments hereof may include approximately 3.07×10⁻⁷ moles to 3.97×10⁻⁷ moles of oxidizing agent contained therein. In addition to the geometry presented above, electrodes, both working and auxiliary, may be approximately 10 microns (3.937×10⁻⁴ inches) thick. Table 5B provides approximate values and ranges for moles of oxidizing agent in the auxiliary electrode per auxiliary electrode area and volume. Table 5C provides approximate values and ranges for moles of oxidizing agent in the auxiliary electrode per working electrode area and volume. The values and ranges presented in Tables 5B and 5C are provided using inches as units. A person of skill in the art will recognize that these values may be converted to mm.

TABLE 5B
Exemplary concentrations of oxidizing agent for auxiliary electrodes
according to certain embodiments with ten (10) working
electrode zones

| | Auxiliary | | | | |
|---|---|---|---|---|---|
| Aux | Electrode | | | | |
| Electrode | Exposed | | | Moles/in\hat{ }3 of | |
| Diameter | Surface | Moles/in\hat{ }2 of Auxiliary | | Auxiliary | |
| (in) | Area (in\hat{ }2) | Electrode, Range | | Electrode, Range | |
| 0.048 | 0.00181 | 1.697E−04 | 2.194E−04 | 4.309 | 5.573 |
| 0.082 | 0.005281 | 5.813E−05 | 7.517E−05 | 1.477 | 1.909 |
| 0.075 | 0.004418 | 6.949E−05 | 8.986E−05 | 1.765 | 2.283 |
| 0.068 | 0.003632 | 8.453E−05 | 1.093E−04 | 2.147 | 2.777 |
| 0.055 | 0.002376 | 1.292E−04 | 1.671E−04 | 3.282 | 4.244 |
| 0.04 | 0.001257 | 2.443E−04 | 3.159E−04 | 6.205 | 8.024 |
| 0.03 | 0.000707 | 4.343E−04 | 5.616E−04 | 11.032 | 14.266 |

TABLE 5C
Exemplary concentrations of oxidizing agent for working electrodes
according to certain embodiments with ten (10) working
electrode zones

| | | Moles/in\hat{ }2 | | Moles/in\hat{ }3 of | |
|---|---|---|---|---|---|
| | Total WE | of aggregate | | aggregate | |
| WE Zone | Spot Area | working electrode | | working electrode | |
| Diameter (in) | (10 spots -in\hat{ }2) | area, range | | volume, range | |
| | 0.0219 | 1.402E−05 | 1.813E−05 | 0.356 | 0.460 |
| | 0.0218 | 1.408E−05 | 1.821E−05 | 0.358 | 0.463 |
| | 0.0217 | 1.415E−05 | 1.829E−05 | 0.359 | 0.465 |
| | 0.0214 | 1.435E−05 | 1.855E−05 | 0.364 | 0.471 |
| | 0.0202 | 1.520E−05 | 1.965E−05 | 0.386 | 0.499 |
| | 0.0182 | 1.687E−05 | 2.181E−05 | 0.428 | 0.554 |

In embodiments, it may be beneficial to eliminate sharp corners in the trilobe electrode design. For example, FIG. 6A illustrates a trilobe design having sharp corners while FIG. 6B illustrates a trilobe design having rounded corners. The rounded corners may reduce the area of the working electrode zones 104, e.g., by 1-5%, but may provide further benefits. For example, the sharp corners may prevent uniform distribution of solution. Sharp corners may also provide small features that are more difficult to obtain accurate imagery of. Accordingly, a reduction of sharp corners, although resulting in smaller working electrode zones 104, may be beneficial.

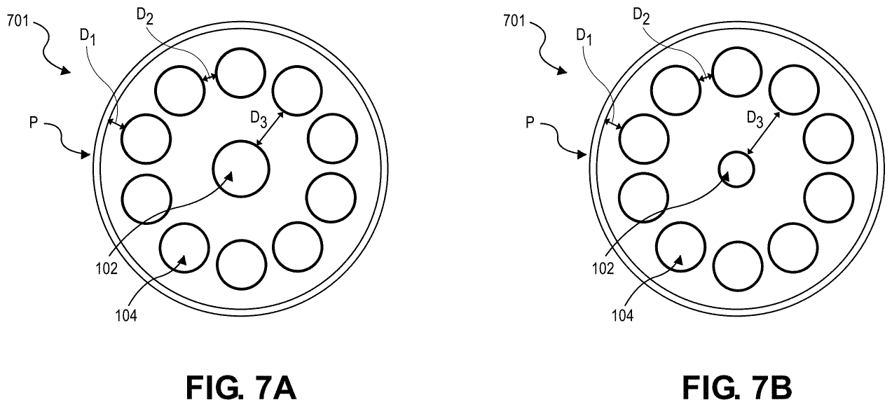

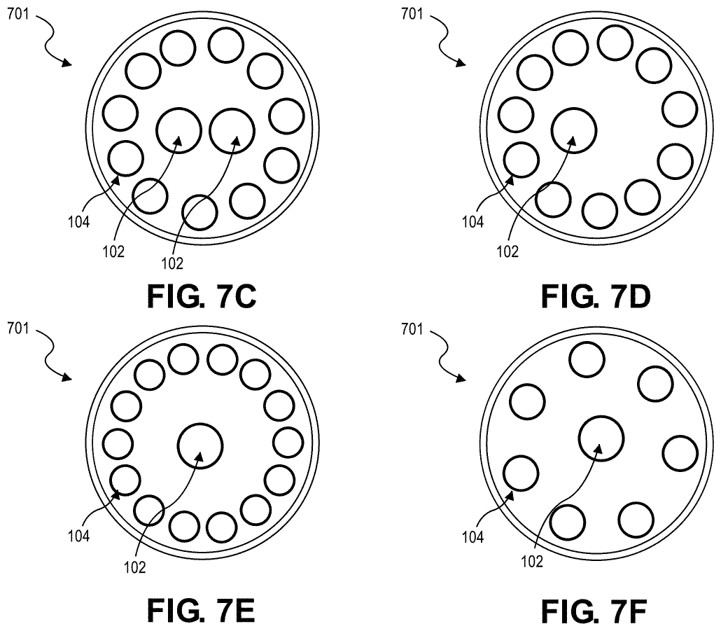

FIGS. 7A and 7B illustrate exemplary, non-limiting embodiments of an electrode design 701 of a well 200 that has a closed ring design with circular-shaped electrodes. As illustrated in FIG. 7A, the well 200 may include a single auxiliary electrode 102. In other embodiments, more than one (1) auxiliary electrode 102 may be included in well 200 (e.g., 2, 3, 4, 5, etc.) In embodiments, the auxiliary electrode 102 may be formed to have an approximate circular shape. In other embodiments, the auxiliary electrode 102 may be formed to have other shapes (e.g., rectangles, squares, ovals, clovers, or any other regular or irregular geometric shape).

In embodiments, the well 200 may include ten (10) working electrode zones 104. In other embodiments, fewer or more than ten working electrode zones 104 may be included in well 200 (e.g., 1, 2, 3, 4, etc.) In embodiments, the working electrode zones 104 may be formed to have an approximate circular shape. In other embodiments, the working electrode zones 104 may be formed to have other shapes (e.g., rectangles, squares, ovals, clovers, or any other regular or irregular geometric shape).

In the closed ring pattern, the working electrode zones 104 may be positioned in a circular shape around the perimeter of the well 200 such that each is at pattern adjacent to a perimeter “P” of the well 200 at a distance “D₁.” In some embodiments, the distance, D₁, may be a minimum distance between a boundary of the working electrode zones 104 and the perimeter, P. That is, each of the working electrode zones 104 may be positioned an equal distance, D₁, from the perimeter P of the well 200 and each of the working electrode zones 104 is equally spaced from another by a distance, “D₂,” (also referred to as working electrode (WE-WE) pitch). In some embodiments, the distance, D₂, may be a minimum distance between a boundary of two adjacent working electrode zones 104. In certain embodiments, distance D₁ may not be equal between one or more working electrode zones 104 and perimeter P of well 200. In further embodiments, distance, D₂, may not be equal between two or more of the working electrode zones 104.

The auxiliary electrode 102 may be positioned in a center of the ring pattern at an equal distance, “D₃,” (as referred to as WE-AUXILIARY pitch) from each of the working electrode zones 104, although in other embodiments, distance D₃ may vary for one or more of the working electrode zones 104 as measured to the auxiliary electrode 102. In some embodiments, the distance, D₃, may be a minimum distance between a boundary of a working electrode zones 104 and a boundary of an auxiliary electrode. In certain embodiments, as illustrated, the distance, D₁, the distance, D₂, and the distance, D₃, may be measured from a closest relative point on a perimeter of the respective feature (e.g., working electrode zone 104, auxiliary electrode 102, or perimeter P). One skilled in the art will realize that the distances may be measured from any relative point on a feature in order to produce a repeatable pattern, for example, a geometric pattern.

In further examples, working electrode zone to auxiliary electrode distance (WE-Auxiliary distance) may be measured from a center of a working electrode zone 104 to a center of an auxiliary electrode 102. Examples of WE-Auxiliary distances include 0.088″ for a 10 spot open concentric design, 0.083″ for a 10 trilobe open concentric design with sharp corners, 0.087″ for a 10 trilobe open concentric design with rounded corners, 0.080″ for a 10 trilobe closed concentric design with sharp corners, 0.082″ for a 10 trilobe closed concentric design with rounded corners, and 0.086″ for a 10 spot closed concentric design. In a penta design, WE-Auxiliary distances may be 0.062″ between an inner working electrode zone 104 and an auxiliary electrode 102 and 0.064″ between an outer working electrode zone 104 and an auxiliary electrode 102. The WE-Auxiliary distance values provided herein may vary by 5%, by 10%, by 15%, and by 25% or more without departing from the scope of this disclosure. In embodiments, WE-Auxiliary distance values may be varied according to a size and configuration of the working electrode zones 104 and the auxiliary zones 102.

Although these figures depict a single auxiliary electrode 102, more than one may be included as well, as illustrated in FIG. 7C. Further, although auxiliary electrode 102 is depicted in these figures as being disposed at an approximate (or true) center of well 200, auxiliary electrode 102 may be disposed at other locations of the well 200 as well, as illustrated in FIG. 7D. Additionally, while these figures illustrate ten (10) working electrode zones 104, greater or fewer number of working electrodes zones 104 may be included, as illustrated in FIGS. 7E and 7F.

The electrochemical cells illustrated in FIGS. 7A-7F may include electrodes of Ag, Ag/AgCl, carbon, carbon composites and/or other carbon-based materials, and/or of any other electrode material as discussed herein.

In certain embodiments, the size of the auxiliary electrode 102 and/or the working electrode zones 104 may be equal. In other embodiments, the size of the auxiliary electrode 102 and/or the working electrode zones 104 may be varied. In one example, the size of the working electrode zones 104 may be constant, and the size of the auxiliary electrode 102 may be varied such as varying the diameter, as shown in Table 6A. One skilled in the art will realize that the dimensions included in Table 6A are approximate values and may vary by, for example, +/−5.0% based on conditions such as manufacturing tolerances.

TABLE 6A
Exemplary dimensions for working electrode zones 104 and auxiliary electrode 102
according to certain embodiments with ten (10) working electrode zones

| | | Total | | | | | |
|---|---|---|---|---|---|---|---|
| | WE | WE | | Auxiliary | | | |
| | Zone | Spot | | Electrode | | Spot | |
| WE | Exposed | Area | | Exposed | | Edge to | |
| Zone | Surface | (10 | Auxiliary | Surface | WE/Auxiliary | Plate | |
| Diameter | Area (sq | spots- | Electrode | Area (sq | Electrode | Wall | |
| (in) | in) | sq in) | Diameter (in) | in) | Area Ratio | (in) | D₂ (in) |
| 0.041 | 0.00131 | 0.0131 | 0.048 | 0.00181 | 7.25 | 0.0200 | 0.0120 |
| 0.041 | 0.00131 | 0.0131 | 0.044 | 0.00152 | 8.63 | 0.0200 | 0.0120 |
| 0.041 | 0.00131 | 0.0131 | 0.040 | 0.00126 | 10.44 | 0.0200 | 0.0120 |
| 0.041 | 0.00131 | 0.0131 | 0.036 | 0.00102 | 12.89 | 0.0200 | 0.0120 |
| 0.041 | 0.00131 | 0.0131 | 0.032 | 0.00080 | 16.32 | 0.0200 | 0.0120 |
| 0.041 | 0.00131 | 0.0131 | 0.028 | 0.00062 | 21.30 | 0.0200 | 0.0120 |
| 0.040 | 0.00130 | 0.0130 | 0.048 | 0.00181 | 7.18 | 0.0200 | 0.0120 |
| 0.036 | 0.00100 | 0.0100 | 0.048 | 0.00181 | 5.52 | 0.0200 | 0.0120 |
| 0.032 | 0.00080 | 0.0080 | 0.048 | 0.00181 | 4.42 | 0.0200 | 0.0120 |
| 0.028 | 0.00060 | 0.0060 | 0.048 | 0.00181 | 3.31 | 0.0200 | 0.0120 |
| 0.024 | 0.00050 | 0.0050 | 0.048 | 0.00181 | 2.76 | 0.0200 | 0.0120 |

Table 6A above provides example values for closed spot electrode well geometry. As discussed above, e.g., at paragraph [0051], Ag/AgCl electrodes consistent with embodiments hereof may include approximately 3.07×10⁻⁷ moles to 3.97×10⁻⁷ moles of oxidizing agent contained therein. In addition to the geometry presented above, electrodes, both working and auxiliary, may be approximately 10 microns (3.937×10⁻⁴ inches) thick. Table 6B provides approximate values and ranges for moles of oxidizing agent in the auxiliary electrode per auxiliary electrode area and volume. Table 6C provides approximate values and ranges for moles of oxidizing agent in the auxiliary electrode per working electrode area and volume. The values and ranges presented in Tables 6B and 6C are provided using inches as units. A person of skill in the art will recognize that these values may be converted to mm.

TABLE 6B
Exemplary concentrations of oxidizing agent for auxiliary electrodes
according to certain embodiments with ten (10) working
electrode zones

| | Auxiliary | | | | |
|---|---|---|---|---|---|
| Aux | Electrode | | | | |
| Electrode | Exposed | | | Moles/in\hat{ }3 of | |
| Diameter | Surface | Moles/in\hat{ }2 of Auxiliary | | Auxiliary | |
| (in) | Area (in\hat{ }2) | Electrode, Range | | Electrode, Range | |
| 0.048 | 0.00181 | 1.697E−04 | 2.194E−04 | 4.309 | 5.573 |
| 0.044 | 0.001521 | 2.019E−04 | 2.611E−04 | 5.128 | 6.632 |
| 0.04 | 0.001257 | 2.443E−04 | 3.159E−04 | 6.205 | 8.024 |
| 0.036 | 0.001018 | 3.016E−04 | 3.900E−04 | 7.661 | 9.907 |
| 0.032 | 0.000804 | 3.817E−04 | 4.936E−04 | 9.696 | 12.538 |
| 0.028 | 0.000616 | 4.986E−04 | 6.447E−04 | 12.664 | 16.376 |

TABLE 6C
Exemplary concentrations of oxidizing agent for working electrodes
according to certain embodiments with ten (10) working
electrode zones

| | | Moles/in\hat{ }2 | | Moles/in\hat{ }3 of | |
|---|---|---|---|---|---|
| | Total WE | of aggregate | | aggregate | |
| WE Zone | Spot Area | working electrode | | working electrode | |
| Diameter (in) | (10 spots -in\hat{ }2) | area, range | | volume, range | |
| 0.041 | 0.0131 | 2.344E-05 | 3.031E-05 | 0.595 | 0.770 |
| 0.04 | 0.013 | 2.362E-05 | 3.054E-05 | 0.600 | 0.776 |
| 0.036 | 0.01 | 3.070E-05 | 3.970E-05 | 0.780 | 1.008 |
| 0.032 | 0.008 | 3.838E-05 | 4.963E-05 | 0.975 | 1.260 |
| 0.028 | 0.006 | 5.117E-05 | 6.617E-05 | 1.300 | 1.681 |
| 0.024 | 0.005 | 6.140E-05 | 7.940E-05 | 1.560 | 2.017 |

Tables 2A-6C provide example dimensions for spot sizes of working electrode zones 104 and of auxiliary electrodes 102. Selection of spot sizes of the working electrode zones 104 and the auxiliary electrodes 102 may be important for optimizing results of ECL processes. For example, as discussed below, e.g., at paragraphs [0282]-[0295], maintaining appropriate ratios between working electrode zone 104 areas and auxiliary electrode 102 areas may be important to ensure that the auxiliary electrode 102 has enough reductive capacity to complete ECL generation for selected voltage waveforms without saturation. In another example, larger working electrode zones 104 may provide for greater binding capacity and increase ECL signal. Larger working electrode zones 104 may also facilitate manufacturing, as they avoid small features and any manufacturing tolerances are a smaller percentage of the overall size. In embodiments, working electrode zone 104 areas may be maximized to increase ECL signal, binding capacity, and facilitate manufacturing while being limited by the need to maintain a sufficient insulated dielectric barrier between the working electrode zones 104 and the auxiliary electrodes 102.

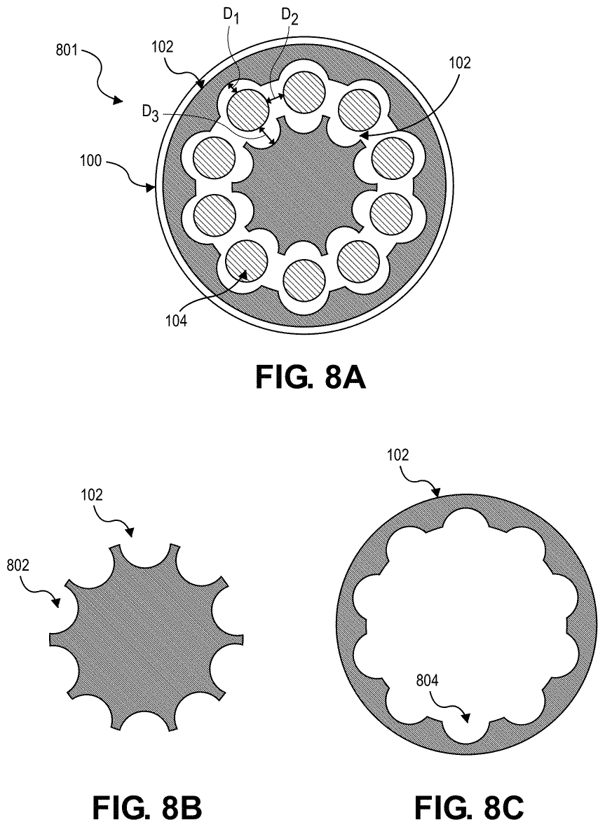

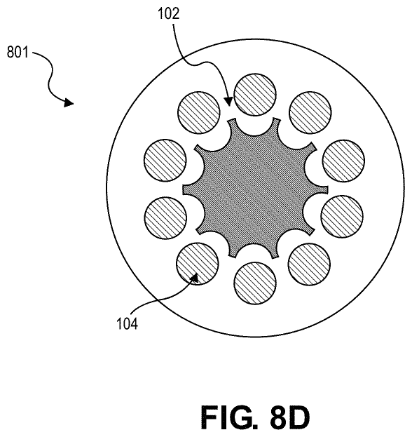

FIGS. 8A-8D illustrate exemplary, non-limiting embodiments of an electrode design 801 of a well 200 that has a closed ring design with circular-shaped working electrode zones and complex-shaped auxiliary electrodes 102. As illustrated in FIG. 8A, the well 200 may include two complex-shaped auxiliary electrodes 102. In other embodiments, fewer (or greater) than two auxiliary electrodes 102 may be included in well 200, as illustrated in FIG. 8D. In embodiments, the auxiliary electrodes 102 may be formed to have a complex shape, such as a “gear,” “cog,” “annulus,” “washer” shape, “oblong” shape, “wedge” shape, etc., as described above. For example, as illustrated in FIG. 8B, the inner of the auxiliary electrodes 102 may be formed in a circular shape having exterior semicircular spaces 802 (e.g., “gear” or “cog” shaped) that correspond to the working electrode zones 104. Likewise, for example, as illustrated in FIG. 8C, the outer of the auxiliary electrodes 102 may be formed in a hollow ring shape having interior semicircular spaces 804 (e.g., “washer” shaped) that correspond to the working electrode zones 104.

In embodiments, the well 200 may include ten (10) working electrode zones 104. In other embodiments, fewer or more than ten working electrode zones 104 may be included in well 200 (e.g., 1, 2, 3, 4, etc.) In embodiments, the working electrode zones 104 may be formed to have an approximate circular shape. In other embodiments, the working electrode zones 104 may be formed to have other shapes (e.g., rectangles, squares, ovals, clovers, or any other regular or irregular geometric shape).

In embodiments, the working electrode zones 104 may be positioned in a circular shape between the two (2) auxiliary electrodes 102. In this configuration exterior semicircular spaces 802 and the interior semicircular spaces 704 allow the two (2) auxiliary electrodes 102 to partially surround the working electrode zones. The outer of the two (2) auxiliary electrodes 102 may be spaced at a distance “D₁,” from the working electrode zones 104, where D₁ is measured from the midpoint of the interior semicircular spaces to a boundary of the working electrode zones 104. In some embodiments, the distance, D₁, may be a minimum distance between the outer of the two auxiliary electrodes 102 and the working electrode zones 104. In certain embodiments, distance D₁ may not be equal between one or more working electrode zones 104 and the outer of the two (2) auxiliary electrodes 102. Each of the working electrode zones 104 may be equally spaced from another by a distance, “D₂.” In some embodiments, the distance, D₂, may be a minimum distance between a boundary of two adjacent working electrode zones 104. In further embodiments, distance, D₂, may not be equal between two or more of the working electrode zones 104. The inner of the two (2) auxiliary electrodes 102 may be spaced at a distance “D₃,” from the working electrode zones 104, where D₃ is measured from the midpoint of the exterior semicircular spaces to an edge of the working electrode zones 104. In some embodiments, the distance, D₃, may be a minimum distance between a boundary of a working electrode zones 104 and a boundary of an auxiliary electrode. In certain embodiments, distance D₁ may not be equal between the one or more working electrode zones 104 and the inner of the two (2) auxiliary electrodes 102.

In certain embodiments, as illustrated, the distance, D₁, the distance, D₂, and the distance, D₃, may be measured from a closest relative point on a perimeter of the respective feature (e.g., working electrode zone 104 or auxiliary electrode 102). One skilled in the art will realize that the distances may be measured from any relative point on a feature in order to produce a repeatable geometric pattern.

The electrochemical cells illustrated in FIGS. 8A-8D may include auxiliary electrodes of Ag/AgCl, of carbon, and/or of any other auxiliary electrode material as discussed herein.

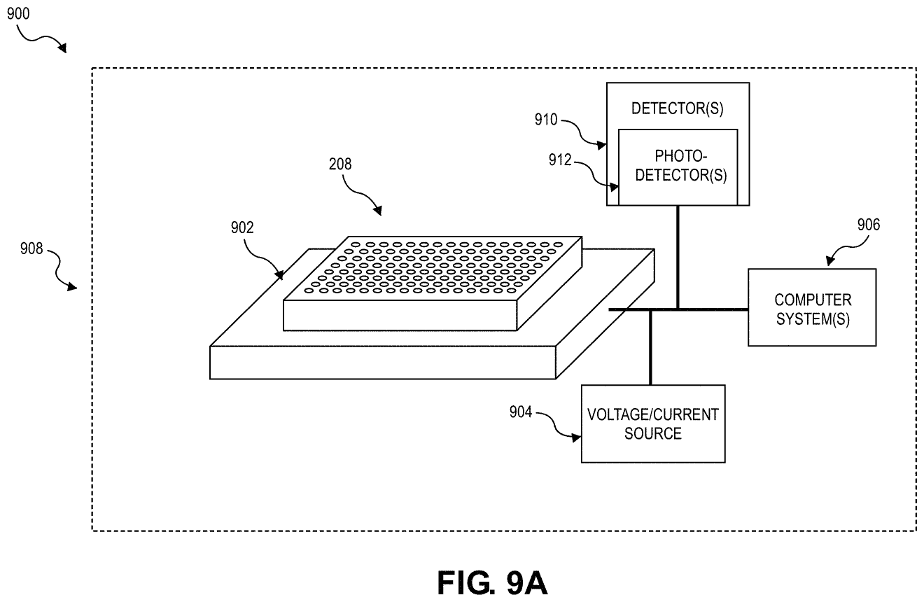

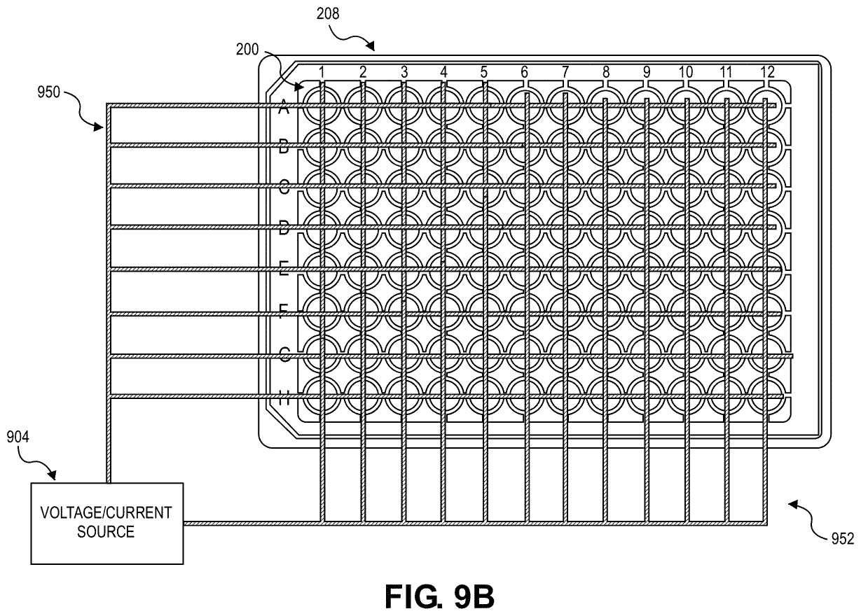

As discussed above, the electrochemical cell 100 may be utilized in devices and apparatus for performing electrochemical analysis. For example, the multi-well plate 208 including wells 200 described above, may be used in any type of apparatus that assists with the performance of biological, chemical, and/or biochemical assays and/or analysis, e.g., an apparatus that performs ECL analysis. FIG. 9 illustrates a generalized assay apparatus 900 in which the multi-well plate 208 including wells 200 may be used for electrochemical analysis and procedures in accordance with an embodiment hereof. One skilled in the art will realize that FIG. 9 illustrates one example of an assay apparatus and that existing components illustrated in FIG. 9 may be removed and/or additional components may be added to the assay apparatus 900 without departing from the scope of embodiments described herein.

As illustrated in FIG. 9, the multi-well plate 208 may be electrically coupled to a plate electrical connector 902. The plate electrical connector 902 may be coupled to a voltage/current source 904. The voltage/current source 904 may be configured to selectively supply a controlled voltage and/or current to the wells 200 of the multi-well plate 208 (e.g., the electrochemical cells 100), through the plate electrical connector 902. For example, the plate electrical connector 1502 may be configured to match and/or mate with electrical contacts of the multi-well plate 208, which are coupled to the one or more auxiliary electrodes 102 and/or the one or more working electrode zones 102, to allow voltage and/or current to be supplied to the wells 200 of the multi-well plate 208.

In some embodiments, the plate electrical connector 902 may be configured to allow the one or more wells 200 to be activated simultaneously (including one or more of working electrode zones and the auxiliary electrode), or two or more of the working electrode zones and/or auxiliary electrode can be activated individually. In certain embodiments, a device, such as one used to carry out scientific analysis, could be electrically coupled to one or more apparatuses (such as, for example, plates, flow cells, etc.). The coupling between the device the one or more apparatuses could include the entire surface of the apparatus (e.g., entire bottom of a plate) or a portion of the apparatus. In some embodiments, the plate electrical connector 902 may be configured to allow one or more of the wells 200 to be selectively addressable, e.g., voltage and/or current selectively applied to ones of the wells 200 and signals read from the detectors 910. For example, as illustrated in FIG. 9B, the multi-well plate 208 may include 96 of the wells 200 that are arranged in Rows labeled “A”-“H” and Columns labeled “1”-“12”. In some embodiments, the plate electrical connector 902 may include a single electrical strip that connects all of the wells 200 in one of Rows A-H or one of the columns 1-12. As such, all of the wells 200 in one of Rows A-H or one of the columns 1-12 may be activated simultaneously, e.g., a voltage and/or current to be supplied by the voltage/current source 904. Likewise, all of the wells 200 in one of Rows A-H or one of the columns 1-12 may be read simultaneously, e.g., a signal read by the detectors 910.

In some embodiments, the plate electrical connector 902 may include a matrix of individual electrical connections, vertical electrical lines 952 and horizontal electrical lines 950, that connect individual wells 200 in the Rows A-H and the columns 1-12. The plate electrical connector 902 (or voltage/current supply 904) may include a switch or other electrical connection device that selectively establishes an electrical connection to the vertical electrical lines 952 and horizontal electrical lines 950. As such, one or more wells 200 in one of Rows A-H or one of the columns 1-12 may be individually activated, e.g., a voltage and/or current to be supplied by the voltage/current source 904, as illustrated in FIG. 9B. Likewise, one or more wells 200 in one of Rows A-H or one of the columns 1-12 may be individually read simultaneously, e.g., by a signal read by the detectors 910. In this example, the one or more wells 200 individually activated by be selected based on the index of the one or more wells 200, e.g., well A1, well A2, etc.

In some embodiments, the plate electrical connector 902 may be configured to allow the one or more working electrode zones 104 and/or the one or more auxiliary electrodes 102 to be activated simultaneously. In some embodiments, the plate electrical connector 902 may be configured to allow one or more of the auxiliary electrodes 102 and/or working electrode zones 104 of each of the wells 200 to be selectively addressable, e.g., voltage and/or current selectively applied to individual ones of the auxiliary electrodes 102 and/or working electrode zones 104 and signals read from the detectors 910. Similar to the wells 200 as described above, for each well 200, the one or more working electrode zones 104 may include a separate electrical contact that allows the plate electrical connector 902 to be electrically to each of the one or more working electrode zones 104 of a well 200. Likewise, for each well 200, the one or more auxiliary electrodes 102 may include a separate electrical contact that allows the plate electrical connector 902 to be electrically to each of the one or more auxiliary electrodes 102 of a well 200.

While not illustrated, the plate electrical connector 902 (or other components of the assay apparatus 900) may include any number of electrical components, e.g., electrical lines, switches, multiplexers, transistors, etc., to allow particular wells 200, auxiliary electrodes 102, and/or working electrode zones 104 to be selectively, electrically coupled to the voltage/current source 904 to allow the voltage and/or current to be selectively applied. Likewise, while not illustrated, the plate electrical connector 902 (or other components of the assay apparatus 900) may include any number of electrical components, e.g., electrical lines, switches, multiplexers, transistors, etc., to allow particular wells 200, auxiliary electrodes 102, and/or working electrode zones 104 to allow signals to be selectively read from the detectors 910.

To control the voltage and/or current supplied, in certain embodiments, a computer system or systems 906 may be coupled to the voltage/current source 904. In other embodiments, the voltage/current source 904 may supply potential and/or current without the aid of a computer system, e.g., manually. The computer system 906 may be configured to control the voltage and/or current supplied to the wells 200. Likewise, in embodiments, the computer systems 906 may be utilized to store, analyze, display, transmit, etc. the data measured during the electrochemical processes and procedures.

The multi-well plate 208 may be housed within a housing 908. The housing 908 may be configured to support and contain the components of assay apparatus 900. In some embodiments, the housing 908 may be configured to maintain experimental conditions (e.g., air tight, light tight, etc.) to accommodate the operations of the assay apparatus 900.

In embodiments, the assay apparatus 900 may include one or more detectors 910 that measure, capture, store, analyze, etc. data associated with the electrochemical processes and procedures of the assay apparatus 900. For example, the detectors 910 may include photo-detectors 912 (e.g., cameras, photodiodes, etc.), voltmeters, ammeters, potentiometers, temperature sensors, etc. In some embodiments, one or more of the detectors 910 may be incorporated into other components of the assay apparatus 900, for example, the plate electrical connector 902, the voltage current source 904, the computer systems 906, the housing 908, etc. In some embodiments, one or more of the detectors 910 may be incorporated into the multi-well plate 208. For example, one or more heaters, temperature controllers, and/or temperature sensors may be incorporated into electrode design of each of the wells 200, as described below.

In embodiments, the one or more photo-detectors 912 may be, for example, film, a photomultiplier tube, photodiode, avalanche photo diode, charge coupled device (“CCD”), or other light detector or camera. The one or more photo-detectors 912 may be a single detector to detect sequential emissions or may include multiple detectors and/or sensors to detect and spatially resolve simultaneous emissions at single or multiple wavelengths of emitted light. The light emitted and detected may be visible light or may be emitted as non-visible radiation such as infrared or ultraviolet radiation. The one or more photo-detectors 912 may be stationary or movable. The emitted light or other radiation may be steered or modified in transit to the one or more photo-detectors 912 using, for example, lenses, mirrors and fiberoptic light guides or light conduits (single, multiple, fixed, or moveable) positioned on or adjacent to any component of the multi-well plate 208. In some embodiments, surfaces of the working electrode zones 104 and/or the auxiliary electrodes 102, themselves, may be utilized to guide or allow transmission of light.

As discussed above, in embodiments, multiple detectors can be employed to detect and resolve simultaneous emissions of various light signals. In addition to the examples already provided herein, detectors can include one or more beam splitters, mirrored lens (e.g., 50% silvered mirror), and/or other devices for sending optical signals to two or more different detectors (e.g., multiple cameras, etc.). These multiple-detector embodiments may include, for example, setting one detector (e.g., camera) to a high gain configuration to capture and quantify low output signals while setting the other to a low gain configuration to capture and quantify high output signals. In embodiments, high output signals may be 2×, 5×, 10×, 100×, 1000×, or larger relative to low output signals. Other examples are contemplated as well.

Turning to the beam splitter examples described above, beam splitters of particular ratios may be employed (e.g., 90:10 ratio with two sensors, although other ratios and/or numbers of sensors are contemplated as well) to detect and resolve emitted light. In this 90:10 example, 90% of the incident light may be directed to a first sensor using a high gain configuration for low light levels and the remaining 10% directed to a second sensor for using a low gain configuration for high light levels. In embodiments, the loss of the 10% of light to the first sensor may be compensated (at least partially) based on various factors, e.g., the sensors/sensor technology selected, binning techniques, etc.) to reduce noise.

In embodiments, each sensor could be the same type (e.g., CCD/CMOS) and in other embodiments they may employ different types (e.g., the first sensor could be a high sensitivity, high performance CCD/CMOS sensor and the second sensor could include a lower cost CCD/CMOS sensor). In other examples, (e.g., for sensors of larger size) the light may be split (e.g., 90/10 as described above, although other ratios are contemplated as well) so that 90% of the signal could be imaged on half the sensor and the remaining 10% imaged on the other half of the sensor. Dynamic range may further be extended by optimizing the optics of this technique, for example, by applying a 99:1 ratio with multiple sensors, where one sensor (e.g., camera) is highly sensitive within a first dynamic range and a second sensor, where its lowest sensitivity starts higher than the first sensor's. When properly optimized, the amount of light each receives can be maximized, thus improving the overall sensitivity. In these examples, techniques may be employed to minimize and/or eliminate cross talk, e.g., by energizing working electrode zones in a sequential fashion. The advantages provided by these examples include simultaneous detection of low and high light levels, which can eliminate the need for dual excitations (e.g., multi-pulse methods), and, thus, ECL read times can be decreased and/or otherwise improved.

In embodiments, the one or more photo-detectors 912 may include one or more cameras (e.g., charge coupled devices (CCDs), complementary metal-oxide-semiconductor (CMOS) image sensors, etc.) that capture images of the wells 200 to capture photons emitted during operations of the assay apparatus 900. In some embodiments, the one or more photo-detectors 912 may include a single camera that captures images of all the wells 200 of the multi-well plate 208, a single camera that captures images of a sub-set of the wells 200, multiple cameras that capture images of all of the wells 200, or multiple cameras that capture images of a sub-set of the wells 200. In some embodiments, each well 200 of the multi-well plate 200 may include a camera that captures images of the well 200. In some embodiments, each well 200 of the multi-well plate 200 may include multiple cameras that capture images of a single working electrode zone 104 or a sub-set of the working electrodes zones 104 in each well 200. In any embodiment, the computer system 906 may include hardware, software, and combination thereof that includes logic to analyze images captured by the one or more photo-detectors 912 and extract luminance data for performing the ECL analysis. In some embodiments, the computer system 906 may include hardware, software, and combinations thereof that include logic for segmenting and enhancing images, for example, to focus on a portion of an image containing one or more of the wells 200, one or more of the working electrode zones 104, and the like, when an image contains data for multiple wells 200, multiple working electrode zones 104, etc. Accordingly, the assay apparatus 900 may provide flexibility because the photo-detectors 912 may capture all the light from multiple working electrode zones 104, and the computer system 906 may use imaging processing to resolve the luminescence data for each working electrode zone 104. As such, the assay apparatus 900 may operate in various modes, for example, in a singleplex mode (e.g., 1 working electrode zone), 10-plex mode (e.g., all working electrodes zones 104 for a 10-working electrode zone well 200), or multiplex mode in general (e.g., a subset of all working electrode zones, including within a single well 200 or among multiple wells 200 at the same time, such as 5 working electrode zones 104 for multiple 10 working electrode zone wells at simultaneously.)

In some embodiments, the one or more photo-detectors 912 may include one or more photodiodes for detecting and measuring photons emitted during chemical luminance. In some embodiments, each well 200 of the multi-well plate 200 may include a photodiode for detecting and measuring photons emitted in the well 200. In some embodiments, each well 200 of the multi-well plate 200 may include multiple photodiodes for detecting and measuring photons emitted from a single working electrode zone 104 or a sub-set of the working electrode zones 104 in each well 200. As such, the assay apparatus 900 may operate in various modes. For example, in a sequential or “time-resolve” mode, the assay apparatus 900 may apply a voltage and/or current to 5 working electrode zones 104 individually. The photodiodes may then sequentially detect/measure the light coming from each of the 5 working electrode zones 104. For instance, a voltage and/or current may be applied to a first of the 5 working electrode zones 104 and the emitted photons may be detected and measured by a corresponding photodiode. This may be repeated sequentially for each of the 5 working electrode zones 104. Likewise, in this example, sequential mode of operation may be performed for working electrode zones 104 within the same well 200, may be performed for working electrode zones 104 located in different wells 200, may be performed for working electrode zones 104 located within sub-sets or “sectors” of multiple wells 200, and combinations thereof. Likewise, in some embodiments, the assay apparatus 900 may operate in a multiplex mode in which one or more working electrode zones 104 are activated simultaneously by the application of a voltage and/or current, and the emitted photons are detected and measured by multiple photodiodes to multiplex. The multiplex mode of operation may be performed for working electrode zones 104 within the same well 200, may be performed for working electrode zones 104 located in different wells 200, may be performed for working electrode zones 104 located with sub-sets or “sectors” of wells 200 from the multi-well plate 208, combinations thereof.

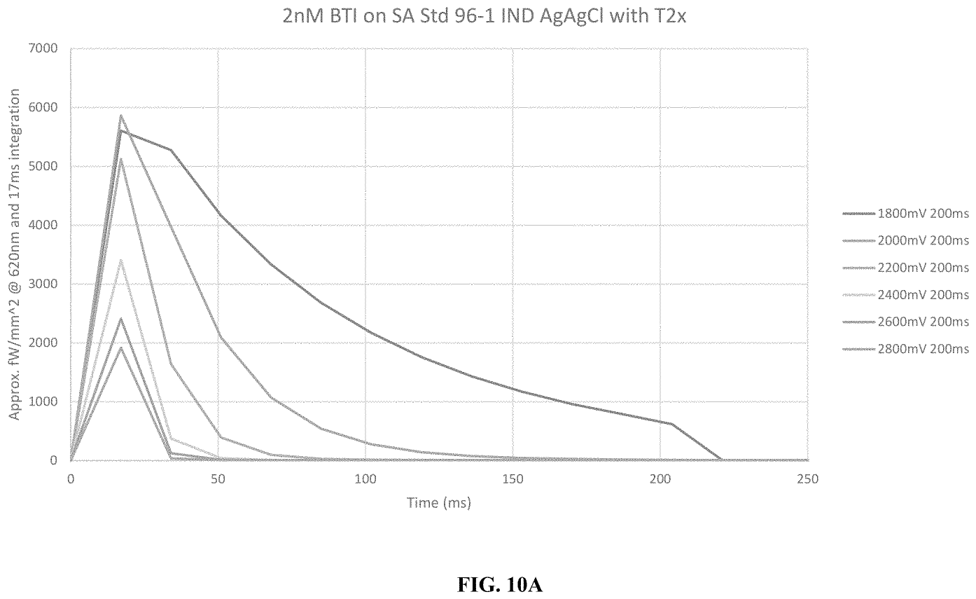

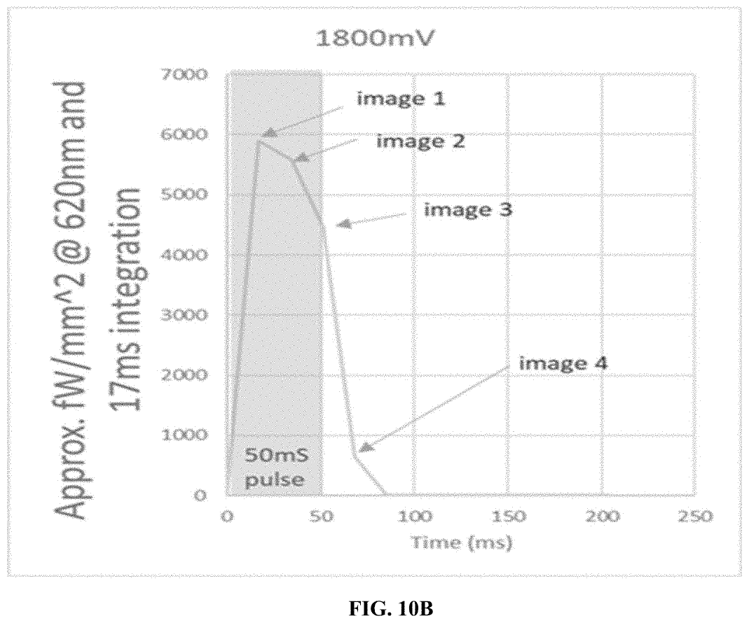

In the embodiments described above, the working electrode zones 104 experience a natural decay in intensity of the emitted photons after the voltage supplied to the working electrode zones 104 is removed. That is, when a voltage is applied to the working electrode zones 104, a redox reaction occurs and photons are emitted at an intensity determined by the voltage applied and the substances undergoing the redox reaction. When the applied voltage is removed, the substance that underwent the redox reaction continues to emit photons, at a decaying intensity, for a period of time based on the chemical properties of the substances. As such, when the working electrode zones 104 are activated in sequence, the assay apparatus 900 (e.g., the computer system 906) may be configured to implement a delay in activating sequential working electrode zones 104. The assay apparatus 900 (e.g., the computer system 906) may determine and implement a delay in activating sequential working electrode zones 104 in order to prevent photons from the previously fired working electrode zones 104 from interfering with photons emitted from a currently activated working electrode zone 104. For example, FIG. 10A shows the decay of ECL during various voltage pulses, and FIG. 10B illustrates the ECL decay time using a pulse of 50 ms. In the example of FIG. 10B, intensity data was determined by taking multiple images during and after the end of a 50 ms long voltage pulse at 1800 mV. To improve the temporal resolution, image frames were taken (or photons detected) every 17 ms. The 50 ms voltage pulse, as illustrated in FIG. 10B, was imaged with 3 frames (e.g., Image 1-3; 3 times 17 ms=51 ms). Any emitted photons, e.g., ECL signal, after image 3 would be due to the decay of an intensity of photons (e.g., ECL) after the working electrode zone 104 was turned off. In FIG. 10B, image 4 captured additional ECL signal after the working electrode zone 104 was turned off, suggesting that there may be some small continuing light generating chemistry after the driving force for this chemistry (e.g., applied voltage potential) is deactivated. That is, because the working electrode zone 104 switches to 0 mV for 1 ms after the end of the 1800 mV voltage pulse, the effects of polarization likely have no effect on the delay. In embodiments, the assay apparatus 900 (e.g., the computer system 906) may be configured to utilize such data for different voltage pulses to delay the activation of sequential working electrode zones 104. As such, an implementation of a delay allows the assay apparatus 900 to minimize cross-talk between working electrode zones 104 and/or wells 200, have high throughput in performing ECL operations, etc.

In any embodiment, the utilization of the one or more auxiliary electrodes 102 improves the operation of the assay apparatus 900. In some embodiments, the utilization of the one or more auxiliary electrodes 102 improves read times for the detectors 910. For example, the use of Ag/AgCl in the one or more auxiliary electrodes 102 improves read times of ECL for several reasons. For example, the use of an electrode (e.g., an auxiliary electrode 102) having a redox couple (in this particular embodiment, Ag/AgCl) can provide a stable interfacial potential to allow electrochemical analysis processes to utilize voltage pulses, rather than voltage ramps. The use of voltage pulses improves the read times because the entire pulsed waveform can be applied at a voltage potential that generates the ECL throughout the entire duration of the waveform. Tables 7 and 8 below include improved read times (in seconds) for various configuration of the assay apparatus 900 utilizing the one or more auxiliary electrodes 102. The examples in these tables are the total read times of all well of a 96-well plate (each well containing either a single working electrode (or single working electrode zone) or 10 working electrodes (or 10 working electrode zones)). For these read times, analysis was performed on all working electrode (or working electrode zones) (either 1 or 10 depending on the experiment) from all 96 wells. In Table 7 below, “spatial” refers to an operating mode in which all working electrode zones 104 are activated concurrently, and images are captured and processed to resolve them. “Time-resolve,” refers to a sequential mode as described above. Time-resolve has the added benefit of permitting adjustments to the ECL image collection (e.g., adjusting binning to adjust dynamic range, etc.). The “Current Plate RT” column includes read times for non-auxiliary electrodes (e.g., carbon electrodes). The last three columns of the table include the difference in read times between the non-auxiliary electrode read times and the auxiliary electrode (e.g., Ag/AgCl) read times. For time-resolved measurements (using these examples with 10 working electrode zones per well in both Table 7 and Table 8), the read time for subplexes will be in between 1 working electrode zone (WE) and 10 WE read times. For the “B” experiments, read time improvement was not calculated because the non-auxiliary electrode plates cannot operate in a time resolved mode. the Table 8 includes similar data in which the assay apparatus 900 includes photodiodes, as discussed above. One skilled in the art will realize that the values included in Tables 7 and 8 are approximate values and may vary by, for example, +/−5.0% based on conditions such as operating conditions and parameters of the assay apparatus.

TABLE 7
Read times (seconds) for imaging-based devices

| | Working | | | | | | | | | |
|---|---|---|---|---|---|---|---|---|---|---|
| | electrode | | | | | | | | | |
| | design/operating | | | | | | | 50 ms | 100 ms | |
| | mode | | | | Current | | | Read | Read | 200 ms |
| | (number | | | | Plate RT | | | time | time | Read time |
| | of | | | | (non- | | | improvement of | improvement of | improvement of |
| Experiment | WE/WE | 50 ms | 100 ms | 200 ms | auxiliary | Current | | auxiliary | auxiliary | auxiliary |
| (Exp.) | mode) | pulse | pulse | pulse | electrodes) | Exposure | Overhead | electrode | electrode | electrode |
| Exp. 1A | 1-WE / | 66 | 71 | 81 | 157 | 96 | 61 | 91 | 86 | 76 |
| | 10-WE | | | | | | | | | |
| | spatial | | | | | | | | | |
| Exp. 1B | 10-WE | 114 | 162 | 258 | | | | n/a | n/a | n/a |
| | time- | | | | | | | | | |
| | resolved | | | | | | | | | |
| Exp. 2A | 1-WE / | 45 | 47 | 49 | 92 | 48 | 44 | 47 | 45 | 43 |
| | 10-WE | | | | | | | | | |
| | spatial | | | | | | | | | |
| Exp. 2B | 10-WE | 57 | 69 | 93 | | | | n/a | n/a | n/a |
| | time- | | | | | | | | | |
| | resolved | | | | | | | | | |
| Exp. 3A | 1-WE / | 51 | 52 | 52 | 69 | 18 | 51 | 18 | 17 | 17 |
| | 10-WE | | | | | | | | | |
| | spatial | | | | | | | | | |
| Exp. 3B | 10-WE | 54 | 57 | 63 | | | | n/a | n/a | n/a |
| | time- | | | | | | | | | |
| | resolved | | | | | | | | | |

TABLE 8
Read times (seconds) for non-imaging-based devices

| Detector | Working electrode | 50 ms | 50 ms | 50 ms |
|---|---|---|---|---|
| Type | design (number of WE) | pulse | pulse | pulse |
| Photodiode | 1-WE | 66 | 71 | 81 |
| Photodiode | 10-WE (time-resolved) | 114 | 162 | 258 |

For Tables 7 and 8, “WE” can refer to either working electrodes or working electrode zones.

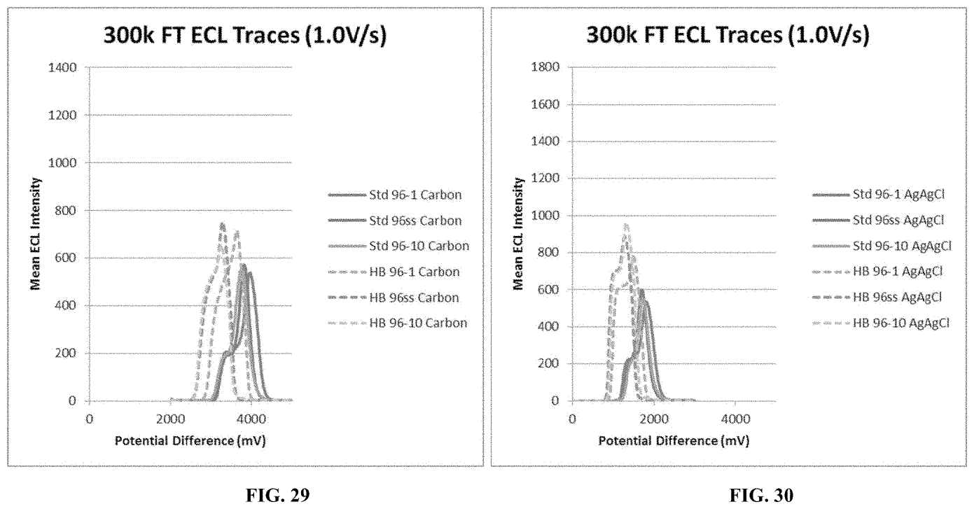

In contrast, with a voltage ramp in ECL applications, there are periods of time when voltage is applied but ECL is not generated (e.g., a portion of the beginning of the ramp and/or a portion at the end of the ramp). For example, as described below in further detail, FIGS. 29 and 30 (using carbon-based and Ag/AgCl-based electrodes, respectively) illustrate a 3 second ramp time (1.0 V/s) applied to the electrodes. With this waveform, there are periods of time in which ECL is not being generated despite a potential being applied. Put another way, when applying a ramp waveform, there are percentages of the overall waveform duration (e.g., 5%, 10%, 15%, etc.) for which ECL is not generated for which a potential is being applied. Those percentages may vary based on several factors, including types of materials used to form the electrodes, relative and absolute sizes of electrodes, etc. FIGS. 29 and 30 illustrate non-limiting, exemplary examples of specific percentages for which ECL was not generated for this particular ramp waveform.

In any of the embodiments described above, the utilization of working electrode zones 104 with different sizes and configuration provides various advantages for the assay apparatus 900. For ECL applications, the optimal working electrode sizes and locations may depend on the exact nature of the application and they type of light detector used for detecting ECL. In binding assays employing binding reagents immobilized on the working electrodes, binding capacity and binding efficiency and speed will generally increase with increasing size for the working electrode zones. For ECL instruments employing imaging detectors (e.g., CCD or CMOS devices), the benefits of larger working electrode zones on binding capacity and efficiency may be balanced by improved sensitivity of these devices in terms of total number of photons, when the light is generated at smaller working electrode zones, and is imaged on a smaller number of imaging device pixels. The position of the working electrode zones 104 may have an impact on the performance of the assay apparatus 900. In some embodiments, spot location, size, and geometry may affect the amount of reflection, scatter or loss of photons on the well sidewalls and influence both the amount of the desired light that is detected, as well as the amount of undesired light (e.g., stray light from adjacent working electrode zones or wells) that is detected as having come from a working electrode zone of interest. In some embodiments, the performance of the assay apparatus 900 may be improved by having a design with no working electrode zone 104 located in the center of a well 200 as well as having the working electrode zones 104 located a uniform distance from the center of the well 200. In some embodiments, the one or more working electrode zones 104 being positioned at radially symmetric positions within the well 200 may improve operation of the assay apparatus 900 because optical light collection and meniscus interaction is the same for all of the one or more working electrode zones 104 in the well 200, as discussed above. The one or more working electrode zones 104 being arranged in at a fixed distance (e.g., circle pattern) allows the assay apparatus to utilize shortened pulsed waveforms, e.g., reduced pulse width. In embodiments, a design in which the one or more working electrode zones 104 have a nearest neighbor as the one or more auxiliary electrodes 102 (e.g., no working electrode zone interposed between) improves the performance of the assay apparatus 900.

In embodiments, as briefly described above, the assay apparatus 900 (e.g., the computer system 906 may be configured to control the voltage/current source 904 to supply voltage and/or current in a pulsed waveform, e.g., direct current, alternating current, DC emulating AC, etc., although other waveforms of varying period, frequency, and amplitude are contemplated as well (e.g., negative ramp sawtooth waveforms, square waveforms, rectangular waveforms, etc. . . . . These waveforms may include various duty cycles as well, e.g., 10%, 20%, 50%, 65%, 90%, or any other percentage between 0 and 100. The computer system 906 may selectively control a magnitude of the pulsed waveform and a duration of the pulsed waveform, as further described below. In an embodiment, as discussed above, the computer system 906 may be configured to selectively provide the pulsed waveform to one or more of the wells 200. For example, the voltage and/or current may be supplied to all of the wells 200. Likewise, for example, a pulsed waveform may be supplied to selected wells 200 (e.g., on an individual or sector basis, such as a grouping of a subset of well—e.g., 4, 16, etc.). For example, as discussed above, the wells 200 may be individually addressable, or addressable in groups or subsets of two or more wells. In an embodiment, the computer system 906 may also be configured to selectively provide the pulsed waveform to one or more of the working electrode zones 104 and/or the auxiliary electrodes 102 in as the manner described above (e.g., individually addressable or addressable in groups of two or more auxiliary electrodes). For example, the pulsed waveform may be supplied to all the working electrode zones 104 within a well 200 and/or addressed to one or more selected working electrode zones 104 within a well 200. Likewise, for example, the pulsed waveform may be supplied to all the auxiliary electrodes 102 and/or addressed to one or more selected auxiliary electrodes 102.

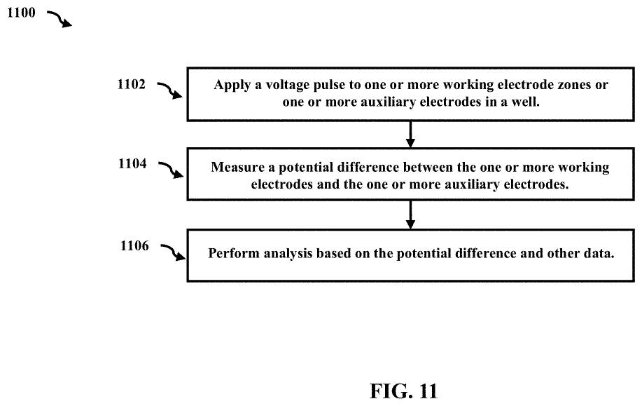

In embodiments, a pulsed waveform supplied by a voltage/current source 904 may be designed to improve electrochemical analysis and procedures of the assay apparatus 900. FIG. 11 depicts a flow chart showing a process 1100 for operating an assay apparatus using pulsed waveforms, in accordance with an embodiment hereof.

In an operation 1102, the process 1100 includes applying a voltage pulse to one or more working electrode zones 104 or one or more auxiliary electrodes 102 in a well. For example, the computer system 906 may control the voltage/current source 904 to supply a voltage pulse to one or more working electrode zones 104 or one or more auxiliary electrodes 102.

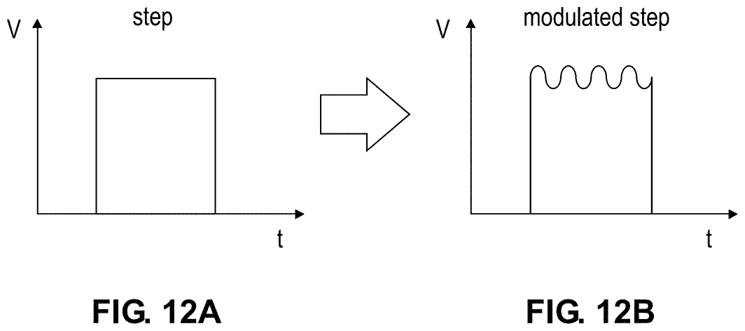

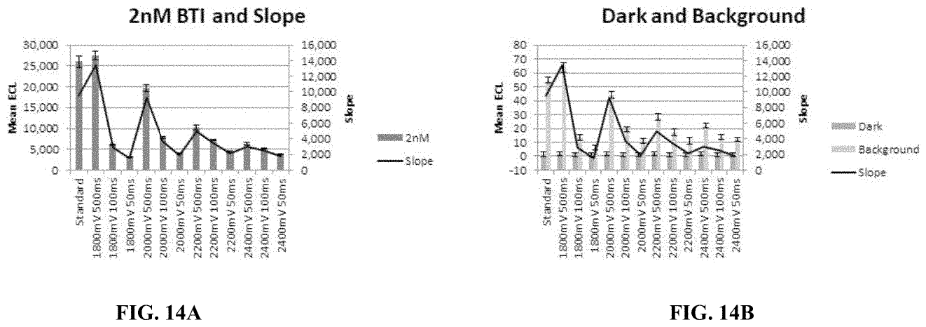

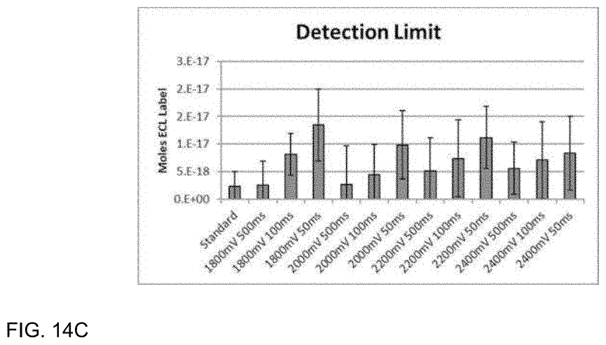

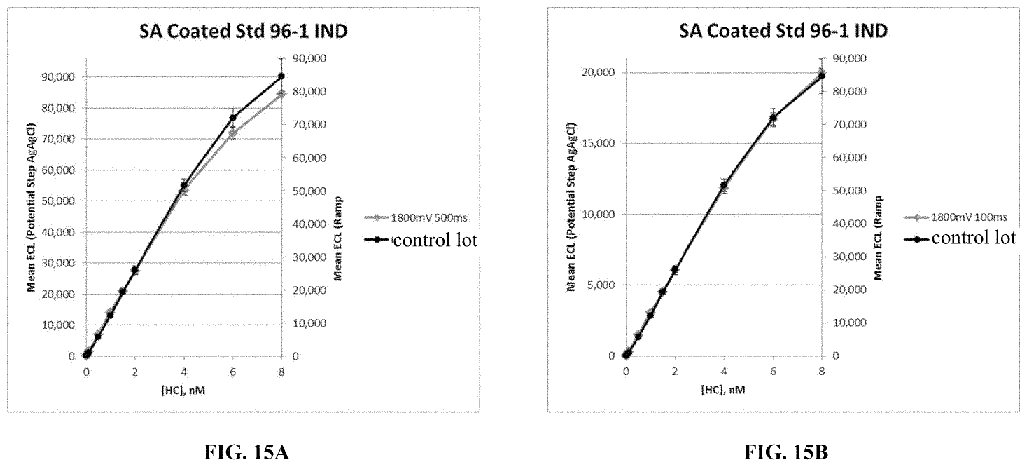

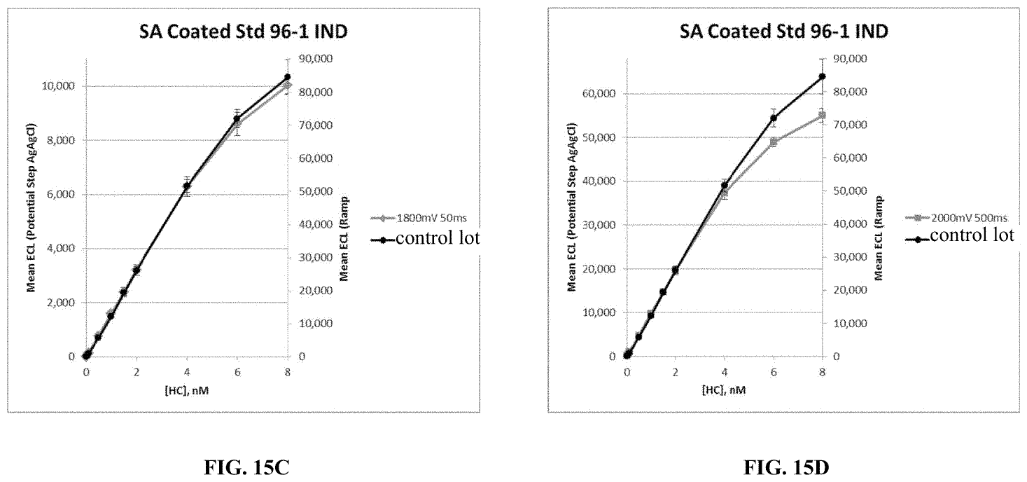

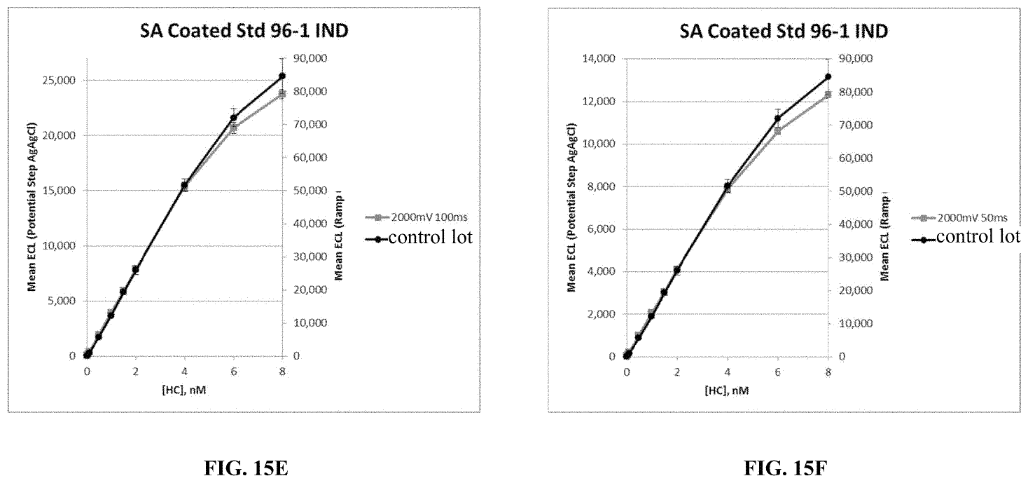

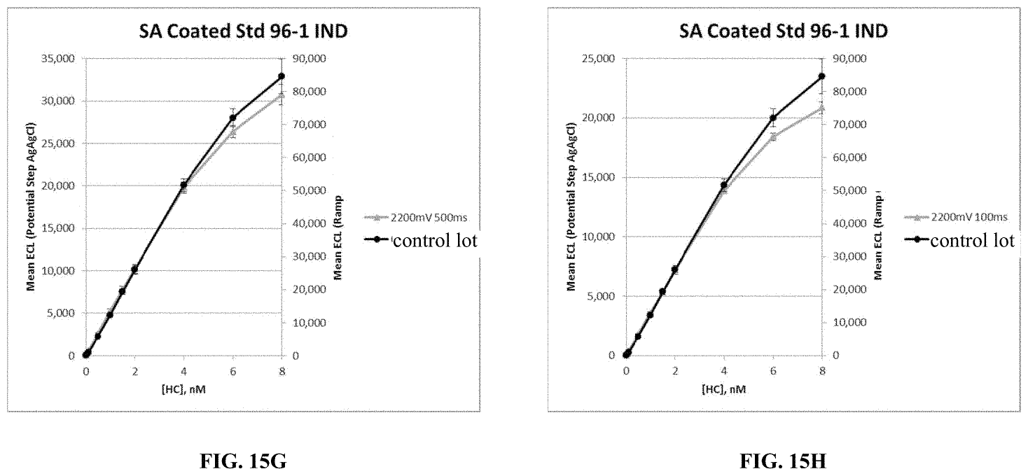

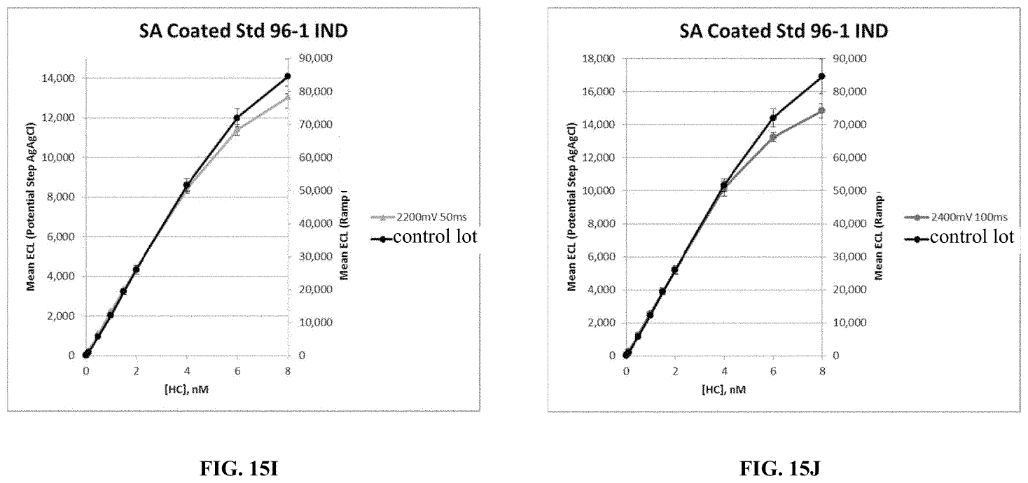

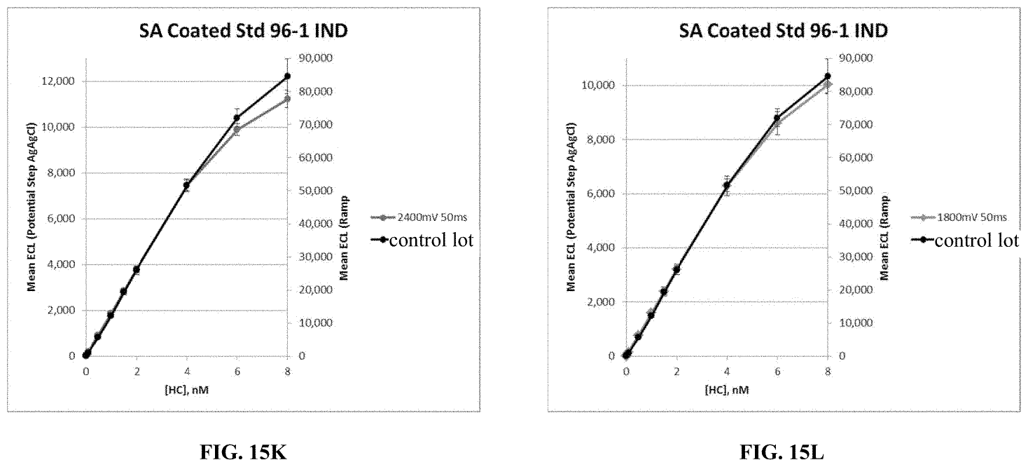

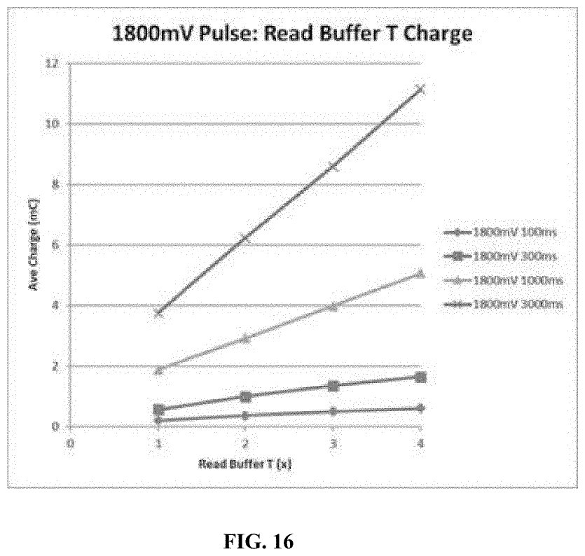

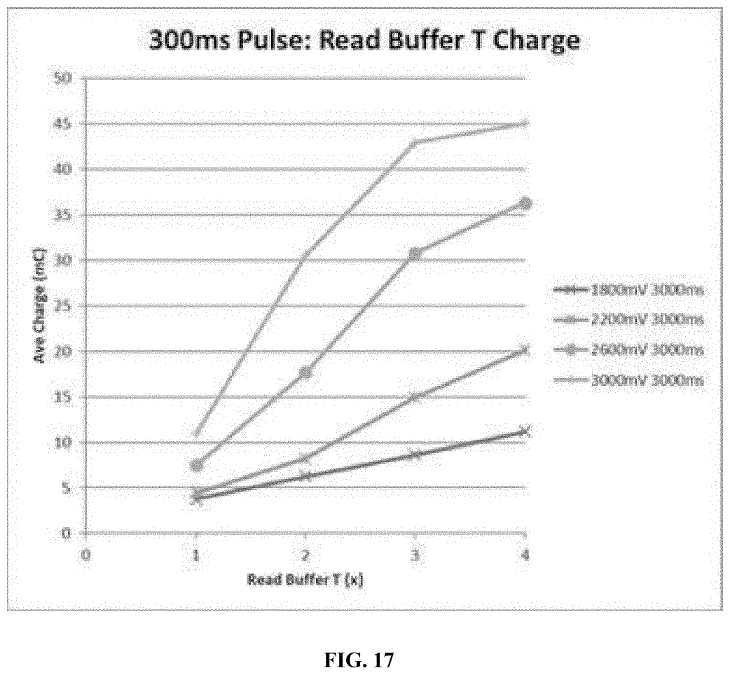

In embodiments, the pulsed waveform may include various waveform types, such as direct current, alternating current, DC emulating AC, etc., although other waveforms of varying period, frequency, and amplitude are contemplated as well (e.g., negative ramp sawtooth waveforms, square waveforms, rectangular waveforms, etc. . . . . These waveforms may include various duty cycles as well, e.g., 10%, 20%, 50%, 65%, 90%, or any other percentage between 0 and 100. FIGS. 12A and 12B illustrate two examples of a pulsed waveform. As illustrated in FIG. 12A, the pulsed waveform may be a square wave having a voltage, V, for a time, T. Examples of voltage pulses are also described in reference to FIGS. 14A, 14B, 15A-15L, 16 and 17, e.g., 1800 mV at 500 ms, 2000 mV at 500 ms, 2200 mV at 500 ms, 2400 mV at 500 ms, 1800 mV at 100 ms, 2000 mV at 100 ms, 2200 mV at 100 ms, 2400 mV at 100 ms, 1800 mV at 50 ms, 2000 mV at 50 ms, 2200 mV at 50 ms, 2400 mV at 50 ms, etc. As illustrated in FIG. 17, the pulsed waveform may be a combination of two types of waveforms, e.g., a square wave modulated by a sine wave. The resulting ECL signal also modulates with the frequency of the sine wave, thus the assay apparatus 900 may include a filter or lock-in circuitry to focus on the ECL signal that exhibit the frequency of the sine wave and filter out electronic noise or stray light that does not exhibit the frequency of the sine wave. While FIGS. 12A and 12B illustrate examples of a pulsed waveform, one skilled in the art will realize that the pulsed waveform may have any structure in which potential is raised to a defined voltage (or range of voltages) for a predefined period of time. One skilled in the art will realize that parameters for the voltages pulses and pulsed waveforms (e.g., durations, duty cycle, and pulse height in volts) described herein are approximate values and may vary by, for example, +/−5.0% based on conditions such as operating parameters of the voltage/current source.

In an operation 1104, the process 1100 includes measuring a potential difference between the one or more working electrode zones 104 and the one or more auxiliary electrodes 102. For example, the detectors 910 may measure the potential difference between the working electrodes zones 104 and the auxiliary electrodes 102 in the wells 200. In some embodiments, the detectors 910 may supply the measured data to the computer systems 1506.

In an operation 1106, the process 1100 includes performing an analysis based on the measured potential differences and other data. For example, the computer systems 906 may perform the analysis on the potential difference and other data. The analysis may be any process or procedure such as potentiometry, coulometry, voltammetry, optical analysis (explained further below), etc. In embodiments, the use of the pulsed waveform allows specific types of analysis to be performed. For example, many different redox reactions may occur in a sample that is activated when the applied potential exceeds a specific level. By using a pulsed waveform of a specified voltage, the assay apparatus 900 may selectively activate some of these redox reactions and not others.

In one embodiment, the disclosure provided herein may be applied to a method for conducting ECL assays. Certain examples of methods for conducting ECL assays are provided in U.S. Pat. Nos. 5,591,581; 5,641,623; 5,643,713; 5,705,402; 6,066,448; 6,165,708; 6,207,369; 6,214,552; and 7,842,246; and Published PCT Applications WO87/06706 and WO98/12539, which are hereby incorporated by reference.

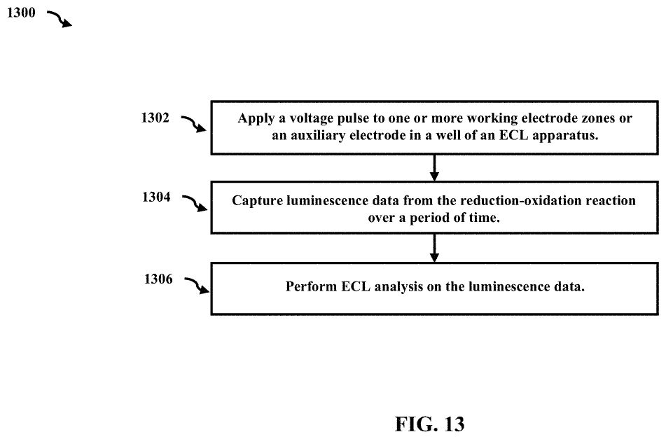

In embodiments, a pulsed waveform supplied by a voltage/current source 904 may be designed to improve the ECL emitted during ECL analysis. For example, the pulsed waveform may improve the ECL emitted during ECL analysis by providing a stable and constant voltage potential thereby producing a stable and predictable ECL emission. FIG. 13 depicts a flow chart showing a process 1300 for operating an ECL apparatus using pulsed waveforms, in accordance with an embodiment hereof.

In an operation 1302, the process 1300 includes applying a voltage pulse to one or more working electrode zones 104 or an auxiliary electrode 102 in a well of an ECL apparatus. For example, the computer system 906 may control the voltage/current source 904 to supply a voltage pulse to one or more working electrode zones 104 or the one or more auxiliary electrodes 102. In embodiments, the one or more auxiliary electrodes 102 may include a redox couple where, when a voltage or potential is applied, a reaction of a species in the redox couple is a predominant redox reaction occurring at the one or more auxiliary electrodes 102. In some embodiments, the applied potential is less than a defined potential required to reduce water or perform electrolysis of water. In some embodiments, less than 1 percent of current is associated with the reduction of water. In some embodiments, less than 1 of current per unit area (exposed surface area) of the one or more auxiliary electrodes 102 is associated with the reduction of water.

In embodiments, the pulsed waveform may include various waveform types, such as direct current, alternating current, DC emulating AC, etc., although other waveforms of varying period, frequency, and amplitude are contemplated as well (e.g., negative ramp sawtooth waveforms, square waveforms, rectangular waveforms, etc. FIGS. 12A and 12B discussed above illustrate two examples of pulsed waveforms. The pulsed waveform may be a square wave having a voltage, V, for a time, T. Examples of voltage pulses are also described in reference to FIGS. 14A, 14B, 15A-15L, 16 and 17, e.g., 1800 mV at 500 ms, 2000 mV at 500 ms, 2200 mV at 500 ms, 2400 mV at 500 ms, 1800 mV at 100 ms, 2000 mV at 100 ms, 2200 mV at 100 ms, 2400 mV at 100 ms, 1800 mV at 50 ms, 2000 mV at 50 ms, 2200 mV at 50 ms, 2400 mV at 50 ms, etc. These waveforms may include various duty cycles as well, e.g., 10%, 20%, 50%, 65%, 90%, or any other percentage between 0 and 100.

In an operation 1304, the process 1300 includes capturing luminescence data from the electrochemical cell over a period of time. For example, the one or more photo-detectors 912 may capture luminescence data emitted from the wells 200 and communicate the luminescence data to the computer system 906. In an embodiment, the period of time may be selected to allow the photo-detectors collect the ECL data. In some embodiments, the one or more photo-detectors 912 may include a single camera that captures images of all the wells 200 of the multi-well plate 208 or multiple cameras that capture image of a sub-set of the wells 200. In some embodiments, each well 200 of the multi-well plate 200 may include a camera that captures images of the well 200. In some embodiments, each well 200 of the multi-well plate 200 may include multiple cameras that capture images of a single working electrode zone 104 or a sub-set of the working electrodes zones 104 in each well 200. Accordingly, the assay apparatus 900 may provide flexibility because the camera may capture all the light from multiple working electrode zones 104, and the computer system 906 may use imaging processing to resolve the luminesce data for each working electrode zone 104. As such, the assay apparatus 900 may operate in various modes, for example, in a singleplex mode (e.g., 1 working electrode zone), 10-plex mode (e.g., all working electrodes zones 104 for a 10-working electrode zone well 200), or multiplex mode in general (e.g., a subset of all working electrode zones, including within a single well 200 or among multiple wells 200 at the same time, such as 5 working electrode zones 104 for multiple 10 working electrode zone wells at simultaneously.)

In some embodiments, an assay apparatus 900 may include a photodiode corresponding to each well 200 of the multi-well plate 200 for detecting and measuring photons emitted in the well 200. In some embodiments, an assay apparatus 900 may include multiple photodiodes corresponding to each well 200 of the multi-well plate 200 for detecting and measuring photons emitted from a single working electrode zone 104 or a sub-set of the working electrode zones 104 in each well 200. As such, the assay apparatus 900 may operate in various modes. For example, the assay apparatus 900 may apply a voltage and/or current to one or more of the working electrode zones 104 from the multi-well plate 208, for example 5 working electrode zones 104, individually. The working electrode zones 104 may be located within a single well 200, located in different wells 200, and combination thereof. The photodiodes may then sequentially detect/measure the light coming from each of the 5 working electrode zones 104. For instance, a voltage and/or current may be applied to a first of the 5 working electrode zones 104 and the emitted photons may be detected and measured by a corresponding photodiode. This may be repeated sequentially for each of the 5 working electrode zones 104. Likewise, in this example, sequential mode of operation may be performed for working electrode zones 104 within the same well 200, may be performed for working electrode zones 104 located in different wells 200, may be performed for working electrode zones 104 located with sub-sets or “sectors” of wells 200, and combinations thereof. Likewise, in some embodiments, the assay apparatus 900 may operate in a multiplex mode in which one or more working electrode zones 104 are activated simultaneously by the application of a voltage and/or current, and the emitted photons may be detected and measured by multiple photodiodes to multiplex. The multiplex mode of operation may be performed for working electrode zones 104 within the same well 200, may be performed for working electrode zones 104 located in different wells 200, may be performed for working electrode zones 104 located with sub-sets or “sectors” of wells 200 from the multi-well plate 208, combinations thereof. FIGS. 14A, 14B, 15A-15L, 16 and 17 below show tests of several waveforms utilized in ECL analysis.

In embodiments, by applying a pulsed waveform to generate ECL, read time and/or exposure time may be improved by more quickly and efficiently generating, collecting, observing, and analyzing ECL data. Further, various exposure approaches may be employed (e.g., single exposure, dual exposure, triple exposure (or greater)) that can utilize disparate exposure times (or equal exposure times) to improve ECL collection, collecting, observing, and analysis by improving, for example, the dynamic range extension (DRE), binning, etc. For example, as discussed above, the utilization of the one or more auxiliary electrodes 102 improves the operation of the assay apparatus 900. In some embodiments, the utilization of the one or more auxiliary electrodes 102 improves read times for the detectors 910. For example, the use of Ag/AgCl in the one or more auxiliary electrodes 102 improves read times of ECL for several reasons For example, the use of an electrode (e.g., an auxiliary electrode 102) having a redox couple (in this particular embodiment, Ag/AgCl) can provide a stable interfacial potential to allow electrochemical analysis processes to utilize voltage pulses, rather than voltage ramps. The use of voltage pulses improves the read times because the entire pulsed waveform can be applied at a voltage potential that generates the ECL throughout the entire duration of the waveform. Moreover, “Time-resolve,” or sequential mode has the added benefit of permitting adjustments to the ECL image collection (e.g., adjusting binning to adjust dynamic range, etc.) Further, as discussed above, the assay apparatus 900 (e.g., the computer system 906) may be configured to utilize such data for different voltage pulses to delay the activation of sequential working electrode zones 104. As such, an implementation of a delay allows the assay apparatus 900 to minimize cross-talk between working electrode zones 104 and/or wells 200, have high throughput in performing ECL operations, etc.

In an operation 1306, the process 1300 includes performing ECL analysis on the luminescence data. For example, the computer systems 906 may perform the ECL analysis on the luminescence data. In some embodiments, luminescence data, e.g., signals, arising from a given target entity on a binding surface of the working electrode zones 104 and/or auxiliary electrode 102, e.g., binding domain, may have a range of values. These values may correlate with quantitative measurements (e.g., ECL intensity) to provide an analog signal. In other embodiments, a digital signal (yes or no signal) may be obtained from each working electrode zone 104 to indicate that an analyte is either present or not present. Statistical analysis may be used for both techniques and may be used for translating a plurality of digital signals so as to provide a quantitative result. Some analytes may require a digital present/not present signal indicative of a threshold concentration. Analog and/or digital formats may be utilized separately or in combination. Other statistical methods may be utilized, for example, technique to determine concentrations through statistical analysis of binding over the concentration gradient. Multiple linear arrays of data with concentration gradients may be produced with a multiplicity of different specific binding reagents being used in different wells 200 and/or with different working electrode zones 104. The concentration gradients may consist of discrete binding domains presenting different concentrations of the binding reagents.

In embodiments, control assay solutions or reagents, e.g., read buffers, may be utilized on the working electrode zones of the wells 200. The control assay solutions or reagents may provide uniformity to each analysis to control for signal variation (e.g., variations due to degradations, fluctuations, aging of the multi-well plate 208, thermal shifts, noise in electronic circuitry and noise in the photodetection device, etc.) For example, multiple redundant working electrode zones 104 (containing identical binding reagents or different binding reagents that are specific for the same analyte) for the same analyte may be utilized. In another example, analytes of known concentration may be utilized or control assay solutions or reagents may be covalently linked to a known quantity of an ECL label or a known quantity of ECL label in solution is used.

In embodiments, the data collected and produced in the process 1300 may be utilized in a variety of applications. The data collected and produced may be stored, e.g., in the form of a database consisting of a collection of clinical or research information. The data collected and produced may also be used for rapid forensic or personal identification. For example, the use of a plurality of nucleic acid probes when exposed to a human DNA sample may be used for a signature DNA fingerprint that may readily be used to identify clinical or research samples. The data collected and produced may be used to identify the presence of conditions (e.g., diseases, radiation level, etc.), organisms (e.g., bacteria, viruses, etc.), and the like.

The above describes an illustrative flow of an example process 1300. The process as illustrated in FIG. 13 is exemplary only, and variations exist without departing from the scope of the embodiments disclosed herein. The steps may be performed in a different order than that described, additional steps may be performed, and/or fewer steps may be performed, as described above. In embodiments, the use of the pulsed waveform in combination with auxiliary electrodes produces various advantages to ECL assays. The auxiliary electrodes allows luminescence to be generated quicker without the use of a ramp.

FIGS. 14A-14C, 15A-15L, 16 and 17 are graphs that show the results of ECL analysis using various pulsed waveforms. FIGS. 15A-15L show raw data plotted vs. BTI concentrations for a model binding assay using the various pulsed waveforms. FIGS. 15A-15L show a comparison between the use of a pulsed waveform applied to wells using Ag/AgCl auxiliary electrodes (labeled according to the pulse parameters) and the use of a ramped waveform (1s at 1.4 V/s) as applied to wells using carbon electrodes as a control (labeled as control lot). FIGS. 14A-14C summarize the performance of the model binding assay according to the various pulsed waveforms as shown in FIGS. 15A-15L. FIGS. 16 and 17 are discussed in greater detail below. In these tests, a model binding assay was used to measure the effects of ECL-generation conditions on the amount of ECL generated from a controlled amount of ECL-labeled binding reagent, bound through a specific binding interaction to a working electrode zone. In this model system, the ECL-labeled binding reagent was an IgG antibody that was labeled with both biotin and an ECL label (SULFO-TAG, Meso Scale Diagnostics, LLC.). Varying concentrations of this binding reagent (referred to as “BTI” or “BTI HC” for BTI high control) were added to wells of 96-well plates having an integrated screen printed carbon ink working electrode with an immobilized layer of streptavidin in each well. Two types of plates were used, the control plate was an MSD Gold 96-well Streptavidin QuickPlex plate with a screen printed carbon ink counter electrode (Meso Scale Diagnostics, LLC.); the test plate was analogous in design but had a screen printed Ag/AgCl auxiliary electrode in the place of the counter electrode. The plates were incubated to allow the BTI in the wells to bind to the working electrodes through a biotin-streptavidin interaction. After completing the incubation, the plates were washed to remove free BTI and an ECL read buffer (MSD Read Buffer Gold, Meso Scale Diagnostics, LLC.) was added and the plate was analyzed by applying a defined voltage wave form between the working and auxiliary electrodes and measuring the emitted ECL. The Ag:AgCl ratio in the auxiliary electrode ink for the test plate was approximately 50:50. Twelve waveforms were employed using 4 different potentials (1800 mV, 2000 mV, 2200 mV, and 2400 mV) at 3 different times or pulse widths (500 ms, 100 ms, and 50 ms). One test plate was tested for each waveform. A control plate was tested using a standard ramp waveform.

Assay performance data was determined and calculated for the plates tested with each waveform. The mean, standard deviation, and % CV were calculated for each sample and are plotted as data points with error bars. The signals measured for BTI solutions ranging from 0 (a blank sample to measure assay background) to 2 nM were fitted linearly (slope, Y-intercept, and R² were calculated.) A detection limit was calculated based upon the mean background+/−3*standard deviations (“stdev”) and the linear fit of the titration curve (shown in FIG. 14C). Signals were also measured for 4, 6, and 8 nM BTI solutions. These signals were divided by the extrapolated signals from the linear fit of the titration curve (this ratio can be used to estimate the binding capacity of the streptavidin layer on the working electrode; ratios significantly less than one indicate that the amount of BTI added is near to or greater than the binding capacity). The ratio of the slope from the production control lot to the slope from each test plate was calculated. FIG. 14A shows the results of these calculations for each pulsed waveform. Each of the graphs in FIGS. 15A-15L illustrates mean ECL data collected for a ramped voltage applied to a multi-well plate with carbon counter electrodes from a control lot and a different voltage pulse applied to an multi-well plate using Ag/AgCl auxiliary electrodes. FIGS. 14A-14C provide summaries of the data shown in FIG. 15A-15L.

Additionally, signal, slope, background, and dark analysis (e.g., signal produced with no ECL) was performed. A plot of the 2 nM signals (with lstdev error bars) and slope was prepared. A bar graph of the background and dark (with lstdev error bars) and slope was prepared. FIG. 14B shows these results. As illustrated in FIGS. 14A and 14B, a pulsed voltage of 1800 mV for 500 ms proceeds the highest mean ECL reading. As shown in FIGS. 14A and 14B, the magnitude and/or the duration of the pulsed waveform affects the ECL signal measured. The change in 2 nM signal with waveform mirrors the change in slope. The change in the background also mirrors the change in slope. The signal, background, and slope decreased with decreasing pulse duration. The signal, background, and slope decreased with increasing pulse potential. The change in signal, background, and slope with decreasing time diminished with increasing pulse potential. The concurrent changes in signal, background, and slope with the various pulse potentials and durations resulted in little to no change in assay sensitivity. The signal, background, and slope decreased with decreasing pulse duration. The signal, background, and slope decreased with increasing pulse potential. The change in signal, background, and slope with decreasing time diminished with increasing pulse potential. The concurrent changes in signal, background, and slope with the various pulse potentials and durations resulted in little to no change in assay sensitivity.

Also, titration curves were analyzed for each of the pulsed waveforms. Plots of the mean ECL signals vs. BTI concentration were prepared. Error bars based upon 1 stdev were included. The titration curve from the test plate is plotted on the primary y-axis. The titration curve was plotted on the secondary y-axis. The scale for the secondary y-axes was 0-90,000 counts (“cts”) of number of detected photons. The scale for the primary y-axes was set to 90,000 divided by the ratio of the slopes. The ratio of the slope to the slope from each test plate was calculated. FIGS. 15A-15L show the results of these calculations for each pulsed waveform.

For the background, dark, and dark noise; the dark (1 & 2 cts) and dark noise (2 cts) were essentially unchanged for all waveform times tested. Background decreased with decreasing pulse duration. Background decreased with increasing applied pulse potential. The change in background with decreasing time diminished with increasing pulse potential. The background from 1800 mV for 50 ms was 6±2 cts, just above the dark+dark noise.

As shown in FIGS. 15A-15L, the % CVs were comparable for all test plates and a reference signal for all signals (8 replicates) except for background. The CVs for the backgrounds increased as the background signal approached the dark and dark noise. Backgrounds (16 replicates) above 40 cts had good CVs: 55 (3.9%), 64 (5.1%), and 44 (5.4%). Below 40 cts and the CVs increased above 7%. All titrations from background to 2 nM HC were linearly fitted with R₂ values ≥0.999. Decreasing the highest concentration of the fitted range yielded decreasing slopes and increasing y-intercepts. This suggests a non-linearity at the low end of the titration curve (likely caused by the different dilutions in the test samples). The y-intercepts for the other assays were essentially between zero and the measured background. All assays yielded lower signals than linear for 6 and 8 nM HC; these decreased binding capacities were similar for all assays. All assays yielded 4 nM signals within 2 stdevs of the extrapolated 4 nM signal. The assay signals after correction with the ratio of production control lot slope and test plate slope were within 3 stdevs of those from the production control lot for 1 nM to 4 nM HC. Below 1 nM HC the corrected signals were higher than those from the production control lot. Between 0.0125 and 0.5 nM HC, the corrected signals from the test plates were within 3 stdevs of each other. The corrected signal for the assays run, with the same BTI solutions, were within 3 stdevs of each other between 0.0125 nM and 4 nM HC. As shown in the plots, the performance of the assays measured with different pulse potentials and durations was within this variability of the performance of the control assay measured with a ramp.

As may be seen by a comparison of FIGS. 15A-15L and 14A and 14B, the signal and slope decreased with decreasing pulse duration (500 ms, 100 ms, and 50 ms). The signal and slope decreased with increasing pulse potential (1800 mV, 2000 mV, 2200 mV, and 2400 mV). The change in signal and slope with decreasing pulse duration diminished with increasing pulse potential. A correction factor (ratio of slopes) may correct the change in signal with the change in waveform. The calculated detection limits were similar for 11 of these waveforms (0.005 nM to 0.009 nM). The calculated detection limit for 1800 mV, 500 ms pulsed waveform was lower (0.0004 nM); likely due to subtle differences in the fits and measured background (and CV).

### Example 1—ECL Measurement Instrumentation

Referring now to FIGS. 14A-14C in detail, ECL measurements were carried out in 96-well plates specially configured for ECL assay applications by inclusion of integrated screen-printed electrodes. The basic structure of the plates is similar to the plates described in U.S. Pat. No. 7,842,246 (see, for example, the description of Plate B, Plate C, Plate D and Plate E in Example 6.1), although the designs were modified to incorporate novel elements of the present disclosure. As with the earlier designs, the bottom of the wells are defined by a sheet of mylar with screen printed electrodes on the top surface which provide integrated working and counter electrode surfaces in each well (or, in some embodiments of the present invention, the novel working and auxiliary electrodes). A patterned screen-printed dielectric ink layer printed over the working electrodes defines one or more exposed working electrode zones within each well. Conductive through-holes through the mylar to screen-printed electrical contacts on the bottom surface of the mylar sheet provide the electrical contacts needed to connect an external source of electrical energy to the electrodes.

ECL measurements in the specially configured plates were carried out using specialized ECL plate readers designed to accept the plates, contact the electrical contacts on the plates, apply electrical energy to the contacts and image ECL generated in the wells. For some measurements, modified software was employed to allow for customization of the timing and shape of the applied voltage waveforms.

Exemplary plate readers include the MESO SECTOR S 600 (www.mesoscale.com/en/products and services/instrumentation/sector_s_600) and the MESO QUICKPLEX SQ 120 (www.mesoscale.com/en/products and services/instrumentation/quickplex_sq_120), both available from Meso Scale Diagnostics, LLC., and the plate readers described in U.S. Pat. No. 6,977,722, and U.S. Provisional Patent Appl. No. 62/874,828, Titled: “Assay Apparatuses, Methods and Reagents” by Krivoy et al., filed Jul. 16, 2019, each of which is incorporated by reference herein in its entirety. Other exemplary devices are described in U.S. patent application Ser. No. 16/513,526, Titled “Graphical User Interface System” by Wohlstadter et al., filed Jul. 16, 2019 and U.S. patent application Ser. No. 16/929,757, Titled “Assay Apparatuses, Methods, and Reagents” by Krivoy et al., filed Jul. 15, 2020, each of which is incorporated by reference herein in its entirety.

### Example 2—Rapid Pulsed ECL Measurements

A model binding assay was used to demonstrate the use of rapid pulsed voltage waveforms in combination with Ag/AgCl auxiliary electrodes to generate ECL signals, and to compare the performance with that observed with the conventional combination of slow voltage ramps and carbon counter electrodes. The model binding assay was performed in 96-well plates in which each well had an integrated screen printed carbon ink working electrode region supporting an immobilized layer of streptavidin. These screen printed plates had either screen-printed carbon ink counter electrodes (MSD Gold 96-Well Streptavidin Plate, Meso Scale Diagnostics, LLC.) or plates with an analogous electrode design except for the use of screen-printed Ag/AgCl ink auxiliary electrodes. In this model system, the ECL-labeled binding reagent was an IgG antibody that was labeled with both biotin and an ECL label (SULFO-TAG, Meso Scale Diagnostics, LLC.). Varying concentrations of this binding reagent (referred to as “BTI” or “BTI HC” for BTI high control) in 50 μL aliquots were added to wells of the 96-well plates. The binding reagent was incubated in the well with shaking for sufficient time to be depleted from the assay solution by binding the immobilized streptavidin on the working electrode. The plates were washed to remove the assay solution and then filled with an ECL read buffer (MSD Read Buffer T 2×, Meso Scale Diagnostics, LLC.). The standard waveform (a 1000 ms ramp from 3200 mV to 4600 mV) was applied to a plate with counter electrodes. Twelve constant voltage pulsed waveforms were evaluated on plates with Ag/AgCl auxiliary electrodes; 4 different potentials (1800 mV, 2000 mV, 2200 mV, and 2400 mV) at 3 different times or pulse widths (500 ms, 100 ms, and 50 ms). One plate was tested for each waveform. FIGS. 14A, 14B, and 15A-15L are graphs that show the results of ECL analysis from this study.

Assay performance data was determined and calculated for the plates tested with each waveform. The mean, standard deviation, and % CV were calculated for each sample. FIGS. 15A-15L show plots of the mean signal's vs. the concentration of the binding reagent with the signals from the standard waveform plotted on a different y-axis than the signals from the potential pulse. The data points in the lower linear regions of the plots—BTI concentrations ranging from 0 (a blank sample to measure assay background) to 0.1 nM—were fit to a line and the slope, standard error in the slope, Y-intercept, standard error in the Y-intercept, and R² value were calculated. All linear fits had R² values ≥0.999. FIGS. 14A and 14B show the 2 nM mean signal, the 0 nM (assay background) mean signal, and the mean dark signal (empty well) for each tested condition with 1 stdev error bars. Both figures also show the calculated slope for each condition. A detection limit provided in terms of concentration of BTI was calculated based upon the mean Y-intercept+3*standard deviations (“stdev”) of the background and the linear fit of the titration curve. The standard errors in the slope and Y-intercept and the standard deviation of the background were propagated to an error in the detection limit. Based on the volume of BTI per well and the number of ECL labels per BTI molecule (0.071), the detection limits could be represented in terms of the moles of ECL label needed to generate a detectable signal (plotted in FIG. 14E).

FIGS. 14C and 14D shows that the ECL signal from BTI on an electrode generated by a 500 ms pulse waveform at a potential of 1800 mV is comparable to the signal generated by a conventional 1000 ms ramp waveform, in half the time. While FIG. 14C shows that for a specific pulse potential, the ECL decreases as the pulse time decreases below 500 ms, comparison with FIG. 14D shows that there is a corresponding decrease in the assay background signal which remains significantly above the camera signal for dark image of empty wells (i.e., an image in the absence of ECL excitation). This result suggests that very short pulses can be used to substantially decrease the time needed to conduct an ECL measurement, while maintaining overall sensitivity.

The calculated detection limit for with the standard waveform (1000 ms ramp) using carbon counter electrodes was 2.4±2.6 attomoles (10⁻¹⁸ moles) of ECL label. FIG. 14E shows that the estimated detection limits for the different excitation conditions tended to increase with decreasing pulse time, but considerably less than would be expected from a linear relationship. For example, the estimated detection limit for a 100 ms pulse at 2000 mV was less than two times higher than the detection limit for the 1000 ms ramp, but in one tenth of the time. In addition, the increases in detection limit with decreased pulse time were not always statistically significant. The detection limits for the “1800 mV 500 ms”, “2000 mV 500 ms”, “2000 mV 100 ms”, and “2200 mV 500 ms” pulses with the Ag/AgCl auxiliary electrodes were within the error of the detection limit with the standard waveform (1000 ms ramp) using carbon counter electrodes.

FIG. 16 depicts graphs that show the results of ECL analysis on read buffer solution, for example, a read buffer T using a pulsed waveform. In the test, Ag/AgCl Std 96-1 IND plates printed with a 50:50 ink were used. For the test, aliquots of MSD T4× (Y0140365) were diluted with molecular grade water to make T3×, T2×, and T1×. Ag/AgCl Std 96-1 IND plates were filled with 150 μL aliquots of these solutions: T4× in two adjacent rows of the wells 200, for example, as illustrated in FIG. 9B, T3× in two adjacent rows of the wells 200, T2× two adjacent rows of the wells 200, T1× in two adjacent rows of the wells 200. These solutions were allowed to soak covered on the bench for 15 min±0.5 min. One plate was measured with each of the following waveforms: 1800 mV for 100 ms, 1800 mV for 300 ms, 1800 mV for 1000 ms, 1800 mV for 3000 ms. The mean ECL signal and mean integrated current were calculated for the 24 replicates per condition and plots of the means vs. MSD T concentration (4, 3, 2, & 1) were prepared.

As shown in FIG. 16, the ECL signals and integrated current increased with increasing concentration of Read Buffer T. The ECL signals and integrated current increased with increasing pulse duration. Read Buffer ECL signals increased linearly between T1× and T3×, but not between 3× and 4×. Integrated current increased linearly between T1× and T4×.

FIG. 17 depict graphs that show the results of another ECL analysis using a pulsed waveform. In the test, Ag/AgCl Std 96-1 IND plates printed with 50:50 ink were used. The test method described above for FIGS. 14A and 14B was utilized with different, longer, pulsed waveforms. One plate was measured with each of the following waveforms: 1800 mV for 3000 ms, 2200 mV for 3000 ms, 2600 mV for 3000 ms, and 3000 mV for 3000 ms. The mean ECL signal and mean integrated current were calculated for the 24 replicates per condition, and plots of the means vs. Read Buffer T concentration (4, 3, 2, & 1) were prepared.

As shown in FIG. 17, the ECL signals increased with increasing concentration of Read Buffer T for pulse potentials of 1800 mV, 2200 mV, and 2600 mV. With a pulse of 3000 mV, the ECL signal decreased between T1× and T2× followed by increasing ECL through T4×. The integrated currents increased with increasing concentration of T for all pulse potentials. The integrated currents with 2600 mV and 3000 mV pulses were somewhat linear between T1× and T3×; however, with T4× the increase in current was less than linear with concentration of Read Buffer T.

### Example 3—Reductive Capacity of Ag/AgCl Auxiliary Electrodes

Assay plates with integrated screen-printed carbon ink working electrodes and screen-printed Ag/AgCl auxiliary electrodes (as described in Example 2) were used to determine the reductive capacity of the auxiliary electrodes, i.e., the amount of reductive charge that can be passed through the electrode while maintaining a controlled potential. To evaluate the capacity in the context of the requirements for an ECL experiment using pulsed ECL measurements, the total charge passing through the auxiliary electrode in the presence of an ECL read-buffer containing TPA was measured while applying a pulsed voltage waveform between the working and auxiliary electrode. Two types of experiments were conducted. In the first (shown in FIG. 16), a voltage pulse near the optimal potential for ECL generation (1800 mV) was applied and held for different amounts of time (100 to 3000 ms). In the second (FIG. 17), different pulse potentials (2200 to 3000 mV) were held for a constant amount of time (3000 ms). In both experiments, the tolerance for changes in the concentrations or coreactant and electrolyte in the read buffer composition was evaluated by testing each voltage and time condition in the presence of the components of MSD Read Buffer T at between 1× to 4λ of the nominal working concentrations of TPA. Each point in the graphs represents the average of 24 replicate measurements.

The Ag/AgCl auxiliary electrodes will support oxidation of TPA at the working electrode, under the potentials applied in the experiment, until the charge passed through the auxiliary electrode consumes all the accessible oxidizing agent (AgCl) in the auxiliary electrode. FIG. 16 shows that the charge passed through the auxiliary electrode using a 1800 mV pulse increases roughly linearly with pulse duration and TPA concentration, demonstrating that the electrode capacity is sufficient to support pulses as long as 3000 ms at 1800 mV, even in the presence of higher than typical concentrations of TPA. FIG. 17 shows an experiment designed to determine the capacity of the auxiliary electrode by using the longest pulse from FIG. 16 (3000 ms), but increasing the potential until the charge passed through the electrode achieves its maximum value. The data points collected using a 3000 mV potential show that the charge increased linearly with the concentration of ECL read buffer up to about 30 mC of total charge. Near 45 mC the total charge appeared to plateau indicating depletion of the oxidizing agent in the Ag/AgCl auxiliary electrode. A charge of 30 mC equates to 3.1×10−7 moles of oxidizing agent in the Ag/AgCl auxiliary electrodes and a charge of 45 mC equates to 4.7×10−7 moles of oxidizing agent in the Ag/AgCl auxiliary electrodes.

Reductive capacity tests were also performed to determine differences in reductive capacity according to spot pattern and auxiliary electrode size. Four different spot patterns were tested using a 2600 mV 4000 ms reductive capacity waveform and a standardized testing solution. Four spot patterns were tested, a 10 spot penta pattern (FIG. 5A), a 10 spot open pattern (FIG. 1C), a 10 spot closed pattern (FIG. 7A), and a 10 spot open trilobe pattern (FIG. 4A). The results are reproduced in Tables A, B, C, and D, below, respectively for the penta, open, closed, and open trilobe patterns. As shown in in Tables A-C, increasing the auxiliary electrode (labeled CE) area in three different patterns increases the total measured charge (e.g., reductive capacity). As shown in Table D, multiple tests with the same auxiliary electrode area results in approximately similar measured charge. Accordingly, maximizing the auxiliary electrode area may serve to increase total reductive capacity of Ag/AgCl electrodes in multiple different spot patterns.

TABLE A

| | | | Ave Intg | | Ave | | |
|---|---|---|---|---|---|---|---|
| | | CE area | Crnt | StDev | Charge | StDev | Charge/Area (mC/sq |
| Group | CE Dia (in) | (in\hat{ }2) | (μA) | (μA) | (mC) | (mC) | in) |
| 1 | 0.03 | 0.00071 | 441,300 | 13,884 | 22.07 | 0.69 | 31223 |
| 2 | 0.027 | 0.00057 | 439,748 | 22,396 | 21.99 | 1.12 | 38407 |
| 3 | 0.024 | 0.00045 | 365,348 | 4,821 | 18.27 | 0.24 | 40386 |
| 4 | 0.021 | 0.00035 | 249,364 | 5,149 | 12.47 | 0.26 | 36003 |
| 5 | 0.018 | 0.00025 | 239,138 | 8,350 | 11.96 | 0.42 | 47000 |
| 6 | 0.015 | 0.00018 | 174,889 | 7,960 | 8.74 | 0.4 | 49458 |

TABLE B

| | | | Ave Intg | | Ave | | |
|---|---|---|---|---|---|---|---|
| | | CE area | Crnt | StDev | Charge | StDev | |
| Group | CE Dia (in) | (in\hat{ }2) | (μA) | (μA) | (mC) | (mC) | Charge/Area (mC/sq in) |
| 1 | 0.048 | 0.00181 | 324,380 | 23,129 | 16.22 | 1.16 | 8964 |
| 2 | 0.044 | 0.00152 | 258,775 | 15,557 | 12.94 | 0.78 | 8510 |
| 3 | 0.04 | 0.00126 | 208,423 | 10,267 | 10.42 | 0.51 | 8292 |
| 4 | 0.036 | 0.00102 | 193,015 | 8,392 | 9.65 | 0.42 | 9481 |
| 5 | 0.032 | 0.00080 | 137,755 | 4,717 | 6.89 | 0.24 | 8567 |
| 6 | 0.028 | 0.00062 | 104,355 | 2,461 | 5.22 | 0.12 | 8477 |

TABLE C

| | | | Ave Intg | | Ave | | |
|---|---|---|---|---|---|---|---|
| | | CE area | Crnt | StDev | Charge | StDev | |
| Group | CE Dia (in) | (in\hat{ }2) | (μA) | (μA) | (mC) | (mC) | Charge/Area (mC/sq in) |
| 1 | 0.048 | 0.00181 | 754,555 | 43,877 | 37.73 | 2.19 | 20850 |
| 2 | 0.044 | 0.00152 | 670,500 | 27,385 | 33.53 | 1.37 | 22052 |
| 3 | 0.04 | 0.00126 | 588,035 | 26,996 | 29.4 | 1.35 | 23396 |
| 4 | 0.036 | 0.00102 | 457,428 | 27,944 | 22.87 | 1.4 | 22468 |
| 5 | 0.032 | 0.00080 | 393,368 | 10,887 | 19.67 | 0.54 | 24458 |
| 6 | 0.028 | 0.00062 | 306,840 | 14,759 | 15.34 | 0.74 | 24913 |

TABLE D

| | | | Ave Intg | | Ave | | |
|---|---|---|---|---|---|---|---|
| | | CE area | Crnt | StDev | Charge | StDev | |
| Group | CE Dia (in) | (in\hat{ }2) | (μA) | (μA) | (mC) | (mC) | Charge/Area (mC/sq in) |
| 1 | 0.048 | 0.00181 | 226,413 | 14,022 | 11.32 | 0.7 | 6256 |
| 2 | 0.048 | 0.00181 | 226,235 | 18,827 | 11.31 | 0.94 | 6250 |
| 3 | 0.048 | 0.00181 | 220,868 | 17,292 | 11.04 | 0.86 | 6101 |
| 4 | 0.048 | 0.00181 | 229,960 | 9,879 | 11.5 | 0.49 | 6355 |
| 5 | 0.048 | 0.00181 | 225,635 | 15,199 | 11.28 | 0.76 | 6234 |
| 6 | 0.048 | 0.00181 | 224,308 | 6,190 | 11.22 | 0.31 | 6200 |

Further, experiments were conducted to determine an amount of AgCl accessible to a redox reaction under various experimental conditions. In an experiment, electrodes printed with Ag/AgCl ink films at approximately 10 microns thickness were used. Different portions of the electrodes ranging from 0% to 100% were exposed to solution and an amount of charge passed was measured. Experimental results show that an amount of charge passed increases approximately linearly with increasing percentage of the electrodes being in contact with a solution. This indicates that reduction occurs less strongly or not at all in electrode portions that are not in direct contact with the test solution. Further, the total amount of charge passed (2.03E+18 e−) by the experimental electrodes corresponds approximately to a total amount of electrons available in the experimental electrodes, based on the total volume of Ag/AgCl in the printed electrodes. This indicates that, at 10 microns thickness and 100% solution contact, all or nearly all of the available AgCl may be accessible in the redox reaction. Accordingly, for films at 10 microns thickness or less, all or nearly all available AgCl may be accessed during a reduction reaction.

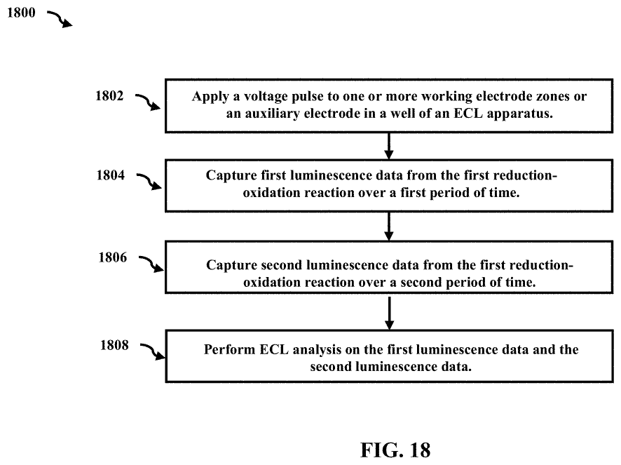

In embodiments, a pulsed waveform supplied by a voltage/current source 904 may be designed to allow the ECL apparatus to capture different luminescence data over time to improve the ECL analysis. FIG. 18 depicts a flow chart showing another process 1800 for operating an ECL apparatus using pulsed waveforms, in accordance with an embodiment hereof.

In an operation 1802, the process 1800 includes applying a voltage pulse to one or more working electrode zones 104 or an auxiliary electrode 102 in a well of an ECL apparatus, the voltage pulse causing a reduction-oxidation reaction to occur in the well. For example, the computer system 906 may control the voltage/current source 904 to supply one or more voltage pulses to one or more working electrode zones 104 or the auxiliary electrode 102.

In embodiments, the voltage pulse may be configured to cause a reduction-oxidation reaction between the one or more working electrode zones 104 and the one or more auxiliary electrodes 102. As discussed above, based on a predefined chemical composition (e.g., mixture of Ag:AgCl) of the one or more auxiliary electrodes 102, the one or more auxiliary electrodes 102 may operate as reference electrodes for determining the potential difference with the one or more working electrode zones 104 and as counter electrodes for the working electrode zones 104. For example, the predefined chemical mixture (e.g., the ratios of elements and alloys in the chemical composition) may provide a interfacial potential during a reduction of the chemical mixture, such that a quantifiable amount of charge is generated throughout the reduction-oxidation reactions occurring in the well 200. That is, the amount of charge passed during a redox reaction is quantifiable by measuring the current, for example, at the working electrode zones 104. In some embodiments, the one or more auxiliary electrode 102 may dictate the total amount of charge that may be passed at the applied potential difference because, when the AgCl has been consumed, the interfacial potential at the auxiliary electrode 102 will shift more negative to the potential of water reduction. This causes the working electrode zone 104 potential to shift to a lower potential (maintaining the applied potential difference) turning off the oxidation reactions that occurred during the AgCl reduction.

In embodiments, the pulsed waveform may include various waveform types, such as direct current, alternating current, DC emulating AC, etc., although other waveforms of varying period, frequency, and amplitude are contemplated as well (e.g., negative ramp sawtooth waveforms, square waveforms, rectangular waveforms, etc. FIGS. 12A and 12B discussed above illustrate two examples of pulsed waveforms. The pulsed waveform may be a square wave having a voltage, V, for a time, T. Examples of voltage pulses are also described in reference to FIGS. 14A, 14B, 15A-15L, 16 and 17, e.g., 1800 mV at 500 ms, 2000 mV at 500 ms, 2200 mV at 500 ms, 2400 mV at 500 ms, 1800 mV at 100 ms, 2000 mV at 100 ms, 2200 mV at 100 ms, 2400 mV at 100 ms, 1800 mV at 50 ms, 2000 mV at 50 ms, 2200 mV at 50 ms, 2400 mV at 50 ms, etc. These waveforms may include various duty cycles as well, e.g., 10%, 20%, 50%, 65%, 90%, or any other percentage between 0 and 100.

In an operation 1804, the process 1800 includes capturing first luminescence data from the first reduction-oxidation reaction over a first period of time. In an operation 1806, the process 1800 includes capturing second luminescence data from the second reduction-oxidation reaction over a second period of time, wherein the first period time is not of equal duration to the second period of time. For example, the one or more photo-detectors 910 may capture first and second luminescence data emitted from the wells 200 and communicate the first and second luminescence data to the computer system 906. For example, in an embodiment, the wells 200 may include substances of interest that require different time periods for the photo-detectors 912 to capture the luminescence data. Thus, the photo-detectors 912 may capture the ECL data over two different periods of time. For instance, one of the time periods may be a short time period (e.g., short camera exposure time of the light generated from ECL), and one of the time periods may be a longer time period. These periods of time could be affected by, for example, light saturation throughout ECL generation. From there, depending on the captured photons, the assay apparatus 900 may either use the long exposure, the short exposure, or a combination of the two. In some embodiments, the assay apparatus 900 may use the long exposure, or the sum of the long and short. In some embodiments, if the captured photons are above a dynamic range of the photo-detectors 912, the assay apparatus 900 may use the short exposure. By adjusting/optimizing these the dynamic range may be potentially increased by an order of magnitude or two. In certain embodiments, the dynamic range could be improved but implementing various multi-pulse and/or multi-exposure schemes. For example, a short exposure could be taken followed by a longer exposure (e.g., exposure of a single working electrode, single working electrode zone, two or more single working electrodes or working electrode zones (either within a single well or across multiple wells), exposure of a single well, of two or more wells, or a sector, or two or more sectors, etc.). In these examples, it may be beneficial to use the longer exposure unless the exposure has become saturated. In that case, for example, the shorter exposure could be utilized. By making these adjustments (either manually or through the aid of hardware, firmware, software, an algorithm, computer readable medium, a computing device, etc.), the dynamic range can be improved. In other examples, a first, short pulse (e.g., 50 ms, although other durations are contemplated as well) can be applied to an electrode or collection of two or more electrodes followed by a second, longer pulse (e.g., 200 ms, although other durations are contemplated as well) for each electrode or collection of electrodes. Other approaches could include reading an entire plate (e.g., 96 wells) using one or more first, short pulses (e.g., 50 ms, although other durations are contemplated as well) followed by reading the entire plate a second time with a second, longer pulse (e.g., 200 ms, although other durations are contemplated as well). In other examples, a long pulse can be applied first, followed by a short pulse; multiple short- and/or long pulses can be applied and/or alternated, etc. In addition to one or more discrete pulses, composite or hybrid functions could be employing using these, or other, durations to, for example, determine and/or model responses in transition regions (e.g., while transitioning between pulses). Moreover, in the above examples, the longer pulse can be use first before a shorter pulse. Moreover, waveforms and/or capture windows can be adjusted to improve the dynamic range as well.

Moreover, if additional information is known about the one or more individual working electrodes and/or working electrode zones (e.g., a particular working electrode zone is known to contain a high abundance analyte), exposure times can be optimized to prevent camera saturation by utilizing this information before taking a reading and/or sample. Using the high abundance analyte example above, because the signals would be expected to be high in dynamic range, a shorter exposure time can be employed (and vice versa for electrodes for which a low signal is expected), thus exposure times, pulse durations, and/or pulse intensity can be customized and/or optimized for individual wells, electrodes, etc. to improve overall read times. Moreover, pixels from one or more ROIs could be continuously sampled to obtain an ECL curve over time, which can be further employed to determine a manner in which to truncate exposure time and extrapolate an ECL generation curve above saturation. In other examples, first, the camera can be set to take a short exposure, after which the intensity of the signal from the short exposure can be examined. This information can be subsequently used to adjust the binning for the final exposure. In other examples, rather than adjusting the binning, other parameters can be adjusted as well, such as, for example, waveforms, capture windows, other current based techniques, etc.

Additional techniques could be employed as well for which the waveform and/or exposure remain constant. For example, the intensity of pixels within one or more ROIs could be measured, and if pixel saturation is observed, other aspects of ECL generation and/or measuring can be utilized to optimize reading and/or read times (e.g., current-ECL correlation, dark mask schemes that obverse dark mask regions around the ROI, which can be used to update the estimated ECL for the saturated electrode and/or portion of an electrode, etc.). These solutions obviate the need for fast analysis and/or reaction times to adjust waveforms and/or durations of exposure over relatively short periods of time (e.g., milliseconds). This is, for example, because ECL generation and/or captures can be performed the same and/or a similar way and analysis can be performed at the end.

Other techniques could be employed to improve dynamic range as well. For example, if applied to an electrochemiluminescence (ECL) application, because ECL labels fluoresce, a pre-flash and/or pre-exposure could be performed to obtain information related to how much label is present in one or more wells, working electrodes, working electrode zones, etc. The information obtained from the pre-flash and/or pre-exposure can be used to optimize the exposure and/or pulse durations to realize additional improvements in dynamic range and/or read times. In other embodiments, in particular as it relates to ECL, because a correlation can exist between current and one or more of the electrodes and the ECL signal, the signature of the signal could inform camera exposure times and/or the applied waveforms (e.g., stop the waveform, decrease the waveform, increase the waveform, etc.). This can be further optimized by improving the precision and update rate of current measurements and optimization of current paths to provide better correlation between current and ECL signal.

Additional improvements in dynamic range can be realized for certain imaging devices according to certain embodiments. Using CMOS-based imaging device in an ECL application, for example, particular regions of interest (ROIs) could be sampled and read out at different points in time within one or more exposures to optimize exposure times. For example, a ROI (e.g., a part of or the entire working electrode and/or a working electrode zone) could comprise a fixed or variable number of pixels or a certain sample percentage of the electrodes area (e.g., 1%, 5%, 10%, etc., although other percentages are contemplated as well). In this example, the pixels and/or sample percentage could be read out early during the exposure. Depending on the signals read from the ROIs, exposure times could be adjusted and/or optimized for particular working electrodes, working electrode zones, wells, etc. In a non-limiting illustrative example, a subset of pixels can be sampled over a sample period of time. If the signal from that subset is trending high, the exposure time can be reduced (e.g., from 3 seconds to 1 seconds, although other durations greater or less than these are contemplated as well). Similarly, if the signal is trending low, longer exposure times can be employed (e.g., 3 seconds, although other durations are contemplated as well). These adjustments can be made either manually or through the aid of hardware, firmware, software, an algorithm, computer readable medium, a computing device, etc. In other embodiments, ROIs could be selected to be distributed in a manner so as to avoid any potential ring effects. This can occur, for example, due to non-uniformity of light around the working electrode zone (e.g., brighter ring will form on the outer perimeter of the working electrode zone, with a darker spot in the center. To combat this, ROIs can be selected that sample both the brighter and darker areas (e.g., a row of pixels from edge to edge, random sampling of pixels from both areas, etc.) Moreover, pixels could be continuously sampled for one or more working electrode zones to determine an ECL generation curve over time. This sampled data can then be used to extrapolate ECL generation curves for points above saturation.

In embodiments, different pulsed waveforms may also be used for the first and the second periods of time. In embodiments, the pulsed waveforms may differ in amplitude (e.g., voltage), duration (e.g., time period), and/or waveform type (e.g., square, sawtooth, etc.) Using different pulsed waveform may be beneficial if multiple types of electro-active species are used as ECL labels which may require different activation potentials and may emit light at different wavelengths. For example, such ECL labels may be complexes based on ruthenium, osmium, hassium, iridium, etc.

In an operation 1808, the process 1800 includes performing ECL analysis on the first luminescence data and the second luminescence data. For example, the computer systems 906 may perform the ECL analysis on the luminescence data. These values may correlate with quantitative measurements (e.g., ECL intensity) to provide an analog signal. In other embodiments, a digital signal (yes or no signal) may be obtained from each working electrode zone 104 to indicate that an analyte is either present or not present. Statistical analysis may be used for both techniques and may be used for translating a plurality of digital signals so as to provide a quantitative result. Some analytes may require a digital present/not present signal indicative of a threshold concentration. Analog and/or digital formats may be utilized separately or in combination. Other statistical methods may be utilized, for example, technique to determine concentrations through statistical analysis of binding over the concentration gradient. Multiple linear arrays of data with concentration gradients may be produced with a multiplicity of different specific binding reagents being used in different wells 200 and/or with different working electrode zones 104. The concentration gradients may consist of discrete binding domains presenting different concentrations of the binding reagents.

In embodiments, control assay solutions or reagents, e.g., read buffers, may be utilized on the working electrode zones of the wells 200. The control assay solutions or reagents may provide uniformity to each analysis to control for signal variation (e.g., variations due to degradations, fluctuations, aging of the multi-well plate 208, thermal shifts, noise in electronic circuitry and noise in the photodetection device, etc.) For example, multiple redundant working electrode zones 104 (containing identical binding reagents or different binding reagents that are specific for the same analyte) for the same analyte may be utilized. In another example, analytes of known concentration may be utilized or control assay solutions or reagents may be covalently linked to a known quantity of an ECL label or a known quantity of ECL label in solution is used.

In embodiments, the data collected and produced in the process 1800 may be utilized in a variety of applications. The data collected and produced may be stored, e.g., in the form of a database consisting of a collection of clinical or research information. The data collected and produced may also be used for rapid forensic or personal identification. For example, the use of a plurality of nucleic acid probes when exposed to a human DNA sample may be used for a signature DNA fingerprint that may readily be used to identify clinical or research samples. The data collected and produced may be used to identify the presence of conditions (e.g., diseases, radiation level, etc.), organisms (e.g., bacteria, viruses, etc.), and the like.

In embodiments, while the above process 1800 includes capturing luminescence data during two time periods, the process 1800 may be utilized to capture luminescence data during any number of time periods, e.g., 3 time period, 4 time period, 5 period, etc. In this embodiment, different pulsed waveforms may also be used for some of the time periods or all of the time periods. In embodiments, the pulsed waveforms may differ in amplitude (e.g., voltage), duration (e.g., time period), and/or waveform type (e.g., square, sawtooth, etc.)

The above describes an illustrative flow of an example process 1800. The process as illustrated in FIG. 18 is exemplary only, and variations exist without departing from the scope of the embodiments disclosed herein. The steps may be performed in a different order than that described, additional steps may be performed, and/or fewer steps may be performed.

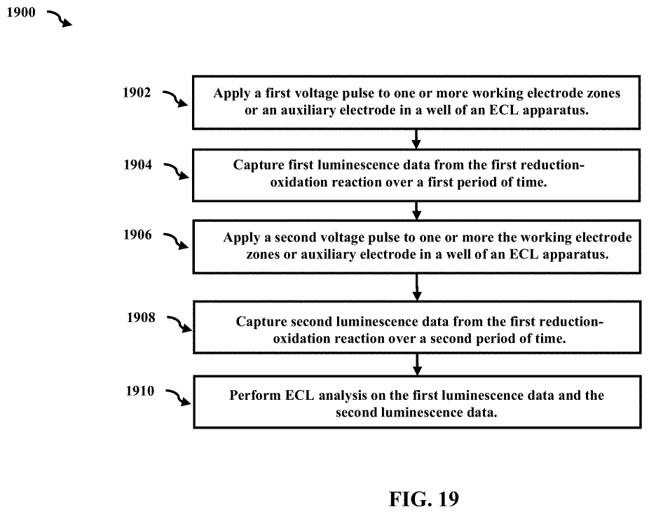

In embodiments, different configurations of pulsed waveforms supplied by a voltage/current source 904 may be utilized together to improve the ECL emitted during ECL analysis. FIG. 19 depicts a flow chart showing another process 1900 for operating an ECL apparatus using pulsed waveforms, in accordance with an embodiment hereof.

In an operation 1902, the process 1900 includes applying a first voltage pulse to one or more working electrode zones 104 or an auxiliary electrode 102 in a well of an ECL apparatus, the first voltage pulse causing a first reduction-oxidation reaction to occur in the well. In an operation 1904, the process 1900 includes capturing first luminescence data from the first reduction-oxidation reaction over a first period of time.

In an operation 1906, the process 1900 includes applying a second voltage pulse to the one or more working electrode zones or the auxiliary electrode in the well, the second voltage pulse causing a second reduction-oxidation reaction to occur in the well. In an operation 1908, the process 1900 includes capturing second luminescence data from the second reduction-oxidation reaction over a second period of time, wherein the first period time is not of equal duration to the second period of time.

In an embodiment, the voltage level (amplitude or magnitude) or pulse width (or duration) for the first voltage pulse and/or the second voltage pulse may be selected to cause a first reduction-oxidation reaction to occur, wherein the first luminescence data corresponds to the first reduction-oxidation reaction that occurs. In an embodiment, the voltage level (amplitude or magnitude) or pulse width (or duration) may be selected for the first voltage pulse and/or the second voltage pulse to cause the second reduction-oxidation reaction to occur, wherein the second luminescence data correspond to the second reduction-oxidation reaction that occurs. In an embodiment, a magnitude of at least one of the first voltage pulse and second voltage pulse may be selected based at least in part on a chemical composition of the counter electrode.

In an operation 1910, the process 1900 includes performing ECL analysis on the first luminescence data and the second luminescence data. For example, the computer systems 906 may perform the ECL analysis on the luminescence data. In some embodiments, luminescence data, e.g., signals, arising from a given target entity on a binding surface of the working electrode zones 104 and/or auxiliary electrode 102, e.g., binding domain, may have a range of values. These values may correlate with quantitative measurements (e.g., ECL intensity) to provide an analog signal. In other embodiments, a digital signal (yes or no signal) may be obtained from each working electrode zone 104 to indicate that an analyte is either present or not present. Statistical analysis may be used for both techniques and may be used for translating a plurality of digital signals so as to provide a quantitative result. Some analytes may require a digital present/not present signal indicative of a threshold concentration. Analog and/or digital formats may be utilized separately or in combination. Other statistical methods may be utilized, for example, technique to determine concentrations through statistical analysis of binding over the concentration gradient. Multiple linear arrays of data with concentration gradients may be produced with a multiplicity of different specific binding reagents being used in different wells 200 and/or with different working electrode zones 104. The concentration gradients may consist of discrete binding domains presenting different concentrations of the binding reagents.

In embodiments, control assay solutions or reagents, e.g., read buffers, may be utilized on the working electrode zones of the wells 200. The control assay solutions or reagents may provide uniformity to each analysis to control for signal variation (e.g., variations due to degradations, fluctuations, aging of the multi-well plate 208, thermal shifts, noise in electronic circuitry and noise in the photodetection device, etc.) For example, multiple redundant working electrode zones 104 (containing identical binding reagents or different binding reagents that are specific for the same analyte) for the same analyte may be utilized. In another example, analytes of known concentration may be utilized or control assay solutions or reagents may be covalently linked to a known quantity of an ECL label or a known quantity of ECL label in solution is used.

In embodiments, the data collected and produced in the process 1900 may be utilized in a variety of applications. The data collected and produced may be stored, e.g., in the form of a database consisting of a collection of clinical or research information. The data collected and produced may also be used for rapid forensic or personal identification. For example, the use of a plurality of nucleic acid probes when exposed to a human DNA sample may be used for a signature DNA fingerprint that may readily be used to identify clinical or research samples. The data collected and produced may be used to identify the presence of conditions (e.g., diseases, radiation level, etc.), organisms (e.g., bacteria, viruses, etc.), and the like.

The above describes an illustrative flow of an example process 1900. The process as illustrated in FIG. 19 is exemplary only, and variations exist without departing from the scope of the embodiments disclosed herein. The steps may be performed in a different order than that described, additional steps may be performed, and/or fewer steps may be performed.

In any of the processes 1300, 1800, and 1900 described above, the voltage pulses may be selective applied to the one or more working electrode zones 104 and/or one or more auxiliary electrodes 102. For example, the voltage pulses may be supplied to all the working electrode zones 104 and/or the auxiliary electrodes 102 in one or more wells 106 of the multi-well plate 108. Likewise, for example, the voltage pulses may be supplied to selected (or “addressable”) sets of the working electrode zones 104 and/or the auxiliary electrodes 102 in one or more wells 106 of the multi-well plate 208 (e.g., on a zone-by-zone basis, well-by-well basis, sector-by-sector basis (e.g., groups of two or more wells), etc.)

The systems, devices, and methods described herein may be applied in various contexts. For example, the systems, devices, and methods may be applied to improve various aspects of ECL measurement and reader devices. Exemplary plate readers include those discussed above and throughout this application, e.g., at paragraph [0174].

For instance, by applying one or more voltage pulses to generate ECL as described herein, read time and/or exposure time may be improved by more quickly and efficiently generating, collecting, observing, and analyzing ECL data. Further, the improved exposed times (e.g., single exposure, dual (or greater) exposures utilizing disparate exposure times (or equal exposure times)) will help improve ECL generation, collecting, observing, and its analysis by improving, for example, the dynamic range extension (DRE), binning, etc., for example, in an embodiment, substances of interest that require different time periods for capturing the luminescence data. Thus, emitted photons may be captured as the ECL data over multiple different periods of time, which could be affected by, for example, light saturation levels throughout ECL generation. The dynamic range could be improved but implementing various multi-pulse and/or multi-exposure schemes. For example, a short exposure could be taken followed by a longer exposure (e.g., exposure of a single working electrode, single working electrode zone, two or more single working electrodes or working electrode zones (either within a single well or across multiple wells), exposure of a single well, of two or more wells, or a sector, or two or more sectors, etc.). In these examples, it may be beneficial to use the longer exposure unless the exposure has become saturated. For example, when taking a short and long exposure, if saturation occurs during the longer exposure, that exposure can be discarded and the shorter exposure can be used. If neither saturates, the longer can be used, which can provide better sensitivity. In that case, for example, the shorter exposure could be utilized. By making these adjustments (either manually or through the aid of hardware, firmware, software, an algorithm, computer readable medium, a computing device, etc.), the dynamic range can be improved, as discussed above in greater detail.

Further, the systems, devices, and methods described herein may be leveraged in various manners to allow for the optimization of software, firmware, and/or control logic to the hardware instruments, such as the readers described above. For example, because the systems, devices, and methods described herein allow for the faster and more efficient generation, collection, observation, and/or analysis of ECL, instruments may be optimized through improved software, firmware, and/or control logic to lower the cost of hardware required to perform ECL analysis (e.g., cheaper lens, fewer and/or cheaper motors to drive the instruments, etc.) The examples provided herein are merely exemplary and additional improvements to these instruments are contemplated as well.

In embodiments as described above, the wells 200 of the multi-well plate 208 may include one or more fluids (e.g., reagents) for conducting ECL analysis. For example, the fluids may include ECL coreactants (e.g., TPA), read buffers, preservatives, additives, excipients, carbohydrates, proteins, detergents, polymers, salts, biomolecules, inorganic compounds, lipids, and the like. In some embodiments, the chemical properties of the fluids in the well 200 during ECL processes may alter the electrochemistry/ECL generation. For example, a relationship between ionic concentration of fluid and electrochemistry/ECL generation may be dependent on different liquid types, read buffers, etc. In embodiments, the one or more auxiliary electrodes may provide a constant interfacial potential regardless of the current being passed, as described above. That is, a plot of the current vs. potential would yield infinite current at a fixed potential.

In some embodiments, the fluids utilized (e.g., in the wells 200 of the multi-well plate 208) may include ionic compounds such as NaCl (e.g., salts). In some embodiments, for example, higher NaCl concentrations in the fluids contained in the wells 200 may improve control ECL generation throughout ECL processes. For example, current vs. potential plots of the auxiliary electrode 102 having a redox couple such as Ag/AgCl have defined slopes. In some embodiments, the slope is dependent upon the salt composition and concertation in the fluid contained in the wells 200. As the Ag+ is reduced, the charge balance within the redox couple of the auxiliary electrode 102 may need to be balanced, requiring ions from the fluid to diffuse to the electrode surface. In some embodiments, the composition of the salts may alter the slope of the current vs. potential curve which then impacts the reference potential at an interface of the auxiliary electrode 102, for example, containing Ag/AgCl for the current being passed. As such, in embodiments, the concentration of ions, such as salts, may be modified and controlled in order to maximize a current generated for an applied voltage.

In embodiments, a volume of the fluids in the well 200 during ECL processes may alter the electrochemistry/ECL generation. In some embodiments, relationship between a volume of the fluids in the well 200 may be dependent on the design of the electrochemical cell 100. For example, a working electrode zones 104 and an auxiliary electrode 102, which are separated by a relatively thick fluid layer, may have a more ideal electrochemical behavior, e.g., spatially consistent interfacial potentials). Conversely, a working electrode zones 104 and an auxiliary electrode 102, which are separated by a relatively thin fluid layer covering both, may have non-ideal electrochemical behavior due to spatial gradients in the interfacial potentials across both electrodes. In some embodiments, the design and the layout of the one or more working electrode zones 104 and the one or more auxiliary electrodes 102 may be to maximize a spatial distance between a working electrode zones 104 and an auxiliary electrode 102. For example, as illustrated in FIG. 3A, the working electrode zones 104 and the auxiliary electrode 102 may be positioned to maximize the spatial distance, D₁. The spatial distance may be maximized by reducing the number of working electrode zones 104, reducing an exposed surface area of the working electrode zones 104, reducing an exposed surface area of the auxiliary electrode 102, etc. While not discussed, the spatial distance maximization of the spatial distance may be applied to the designs illustrated in FIGS. 3A-3F, 4A-4F, 5A-5C, 6A-6F, 7A-7F, and 8A-8D.

In embodiments, the multi-well plate 208 described above may form part of one or more kits for use in conducting assays, such as ECL assays, on the assay apparatus. A kit may include an assay module, e.g., the multi-well plate 208, and at least one assay component selected from the group consisting of binding reagents, enzymes, enzyme substrates and other reagents useful in carrying out an assay. Examples include, but are not limited to, whole cells, cell surface antigens, subcellular particles (e.g., organelles or membrane fragments), viruses, prions, dust mites or fragments thereof, viroids, antibodies, antigens, haptens, fatty acids, nucleic acids (and synthetic analogs), proteins (and synthetic analogs), lipoproteins, polysaccharides, lipopolysaccharides, glycoproteins, peptides, polypeptides, enzymes (e.g., phosphorylases, phosphatases, esterases, trans-glutaminases, transferases, oxidases, reductases, dehydrogenases, glycosidases, protein processing enzymes (e.g., proteases, kinases, protein phophatases, ubiquitin-protein ligases, etc.), nucleic acid processing enzymes (e.g., polymerases, nucleases, integrases, ligases, helicases, telomerases, etc.)), enzyme substrates (e.g., substrates of the enzymes listed above), second messengers, cellular metabolites, hormones, pharmacological agents, tranquilizers, barbiturates, alkaloids, steroids, vitamins, amino acids, sugars, lectins, recombinant or derived proteins, biotin, avidin, streptavidin, luminescent labels (preferably electrochemiluminescent labels), electrochemiluminescence coreactants, pH buffers, blocking agents, preservatives, stabilizing agents, detergents, dessimayts, hygroscopic agents, read buffers, etc. Such assay reagents may be unlabeled or labeled (preferably with a luminescent label, most preferably with an electrochemiluminescent label). In some embodiments, the kit may include an ECL assay module, e.g., the multi-well plate 208, and at least one assay component selected from the group consisting of: (a) at least one luminescent label (preferably electrochemiluminescent label); (b) at least one electrochemiluminescence coreactant); (c) one or more binding reagents; (d) a pH buffer; (e) one or more blocking reagents; (f) preservatives; (g) stabilizing agents; (h) enzymes; (i) detergents; (j) desicmayts and (k) hygroscopic agents.

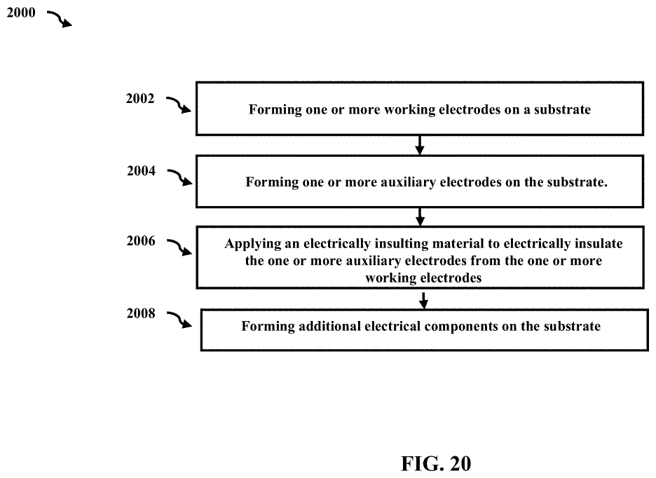

FIG. 20 depicts a flow chart showing a process 2000 for manufacturing wells including working and auxiliary electrodes, in accordance with an embodiment hereof. For example, the process 2000 may be utilized to manufacture one or more of the wells 200 of the multi-well plate 208 that includes one or more working electrode zones 104 and one or more auxiliary electrodes 102.

In an operation 2002, the process 2000 includes forming one or more working electrode zones 104 on a substrate. In embodiments, the one or more working electrodes may be formed using any type of manufacturing process, e.g., screen-printing, three dimensional (3D) printing, deposition, lithography, etching, and combinations thereof. In embodiments, the one or more working electrode zones 104 may be formed as multi-layered structures that may be deposed and patterned.

In embodiments, the one or more working electrodes may be a continuous/contiguous area for which a reaction may occur, and an electrode “zone,” may be a portion (or the whole) of the electrode for which a particular reaction of interest occurs. In certain embodiments, a working electrode zone may comprise an entire working electrode, and in other embodiments, more than one working electrode zone may be formed within and/or on a single working electrode. For example, the working electrode zones may be formed by individual working electrodes. In this example, the working electrode zones may be configured as a single working electrode formed of one or more conducting materials. In another example, the working electrode may be formed by isolating portions of a single working electrode. In this example, a single working electrode may be formed of one or more conducting materials, and the working electrode zones may be formed by electrically isolating areas (“zones”) of the single working electrode using insulating materials such as a dielectric. In any embodiment, the working electrode may be formed of any type of conducting materials such as metals, metal alloys, carbon compounds, etc. and combinations of conducting and insulating materials.

In an operation 2004, the process 2000 includes forming one or more auxiliary electrodes 102 on the substrate. In embodiments, the one or more auxiliary electrodes may be formed using any type of manufacturing process, e.g., screen-printing, three dimensional (3D) printing, deposition, lithography, etching, and combinations thereof. In embodiments, the auxiliary electrodes 102 may be formed as multi-layered structures that may be deposed and patterned. In embodiments, the one or more auxiliary electrodes may be formed of a chemical mixture that provides a interfacial potential during a reduction of the chemical mixture, such that a quantifiable amount of charge is generated throughout the reduction-oxidation reactions occurring in the well. The one or more auxiliary electrodes includes an oxidizing agent that supports reduction-oxidation reaction, which may be used during biological, chemical, and/or biochemical assays and/or analysis, such as, for example, ECL generation and analysis. In an embodiment, an amount of an oxidizing agent in a chemical mixture of the one or more auxiliary electrodes is greater than or equal to an amount of oxidizing agent required for an entirety of a reduction-oxidation reaction (“redox”) that is to occur in at least one well during one or more biological, chemical, and/or biochemical assays and/or analysis, such as ECL generation. In this regard, a sufficient amount of the chemical mixture in the one or more auxiliary electrodes will still remain after a redox reaction occurs for an initial biological, chemical, and/or biochemical assays and/or analysis, thus allowing one or more additional redox reactions to occur throughout subsequent biological, chemical, and/or biochemical assays and/or analysis. In another embodiment, an amount of an oxidizing agent in a chemical mixture of one or more auxiliary electrodes is at least based in part on a ratio of an exposed surface area of each of the plurality of working electrode zones to an exposed surface area of the auxiliary electrode.

For example, the one or more auxiliary electrodes may be formed of a chemical mixture that includes a mixture of silver (Ag) and silver chloride (AgCl), or other suitable metal/metal halide couples. Other examples of chemical mixtures may include metal oxides with multiple metal oxidation states, e.g., manganese oxide, or other metal/metal oxide couples, e.g., silver/silver oxide, nickel/nickel oxide, zinc/zinc oxide, gold/gold oxide, copper/copper oxide, platinum/platinum oxide, etc.)

In an operation 2006, the process includes forming an electrically insulating material to electrically insulate the one or more auxiliary electrodes form the one or more working electrodes. In embodiments, the electrically insulating material may be formed using any type of manufacturing process, e.g., screen-printing, 3D printing, deposition, lithography, etching, and combinations thereof. The electrically insulating materials may include dielectrics.

In an operation 2008, the process 2000 includes forming additional electrical components on the substrate. In embodiments, the one or more auxiliary electrodes may be formed using any type of manufacturing process, e.g., screen-printing, 3D printing, deposition, lithography, etching, and combinations thereof. The additional electrical components may include through holes, electrical traces, electrical contacts, etc. For example, the through holes are formed within the layers or materials forming the working electrode zones 104, the auxiliary electrodes 102, and the electrically insulating materials so that electrical contact may be made with the working electrode zones 104 and the auxiliary electrodes 102 without creating a short with other electrical components. For instance, one or more additional insulating layers may be formed on the substrate in order to support electrical traces that are coupled through while isolating the electrical traces.

In embodiments, the additional electrical components may include an electrical heater, a temperature controller, and/or a temperature sensor. The electrical heater, temperature controller, and/or temperature sensor may assist in the electrochemical reaction, e.g., ECL reaction, and electrode performance may be temperature dependent. For example, a screen-printed resistance heater may be integrated into the electrode design. The resistance heater may be powered and controlled by temperature controller, and/or temperature sensor, whether integrated or external. These are self-regulating and formulated to generate a certain temperature when a constant voltage is applied. The inks may assist in controlling temperature during an assay or during the plate read-out. The inks (and/or the heater) may also be useful in cases where elevated temperatures are desired during an assay (e.g., in assays with a PCR component). A temperature sensor may also be printed onto the electrode (working and/or auxiliary electrode) to provide actual temperature information.

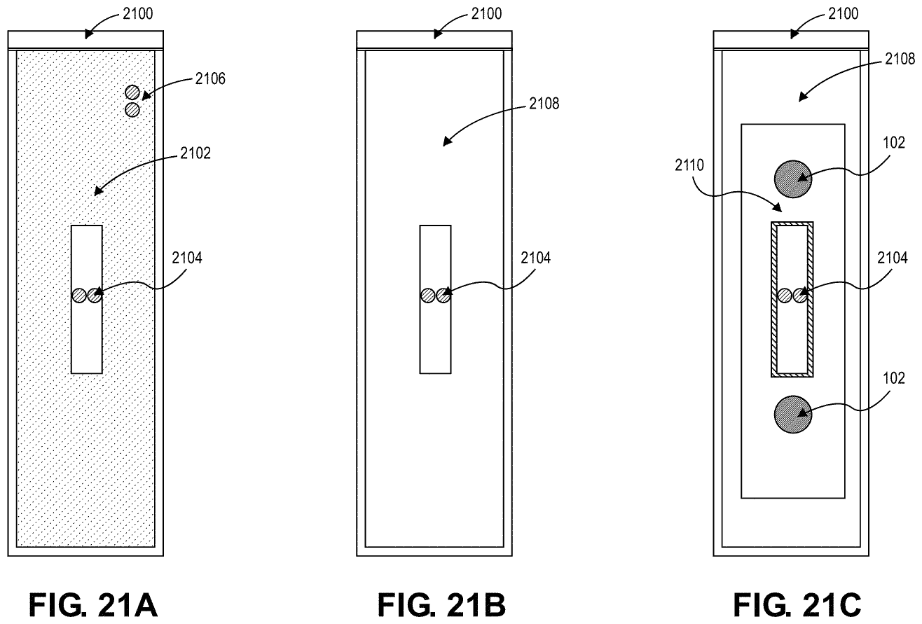

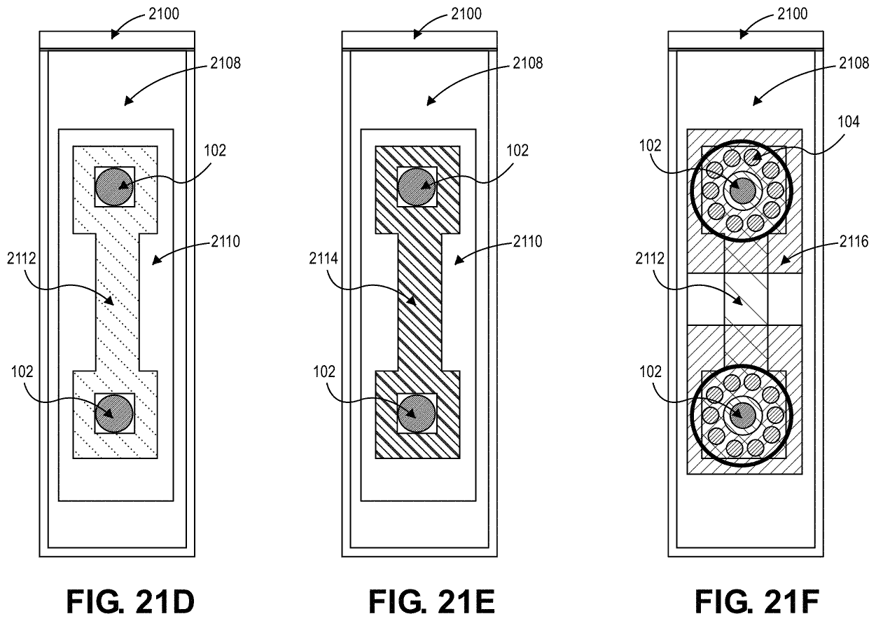

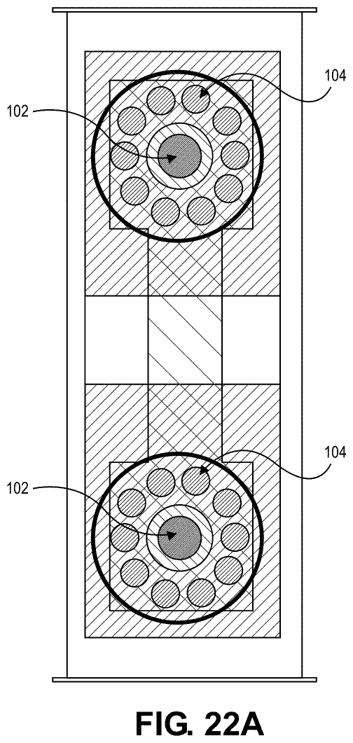

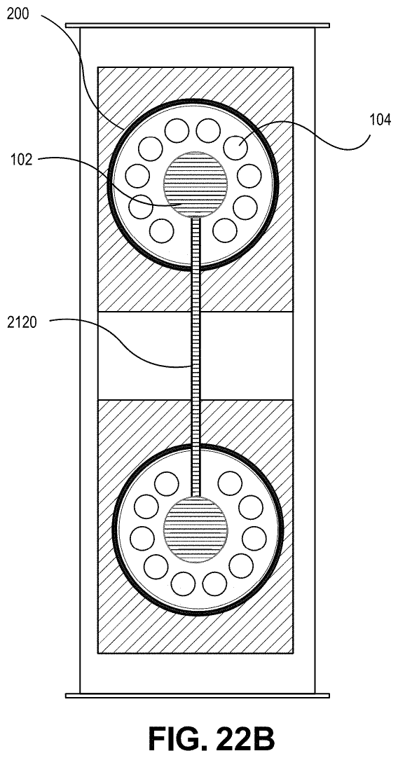

FIGS. 21A-21F illustrate non-limiting example of a process of forming working electrode zones 104 and auxiliary electrodes 102 in one or more wells 200, in accordance with an embodiment hereof. While FIGS. 21A-21F illustrate the formation of two (2) wells (as illustrated in FIG. 22A), one skilled in the art will realize that the process illustrated in FIGS. 21A-21F may be applied to any number of wells 200. Moreover, while FIGS. 21A-21F illustrate the formation of the auxiliary electrodes 102 and the working electrode zones 104 in an electrode design similar to the electrode design 701 illustrated in FIGS. 7A-7F, one skilled in the art will realize that the process illustrated in FIGS. 21A-21F may be utilized on an electrode design described herein.

The process for manufacturing the auxiliary electrodes 102, the working electrode zones 104, and other electrical components may be performed utilizing screen-printing processes as discussed below, where the different materials are formed using inks or paste. In embodiments, the auxiliary electrodes 102 and the working electrode zones 104 may be formed using any type of manufacturing process, e.g., 3D printing, deposition, lithography, etching, and combinations thereof.

As illustrated in FIG. 21A, a first conductive layer 2102 may be printed on a substrate 2100. In embodiments, the substrate 2100 may be formed of any material (e.g., insulating materials) that provides a support to the components of the well 200. In some embodiments, the first conductive layer 2102 may be formed of a metal, for example, silver. Other examples of the first conductive layer 2102 may include metals such as gold, silver, platinum, nickel, steel, iridium, copper, aluminum, a conductive alloy, or the like. Other examples of the first conductive layer 2102 may include oxide coated metals (e.g., aluminum oxide coated aluminum). Other examples of the first conductive layer 2102 may include carbon-based materials such as carbon, carbon black, graphitic carbon, carbon nanotubes, carbon fibrils, graphite, carbon fibers and mixtures thereof. Other examples of the first conductive layer 2102 may include conducting carbon-polymer composites.

The substrate 2100 may also include one or more through holes or other type of electrical connections (e.g., traces, electrical contacts, etc.) for connecting the components of the substrate 2100 and providing locations where electrical connections may be made to the components. For example, as illustrated, the substrate 2100 may include first through holes 2104 and second through holes 2106. The first through holes 2104 may be electrically isolated from the first conductive layer 2102. The second through holes 2106 may be electrically coupled to the first conductive layer 2102. Fewer or greater numbers of holes are contemplated as well. For example, the through holes may be formed within the layers or materials forming the working electrode zones 104, the auxiliary electrodes 102, and the electrically insulating materials so that electrical contact may be made with the working electrode zones 104 and the auxiliary electrodes 102 without creating a short with other electrical components. For instance, one or more additional insulating layers may be formed on the substrate in order to support electrical traces that are coupled through while isolating the electrical traces.

As illustrated in FIG. 21B, a second conductive layer 2108 may be printed on the first conductive layer 2102. In embodiments, the second conductive layer 2108 may be formed of a chemical mixture that includes a mixture of silver (Ag) and silver chloride (AgCl), or other suitable metal/metal halide couples. Other examples of chemical mixtures may include metal oxides as discussed above. In some embodiments, the second conductive layer 2108 may be formed to be the approximate dimension of the first conductive layer 2102. In some embodiments, the second conductive layer 2108 may be formed to dimension that are larger or smaller than the first conductive layer 2102. The second conductive layer 2108 may be formed by printing second conductive layer 2108 using an Ag/AgCl chemical mixture (e.g., ink, paste, etc.) that has a defined ratio of Ag to AgCl. In an embodiment, an amount of oxidizing agent in a chemical mixture of an auxiliary electrode is at least based in part of a ratio of Ag to AgCl in the chemical mixture of the auxiliary electrode. In an embodiment, a chemical mixture of an auxiliary electrode having Ag and AgCl comprises approximately 50 percent or less AgCl, for example, 34 percent, 10 percent, etc. While not illustrated, one or more additional intervening layers (e.g., insulating layers, conductive layers, and combination thereof) may be formed in between the second conductive layer 2108 and the first conductive layer 2102.

As illustrated in FIG. 21C, a first insulating layer 2110 may be printed on the second conductive layer 2108. The first insulating layer 2110 may be formed of any type of insulating material, for example, a dielectric, polymers, glass, etc. The first insulating layer 2110 may be formed in a pattern to expose two portions (“spots”) of the second conductive layer 2108, thereby forming two (2) auxiliary electrodes 102. The exposed portions may correspond to a desired shape and size of the auxiliary electrodes 102. In embodiments, the auxiliary electrodes 102 may be formed to any number, size, and shape, for example, as those described in the electrode designs described above with reference to FIGS. 3A-3F, 4A-4F, 5A-5C, 6A-6F, 7A-7F, 8A-8D, and 38A-39E.

As illustrated in FIGS. 21D and 21E, a third conductive layer 2112 may be printed on the insulating layer 2110, and, subsequently, a fourth conductive layer 2114 may be printed on the third conductive layer 2112. In embodiments, the third conductive layer 2112 may be formed of a metal, for example, Ag. In embodiments, the fourth conductive layer 2114 may be formed of a composite material, for example, a carbon composite. Other examples of the first conductive layer 2102 may include metals such as gold, silver, platinum, nickel, steel, iridium, copper, aluminum, a conductive alloy, or the like. Other examples of the first conductive layer 2102 may include oxide coated metals (e.g., aluminum oxide coated aluminum). Other examples of the first conductive layer 2102 may include other carbon-based materials such as carbon, carbon black, graphitic carbon, carbon nanotubes, carbon fibrils, graphite, carbon fibers and mixtures thereof. Other examples of the first conductive layer 2102 may include conducting carbon-polymer composites. The third conductive layer 2112 and fourth conductive layer 2114 may be formed in a pattern to form a base of the working electrode zones and provide electrical coupling to the first through holes 2104. In embodiments, through holes may be formed to any number, size, and shape, for example, as those described in the electrode designs described above with reference to FIGS. 3A-3F, 4A-4F, 5A-5C, 6A-6F, 7A-7F, 8A-8D, and 38A-39E.

As illustrated in FIG. 21F, a second insulating layer 2116 may be printed on the fourth conductive layer 2114. The second insulating layer 2116 may be formed of any type of insulating material, for example, a dielectric. The second insulating layer 2116 may be formed in a pattern to expose twenty (20) portions (“spots”) of the fourth conductive layer 2114, thereby forming ten (10) working electrode zones 104 for each well 200, as illustrated in FIG. 22A. The second insulating layer 2116 may also be formed to expose the auxiliary electrodes 102. Accordingly, printing or deposition of the second insulating layer 2116 may control the size and/or area of the working electrode zones 104 as well as the size and/or area of the auxiliary electrodes 102. The exposed portions may correspond to a desired shape and size of the working electrode zones 104 and the auxiliary electrodes 102. In embodiments, the working electrode zones 104 may be formed to any number, size, and shape, for example, as those described in the electrode designs described above with reference to FIGS. 3A-3F, 4A-4F, 5A-5C, 6A-6F, 7A-7F, 8A-8D, and 38A-39E. In certain embodiments, one of more of the described layers can be formed in particular order to minimize contamination, of layers (e.g., the carbon-based layers, etc.).

In the method described above, conductivity between the auxiliary electrodes 102 is maintained through the conductive layer 2108 which is then masked by the insulating layer 2110. This design permits the conductive connection between the auxiliary electrodes 102 to run underneath the working electrode zones 104. FIG. 22B illustrates a further embodiment of wells 200 as produced by a manufacturing method somewhat similar to that described above with respect to FIGS. 21A-F and 22A. As shown in FIG. 22B, the working electrode zones 104 may be arranged in a circular pattern having a gap, e.g., in a C-shape. Each well 200 may have, for example, ten working electrode zones. In further embodiments, any suitable number of working electrode zones may be included. The gap in the working electrode zone 104 pattern permits a conductive trace 2120 to run between the auxiliary electrodes 102 of the two wells 200. Because the conductive trace 2120 runs between the auxiliary electrodes 102 and does not cross over them, the auxiliary electrodes 102, working electrode zones 104, and conductive trace 2120 may be printed on a same layer during a manufacturing process. For example, in embodiments that include individually addressable working electrode zones 104, each of the auxiliary electrodes 102, working electrode zones 104, and conductive trace 2120 may be printed as individual features on a same layer of a substrate. The C-shape design of the electrodes depicted in FIG. 22B is not limited to use in a dual-well layout. Other layouts including different numbers of wells are consistent with embodiments hereof. For example, a single well layout may include the C-shaped electrode layout. In other examples, four or more wells 200 may be laid out with the C-shaped electrode layout and have multiple conductive traces 2120 connecting the auxiliary electrodes 102 of each well 200 in the layout.

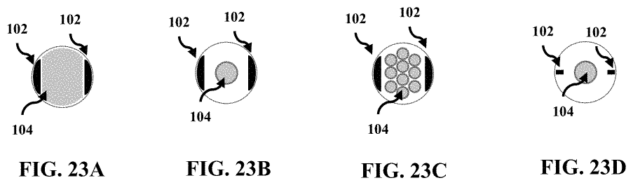

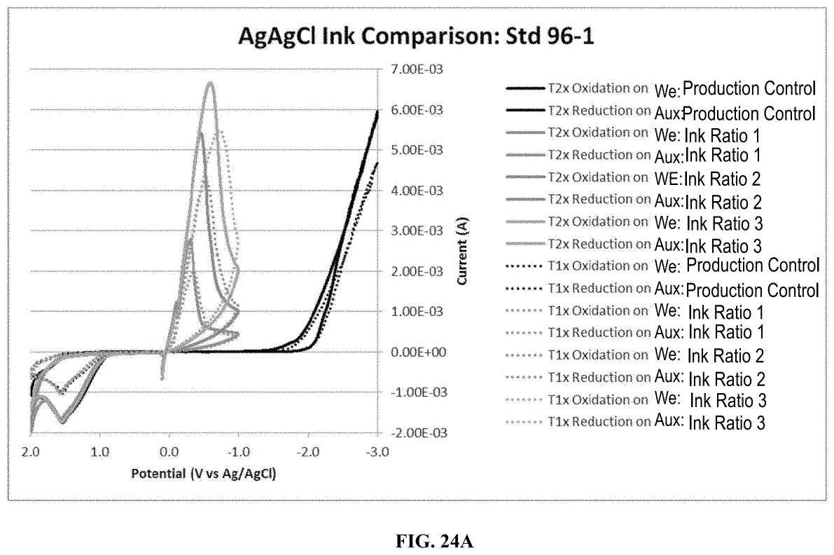

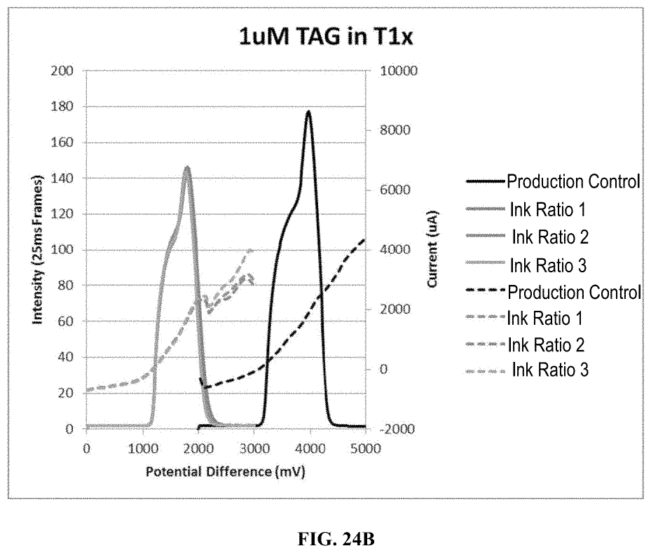

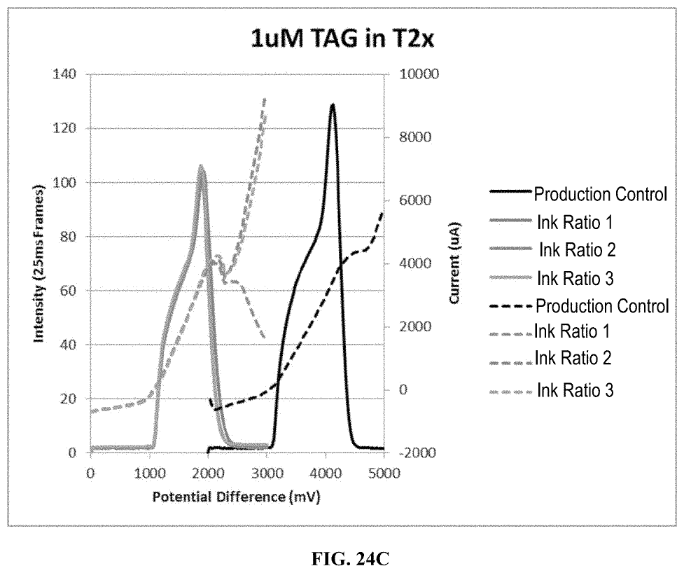

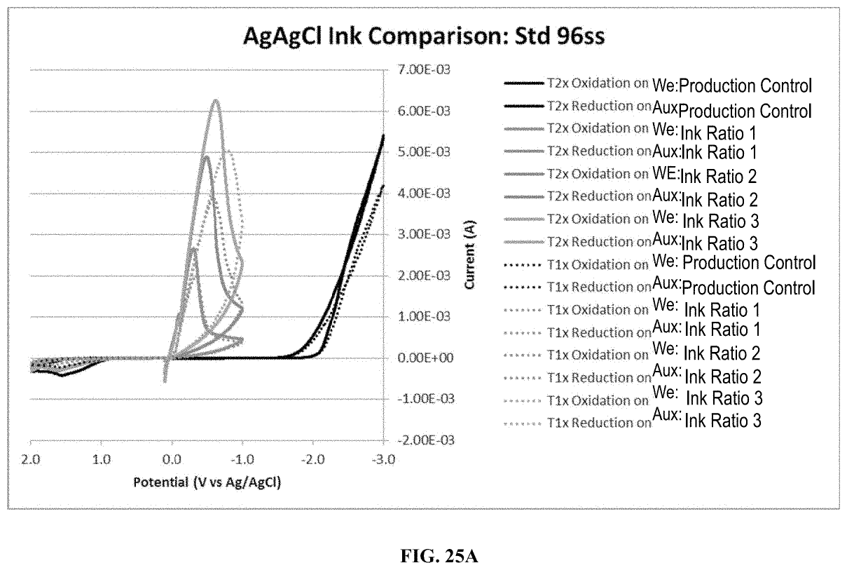

FIGS. 24A-24C, 25A-25C, 26A-26D, 27A-27C, 28, and 29 illustrate test results performed on various multi-well plates in accordance with embodiments hereof. The test included two different test lots. Each of the two different test lots included four (4) different configurations of the multi-well plates: Standard (“Std”) 96-1 plates, Std 96ss plates (small spot plates), Std 96-10 plates, and Std 96ss “BAL.” The Std 96-1 plates includes 96 wells 106 with 1 working electrode zone in each of the wells 106, as illustrated in FIG. 23A. The Std 96ss plates includes 96 wells 106 with 1 working electrode zone in each of the wells 106, as illustrated in FIG. 23B. The Std 96-10 plates includes 96 wells 106 with 10 working electrode zone in each of the wells 106, as illustrated in FIG. 23C. The Std 96ss “BAL” has two auxiliary electrodes and a single working electrode zone, as illustrated in FIG. 23D. In each test lot, three sets of each configuration of the multi-well plates was screen printed using different Ag/AgCl inks to produce different ratios of the chemical mixture of Ag/AgCl as shown in Table 8. Each of the plates described above were constructed with two auxiliary electrodes per well. The “BAL” configuration was constructed to have auxiliary electrodes with smaller dimension relative to the other configurations.

TABLE 9

| AgCl Ink | Ag:AgCl Molar Ratio |
|---|---|
| Ratio 1 | 90:10 |
| Ratio 2 | 66:34 |
| Ratio 3 | 50:50 |

The test also included a production control that included working electrode zones and counter electrodes formed of carbon labeled production control in the figures.

Tests were performed with test solution using electrodes designs as described above to generate voltammetry, ECL traces (ECL intensity vs. applied potential difference), integrated ECL signal measurements. The test solutions included three TAG solutions: 1 μM TAG (TAG refers to ECL labels or species that emit a photon when electrically excited) solution in T1×, 1 μM TAG solution in T2×, and MSD Free TAG 15,000 ECL (Y0260157). The 1 μM TAG solution in T1× included 5.0 mM Tris(2,2′ bipyridine) ruthenium (II) chloride stock solution (Y0420016) and MSD T1× (Y0110066). The 1 μM TAG solution in T2× included 5.0 mM Tris(2,2′ bipyridine) ruthenium (II) chloride stock solution (Y0420016) and MSD T2× (Y0200024). The test solutions also included a Read Buffer Solution that included MSD T1× (Y0110066). Measurements were performed for voltammetry, ECL Traces, and Free TAG 15,000 ECL tests and MSD T1×ECL signals under the following conditions.

For voltammetry using a standard three electrode configuration (working, reference, and counter electrode, using a one plate of each Ag/AgCl ink and one plate from inventory of Std 96-1, Std 96ss, and Std 96-10 were measured. Reductive voltammetry was measured on the counter electrodes. For reductive voltammetry, wells were filled with 150 μL of 1 μM TAG in T1× or 1 μM TAG in T2× and allowed to stand for at least 10 minutes. Waveforms were applied to the Ag/AgCl plates as follows: 0.1 V to −1.0 V and back to 0.1 V at 100 mV/s. Waveforms were applied to the production control as follows: 0 V to −3 V and back to 0 V at 100 mV/s. Three replicate wells of each solution were measured and averaged.

Oxidative voltammetry was measured on the working electrodes. For oxidative voltammetry, wells were filled with 150 μL of 1 μM TAG in T1× or 1 μM TAG in T2× and allowed to stand for at least 10 minutes. Waveforms were applied to the Ag/AgCl as follows: 0 V to 2 V and back to 0 V in 100 mV/s. Waveforms were applied to the production control as follows: 0 V to 2 V and back to 0 V in 100 mV/s. Three replicate wells of each solution were measured and averaged.

For ECL traces, one plate of each Ag/AgCl ink and one plate from inventory of Std 96-1, Std 96ss, and Std 96-10 were measured. Six wells were filled with 150 microliters (μL) of 1 micromolar (μM) TAG in T1× and six wells with 1 mM TAG in T2×. The plates were allowed to stand for at least 10 minutes. The ECL was measured on a proprietary video system using the following parameters: Ag/AgCl: 0 V to 3000 mV in 3000 ms imaged using with 120 sequential 25 ms frames (e.g., length of expose for an image) and production control: 2000 mV to 5000 mV in 3000 ms with 25 ms frames. The six replicate wells of each solution were averaged for ECL intensity vs. potential and Current vs. potential.

For the integrated ECL signals, six plates of each AgCl ink and six plates from inventory of Std 96-1, Std 96ss, and Std 96-10 were measured: two plates of MSD T1× and four plates of “Free TAG 15,000 ECL”. The plates were filled with 150 μL of “Free TAG 15,000 ECL” or MSD T1× and allowed to stand for at least 10 min. The ECL was measured on an MESO QUICKPLEX SQ 120 instrument (“SQ 120”) using the following waveforms for AgCl: 0 V to 3000 mV in 3000 ms. The ECL was measured on an SQ120 using the following waveforms for production control: 2000 mV to 5000 mV in 3000 ms. Intraplate and interplate values were calculated. The results of the test are discussed below.

FIGS. 24A-24C illustrate the results from the ECL measure performed on Std 96-1 plates. FIG. 24A is graph showing voltammetry measurements for the Std 96-1 plates. In particular, FIG. 24A shows average voltammograms for the Std 96-1 plates. As illustrated in FIG. 24A, an increase in current occurred between T1× solution and T2× solution. The oxidative curves were similar for the three Ag/AgCl ink plates and the control plate. The onset of oxidation was at approximately 0.8 V vs. Ag/AgCl. The peak potential was at approximately 1.6 V vs. Ag/AgCl. A shift in the reduction occurred when the CE was changed from carbon to Ag/AgCl. The onset of water reduction on carbon was at ca. −1.8 V vs. Ag/AgCl. The onset of AgCl reduction was at ca. 0 V vs. Ag/AgCl. An increase in total AgCl reduction occurred with an increase in the AgCl content of the Ag/AgCl ink. A small shoulder occurred at −0.16 V in the reductive voltammetry on Ag/AgCl that increased in current between the T1× solution and T2× solution. These results show that increasing the concentration of read buffer from T1× to T2× increased the oxidative current. Incorporating AgCl into the auxiliary electrode shifted the onset of reduction to the expected 0V vs. the carbon reference electrode. Increasing the AgCl in the ink increased the total AgCl reduction without impacting the slope of the current vs. potential curves.

FIG. 24B and FIG. 24C are graphs showing ECL measurements for the Std 96-1 plates. In particular, FIG. 24B and FIG. 24C show average ECL and current traces for the Std 96-1 plates having either the T1× solution or the T2× solution, as noted in FIG. 24A. As illustrated, the three Ag/AgCl ink plates yielded similar ECL traces. The onset of ECL occurred at ca. 1100 mV in T1× solution and T2× solution. The peak potentials occurred at 1800 mV for T1× solution and 1900 mV for T2× solution. The ECL intensity returned to baseline at ca. 2250 mV. The three Ag/AgCl ink plates yielded similar current traces except for lower current on Ink Ratio 1 (90/10 Ag:AgCl) with T2× at the end of the waveform. The ECL onset was shifted to ca. 3100 mV and the peak potential was shifted to ca. 4000 mV on the production plate. The relative shift in ECL on the production plate was comparable to the shift in the onset of reductive current measured in the referenced voltammetry. The full width at half max of the ECL trace on the production plate was wider than with the Ag/AgCl ink plates, which correlates with the lower slope of the reductive current in the reference voltammetry.

As shown in FIG. 24C, the total current passed during the waveform with the 90:10 ratio was less than with the other inks. This indicated the 90:10 ratio may limit the amount of oxidation that could occur at the working electrode. A ratio of 50:50 was selected to ensure sufficient reductive capacity for experiments where more current might be passed than with FT in T2× using this waveform. As shown by the tests, Ag/AgCl ink provides a controlled potential for the reduction on the auxiliary electrode 102. Using the Ag/AgCl, the auxiliary electrode 102 shifts the ECL reactions to the potentials where TPA oxidation occurs when measured using a true Ag/AgCl reference electrode.

For the auxiliary electrode 102, the amount of AgCl accessible in the auxiliary electrode 102 needs to be sufficient to not be fully consumed during the ECL measurement. For example, one mole of AgCl is required for every mole of electrons passed during oxidation at the working electrode. Less than this amount of AgCl will result in loss of control of the interfacial potential at the working electrode zones 104. A loss of control refers to a situation which interfacial potential is not maintained within a particular range throughout the chemical reaction. One goal of having a controlled interfacial potential is to ensure consistency and repeatability of readings well-to-well, plate-to-plate, screen lot-screen lot, etc.

Table 10 shows intraplate and interplate FT and T1× values of the Std 96-1 plates determined from the ECL measurement. As shown in Table 10, the three Ag/AgCl ink plates yielded equivalent values. The production plate yielded higher FT and T1×ECL signals. These higher signals may be attributed to a lower effected ramp rate due to the lower slope of the reductive voltammetry.

TABLE 10

| | | | | | FT Ave | FT | FT | | T1x |
|---|---|---|---|---|---|---|---|---|---|
| | | | | FT Ave | Intraplate | Interplate | Intraplate | T1x Ave | Interplate |
| Ag:AgCl | Vi | Vf | T | Intraplate | % CV | % CV | StDev | Intraplate | % CV |
| 90/10 | 0 | 3000 | 3000 | 12,856 | 1.4% | 1.6% | 206 | 62 | 5.7% |
| 66/34 | 0 | 3000 | 3000 | 12,399 | 1.1% | 1.1% | 139 | 74 | 100.5% |
| 50/50 | 0 | 3000 | 3000 | 12,338 | 1.4% | 1.0% | 127 | 69 | 5.7% |
| n/a | 2000 | 3000 | 3000 | 14,484 | 1.4% | 1.9% | 277 | 95 | 4.1% |

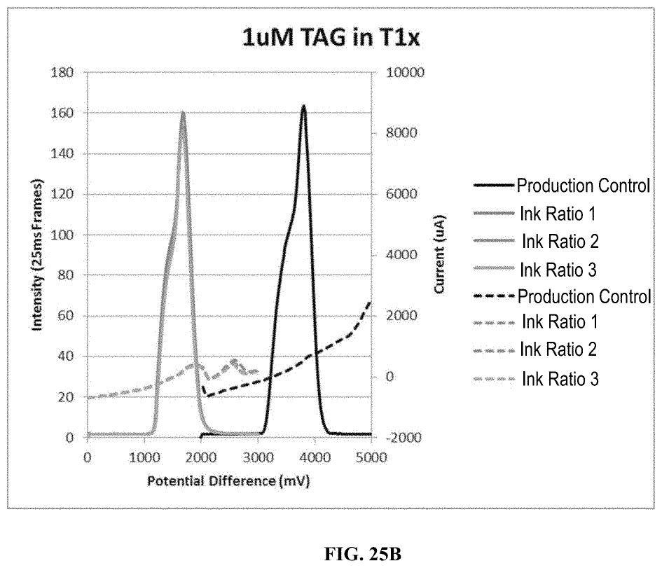

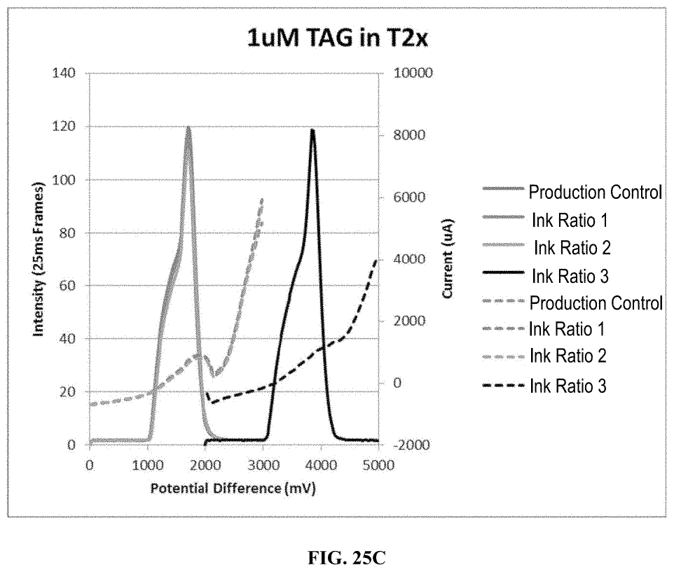

FIGS. 25A-25C illustrate the results from the ECL measure performed on Std 96ss plates. FIG. 25A is graph showing voltammetry measurements for the Std 96ss plates. In particular, FIG. 25A shows average voltammograms of the Std 96ss plates. As illustrated in FIG. 25A, an increase in current occurred between the T1× solution and the T2× solution. The oxidative curves were similar for the three Ag/AgCl ink plates and the control plate. The onset of oxidation occurred at ca. 0.8 V vs. Ag/AgCl. The peak potential occurred at approximately 1.6 V vs. Ag/AgCl. A shift in the reduction occurred when the auxiliary electrode was changed from carbon to Ag/AgCl. The onset of water reduction on carbon occurred at approximately −1.8 V vs. Ag/AgCl. The onset of AgCl reduction occurred at approximately 0 V vs. Ag/AgCl. There was an increase in total AgCl reduction with an increase in the AgCl content of the Ag/AgCl ink. A small shoulder occurred at −0.16 V in the reductive voltammetry on Ag/AgCl that increased in current between the T1× solution and the T2× solution.

FIG. 25B and FIG. 25C are graphs showing ECL measurements for the Std 96ss plates. In particular, FIG. 125B and FIG. 25C show average ECL and current traces for the Std 96ss plates having either the T1× solution or the T2× solution, as noted in FIG. 10A. As illustrated, the three Ag/AgCl ink plates yielded very similar ECL traces. The onset of ECL occurred at approximately 1100 mV in the T1× solution and the T2× solution. The peak potentials occurred at 1675 mV for the T1× solution and 1700 mV for the T2× solution. The ECL intensity returned to baseline at approximately 2175 mV. The three Ag/AgCl ink plates yielded similar current traces. The ECL onset was shifted to approximately 3000 mV, and the peak potential was shifted to approximately 3800 mV on the production plate. The relative shift in ECL on the production plate was comparable to the shift in the onset of reductive current measured in the referenced voltammetry. The full width at half max of the ECL trace on the production plate was wider than with the Ag/AgCl ink plates, which correlates with the lower slope of the reductive current in the reference voltammetry. The results shown in FIGS. 25A-25C are consistent with those of FIGS. 24A-24C, indicating that the changes occurring due to use of the Ag/AgCl electrodes are robust across different electrode configurations.

Table 11 shows intraplate and interplate FT and T1× values for the Std 96ss plates determined from the ECL measurement. As shown in Table 11, the three Ag/AgCl ink plates yielded equivalent values. The production plate yielded higher FT and T1×ECL signals. These higher signals may be attributed to a lower effected ramp rate due to the lower slope of the reductive voltammetry. The higher background signal on the production plate may have been due to a non-standard waveform on the reader used for that experiment.

TABLE 11

| | | | | | FT Ave | FT | FT | | T1x |
|---|---|---|---|---|---|---|---|---|---|
| | | | | FT Ave | Intraplate | Interplate | Intraplate | T1x Ave | Interplate |
| Ag:AgCl | Vi | Vf | T | Intraplate | % CV | % CV | StDev | Intraplate | % CV |
| 90/10 | 0 | 3000 | 3000 | 13,634 | 3.4% | 8.2% | 1112 | 94 | 5.9% |
| 66/34 | 0 | 3000 | 3000 | 13,705 | 2.2% | 4.3% | 589 | 106 | 4.3% |
| 50/50 | 0 | 3000 | 3000 | 13,475 | 3.4% | 5.9% | 791 | 104 | 5.6% |
| n/a | 2000 | 3000 | 3000 | 15,443 | 3.4% | 2.4% | 366 | 122 | 3.1% |

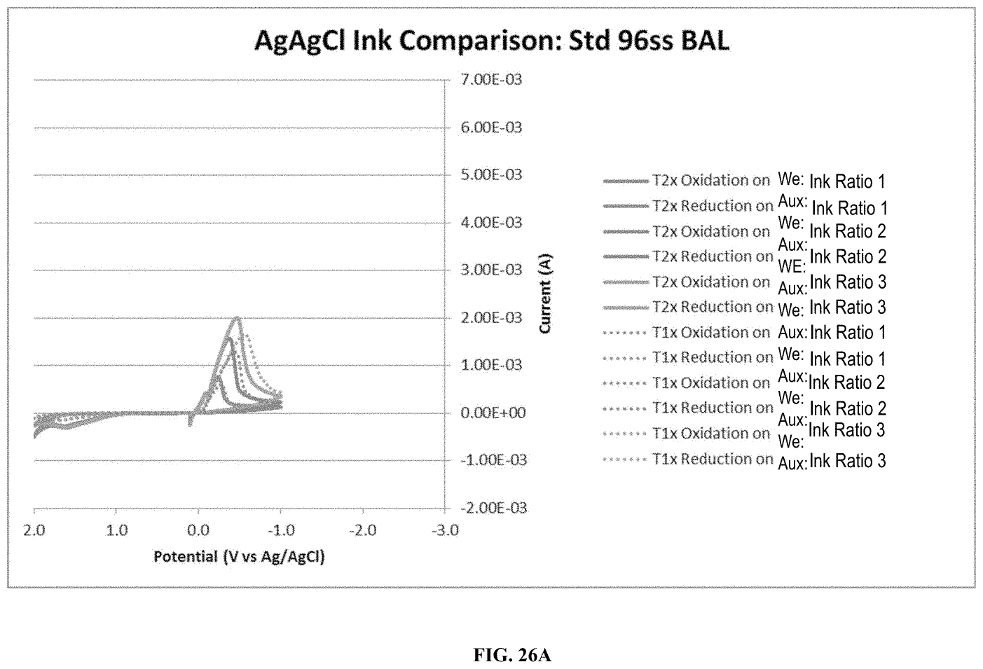

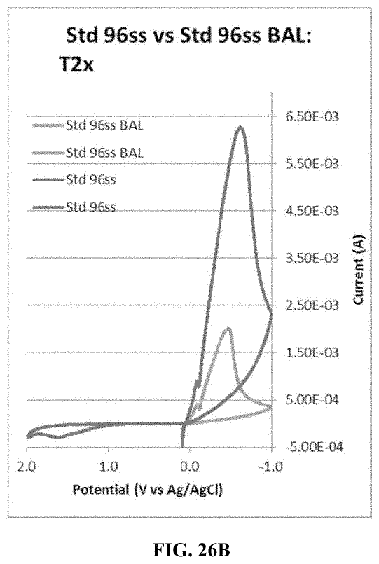

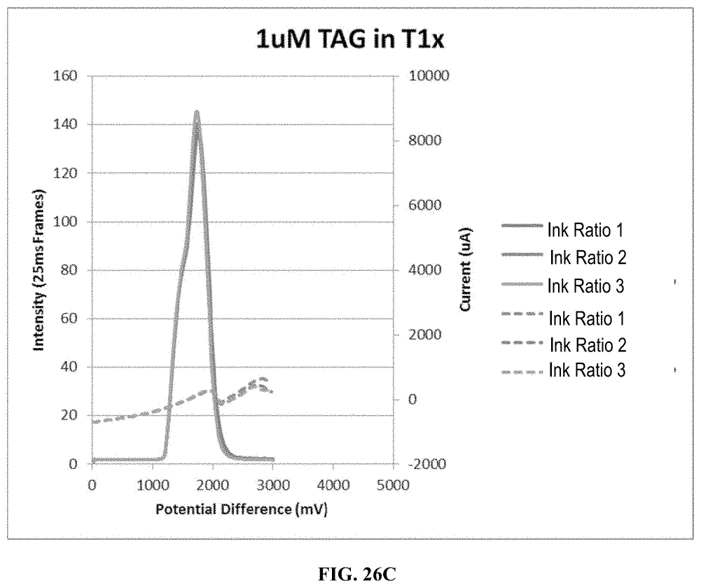

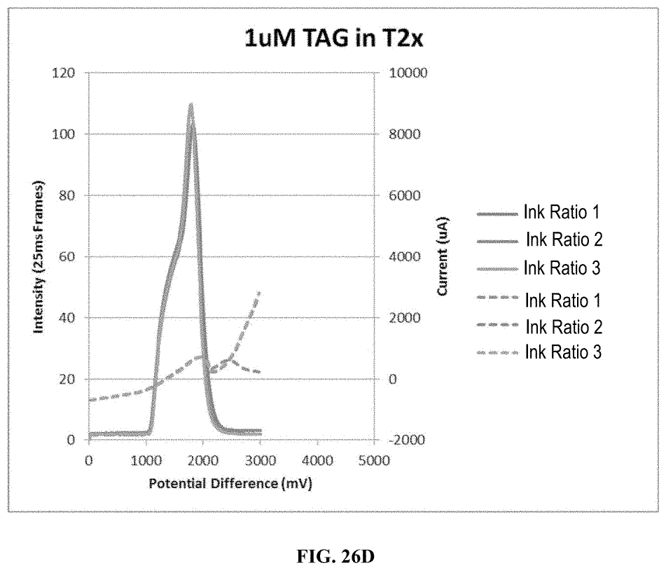

FIGS. 26A-26D illustrate the results from the ECL measure performed on Std 96ss BAL plates. FIG. 26A is a graph showing voltammetry measurements for the Std 96ss BAL plates. In particular, FIG. 26A shows average voltammograms for the Std 96ss BAL plates. As illustrated in FIG. 26A, an increase in current occurred between the T1× solution and the T2× solution. The oxidative curves were similar for the three Ag/AgCl ink plates and the production control. The onset of oxidation occurred at approximately 0.8V vs. Ag/AgCl. The peak potential occurred at ca. 1.6 V vs. Ag/AgCl. An increase in total AgCl reduction occurred with an increase in the AgCl content of the Ag/AgCl ink. A small shoulder at −0.16 V occurred in the reductive voltammetry on Ag/AgCl that increased in current between the T1× solution and the T2× solution. The overall auxiliary electrode current was reduced relative to the Std 96ss plate configuration due to the smaller electrode area. The slope of the current vs. potential plot was lower than in the Std 96ss plate configuration.

FIG. 26B is a graph showing Std 96ss vs. Std 96ss BAL with the T2× solution on Ink Ratio 3. As illustrated in FIG. 26B, the oxidative peak current (approximately −0.3 mA) was similar for both of these formats. At most reductive currents Std 96ss BAL was at a higher negative potential than Std 96ss.

FIG. 26C and FIG. 26D are graphs showing ECL measurements for the Std 96ss BAL plates. In particular, FIG. 26C and FIG. 26D show average ECL and current traces for the Std 96ss BAL plates having either the T1× solution or the T2× solution. As illustrated, the three plates with Ag/AgCl counter electrodes yielded similar ECL traces. The onset of ECL occurred at ca. 1100 mV in the T1× solution and the T2× solution. The peak potentials occurred at 1750 mV for the T1× solution and 1800 mV for the T2× solution. The ECL intensity returned to baseline at ca. 2300 mV. The onset of ECL was similar to Std 96ss plates, but the peak potential and return to baseline was shifted later in potential than on Std 96ss plates. The differences between Std 96ss plates and the Std 96ss BAL plates may be attributed to a lower effected ramp rate due to the lower slope of the reductive voltammetry on the smaller counter electrode. The three plates with Ag/AgCl counter electrodes yielded similar current traces except for lower current on 90/10 Ag:AgCl with the T2× solution at the end of the waveform. The different behavior of Ink Ratio 1 with the T2× solution was also observed in the Std 96-1 plate format. The results shown in FIGS. 26A-26D are consistent with those of FIGS. 24A-24C and 25A-25C, indicating that the changes occurring due to use of the Ag/AgCl electrodes are robust across different electrode configurations.

Table 12 shows intraplate and interplate FT and T1× values for the Std 96ss BAL plates determined from the ECL measurement. As shown in Table 12, the ECL signals are higher than in the Std 96ss plate configuration. The higher signals may be attributed to a lower effective ramp rate due to the lower slope of the reductive voltammetry on the smaller counter electrode. There was decreasing FT signal with increasing AgCl content in the ink.

TABLE 12

| | | | | | FT Ave | FT | FT | | T1x |
|---|---|---|---|---|---|---|---|---|---|
| | | | | FT Ave | Intraplate | Interplate | Intraplate | T1x Ave | Interplate |
| Ag:AgCl | Vi | Vf | T | Intraplate | % CV | % CV | StDev | Intraplate | % CV |
| 90/10 | 0 | 3000 | 3000 | 16,061 | 2.8% | 4.4% | 710 | 94 | 7.2% |
| 66/34 | 0 | 3000 | 3000 | 15,330 | 2.2% | 4.4% | 679 | 106 | 4.4% |
| 50/50 | 0 | 3000 | 3000 | 14,635 | 2.8% | 9.6% | 1412 | 99 | 5.1% |

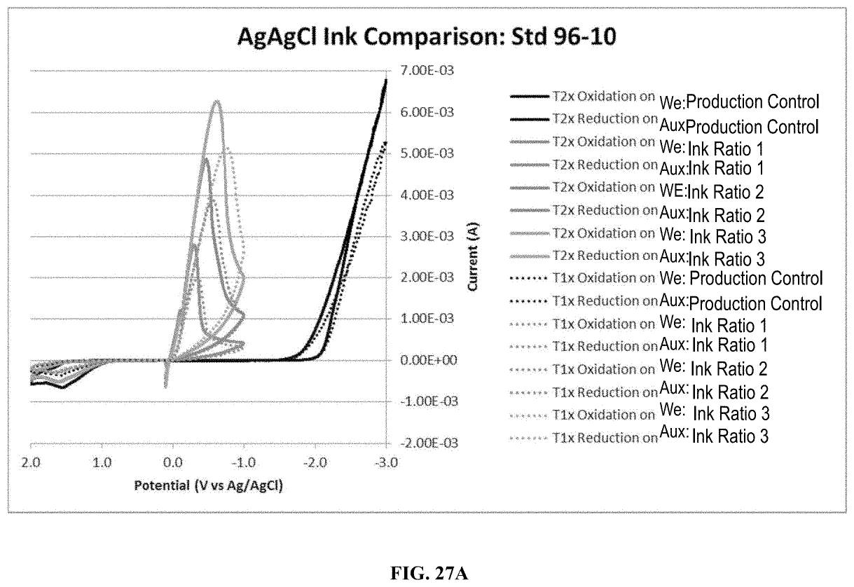

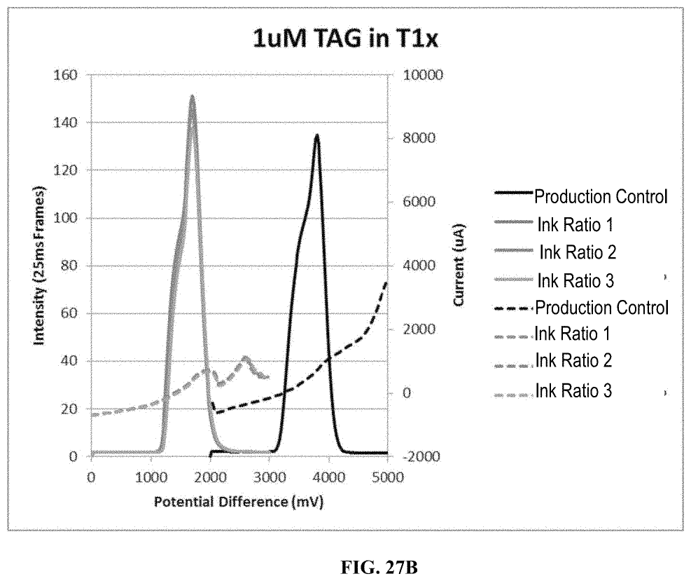

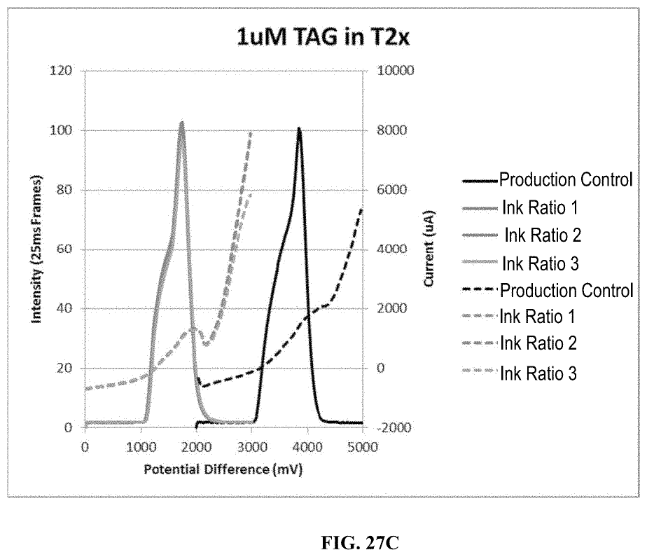

FIGS. 27A-27C illustrate the results from the ECL measure performed on Std 96-10 plates. FIG. 27A is graph showing voltammetry measurements for the Std 96-10 plates. In particular, FIG. 27A shows average voltammograms for the Std 96-10 plates. As illustrated in FIG. 27A, an increase in current occurred between the T1× solution and the T2× solution. The oxidative curves were similar for the three plates with Ag/AgCl counter electrode and the production control. The onset of oxidation occurred at approximately 0.8 V vs. Ag/AgCl. The peak potential occurred at approximately 1.6 V vs. Ag/AgCl. Higher oxidative current was present on the production control. A shift in the reduction occurred when the auxiliary counter electrode was changed from carbon to Ag/AgCl. The onset of water reduction on carbon occurred at approximately −1.8 V vs. Ag/AgCl. The onset of AgCl reduction occurred at approximately 0 V vs. Ag/AgCl. An increase in total AgCl reduction occurred with an increase in the AgCl content of the Ag/AgCl ink. A small shoulder at −0.16 V occurred in the reductive voltammetry on Ag/AgCl that increased in current between the T1× solution and the T2× solution.

FIG. 27B and FIG. 27C are graphs showing ECL measurements for the Std 96-10 plates. In particular, FIG. 27B and FIG. 27C show average ECL and current traces for the Std 96-10 plates having either the T1× solution or the T2× solution. As illustrated, the three plates with Ag/AgCl counter electrodes yielded similar ECL traces. The onset of ECL occurred at approximately 1100 mV in the T1× solution and the T2× solution. The peak potentials occurred at 1700 mV for the T1× solution and 1750 mV for the T2× solution. The ECL intensity returned to baseline at approximately 2250 mV. The three plates with Ag/AgCl counter electrodes yielded similar current traces. The ECL onset was shifted to approximately 3000 mV, and the peak potential was shifted to approximately 3800 mV on the production plate. The relative shift in ECL on the production plate was comparable to the shift in the onset of reductive current measured in the referenced voltammetry. The full width at half max of the ECL trace on the production plate was wider than with the Ag/AgCl inks, which correlates with the lower slope of the reductive current in the reference voltammetry. The results shown in FIGS. 27A-27C are consistent with those of FIGS. 24A-24C, 25A-25C, and 26A-26D, indicating that the changes occurring due to use of the Ag/AgCl electrodes are robust across different spot sizes.

Table 13 shows intraplate and interplate FT and T1× values the Std 96-10 plates determined from the ECL measurement. As shown in Table 13, the three plates with Ag/AgCl counter electrodes yielded equivalent values. The production plate yielded lower FT and T1×ECL signals. The source of the lower signals on the production plate is not known, but may be associated with the higher oxidative currents measured in the referenced voltammetry.

TABLE 13

| | | | | | FT Ave | FT | FT | | T1x |
|---|---|---|---|---|---|---|---|---|---|
| | | | | FT Ave | Intraplate | Interplate | Intraplate | T1x Ave | Interplate |
| Ag:AgCl | Vi | Vf | T | Intraplate | % CV | % CV | StDev | Intraplate | % CV |
| 90/10 | 0 | 3000 | 3000 | 15,777 | 2.8% | 5.2% | 817 | 110 | 12.9% |
| 66/34 | 0 | 3000 | 3000 | 15,173 | 4.6% | 5.2% | 782 | 114 | 13.5% |
| 50/50 | 0 | 3000 | 3000 | 15,100 | 4.6% | 5.3% | 793 | 112 | 13.3% |
| n/a | 2000 | 3000 | 3000 | 13,098 | 4.6% | 5.2% | 678 | 57 | 27.1% |

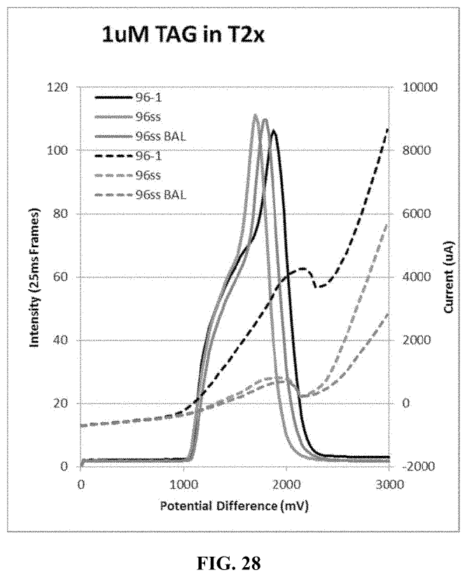

As shown in the test results discussed above and in FIG. 28, the auxiliary electrodes comprising Ag/AgCl shifted the ECL in the unreferenced system to potentials comparable to the oxidations measured in the referenced system, i.e., systems including separate reference electrode. For the auxiliary electrodes composed of Ag/AgCl, the ECL onset occurred at a potential difference of 1100 mV. The ECL peaks occurred at potential differences of (plate type average): Std 96-1 plate—1833 mV, Std 96ss plate—1688 mV, Std 96ss BAL plate-1775 mV, and Std 96-10 plate—1721 mV. Onset of oxidative current occurred at 0.8 V vs. Ag/AgCl. Peak oxidative current occurred at ca. 1.6 V vs. Ag/AgCl.

Additionally, as shown by the test results, three ink formulations were tested with a range of Ag to AgCl ratios, and the varying amount of AgCl was detectable in the referenced reductive voltammetry. All three formulations yielded comparable ECL traces. There were some differences in the current vs. potential plots when measuring ECL in the T2× solution. Current capacity appeared to be limited for Std 96-1 and Std 96ss BAL with Ag:AgCl ratio 90/10, and these plate types have the largest working to counter electrode area ratios. FT signals were comparable with the 3 formulations except in the 96ss BAL plate type.

In the preceding examples, the Std 96-1 plate working electrode area is 0.032171 in². The Std 96ss plate working electrode area is 0.007854 in². The Std 96-1 and Std 96sspr auxiliary electrode area was estimated to be 0.002646 in². The Std 96ss BAL plate auxiliary electrode area was designed to be 0.0006459 in². The area ratios may be: Std 96-1: 12.16, Std 96ss: 2.968, and Std 96ss BAL: 12.16. The ratios of the peak reductive currents on Std 96ss plate and Std 96ss BAL plate indicate the auxiliary electrode area in Std 96ss BAL plate was reduced to 0.0007938 in². The ECL traces suggest that this reduction in counter electrode area is approaching what is needed to unify the ECL traces from Std 96-1 plate and Std 96ss BAL plate.

### Example 4—Effect of the Ratio of Working Electrode to Auxiliary Electrode Area on the Performance of Ag/AgCl Auxiliary Electrodes

Four different multi-well plate configurations were tested that differed in the ratio of working electrode to auxiliary electrode area within each well, as illustrated by the exposed working electrode areas 104 and auxiliary electrode areas 102 in the electrode patterns depicted in FIGS. 23A-D. The first—“Std 96-1 Plates” (FIG. 23A)—have wells with a large working electrode area (as defined by a dielectric ink patterned over the working electrode) bounded by two auxiliary electrode strips and have the same electrode configuration as the plates used in Examples 2 and 3. The second—“Std 96ss Plates” (FIG. 23B)—is similar to the first except that the dielectric ink over the working electrode area is patterned to only expose a smaller circular exposed working electrode area (providing a small spot or “ss” area) in the center of the well. The third-“Std 96-10” (FIG. 23C)—is similar to the first except that the dielectric ink over the working electrode area is patterned to expose 10 small circles of exposed working electrode area providing a “10-spot” pattern of working electrode areas in each well. The fourth—“Std 96ss BAL” (FIG. 23D)—has the small exposed working electrode area of the Std 96ss pattern, but the area of the exposed auxiliary electrodes is significantly reduced so that the ratio of working electrode area to counter electrode area is similar to the Std 96-1 configuration maintaining a balance between these areas. The total area of exposed working electrode and the total area of exposed auxiliary electrode, and the ratio of the working electrode to counter electrode areas, for each of the configurations is provided in Table 14. To evaluate the effect of Ag/AgCl ink on auxiliary electrode performance, each of the electrode configurations was manufactured using auxiliary electrodes prepared with three different inks having different ratios of Ag to AgCl as described in Table 15. The Std 96-1, Std 96ss and Std 96-10 configurations were also compared to analogous plates—the “control” or “production control” plates—having conventional carbon ink counter electrodes instead of Ag/AgCl auxiliary electrodes (MSD 96 well, MSD 96 Well Small Spot and MSD 96 Well 10 Spot Plates, Meso Scale Diagnostics, LLC.).

TABLE 14

| | | Working | Counter/Auxiliary | |
|---|---|---|---|---|
| | | Electrode Area | Electrode Area | WE:CE Area |
| Plate Type | FIG. | (sq in) | (sq in) | Ratio |
| 96-1 | 23A | 0.0322 | 0.00265 | 12.15 |
| 96ss | 23B | 0.00785 | 0.00265 | 2.96 |
| 96-10 | 23C | 0.00139 | 0.00265 | 5.25 |
| 96ss BAL | 23D | 0.00785 | 0.000646 | 12.15 |

TABLE 15

| Ag/AgCl Ink | Ag:AgCl Molar Ratio |
|---|---|
| Ratio 1 | 90:10 |
| Ratio 2 | 66:34 |
| Ratio 3 | 50:50 |

The different electrode configurations were evaluated by cyclic voltammetry in the presence of ECL read buffers (MSD Read Buffer T at 1× and 2× relative to the nominal working concentration), and by using them for ECL measurements of solutions of tris(2, 2′ bipyridine) ruthenium (II) chloride (“TAG”) in these read buffers. Voltammetry was measured using a standard three electrode configuration (working, reference, and counter electrode), using a 3M KCl Ag/AgCl reference electrode. Oxidation of the ECL read buffers on the working electrodes 104 was measured by cycling from 0 V to 2 V and back at a 100 mV/s scan rate using working electrodes 104 and auxiliary electrodes 102, respectively, as the working and counter electrodes for voltammetry. Reduction of the ECL read buffers on the auxiliary electrodes 102 was measured by cycling from −0.1 V to −1 V and back at a 100 mV/s scan rate using auxiliary electrodes 102 and working electrodes 104, respectively, as the working and counter electrodes for voltammetry. To measure reduction of the ECL read buffer on the carbon counter electrodes of the “control” plates, a wider voltage range was required and the voltage was cycled from 0 V to −3 V and back at a 100 mV/s scan rate. Wells were filled with 150 μL of ECL read buffer and allowed to stand for at least 10 minutes prior to measuring the voltammetry. Each solution was measured in triplicate wells and the voltammetric data was averaged.

Integrated ECL signals for TAG solutions were measured on an MESO QUICKPLEX SQ 120 instrument (“SQ 120”) using the following waveforms: a 0 V to 3000 mV ramp over 3000 ms (for the test plates with Ag/AgCl auxiliary electrodes) and a 2000 mV to 5000 mV ramp over 3000 ms (for the controls plates with carbon ink counter electrodes). All wells were filled with 150 μL of MSD Free Tag (“FT”, a solution of TAG in MSD Read Buffer T 1× designed to provide a signal of about 15,000 in the ECL signal units of the SQ 120 instrument) and the plates were allowed to stand for at least 10 minutes. Two replicate plates (96 wells per plate) of T1× were run to measure the background signal in the absence of TAG and 4 replicate plates for FT were measured to measure the ECL signal generated from the TAG. The instrument reports a value proportional to the integrated ECL intensity over the duration of applied waveform, after normalization for area of the exposed working electrode area. Intraplate and interplate averages and standard deviations were calculated across the wells run for each solution and electrode configuration.

To measure ECL intensity as a function of time during the ECL measurement, ECL measurements from TAG solutions were carried out on a modified MSD plate reader with a proprietary video system. The same waveforms and procedure were used as when measuring integrated signals; however, the ECL was imaged as a sequential series of 120×25 ms frames captured over the course of the 3000 ms waveforms and more concentrated solutions of TAG were used (1 μM TAG in MSD Read Buffer T 1× and 2×). Each frame was background corrected using an image captured prior to the start of the waveform. The ECL intensity for each exposed working electrode area (or “spot”) in an image was calculated by summing up the intensity measured for each pixel in the region defined by the spot. For images with multiple spots within a well, the intensity value for the spots within the well were averaged. The instrument also measured electrical current passed through the well as a function of time during the ECL experiments. For each solution and electrode configuration, the average and standard deviation for the ECL intensity and current was calculated based on data from six replicate wells.

The voltammetry data for the Std 96-1, Std 96ss, Std 96 ss BAL and Std 96-10 plates are shown in FIGS. 24A, 25A, 26A and 27A, respectively. The oxidative current on the working electrodes 104 in this three-electrode setup is largely independent of the nature of the auxiliary or counter electrode with the onset of oxidation of the read buffers occurring at around 0.8 V and a peak in current at about 1.6 V, in all cases. The oxidative current increases from 1× to 2× read buffer as the concentration of the tripropylamine ECL coreactant increases, and the peak and integrated oxidative current increases roughly in scale with the exposed working electrode area (as provided in Table 14). The small differences that were observed in some cases between currents in the test and control plates were likely associated with differences in the carbon ink lots used to manufacture the working electrodes.

The reductive current measured at the auxiliary or counter electrodes 102 showed an onset of reduction at approximately 0 V for the Ag/AgCl auxiliary electrodes (associated with the reduction of AgCl to Ag) compared to about 3100 mV for the carbon ink counter electrodes (most likely associated with the reduction of water). An increase in the slope of the current onset and the overall integrated current was observed for Read Buffer T at 2× vs. 1× concentration, however, the increase was small and may be associated with the higher ionic strength at 2×. For a given combination of Ag/AgCl ink and read buffer formulations, the reductive currents measured at the auxiliary electrode for the Std 96-1, Std 96ss and Std 96-10 electrode configurations were largely independent of the electrode configuration, as the auxiliary electrode geometries in these configurations were identical. As the percentage of AgCl in the Ag/AgCl ink increased from 10% (Ratio 1) to 34% (Ratio 2) to 50% (Ratio 3), the reduction onset potential and the slope of the reduction onset current did not change significantly demonstrating a relative insensitivity of the electrode potential on percentage of the AgCl. However, with increasing AgCl the peak potential shifts more negative and the integrated current increases roughly in scale with the percentage of AgCl in the ink, demonstrating that an increase in AgCl is associated with an increase in reductive capacity. Comparing the reduction currents on the 96ss vs. 96ss BAL configurations (FIG. 26B), the shapes and peak potentials are roughly the same, however, the peak and integrated currents for the 96ssBAL are reduced roughly in scale with the lower auxiliary electrode area.

ECL intensity from 1 μM TAG in MSD Read Buffer T 1×, as a function of applied potential, is provided in FIGS. 24B, 25B, 26C, and 27B for the Std 96-1, Std 96ss, Std 96 ss BAL and Std 96-10 electrode configurations, respectively. Analogous plots for 1 μM TAG in MSD Read Buffer T 2× are provided in FIGS. 24C, 25C, 26D and 27C, respectively. All plots also provide plots of the associated electrical current through the electrodes as a function of potential. Within each of the test electrode configurations, the ECL traces generated using auxiliary electrodes with the three different Ag/AgCl ink formulations were roughly superimposable indicating that even the Ag/AgCl formulation with the lowest percentage of AgCl (10%) had sufficient reductive capacity to complete the generation of ECL. For the measurements of TAG in MSD Read Buffer T 1× using Ag/AgCl, the current traces were also largely superimposable. However, for the measurements of TAG in MSD Read Buffer T 2×, particularly for the configurations with the lowest ratios of Ag/AgCl auxiliary electrode area to working electrode area (the 96-1 and 96ss BAL configurations), the current measured using the ink with the lowest percentage of AgCl diverged at higher potentials and exhibited decreases in current with increasing potential. Because this divergence occurred at a potential that was near the end of the ECL peak, it did not significantly affect the ECL trace, but it indicates that the 10% AgCl ink may be near to the borderline for sufficient reductive capacity to complete the generation of ECL using the chosen waveforms, read buffers and electrode configurations.

Subtle changes in the shape of the peak in the ECL trace were observed with changes in electrode configuration. In all configurations, and with both read buffer concentrations, the onset of ECL generation occurred at roughly 3100 mV when using a carbon ink counter electrode and 1100 mV when using a Ag/AgCl auxiliary electrode. The onset potential using the Ag/AgCl auxiliary electrode is much closer to the roughly 800 mV onset potential that is observed in a three electrode system with a Ag/AgCl reference. While the onset potential is relatively independent of electrode configuration, small differences were observed in the potential at which the peak ECL intensity occurs. For the Std 96-1 configuration, the peak ECL using a Ag/AgCl auxiliary electrode occurs at roughly 1800 mV and 1900 mV for TAG in the 1× and 2× read buffer formulations, respectively. With the carbon counter electrode, the peaks are at 4000 and 4100 mV. As the ratio of working electrode area to auxiliary/counter electrode area decreases, the peak potential decreases. This effect occurs because the required current at the working electrode to achieve peak ECL can be achieved with a lower current density, and therefore a lower potential drop, at the auxiliary/counter electrode. For the Std 96-10 configuration, the peak ECL using a Ag/AgCl auxiliary electrode occurs at roughly 1700 mV and 1750 mV for TAG in the 1× and 2× read buffer formulations, respectively. For the Std 96ss configuration with the lowest ratio of electrode areas, the peak ECL using a Ag/AgCl auxiliary electrode occurs at roughly 1675 mV and 1700 mV for TAG in the 1× and 2× read buffer formulations, respectively. The shape of the ECL curve can be kept more consistent across configurations varying in working electrode area by balancing the auxiliary electrode area to maintain a fixed ratio. The Std 96ss BAL configuration has the working electrode area of the Std 96ss configuration, but the auxiliary electrode area was reduced so that the ratio of electrode areas matches that of the Std 96-1 configuration. For the Std 96ss BAL configuration, the peak ECL using a Ag/AgCl auxiliary electrode occurs at roughly 1750 mV and 1800 mV for TAG in the 1× and 2× read buffer formulations, respectively, and which are higher than the values observed with the Std 966 configuration and approaching the values observed with the Std 96-1 configuration. The difference in peak potential between the Std 96-1 and Std 96ss BAL configuration may just indicate that the actual area ratios achieved when printing the Std 96ss plates may be less than targeted in the screen print designs. The ECL traces and currents for 1 μM TAG in MSD Read Buffer T 2× for the three electrode configurations are compared in FIG. 28.

The integrated ECL signal results from the Std 96-1, Std 96ss, Std 96ss BAL and Std 96-10 electrode configurations are provided in Tables 16, 17, 18 and 19, respectively. Each table provides results for the three different Ag/AgCl auxiliary electrode compositions and the control carbon counter electrode conditions (Ag:AgCl=“n/a”). The table provides the starting potential (Vi), ending potential (Vf) and duration (T) of the ramp waveform used for that condition, as well as the average integrated ECL signal measured for the TAG solution (FT) and the background signal measured for the base buffer used for the TAG solution (T1×) in the absence of TAG. The coefficients of variation (CV) are also provided for the variation within each plate and across plates. The tables (16-19) show that the integrated signals were largely independent of the electrode configuration and auxiliary/counter electrode ink composition. No obvious trend in CVs with electrode configuration or composition was observed; the conditions with the highest CVs were generally associated with a single outlier well or plate. Slightly higher signals were observed for the Std 96ss BAL configuration than for the Std 96ss configuration despite sharing identical working electrode geometries. The currents required at the working electrode during ECL generation created a higher current density on the smaller Std 96ss BAL auxiliary electrode, which put the auxiliary electrode in a region of the current vs. voltage curve (FIG. 26B) with a lower slope. The end result was to slow the effective voltage ramp rate at the working electrode and increase the time during which ECL was generated.

TABLE 16

| | | | | | FT Ave | FT | FT | | T1x |
|---|---|---|---|---|---|---|---|---|---|
| | | | | FT Ave | Intraplate | Interplate | Intraplate | T1x Ave | Interplate |
| Ag:AgCl | Vi | Vf | T | Intraplate | % CV | % CV | StDev | Intraplate | % CV |
| 90/10 | 0 | 3000 | 3000 | 12,856 | 1.4% | 1.6% | 206 | 62 | 5.7% |
| 66/34 | 0 | 3000 | 3000 | 12,399 | 1.1% | 1.1% | 139 | 74 | 100.5% |
| 50/50 | 0 | 3000 | 3000 | 12,338 | 1.4% | 1.0% | 127 | 69 | 5.7% |
| n/a | 2000 | 3000 | 3000 | 14,484 | 1.4% | 1.9% | 277 | 95 | 4.1% |

TABLE 17

| | | | | | FT Ave | FT | FT | | T1x |
|---|---|---|---|---|---|---|---|---|---|
| | | | | FT Ave | Intraplate | Interplate | Intraplate | T1x Ave | Interplate |
| Ag:AgCl | Vi | Vf | T | Intraplate | % CV | % CV | StDev | Intraplate | % CV |
| 90/10 | 0 | 3000 | 3000 | 13,634 | 3.4% | 8.2% | 1112 | 94 | 5.9% |
| 66/34 | 0 | 3000 | 3000 | 13,705 | 2.2% | 4.3% | 589 | 106 | 4.3% |
| 50/50 | 0 | 3000 | 3000 | 13,475 | 3.4% | 5.9% | 791 | 104 | 5.6% |
| n/a | 2000 | 3000 | 3000 | 15,443 | 3.4% | 2.4% | 366 | 122 | 3.1% |

TABLE 18

| | | | | | FT Ave | FT | FT | | T1x |
|---|---|---|---|---|---|---|---|---|---|
| | | | | FT Ave | Intraplate | Interplate | Intraplate | T1x Ave | Interplate |
| Ag:AgCl | Vi | Vf | T | Intraplate | % CV | % CV | StDev | Intraplate | % CV |
| 90/10 | 0 | 3000 | 3000 | 16,061 | 2.8% | 4.4% | 710 | 94 | 7.2% |
| 66/34 | 0 | 3000 | 3000 | 15,330 | 2.2% | 4.4% | 679 | 106 | 4.4% |
| 50/50 | 0 | 3000 | 3000 | 14,635 | 2.8% | 9.6% | 1412 | 99 | 5.1% |

TABLE 19

| | | | | | FT Ave | FT | FT | | T1x |
|---|---|---|---|---|---|---|---|---|---|
| | | | | FT Ave | Intraplate | Interplate | Intraplate | T1x Ave | Interplate |
| Ag:AgCl | Vi | Vf | T | Intraplate | % CV | % CV | StDev | Intraplate | % CV |
| 90/10 | 0 | 3000 | 3000 | 15,777 | 2.8% | 5.2% | 817 | 110 | 12.9% |
| 66/34 | 0 | 3000 | 3000 | 15,173 | 4.6% | 5.2% | 782 | 114 | 13.5% |
| 50/50 | 0 | 3000 | 3000 | 15,100 | 4.6% | 5.3% | 793 | 112 | 13.3% |
| n/a | 2000 | 3000 | 3000 | 13,098 | 4.6% | 5.2% | 678 | 57 | 27.1% |

Examples of voltage pulses are described above in reference to 12A, 12B, 14A, 14B, 15A-15L, 16 and 17. In embodiments, the magnitude and duration of a pulsed waveform may be tailored to the chemical mixture of the auxiliary electrodes 102 and/or the configuration of the working electrode zones 104. FIGS. 14A, 14B, 15A-15L, 16 and 17 are graphs that illustrate tests performed to optimize waveforms for high bind versus standard plates. The test were performed for various configuration for working electrode zones 104 formed with carbon, counter electrodes formed with carbon, and auxiliary electrodes 102 formed with Ag/AgCl at various ratios. In this test, the voltages were ramped to determine potential values that maximize ECL. The graphs show how the high bind versus standard electrode affects how and at what point in the curve ECL is generated by varying potentials. The results of the test may be utilized to determine an optimal magnitude and/or duration for a pulsed waveform.

More particularly, in the test, FT ECL Traces were performed on uncoated standard (“Std”) and high bind (“HB”) 96-1, 96ss, and 96-10 Plates, as illustrated in FIG. 8A-8D. 300k FT was measured on 12 different SI plate types: Std & HB 96-1, 96ss, and 96-10 production control plates; Std & HB 96-1, 96ss, and 96-10 Ink Ratio 3 Ag/AgCl plates where the Ag:AgCl ratio was 50:50. Five waveforms were run on each plate type (4 replicate wells each). The waveforms for the production plates were as follows: 2000 mV to 5000 mV in 3000 ms (1.0 V/s), 2000 ms (1.5 V/s), 1500 ms (2.0 V/s), 1200 ms (2.5 V/s), and 1000 ms (3.0 V/s). The waveforms for the Ag/AgCl plates were as follows: 0 mV to 3000 mV in 3000 ms (1.0 V/s), 2000 ms (1.5 V/s), 1500 ms (2.0 V/s), 1200 ms (2.5 V/s), and 1000 ms (3.0 V/s). The production and Ag/AgCl plates were measured on the ECL system with a video system to capture luminescence data. To generate the graphs illustrated in FIGS. 14A, 14B, 15A-15L, 16 and 17, macros were used to determine the ECL intensity at each potential, and the 4 replicates were averaged. Mean ECL versus potential plots were prepared.

Based on the test performed, ECL peak voltages were determined for each of the production and test plates, as shown in Table 20. The ECL peak voltages may be utilized to set the magnitude of pulsed waveforms in ECL processes.

TABLE 20

| | Carbon CE | AgAgCl Auxiliary Electrode |
|---|---|---|
| Surface | ECL Peak (mV) | ECL Peak (mV) |
| Std 96-1 | 3975 | 1825 |
| Std 96ss | 3825 | 1700 |
| Std 96-10 | 3750 | 1725 |
| HB 96-1 | 3650 | 1500 |
| HB 96ss | 3275 | 1275 |
| HB 96-10 | 3250 | 1325 |

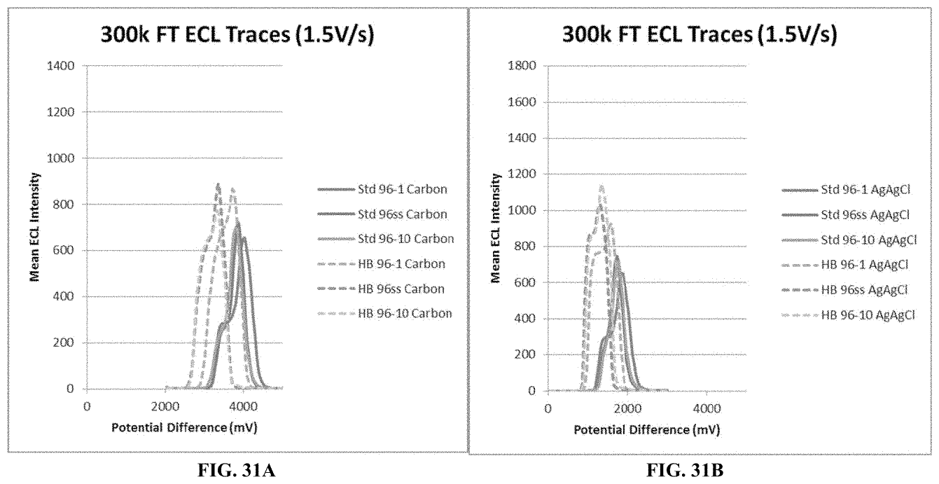

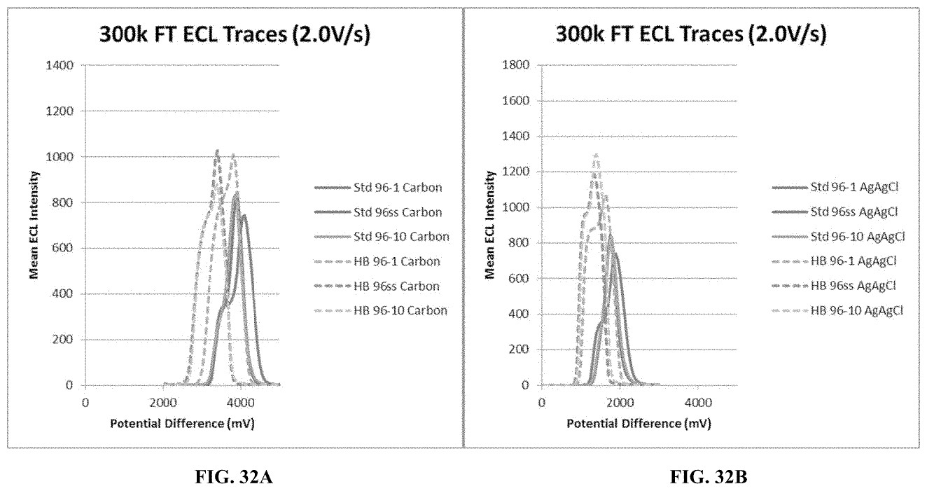

As shown by FIGS. 26, 27, 28A, 28B, 29, 30, 31, 32A, and 32B, ramp rate caused changes in the measured ECL, further shown in Table 21. Increasing the ramp rate increased intensity and decreased signals. Increasing the ramp rate increased the width of the ECL peak. The baseline intensity was defined as the average intensity in the first 10 frames. The onset potential was defined as the potential at which the ECL intensity exceeded 2× the average baseline. The return to baseline was defined as the potential at which the ECL intensity was below 2× the baseline. The width was defined as the potential difference between the return and onset potentials.

For Ag/AgCl auxiliary electrodes 102, the widths increased from 175 mV to 525 mV between 1.0 V/s and 3.0 V/s with carbon counter electrode. The greatest change was with HB 96-1. The smallest change was with Std 96ss. The widths increased from 375 mV to 450 mV between 1.0 V/s and 3.0 V/s with Ag/AgCl counter electrode

TABLE 21

| | Carbon CE | | | | | Ag/AgCl Auxiliary Electrode | | | | |
|---|---|---|---|---|---|---|---|---|---|---|
| | Width | Width | Width | Width | Width | Width | Width | Width | Width | Width |
| Surface | (1 V/s) | (1.5 V/s) | (2 V/s) | (2.5 V/s) | (3 V/s) | (1 V/s) | (1.5 V/s) | (2 V/s) | (2.5 V/s) | (3 V/s) |
| Std 96-1 | 1525 | 1650 | 1850 | 1875 | 1875 | 1425 | 1575 | 1700 | 1812.5 | 1800 |
| Std 96ss | 1400 | 1462.5 | 1500 | 1500 | 1575 | 1300 | 1425 | 1500 | 1625 | 1725 |
| Std 96- | 1525 | 1612.5 | 1750 | 1750 | 1800 | 1350 | 1425 | 1550 | 1625 | 1650 |
| 10 | | | | | | | | | | |
| HB 96-1 | 1425 | 1575 | 1700 | 1875 | 1950 | 1225 | 1350 | 1550 | 1562.5 | 1650 |
| HB 96ss | 1275 | 1350 | 1450 | 1500 | 1575 | 1225 | 1312.5 | 1400 | 1500 | 1575 |
| HB 96- | 1550 | 1612.5 | 1750 | 1687.5 | 1800 | 1350 | 1500 | 1650 | 1687.5 | 1800 |
| 10 | | | | | | | | | | |

For Ag/AgCl auxiliary electrodes 102, the widths increased from 175 mV to 525 mV between 1.0 V/s and 3.0 V/s with carbon counter electrode. The greatest change was with HB 96-1. The smallest change was with Std 96ss. The widths increased from 375 mV to 450 mV between 1.0 V/s and 3.0 V/s with Ag/AgCl counter electrode.

### Example 5—Effect of Working Electrode Composition and Ramp Rate on ECL Generation Using Ag/AgCl Auxiliary Electrodes

For this experiment, plates were prepared in the 96-1, 96ss and 96-10 configurations as described in Example 4. Test plates with Ag/AgCl auxiliary electrodes (“Ag/AgCl”) used the 50% AgCl Ag/AgCl mixture shown in Example 4 to provide more than sufficient reduction capacity for ECL generation using the chosen electrode configurations. Control plates (“Carbon”) were also prepared that had conventional carbon ink counter electrodes instead of Ag/AgCl auxiliary electrodes. For each combination of electrode configuration and auxiliary/counter electrode composition, plates were made with working electrodes with standard carbon ink electrodes as used in the previous examples (described as “Standard” or “Std”) or with carbon electrodes that had been treated with an oxygen plasma after printing (described as “High Bind” or “HB”).

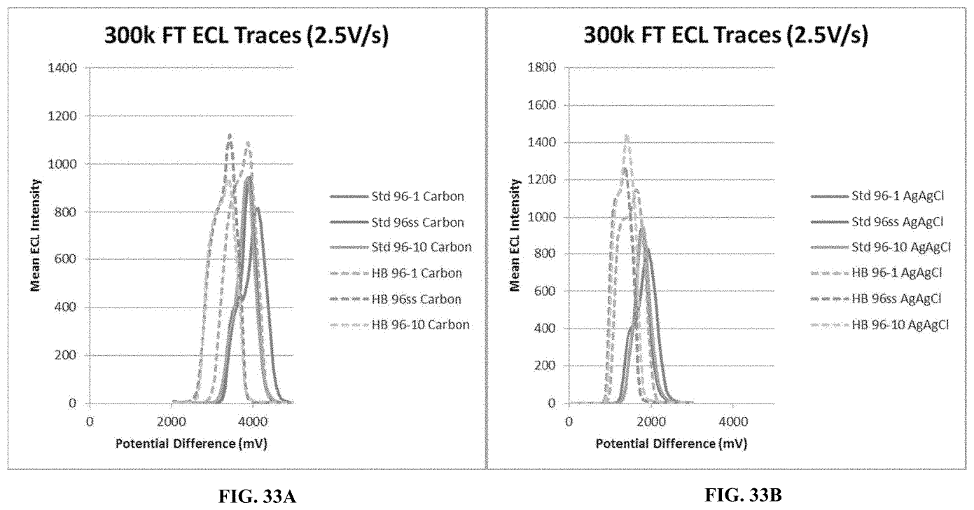

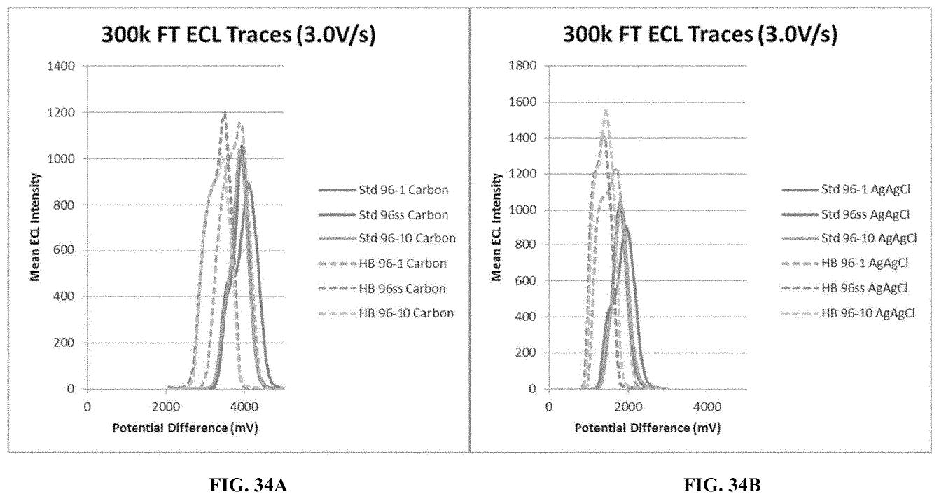

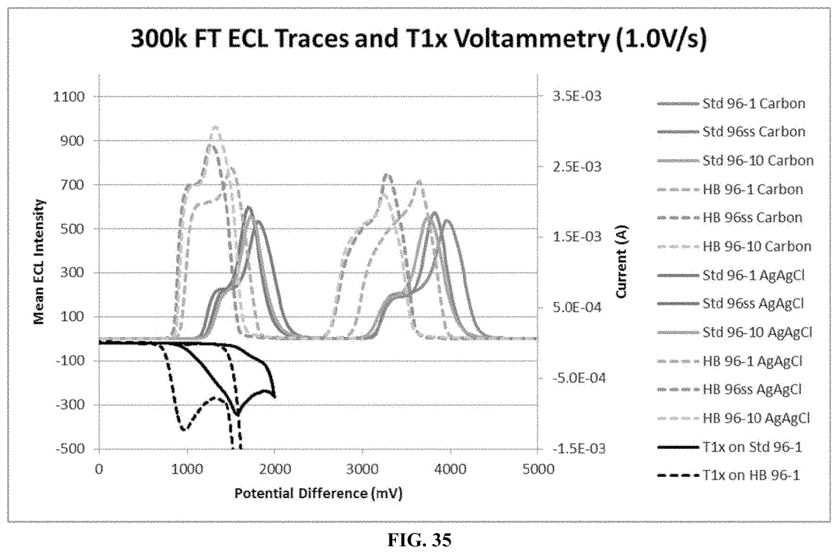

These plates were used to generate ECL from TAG dissolved in MSD Read Buffer T 1× at a concentration that provides an ECL signal of roughly 300,000 ECL counts (a solution termed “300k Free Tag” or “300k FT”) when analyzed in a Std 96-1 plate on an MSD SECTOR Imager plate reader. For this example, the analysis was conducted using a video capture system (as described in Example 4) to measure the ECL time course during the ECL experiments. ECL was generated using a 3 V ramp waveform from 0 V to 3 V for plates with Ag/AgCl auxiliary electrodes and 2 V to 5 V for plates with carbon counter electrodes. The effect of ramp speed was evaluating by testing each plate/electrode condition with 5 different ramp durations (ramp speeds): 3.0 s (1.0 V/s), 2.0 s (1.5 V/s), 1.5 s (2.0 V/s), 1.2 s (2.5 V/s) and 1.0 s (3.0 V/s). Plots of ECL intensity vs. applied potential for the control plates with carbon counter electrodes using the five different ramp speeds are provided in FIGS. 29, 31A, 32A, 33A and 34A, respectively. Analogous plots for the test plates with AgCl auxiliary electrodes are provided in FIGS. 30, 31B, 32B, 33B and 34B. The traces for the control and test plates are plotted together in FIG. 35 for the 1.0 V/s ramp rate.

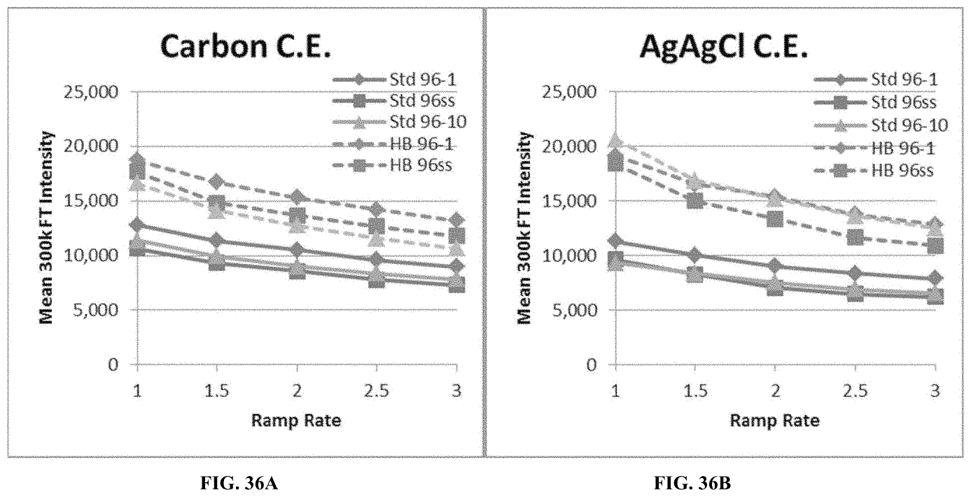

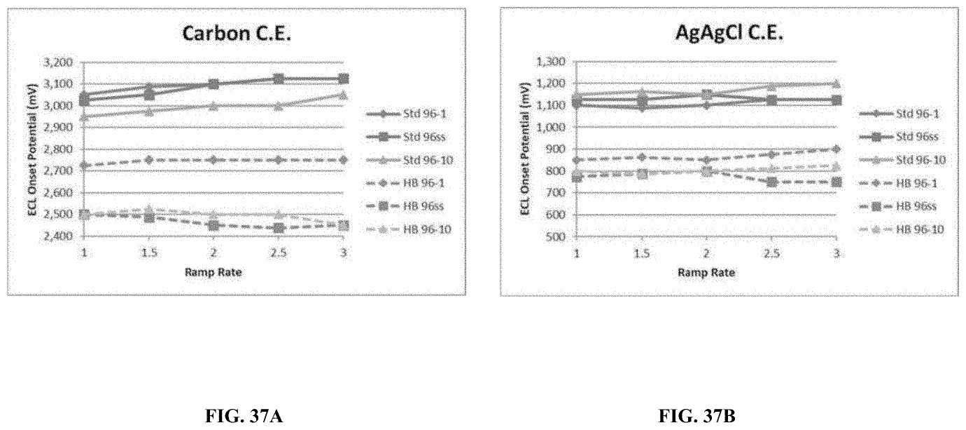

At all ramp rates and electrode configurations, the onset of ECL is at lower potential for the HB working electrodes than the Std working electrodes, due to its lower potential for the onset of TPA oxidation (−0.6 V for HB and −0.8 V for Std, vs. Ag/AgCl ref). For the control plates with carbon counter electrodes, the onset for ECL for the HB 96-1 plates is at higher potential than the other HB electrode configurations, which is likely an effect of the higher reducing potential at the counter electrode needed to support the higher current required for the large-area working electrode of the 96-1 format. This large shift in onset potential was not observed when Ag/AgCl auxiliary electrodes were used, demonstrating that the potential at these electrodes were less sensitive to this change in current density. FIGS. 36A and 36B plot the integrated ECL intensity across the waveform as a function of ramp rate and show that the integrated ECL intensity decreases with ramp rate as less time is spent in the voltage region where ECL is produced. FIGS. 37A and 37B plot the ECL onset potential as a function of ramp rate and show that, relative to using carbon counter electrodes, the Ag/AgCl auxiliary electrodes provide an ECL onset potential that is less sensitive to electrode configuration and ramp rate.

FIG. 35 plots the ECL traces for the test (Ag/AgCl) and control (Carbon) plates at the 1.0 V/s ramp rate (colored curves). The plot also shows (black curves) the cyclic voltammetry current vs. voltage traces for the oxidation of TPA in MSD Read Buffer T 1× on Std and HB carbon working electrodes. The plot shows that the higher ECL onset potential for Std vs. HB is associated with a higher onset potential for TPA oxidation. The higher sensitivity of HB vs. Std for the effect of electrode configuration on ECL onset potential is likely due to the much higher TPA oxidation currents observed with HB electrodes near the ECL onset potential. Table 22 provides the applied potential that provides the maximum ECL intensity for each of the pate types measured with the 1.0 V/s waveforms. With the Ag/AgCl auxiliary electrodes, the ECL peak potentials were correlated with the working-to-counter electrode area ratios: 96-1>96-10>96ss. As with the ECL onset potentials on HB plates, the Ag/AgCl auxiliary electrodes minimized the impact of the electrode area ratio on the shifts in the ECL peak potentials and HB plates.

TABLE 22

| | Carbon CE | AgAgCl Auxiliary Electrode |
|---|---|---|
| Surface | ECL Peak (mV) | ECL Peak (mV) |
| Std 96-1 | 3975 | 1825 |
| Std 96ss | 3825 | 1700 |
| Std 96-10 | 3750 | 1725 |
| HB 96-1 | 3650 | 1500 |
| HB 96ss | 3275 | 1275 |
| HB 96-10 | 3250 | 1325 |

Various experiments were conducted to with assay plates employing Ag/AgCl auxiliary electrodes and working electrodes in various configurations. Results of some of these are discussed herein. Experiments to determine differences in ECL signal intensity with changes in working electrode to auxiliary electrode ratio at different BTI concentrations and electrode configurations were conducted. For all configurations tested—concentric open spot arrangement (e.g., as shown in FIGS. 3A and 3B), concentric closed spot arrangement (e.g., as shown in FIGS. 7A and 7B), concentric open trilobe arrangement (e.g., as shown in FIGS. 4A and 4B), and concentric penta arrangement (e.g., as shown in FIGS. 5A and 5B), an increasing ECL response intensity with increasing ratio was observed. This result was observed in situations where the increased ratio is due to a change in auxiliary electrode size or due to a change in working electrode size.

In another experiment, differences in ECL signal intensity with changes in incubation time at different BTI concentrations and electrode configurations were observed. For all configurations tested—concentric open spot arrangement (e.g., as shown in FIGS. 3A and 3B), concentric open trilobe arrangement (e.g., as shown in FIGS. 4A and 4B), and concentric penta arrangement (e.g., as shown in FIGS. 5A and 5B), increasing ECL signal was observed with incubation times of two or three hours, relative to a one hour incubation time. An increase in ECL signal intensity at 3 hour incubation times, relative to a 2 hour incubation time, was also observed. In a further experiment, differences in % CV with incubation time across different electrode arrangements at different BTI concentrations were observed. The tested configurations were a concentric open spot arrangement (e.g., as shown in FIGS. 3A and 3B), a concentric open trilobe arrangement (e.g., as shown in FIGS. 4A and 4B), and a concentric penta arrangement (e.g., as shown in FIGS. 5A and 5B), In the concentric open spot arrangement, a reduction in % CV with increasing incubation time was observed. In the concentric open trilobe arrangement an increase in % CV with increasing incubation time from 1 to 2 hours was observed. In the concentric penta arrangement, an increase in % CV with increasing incubation time from 1 to 2 and from 2 to 3 hours was observed.

In another experiment, differences in gain at different working electrode zone to auxiliary electrode zone ratios across the different spots of an electrochemical cell in different electrode configurations were observed. The tested configurations were a non-concentric 10-spot arrangement, a concentric open spot arrangement (e.g., as shown in FIGS. 3A and 3B), and a concentric open trilobe arrangement (e.g., as shown in FIGS. 4A and 4B). The results, summarized in Table 23 below, indicate that the spread between the minimum and maximum gains are reduced in the concentric open arrangements relative to the non-concentric layout. Accordingly, concentric arrangement of working electrode zones may provide an advantage in maintaining a consistent gain across all spots or locations in a well.

TABLE 23

| | | Concentric | Concentric |
|---|---|---|---|
| | Non-Concentric | Open Spot | Open Trilobe |
| Max Gain | 1.157 | 1.05 | 1.079 |
| Min Gain | 0.879 | 0.944 | 0.934 |
| Spread | 0.278 | 0.106 | 0.145 |

In embodiments, the concentric approximately equidistant electrode configurations may provide specific advantages to ECL procedures, as discussed above and throughout. Due to the symmetry of these designs (see e.g., FIGS. 1C, 3A-3F, 6A-7F), each of the spots or working electrode zones is affected similarly by the overall geometry of the well. For example, as discussed with respect to FIG. 2C, a meniscus effect in the fluid filling the well will be approximately equal for each of the concentrically arranged working electrode zones. This occurs because the meniscus is a radial effect, and the concentrically arranged working electrode zones are located approximately equidistant from a center of the well. Additionally, as discussed above, mass transport effects may be equalized among the different working electrode zones. During orbital or rotational shaking, due to mass transport effects over time, a distribution of materials within the well may be dependent on a distance from the center of the well. Accordingly, a concentric arrangement of working electrode zones serves to reduce or minimize variations that may occur due to uneven material distribution throughout a well. Additionally, because each of the working electrode zones is located approximately equidistant from an auxiliary electrode, any voltammetry effects that may otherwise occur due to unequal distances may be reduced or minimized.

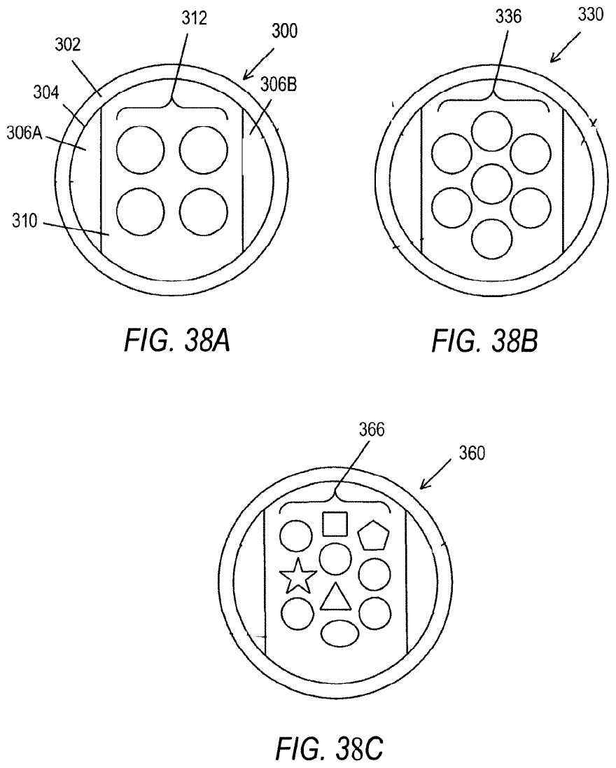

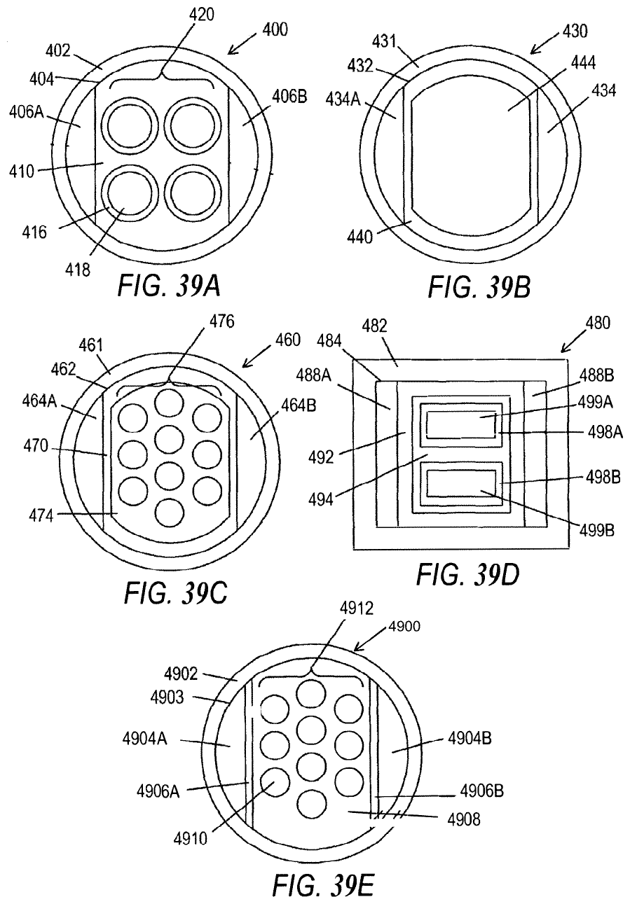

The preceding disclosure provides electrochemical cells involving working electrode zones and auxiliary electrodes. Various designs are presented and discussed. In some examples, electrode arrangements (e.g., concentric and equidistant arrangements) and advantages provided by these are discussed. In further examples, electrode composition (e.g., Ag, Ag/AgCl, and/or any other materials disclosed throughout (e.g., metal oxides, metal/metal oxide couples, etc.)) and advantages provided by these are discussed. It is understood that the scope of embodiments discussed herein includes the various electrode arrangement examples (e.g., as shown in FIGS. 3A-8D) used with electrodes of other materials as well (e.g., carbon, carbon composites and/or other carbon-based materials, etc.). Advantages generated by electrochemical cell electrode arrangements and geometry discussed herein may be realized in embodiments that include electrodes of any of the materials described herein. Further, advantages generated by electrochemical cells forming electrodes using Ag, Ag/AgCl, and/or any other materials disclosed throughout (e.g., metal oxides, metal/metal oxide couples, etc.) as discussed herein may be realized in embodiments that include other working electrode zone arrangements (for examples, see FIGS. 3A-4E of U.S. Pat. No. 7,842,246, Issued Nov. 30, 2010, the entirety of which is incorporated herein). Examples of such electrochemical cells employing non-concentric electrode arrangements formed of various materials, such as metal oxides, metal/metal oxide couples, etc. (e.g., Ag and/or Ag/AgCl) are illustrated in FIGS. 38A-39E.

FIGS. 38A-39E illustrate electrochemical cells including working electrodes, working electrode zones, and counter or auxiliary electrodes. The illustrated electrodes may comprise any of the various electrode materials discussed herein, including at least Ag/AgCl, as well as other chemical mixtures including metal oxides with multiple metal oxidation states, e.g., manganese oxide, or other metal/metal oxide couples, e.g., silver/silver oxide, nickel/nickel oxide, zinc/zinc oxide, gold/gold oxide, copper/copper oxide, platinum/platinum oxide, etc. In certain specific embodiments, the auxiliary/counter electrodes illustrated in these FIGS. 38A-39E include Ag/AgCl according to embodiments discussed herein.

FIG. 38A illustrates a well 300 according to another embodiment of the present invention. Well 300 has a wall 302 having an interior surface 304, auxiliary/counter electrodes 306A and 306B, working electrode 310 having working electrode zones 312.

FIG. 38B illustrates a well 330 according to embodiments wherein well 330 has a plurality of working electrode zones 336.

FIG. 38C illustrates a well 360 according to embodiments wherein well 360 has a plurality of working electrode zones 366.

FIG. 39A illustrates a well 400 according to yet another embodiment of the present invention. Well 400 has a wall 402 having an interior surface 404, auxiliary/counter electrodes 406A and 406B, working electrode 410, and boundaries 416 that define a group 420 of working electrode zones 418 of working electrode 410.

FIG. 39B illustrates a well 430 according to embodiments. Well 430 includes wall 431 having an interior surface 432. Boundary 440 separates auxiliary/counter auxiliary electrodes 434A and 434B from working electrode 444.

FIG. 39C illustrates a well 460 according to embodiments wherein boundary 470 separates auxiliary/counter electrodes 464A and 464B from working electrode 474. Well 460 includes wall 461 having an interior surface 462. Working electrode 474 has a plurality of working electrode zones 476.

FIG. 39D illustrates a well 480 according to the invention with a wall 482 having an interior surface 484, auxiliary/counter electrodes 488A and 488B, boundary 492, working electrode 494, boundaries 498A and 498B and working electrode zones 499A and 499B.

FIG. 39E illustrates a well 4900 according to the present invention. Well 4900 has wall 4902 with interior surface 4903, auxiliary/counter electrodes 4904A and 4904B, gaps 4906A and 4906B exposing a support, barrier 4908 with a plurality of holes 4912 that expose working electrode zones 4910.

Further embodiments include:

Embodiment 1 is an electrochemical cell for performing electrochemical analysis, the electrochemical cell comprising: a plurality of working electrode zones disposed, and defining a pattern, on a surface of the cell; and at least one auxiliary electrode disposed on the surface, the at least one auxiliary electrode having a redox couple confined to its surface, wherein the at least one auxiliary electrode is disposed at an approximate equal distance from at least two of the plurality of working electrode zones.

Embodiment 2 is the electrochemical cell of embodiment 1, wherein, during the electrochemical analysis, the auxiliary electrode has a potential defined by the redox couple.

Embodiment 3 is the electrochemical cell of embodiment 2, wherein the potential ranges from approximately 0.1 volts (V) to approximately 3.0 V.

Embodiment 4 is the electrochemical cell of embodiment 3, wherein the potential is approximately 0.22 V.

Embodiment 5 is the electrochemical cell of embodiment 1, wherein the plurality of working electrode zones have an aggregate exposed area, the at least one auxiliary electrode has an exposed surface area, and the aggregate exposed area of the plurality of working electrode zones divided by the exposed surface area of the at least one auxiliary electrode define an area ratio that has a value greater than 1.

Embodiment 6 is the electrochemical cell of embodiment 1, wherein the pattern minimizes a number of working electrode zones that are adjacent to one another for each of the working electrode zones among the plurality of working electrode zones.

Embodiment 7 is the electrochemical cell of embodiment 6, wherein the number of working electrode zones that are adjacent to one another is no greater than two.

Embodiment 8 is the electrochemical cell of embodiment 1, wherein at least one of the plurality of working electrode zones is adjacent to three or more other working electrode zones among the plurality of working electrode zones.

Embodiment 9 is the electrochemical cell of embodiment 1, wherein the pattern is configured to provide uniform mass transport of a substance to each of the plurality of working electrode zones under conditions of rotational shaking.

Embodiment 10 is the electrochemical cell of embodiment 1, wherein the pattern comprises a geometric pattern.

Embodiment 11 is the electrochemical cell of any of embodiments 1-10, wherein each of the plurality of working electrode zones defines a circular shape having surface area that defines a circle.

Embodiment 12 is the electrochemical cell of any of embodiments 1-11, wherein the plurality of working electrode zones comprises a plurality of electrically isolated zones formed on a single electrode.

Embodiment 13 is the electrochemical cell of embodiment 1, wherein the redox couple comprises a mixture of silver (Ag) and silver chloride (AgCl).

Embodiment 14 is the electrochemical cell of embodiment 13, wherein the mixture of Ag and AgCl comprises approximately 50 percent or less AgCl.

Embodiment 15 is the electrochemical cell of embodiment 14, wherein the mixture has a molar ratio of Ag to AgCl within a specified range.

Embodiment 16 is the electrochemical cell of embodiment 15, wherein the molar ratio is approximately equal to or greater than 1.

Embodiment 17 is the electrochemical cell of embodiment 13, wherein, during the electrochemical analysis the auxiliary electrode has a potential defined by the redox couple, and wherein the potential is approximately 0.22 volts (V).

Embodiment 18 is the electrochemical cell of any of embodiments 1-17, wherein the electrochemical analysis comprises electrochemiluminescence (ECL) analysis.

Embodiment 19 is the electrochemical cell of any of embodiments 1-18, wherein the electrochemical analysis involves a reduction or oxidation of an amount of one or more chemical moieties, and the at least one auxiliary electrode is configured to maintain a controlled interfacial potential until all of the chemical moieties have been oxidized or reduced.

Embodiment 20 is the electrochemical cell of any of embodiments 1-19, wherein the electrochemical cell is part of a flow cell.

Embodiment 21 is the electrochemical cell of any of embodiments 1-19, wherein the electrochemical cell is part of a plate.

Embodiment 22 is the electrochemical cell of any of embodiments 1-19, wherein the electrochemical cell is part of a cartridge.

Embodiment 23 is an electrochemical cell for performing electrochemical analysis, the electrochemical cell comprising: a plurality of working electrode zones disposed, and defining a pattern, on a surface of the cell; and at least one auxiliary electrode disposed on the surface, the auxiliary electrode having a redox couple confined to its surface, wherein the redox couple provides a quantifiable amount of coulombs per unit of the at least one auxiliary electrode's surface area throughout a redox reaction of the redox couple.

Embodiment 24 is the electrochemical cell of embodiment 23, wherein, during the electrochemical analysis, the auxiliary electrode has a standard reduction potential defined by the redox couple.

Embodiment 25 is the electrochemical cell of embodiment 24, wherein the standard reduction potential ranges from approximately 0.1 volts (V) to approximately 3.0 V.

Embodiment 26 is the electrochemical cell of embodiment 25, wherein the standard reduction potential is approximately 0.22 volts.

Embodiment 27 is the electrochemical cell of embodiment 23, wherein an amount of an oxidizing agent in the redox couple is greater than or equal to an amount of charge required to pass through the auxiliary electrode to complete the electrochemical analysis.

Embodiment 28 is the electrochemical cell of embodiment 27, wherein the at least one auxiliary electrode has between approximately 3.07×10⁻⁷ to 3.97×10⁻⁷ moles of oxidizing agent.

Embodiment 29 is the electrochemical cell of embodiment 27, wherein the at least one auxiliary electrode has between approximately 1.80×10⁻⁷ to 2.32×10⁻⁷ moles of oxidizing agent per mm² of auxiliary electrode area.

Embodiment 30 is the electrochemical cell of embodiment 27, wherein the at least one auxiliary electrode has at least approximately 3.7×10⁻⁹ moles of oxidizing agent per mm² of total working electrode area in the well.

Embodiment 31 is the electrochemical cell of embodiment 27, wherein the at least one auxiliary electrode has at least approximately 5.7×10⁻⁹ moles of oxidizing agent per mm² of total working electrode area in the well.

Embodiment 32 is the electrochemical cell of embodiment 23, wherein the redox couple passes approximately 0.5 to 4.0 mA of current throughout a redox reaction of the redox couple to generate electrochemiluminescence (ECL) at a range of approximately 1.4V to 2.6V.

Embodiment 33 is the electrochemical cell of embodiment 23, wherein the redox couple passes an average current of approximately 2.39 mA throughout a redox reaction to generate electrochemiluminescence (ECL) at a range of approximately 1.4 to 2.6 V.

Embodiment 34 is the electrochemical cell of embodiment 23, wherein the redox couple maintains an interface potential of between −0.15 to −0.5 V while passing a charge of approximately 1.56×10⁻⁵ to 5.30×10⁻⁴ C/mm² of electrode surface area.

Embodiment 35 is the electrochemical cell of embodiment 23, wherein the plurality of working electrode zones have an aggregate exposed area, the at least one auxiliary electrode has an exposed surface area, and the aggregate exposed area of the plurality of working electrode zones divided by the exposed surface area of the at least one auxiliary electrode define an area ratio that has a value greater than 1.

Embodiment 36 is the electrochemical cell of embodiment 23, wherein the pattern minimizes a number of working electrode zones that are adjacent to one another for each of the working electrode zones among the plurality of working electrode zones.

Embodiment 37 is the electrochemical cell of embodiment 23, wherein the number of working electrode zones that are adjacent to one another is no greater than two.

Embodiment 38 is the electrochemical cell of embodiment 23, wherein at least one of the plurality of working electrode zones is adjacent to three or more other working electrode zones among the plurality of working electrode zones.

Embodiment 39 is the electrochemical cell of embodiment 23, wherein the pattern is configured to provide uniform mass transport of a substance to each of the plurality of working electrode zones under conditions of rotational shaking.

Embodiment 40 is the electrochemical cell of embodiment 23, wherein the pattern comprises a geometric pattern.

Embodiment 41 is the electrochemical cell of any of embodiments 23-40, wherein each of the plurality of working electrode zones defines a circular shape having surface area that defines a circle.

Embodiment 42 is the electrochemical cell of any of embodiments 23-41, wherein the plurality of working electrode zones comprises a plurality of electrically isolated zones formed on a single electrode.

Embodiment 43 is the electrochemical cell of embodiment 1, wherein the redox couple comprises a mixture of silver (Ag) and silver chloride (AgCl).

Embodiment 44 is the electrochemical cell of embodiment 43, wherein the mixture of Ag and AgCl comprises approximately 50 percent or less AgCl.

Embodiment 45 is the electrochemical cell of embodiment 43, wherein the mixture has a molar ratio of Ag to AgCl within a specified range.

Embodiment 46 is the electrochemical cell of embodiment 45, wherein the molar ratio is approximately equal to or greater than 1.

Embodiment 47 is the electrochemical cell of embodiment 43, wherein during the electrochemical analysis, the auxiliary electrode has a standard reduction potential, and wherein the standard reduction potential is approximately 0.22 volts (V).

Embodiment 48 is the electrochemical cell of any of embodiments 23-47, wherein the electrochemical analysis comprises electrochemiluminescence (ECL) analysis.

Embodiment 49 is the electrochemical cell of any of embodiments 23-48, wherein the electrochemical analysis involves a reduction or oxidation of an amount of one or more chemical moieties, and the at least one auxiliary electrode is configured to maintain a controlled interfacial potential until all of the chemical moieties have been oxidized or reduced.

Embodiment 50 is the electrochemical cell of any of embodiments 23-49, wherein the electrochemical cell is part of a flow cell.

Embodiment 51 is the electrochemical cell of any of embodiments 23-49, wherein the electrochemical cell is part of a plate.

Embodiment 52 is the electrochemical cell of any of embodiments 23-49, wherein the electrochemical cell is part of a cartridge.

Embodiment 53 is an electrochemical cell for performing electrochemical analysis, the electrochemical cell comprising: a plurality of working electrode zones disposed, and defining a pattern, on a surface of the cell; and at least one auxiliary electrode disposed on the surface and formed of a chemical mixture comprising an oxidizing agent, the at least one auxiliary electrode having a redox couple confined to its surface, wherein an amount of the oxidizing agent is sufficient to maintain the defined potential throughout an entire redox reaction of the redox couple.

Embodiment 54 is the electrochemical cell of embodiment 53, wherein, during the electrochemical analysis, the auxiliary electrode has a potential defined by the redox couple.

Embodiment 55 is the electrochemical cell of embodiment 54, wherein the potential ranges from approximately 0.1 volts (V) to approximately 3.0 V.

Embodiment 56 is the electrochemical cell of embodiment 55, wherein the potential is approximately 0.22 V.

Embodiment 57 is the electrochemical cell of embodiment 53, wherein an amount of the oxidizing agent is greater than or equal to an amount of charge required to pass through the at least one auxiliary electrode to complete the electrochemical analysis.

Embodiment 58 is the electrochemical cell of embodiment 53, wherein the at least one auxiliary electrode has between approximately 3.07×10⁻⁷ to 3.97×10⁻⁷ moles of oxidizing agent.

Embodiment 59 is the electrochemical cell of embodiment 53, wherein the at least one auxiliary electrode has between approximately 1.80×10⁻⁷ to 2.32×10⁻⁷ moles of oxidizing agent per mm² of auxiliary electrode area.

Embodiment 60 is the electrochemical cell of embodiment 53, wherein the at least one auxiliary electrode has at least approximately 3.7×10⁻⁹ moles of oxidizing agent per mm² of total working electrode area.

Embodiment 61 is the electrochemical cell of embodiment 53, wherein the at least one auxiliary electrode has at least approximately 5.7×10⁻⁹ moles of oxidizing agent per mm² of total working electrode area 1.

Embodiment 62 is the electrochemical cell of embodiment 53, wherein the redox couple passes approximately 0.5 to 4.0 mA of current throughout a redox reaction of the redox couple to generate electrochemiluminescence (ECL) at a range of approximately 1.4V to 2.6V.

Embodiment 63 is the electrochemical cell of embodiment 53, wherein the redox couple passes an average current of approximately 2.39 mA throughout a redox reaction to generate electrochemiluminescence (ECL) at a range of approximately 1.4 to 2.6 V.

Embodiment 64 is the electrochemical cell of embodiment 53, wherein the redox couple maintains an interface potential of between −0.15 to −0.5 V while passing a charge of approximately 1.56×10⁻⁵ to 5.30×10⁻⁴ C/mm² of electrode surface area.

Embodiment 65 is the electrochemical cell of embodiment 53, wherein the plurality of working electrode zones have an aggregate exposed area, the at least one auxiliary electrode has an exposed surface area, and the aggregate exposed area of the plurality of working electrode zones divided by the exposed surface area of the at least one auxiliary electrode define an area ratio that has a value greater than 1.

Embodiment 66 is the electrochemical cell of embodiment 53, wherein the pattern minimizes a number of working electrode zones that are adjacent to one another for each of the working electrode zones among the plurality of working electrode zones.

Embodiment 67 is the electrochemical cell of embodiment 53, wherein the number of working electrode zones that are adjacent to one another is no greater than two.

Embodiment 68 is the electrochemical cell of embodiment 53, wherein at least one of the plurality of working electrode zones is adjacent to three or more other working electrode zones among the plurality of working electrode zones.

Embodiment 69 is the electrochemical cell of embodiment 53, wherein the pattern is configured to provide uniform mass transport of a substance to each of the plurality of working electrode zones under conditions of rotational shaking.

Embodiment 70 is the electrochemical cell of embodiment 53, wherein the pattern comprises a geometric pattern.

Embodiment 71 is the electrochemical cell of any of embodiments 53-70, wherein each of the plurality of working electrode zones defines a circular shape having surface area that defines a circle.

Embodiment 72 is the electrochemical cell of any of embodiments 53-71, wherein the plurality of working electrode zones comprises a plurality of electrically isolated zones formed on a single electrode.

Embodiment 73 is the electrochemical cell of embodiment 53, wherein the redox couple comprises a mixture of silver (Ag) and silver chloride (AgCl).

Embodiment 74 is the electrochemical cell of embodiment 73, wherein the mixture of Ag and AgCl comprises approximately 50 percent or less AgCl.

Embodiment 75 is the electrochemical cell of embodiment 73, wherein the mixture has a molar ratio of Ag to AgCl within a specified range.

Embodiment 76 is the electrochemical cell of embodiment 75, wherein the molar ratio is approximately equal to or greater than 1.

Embodiment 77 is the electrochemical cell of embodiment 73, wherein, during the electrochemical analysis, the auxiliary electrode has a potential defined by the redox couple, and wherein the potential is approximately 0.22 volts (V).

Embodiment 78 is the electrochemical cell of any of embodiments 53-77, wherein the electrochemical analysis comprises electrochemiluminescence (ECL) analysis.

Embodiment 79 is the electrochemical cell of any of embodiments 53-78, wherein the electrochemical analysis involves a reduction or oxidation of an amount of one or more chemical moieties, and the at least one auxiliary electrode is configured to maintain a controlled interfacial potential until all of the chemical moieties have been oxidized or reduced.

Embodiment 80 is the electrochemical cell of any of embodiments 53-79, wherein the electrochemical cell is part of a flow cell.

Embodiment 81 is the electrochemical cell of any of embodiments 53-79, wherein the electrochemical cell is part of a plate.

Embodiment 82 is the electrochemical cell of any of embodiments 53-79, wherein the electrochemical cell is part of a cartridge.

Embodiment 83 is an electrochemical cell for performing electrochemical analysis, the electrochemical cell comprising: a plurality of working electrode zones disposed, and defining a pattern, on a surface of the cell; and at least one auxiliary electrode disposed on the surface, the auxiliary electrode having a defined interfacial potential.

Embodiment 84 is the electrochemical cell of embodiment 83, wherein, during the electrochemical analysis, the auxiliary electrode has a potential defined by a redox couple.

Embodiment 85 is the electrochemical cell of embodiment 84, wherein the potential ranges from approximately 0.1 volts (V) to approximately 3.0 V.

Embodiment 86 is the electrochemical cell of embodiment 3, wherein the potential is approximately 0.22 V.

Embodiment 87 is the electrochemical cell of embodiment 83, wherein an amount of an oxidizing agent in the at least one auxiliary electrode is greater than or equal to an amount of charge required to pass through the at least one auxiliary electrode to complete the electrochemical analysis.

Embodiment 88 is the electrochemical cell of embodiment 87, wherein the at least one auxiliary electrode has between approximately 3.07×10⁻⁷ to 3.97×10⁻⁷ moles of oxidizing agent.

Embodiment 89 The electrochemical cell of embodiment 87, wherein the at least one auxiliary electrode has between approximately 1.80×10⁻⁷ to 2.32×10⁻⁷ moles of oxidizing agent per mm² of auxiliary electrode area.

Embodiment 90 is the electrochemical cell of embodiment 87, wherein the at least one auxiliary electrode has at least approximately 3.7×10⁻⁹ moles of oxidizing agent per mm² of total working electrode area in the well.

Embodiment 91 is the electrochemical cell of embodiment 87, wherein the at least one auxiliary electrode has at least approximately 5.7×10⁻⁹ moles of oxidizing agent per mm² of total working electrode area in the well.

Embodiment 92 is the electrochemical cell of embodiment 83, wherein the plurality of working electrode zones have an aggregate exposed area, the at least one auxiliary electrode has an exposed surface area, and the aggregate exposed area of the plurality of working electrode zones divided by the exposed surface area of the at least one auxiliary electrode define an area ratio that has a value greater than 1.

Embodiment 93 is the electrochemical cell of embodiment 83, wherein the pattern minimizes a number of working electrode zones that are adjacent to one another for each of the working electrode zones among the plurality of working electrode zones.

Embodiment 94 is the electrochemical cell of embodiment 83, wherein the number of working electrode zones that are adjacent to one another is no greater than two.

Embodiment 95 is the electrochemical cell of embodiment 83, wherein at least one of the plurality of working electrode zones is adjacent to three or more other working electrode zones among the plurality of working electrode zones.

Embodiment 96 is the electrochemical cell of embodiment 83, wherein the pattern is configured to provide uniform mass transport of a substance to each of the plurality of working electrode zones under conditions of rotational shaking.

Embodiment 97 is the electrochemical cell of embodiment 83, wherein the pattern comprises a geometric pattern.

Embodiment 98 is the electrochemical cell of any of embodiments 83-97, wherein each of the plurality of working electrode zones defines a circular shape having surface area that defines a circle.

Embodiment 99 is the electrochemical cell of any of embodiments 83-98, wherein the plurality of working electrode zones comprises a plurality of electrically isolated zones formed on a single electrode.

Embodiment 100 is the electrochemical cell of embodiment 83, wherein the at least one auxiliary electrode comprises a mixture of silver (Ag) and silver chloride (AgCl).

Embodiment 101 is the electrochemical cell of embodiment 100, wherein the mixture of Ag and AgCl comprises approximately 50 percent or less AgCl.

Embodiment 102 is the electrochemical cell of embodiment 100, wherein the mixture has a molar ratio of Ag to AgCl within a specified range.

Embodiment 103 is the electrochemical cell of embodiment 102, wherein the molar ratio is approximately equal to or greater than 1.

Embodiment 104 is the electrochemical cell of embodiment 100, wherein, during the electrochemical analysis, the auxiliary electrode has a potent defined by a redox couple, and

wherein the defined interfacial potential is approximately 0.22 volts (V).

Embodiment 105 is the electrochemical cell of any of embodiments 83-104, wherein the electrochemical analysis comprises electrochemiluminescence (ECL) analysis.

Embodiment 106 is the electrochemical cell of any of embodiments 83-105, wherein the electrochemical analysis involves a reduction or oxidation of an amount of one or more chemical moieties, and the at least one auxiliary electrode is configured to maintain a controlled interfacial potential until all of the chemical moieties have been oxidized or reduced.

Embodiment 107 is the electrochemical cell of any of embodiments 83-106, wherein the electrochemical cell is part of a flow cell.

Embodiment 108 is the electrochemical cell of any of embodiments 83-106, wherein the electrochemical cell is part of a plate.

Embodiment 109 is the electrochemical cell of any of embodiments 83-106, wherein the electrochemical cell is part of a cartridge.

Embodiment 110 is an electrochemical cell for performing electrochemical analysis, the electrochemical cell comprising: a plurality of working electrode zones disposed, and defining a pattern, on a surface of the cell; and at least one auxiliary electrode disposed on the surface, the at least one auxiliary electrode comprising a first substance and a second substance, wherein the second substance is a redox couple of the first substance.

Embodiment 111 is the electrochemical cell of embodiment 110, wherein, during the electrochemical analysis, the auxiliary electrode has a potential defined by the redox couple.

Embodiment 112 is the electrochemical cell of embodiment 111, wherein the potential ranges from approximately 0.1 volts (V) to approximately 3.0 V.

Embodiment 113 is the electrochemical cell of embodiment 112, wherein the potential is approximately 0.22 V.

Embodiment 114 is the electrochemical cell of embodiment 110, wherein an amount of an oxidizing agent in the redox couple is greater than or equal to an amount of charge required to pass through the auxiliary electrode to complete the electrochemical analysis.

Embodiment 115 is the electrochemical cell of embodiment 114, wherein the at least one auxiliary electrode has between approximately 3.07×10⁻⁷ to 3.97×10⁻⁷ moles of oxidizing agent.

Embodiment 116 is the electrochemical cell of embodiment 114, wherein the at least one auxiliary electrode has between approximately 1.80×10⁻⁷ to 2.32×10⁻⁷ moles of oxidizing agent per mm² of auxiliary electrode area.

Embodiment 117 is the electrochemical cell of embodiment 114, wherein the at least one auxiliary electrode has at least approximately 3.7×10⁻⁹ moles of oxidizing agent per mm² of total working electrode area in the well.

Embodiment 118 is the electrochemical cell of embodiment 114, wherein the at least one auxiliary electrode has at least approximately 5.7×10⁻⁹ moles of oxidizing agent per mm² of total working electrode area in the well.

Embodiment 119 is the electrochemical cell of embodiment 110, wherein the redox couple passes approximately 0.5 to 4.0 mA of current throughout a redox reaction of the redox couple to generate electrochemiluminescence (ECL) at a range of approximately 1.4V to 2.6V.

Embodiment 120 is the electrochemical cell of embodiment 110, wherein the redox couple passes an average current of approximately 2.39 mA throughout a redox reaction to generate electrochemiluminescence (ECL) at a range of approximately 1.4 to 2.6 V.

Embodiment 121 is the electrochemical cell of embodiment 110, wherein the redox couple maintains an interface potential of between −0.15 to −0.5 V while passing a charge of approximately 1.56×10⁻⁵ to 5.30×10⁻⁴ C/mm² of electrode surface area.

Embodiment 122 is the electrochemical cell of embodiment 110, wherein the plurality of working electrode zones have an aggregate exposed area, the at least one auxiliary electrode has an exposed surface area, and the aggregate exposed area of the plurality of working electrode zones divided by the exposed surface area of the at least one auxiliary electrode define an area ratio that has a value greater than 1.

Embodiment 123 is the electrochemical cell of embodiment 110, wherein the pattern minimizes a number of working electrode zones that are adjacent to one another for each of the working electrode zones among the plurality of working electrode zones.

Embodiment 124 is the electrochemical cell of embodiment 110, wherein the number of working electrode zones that are adjacent to one another is no greater than two.

Embodiment 125 is the electrochemical cell of embodiment 110, wherein at least one of the plurality of working electrode zones is adjacent to three or more other working electrode zones among the plurality of working electrode zones.

Embodiment 126 is the electrochemical cell of embodiment 110, wherein the pattern is configured to provide uniform mass transport of a substance to each of the plurality of working electrode zones under conditions of rotational shaking.

Embodiment 127 is the electrochemical cell of embodiment 110, wherein the pattern comprises a geometric pattern.

Embodiment 128 is the electrochemical cell of any of embodiments 110-127, wherein each of the plurality of working electrode zones defines a circular shape having surface area that defines a circle.

Embodiment 129 is the electrochemical cell of any of embodiments 110-128, wherein the plurality of working electrode zones comprises a plurality of electrically isolated zones formed on a single electrode.

Embodiment 130 is the electrochemical cell of embodiment 110, wherein the first substance is silver (Ag) and the second substance is silver chloride (AgCl).

Embodiment 131 is the electrochemical cell of embodiment 130, wherein the at least one auxiliary electrode comprises approximately 50 percent or less AgCl relative to Ag.

Embodiment 132 is the electrochemical cell of embodiment 130, wherein the first substance has a molar ratio relative to the second substance within a specified range.

Embodiment 133 is the electrochemical cell of embodiment 132, wherein the molar ratio is approximately equal to or greater than 50%.

Embodiment 134 is the electrochemical cell of any of embodiments 110-133, wherein the electrochemical analysis comprises electrochemiluminescence (ECL) analysis.

Embodiment 135 is the electrochemical cell of any of embodiments 110-134, wherein the electrochemical analysis involves a reduction or oxidation of an amount of one or more chemical moieties, and the at least one auxiliary electrode is configured to maintain a controlled interfacial potential until all of the chemical moieties have been oxidized or reduced.

Embodiment 136 is the electrochemical cell of any of embodiments 110-135, wherein the electrochemical cell is part of a flow cell.

Embodiment 137 is the electrochemical cell of any of embodiments 110-135, wherein the electrochemical cell is part of a plate.

Embodiment 138 is the electrochemical cell of any of embodiments 110-135, wherein the electrochemical cell is part of a cartridge.

Embodiment 139 is an electrochemical cell for performing electrochemical analysis, the apparatus comprising: a plurality of working electrode zones disposed, and defining a pattern, on a surface of the cell; and at least one auxiliary electrode disposed on the surface, the at least one auxiliary electrode having a redox couple confined to its surface, wherein when an applied potential is introduced to the cell during the electrochemical analysis, a reaction of a species in the redox couple is a predominate redox reaction occurring at the auxiliary electrode.

Embodiment 140 is the electrochemical cell of embodiment 139, wherein the applied potential is less than a defined potential required to reduce water or perform electrolysis of water.

Embodiment 141 is the electrochemical cell of embodiment 140, wherein less than 1 percent of current is associated with the reduction of water.

Embodiment 142 is the electrochemical cell of embodiment 140, wherein less than 1 of current per unit area of the auxiliary electrode is associated with the reduction of water.

Embodiment 143 is the electrochemical cell of embodiment 139, wherein, during the electrochemical analysis, the auxiliary electrode has a potential defined by the redox couple.

Embodiment 144 is the electrochemical cell of embodiment 143, wherein the potential ranges from approximately 0.1 volts (V) to approximately 3.0 V.

Embodiment 145 is the electrochemical cell of embodiment 144, wherein the potential is approximately 0.22 V.

Embodiment 146 is the electrochemical cell of embodiment 139, wherein the plurality of working electrode zones have an aggregate exposed area, the at least one auxiliary electrode has an exposed surface area, and the aggregate exposed area of the plurality of working electrode zones divided by the exposed surface area of the at least one auxiliary electrode define an area ratio that has a value greater than 1.

Embodiment 147 is the electrochemical cell of embodiment 139, wherein the pattern minimizes a number of working electrode zones that are adjacent to one another for each of the working electrode zones among the plurality of working electrode zones.

Embodiment 148 is the electrochemical cell of embodiment 139, wherein the number of working electrode zones that are adjacent to one another is no greater than two.

Embodiment 149 is the electrochemical cell of embodiment 139, wherein at least one of the plurality of working electrode zones is adjacent to three or more other working electrode zones among the plurality of working electrode zones.

Embodiment 150 is the electrochemical cell of embodiment 139, wherein the pattern is configured to provide uniform mass transport of a substance to each of the plurality of working electrode zones under conditions of rotational shaking.

Embodiment 151 is the electrochemical cell of embodiment 139, wherein the pattern comprises a geometric pattern.

Embodiment 152 is the electrochemical cell of any of embodiments 139-151, wherein each of the plurality of working electrode zones defines a circular shape having surface area that defines a circle.

Embodiment 153 is the electrochemical cell of any of embodiments 139-152, wherein the plurality of working electrode zones comprises a plurality of electrically isolated zones formed on a single electrode.

Embodiment 154 is the electrochemical cell of embodiment 139, wherein the redox couple comprises a mixture of silver (Ag) and silver chloride (AgCl).

Embodiment 155 is the electrochemical cell of embodiment 154, wherein the mixture of Ag and AgCl comprises approximately 50 percent or less AgCl.

Embodiment 156 is the electrochemical cell of embodiment 154, wherein the mixture has a molar ratio of Ag to AgCl within a specified range.

Embodiment 157 is the electrochemical cell of embodiment 156, wherein the molar ratio is approximately equal to or greater than 1.

Embodiment 158 is the electrochemical cell of any of embodiments 139-157, wherein the electrochemical analysis comprises electrochemiluminescence (ECL) analysis.

Embodiment 159 is the electrochemical cell of any of embodiments 139-158, wherein the electrochemical analysis involves a reduction or oxidation of an amount of one or more chemical moieties, and the at least one auxiliary electrode is configured to maintain a controlled interfacial potential until all of the chemical moieties have been oxidized or reduced.

Embodiment 160 is the electrochemical cell of any of embodiments 139-159, wherein the electrochemical cell is part of a flow cell.

Embodiment 161 is the electrochemical cell of any of embodiments 139-159, wherein the electrochemical cell is part of a plate.

Embodiment 162 is the electrochemical cell of any of embodiments 139-159, wherein the electrochemical cell is part of a cartridge.

Embodiment 163 is a method for performing electrochemical analysis, the method comprising: applying a voltage pulse to one or more working electrode zones and at least one auxiliary electrode in an electrochemical cell, wherein: the one or more working electrode zones define a pattern on a surface of the cell, the at least one auxiliary electrode is disposed on the surface and has a redox couple confined to its surface, the at least one auxiliary electrode is disposed at an approximate equal distance from at least two of the plurality of working electrode zones, and during the voltage pulse, a potential at the auxiliary electrode is defined by the redox couple; capturing luminescence data over a period of time; and reporting the luminescence data.

Embodiment 164 is the method of embodiment 163, wherein the luminescence data includes electrochemical luminescence data.

Embodiment 165 is the method of embodiment 163, the method further comprising:
analyzing the luminescence data.

Embodiment 166 is the method of embodiment 163, wherein the luminescence data is captured during a duration of the voltage pulse.

Embodiment 167 is the method of embodiment 166, wherein the luminescence data is captured during at least 50 percent of the duration of the voltage pulse.

Embodiment 168 is the method of embodiment 166, wherein the luminescence data is captured during at least 75 percent of the duration of the voltage pulse.

Embodiment 169 is the method of embodiment 166, wherein the luminescence data is captured during at least 100 percent of the duration of the voltage pulse.

Embodiment 170 is the method of embodiment 163, wherein a duration of the voltage pulse is less than or equal to approximately 200 milliseconds (ms).

Embodiment 171 is the method of embodiment 170, wherein the duration of the voltage pulse is approximately 100 ms.

Embodiment 172 is the method of embodiment 170, wherein the duration of the voltage pulse is approximately 50 ms.

Embodiment 173 is the method of embodiment 163, wherein the voltage pulse is applied to the one or more working electrodes and the at least one auxiliary electrode concurrently.

Embodiment 174 is the method of embodiment 173, wherein a read time for capturing the luminescence data ranges and reporting the luminescence data for an entirety of the one or more working electrodes ranges from approximately 66 seconds to approximately 81 seconds.

Embodiment 175 is the method of embodiment 173, wherein a read time for capturing the luminescence data ranges and reporting the luminescence data for an entirety of the one or more working electrodes ranges from approximately 45 seconds to approximately 49 seconds.

Embodiment 176 is the method of embodiment 173, wherein a read time for capturing the luminescence data ranges and reporting the luminescence data for an entirety of the one or more working electrodes ranges from approximately 51 seconds to approximately 52 seconds.

Embodiment 177 is the method of embodiment 163, wherein the voltage pulse is applied to the one or more working electrodes and the at least one auxiliary electrode sequentially.

Embodiment 178 is the method of embodiment 177, wherein a read time for capturing the luminescence data ranges and reporting the luminescence data for an entirety of the one or more working electrodes ranges from approximately 114 seconds to approximately 258 seconds.

Embodiment 179 is the method of embodiment 177, wherein a read time for capturing the luminescence data ranges and reporting the luminescence data for an entirety of the one or more working electrodes ranges from approximately 57 seconds to approximately 93 seconds.

Embodiment 180 is the method of embodiment 177, wherein a read time for capturing the luminescence data ranges and reporting the luminescence data for an entirety of the one or more working electrodes ranges from approximately 54 seconds to approximately 63 seconds.

Embodiment 181 is the method of embodiment 163, wherein a read time for capturing the luminescence data and reporting the luminescence data increases with an increase of a duration of the voltage pulse.

Embodiment 182 is the method of any of embodiments 163-181, wherein the voltage pulse is applied to an addressable subset of the one or more working electrode zones.

Embodiment 183 is the method of any of embodiments 163-182, the method further comprising: selecting a magnitude of the voltage pulse based at least in part on a chemical composition of the at least one auxiliary electrode.

Embodiment 184 is a computer readable medium storing instructions that cause one or more processors to perform any one of the method of embodiments 163-183.

Embodiment 185 is a method for performing electrochemical analysis, the method comprising: applying a voltage pulse to one or more working electrode zones and at least one auxiliary electrode in an electrochemical cell, wherein: the one or more working electrode zones define a pattern, on a surface of the cell, the at least one auxiliary electrode is disposed on the surface, the at least auxiliary electrode has a redox couple confined to its surface with a standard redox potential, and the redox couple provides a quantifiable amount of coulombs per unit of the at least one auxiliary electrode's surface area throughout a redox reaction of the redox couple; capturing luminescence data over a period of time; and reporting the luminescence data.

Embodiment 186 is the method of embodiment 185, wherein the luminescence data includes electrochemical luminescence data.

Embodiment 187 is the method of embodiment 185, the method further comprising:
analyzing the luminescence data.

Embodiment 188 is the method of embodiment 185, wherein the luminescence data is captured during a duration of the voltage pulse.

Embodiment 189 is the method of embodiment 188, wherein the luminescence data is captured during at least 50 percent of the duration of the voltage pulse.

Embodiment 190 is the method of embodiment 188, wherein the luminescence data is captured during at least 75 percent of the duration of the voltage pulse.

Embodiment 191 is the method of embodiment 188, wherein the luminescence data is captured during at least 100 percent of the duration of the voltage pulse.

Embodiment 192 is the method of embodiment 185, wherein a duration of the voltage pulse is less than or equal to approximately 200 milliseconds (ms).

Embodiment 193 is the method of embodiment 192, wherein the duration of the voltage pulse is approximately 100 ms.

Embodiment 194 is the method of embodiment 192, wherein the duration of the voltage pulse is approximately 50 ms.

Embodiment 195 is the method of embodiment 185, wherein the voltage pulse is applied to the one or more working electrodes and the at least one auxiliary electrode concurrently.

Embodiment 196 is the method of embodiment 195, wherein a read time for capturing the luminescence data ranges and reporting the luminescence data for an entirety of the one or more working electrodes ranges from approximately 66 seconds to approximately 81 seconds.

Embodiment 197 is the method of embodiment 195, wherein a read time for capturing the luminescence data ranges and reporting the luminescence data for an entirety of the one or more working electrodes ranges from approximately 45 seconds to approximately 49 seconds.

Embodiment 198 is the method of embodiment 195, wherein a read time for capturing the luminescence data ranges and reporting the luminescence data for an entirety of the one or more working electrodes ranges from approximately 51 seconds to approximately 52 seconds.

Embodiment 199 is the method of embodiment 185, wherein the voltage pulse is applied to the one or more working electrodes and the at least one auxiliary electrode sequentially.

Embodiment 200 is the method of embodiment 199, wherein a read time for capturing the luminescence data ranges and reporting the luminescence data for an entirety of the one or more working electrodes ranges from approximately 114 seconds to approximately 258 seconds.

Embodiment 201 is the method of embodiment 199, wherein a read time for capturing the luminescence data ranges and reporting the luminescence data for an entirety of the one or more working electrodes ranges from approximately 57 seconds to approximately 93 seconds.

Embodiment 202 is the method of embodiment 199, wherein a read time for capturing the luminescence data ranges and reporting the luminescence data for an entirety of the one or more working electrodes ranges from approximately 54 seconds to approximately 63 seconds.

Embodiment 203 is the method of embodiment 185, wherein a read time for capturing the luminescence data and reporting the luminescence data increases with an increase of a duration of the voltage pulse.

Embodiment 204 is the method of any of embodiments 185-203, wherein the voltage pulse is applied to an addressable subset of the one or more working electrode zones.

Embodiment 205 is the method of any of embodiments 185-204, the method further comprising: selecting a magnitude of the voltage pulse based at least in part on a chemical composition of the at least one auxiliary electrode.

Embodiment 206 is a computer readable medium storing instructions that cause one or more processors to perform any one of the method of embodiments 185-205.

Embodiment 207 is a method for performing electrochemical analysis, the method comprising: applying a voltage pulse to one or more working electrode zones and an auxiliary electrode in an electrochemical cell, wherein: the one or more working electrode zones define a pattern on a surface of the electrochemical cell, the at least one auxiliary electrode is disposed on the surface and is formed of a chemical mixture comprising an oxidizing agent, the at least one auxiliary electrode has a redox couple confined to its surface, and during the voltage pulse, an amount of the oxidizing agent is sufficient to maintain a potential throughout an entire redox reaction of the redox couple; capturing luminescence data over a period of time; and reporting the luminescence data.

Embodiment 208 is the method of embodiment 207, wherein the luminescence data includes electrochemical luminescence data.

Embodiment 209 is the method of embodiment 207, the method further comprising: analyzing the luminescence data.

Embodiment 210 is the method of embodiment 207, wherein the luminescence data is captured during a duration of the voltage pulse.

Embodiment 211 is the method of embodiment 210, wherein the luminescence data is captured during at least 50 percent of the duration of the voltage pulse.

Embodiment 212 is the method of embodiment 210, wherein the luminescence data is captured during at least 75 percent of the duration of the voltage pulse.

Embodiment 213 is the method of embodiment 210, wherein the luminescence data is captured during at least 100 percent of the duration of the voltage pulse.

Embodiment 214 is the method of embodiment 207, wherein a duration of the voltage pulse is less than or equal to approximately 200 milliseconds (ms).

Embodiment 215 is the method of embodiment 214, wherein the duration of the voltage pulse is approximately 100 ms.

Embodiment 216 is the method of embodiment 214, wherein the duration of the voltage pulse is approximately 50 ms.

Embodiment 217 is the method of embodiment 207, wherein the voltage pulse is applied to the one or more working electrodes and the at least one auxiliary electrode concurrently.

Embodiment 218 is the method of embodiment 217, wherein a read time for capturing the luminescence data ranges and reporting the luminescence data for an entirety of the one or more working electrodes ranges from approximately 66 seconds to approximately 81 seconds.

Embodiment 219 is the method of embodiment 217, wherein a read time for capturing the luminescence data ranges and reporting the luminescence data for an entirety of the one or more working electrodes ranges from approximately 45 seconds to approximately 49 seconds.

Embodiment 220 is the method of embodiment 217, wherein a read time for capturing the luminescence data ranges and reporting the luminescence data for an entirety of the one or more working electrodes ranges from approximately 51 seconds to approximately 52 seconds.

Embodiment 221 is the method of embodiment 207, wherein the voltage pulse is applied to the one or more working electrodes and the at least one auxiliary electrode sequentially.

Embodiment 222 is the method of embodiment 221, wherein a read time for capturing the luminescence data ranges and reporting the luminescence data for an entirety of the one or more working electrodes ranges from approximately 114 seconds to approximately 258 seconds.

Embodiment 223 is the method of embodiment 221, wherein a read time for capturing the luminescence data ranges and reporting the luminescence data for an entirety of the one or more working electrodes ranges from approximately 57 seconds to approximately 93 seconds.

Embodiment 224 is the method of embodiment 221, wherein a read time for capturing the luminescence data ranges and reporting the luminescence data for an entirety of the one or more working electrodes ranges from approximately 54 seconds to approximately 63 seconds.

Embodiment 225 is the method of embodiment 207, wherein a read time for capturing the luminescence data and reporting the luminescence data increases with an increase of a duration of the voltage pulse.

Embodiment 226 is the method of any of embodiments 207-225, wherein the voltage pulse is applied to an addressable subset of the one or more working electrode zones.

Embodiment 227 is the method of any of embodiments 207-226, the method further comprising: selecting a magnitude of the voltage pulse based at least in part on a chemical composition of the at least one auxiliary electrode.

Embodiment 228. A computer readable medium storing instructions that cause one or more processors to perform any one of the method of embodiments 207-227.

Embodiment 229. A method for performing electrochemical analysis, the method comprising: applying a voltage pulse to one or more working electrode zones and at least one auxiliary electrode in an electrochemical cell, wherein: the one or more working electrode zones define a pattern on a surface of the cell, the at least one auxiliary electrode is disposed on the surface, and the auxiliary electrode has a defined interfacial potential during the voltage pulse; capturing luminescence data over a period of time; and reporting the luminescence data.

Embodiment 230 is the method of embodiment 229, wherein the luminescence data includes electrochemical luminescence data.

Embodiment 231 is the method of embodiment 229, the method further comprising: analyzing the luminescence data.

Embodiment 232 is the method of embodiment 229, wherein the luminescence data is captured during a duration of the voltage pulse.

Embodiment 233 is the method of embodiment 232, wherein the luminescence data is captured during at least 50 percent of the duration of the voltage pulse.

Embodiment 234 is the method of embodiment 232, wherein the luminescence data is captured during at least 75 percent of the duration of the voltage pulse.

Embodiment 235 is the method of embodiment 232, wherein the luminescence data is captured during at least 100 percent of the duration of the voltage pulse.

Embodiment 236 is the method of embodiment 229, wherein a duration of the voltage pulse is less than or equal to approximately 200 milliseconds (ms).

Embodiment 237 is the method of embodiment 236, wherein the duration of the voltage pulse is approximately 100 ms.

Embodiment 238 is the method of embodiment 236, wherein the duration of the voltage pulse is approximately 50 ms.

Embodiment 239 is the method of embodiment 229, wherein the voltage pulse is applied to the one or more working electrodes and the at least one auxiliary electrode concurrently.

Embodiment 240 is the method of embodiment 239, wherein a read time for capturing the luminescence data ranges and reporting the luminescence data for an entirety of the one or more working electrodes ranges from approximately 66 seconds to approximately 81 seconds.

Embodiment 241 is the method of embodiment 239, wherein a read time for capturing the luminescence data ranges and reporting the luminescence data for an entirety of the one or more working electrodes ranges from approximately 45 seconds to approximately 49 seconds.

Embodiment 242 is the method of embodiment 239, wherein a read time for capturing the luminescence data ranges and reporting the luminescence data for an entirety of the one or more working electrodes ranges from approximately 51 seconds to approximately 52 seconds.

Embodiment 243 is the method of embodiment 229, wherein the voltage pulse is applied to the one or more working electrodes and the at least one auxiliary electrode sequentially.

Embodiment 244 is the method of embodiment 243, wherein a read time for capturing the luminescence data ranges and reporting the luminescence data for an entirety of the one or more working electrodes ranges from approximately 114 seconds to approximately 258 seconds.

Embodiment 245 is the method of embodiment 243, wherein a read time for capturing the luminescence data ranges and reporting the luminescence data for an entirety of the one or more working electrodes ranges from approximately 57 seconds to approximately 93 seconds.

Embodiment 246 is the method of embodiment 243, wherein a read time for capturing the luminescence data ranges and reporting the luminescence data for an entirety of the one or more working electrodes ranges from approximately 54 seconds to approximately 63 seconds.

Embodiment 247 is the method of embodiment 229, wherein a read time for capturing the luminescence data and reporting the luminescence data increases with an increase of a duration of the voltage pulse.

Embodiment 248 is the method of any of embodiments 229-247, wherein the voltage pulse is applied to an addressable subset of the one or more working electrode zones.

Embodiment 249 is the method of any of embodiments 229-248, the method further comprising: selecting a magnitude of the voltage pulse based at least in part on a chemical composition of the at least one auxiliary electrode

Embodiment 250 is a computer readable medium storing instructions that cause one or more processors to perform any one of the method of embodiments 229-249.

Embodiment 251 is a method for performing electrochemical analysis, the method comprising: applying a voltage pulse to one or more working electrode zones and at least one auxiliary electrode in an electrochemical cell, wherein: the one or more working electrode zones define a pattern on a surface of the electrochemical cell, the at least one auxiliary electrode is disposed on the surface and comprises a first substance and a second substance, and the second substance is a redox couple of the first substance; capturing luminescence data over a period of time; and reporting the luminescence data.

Embodiment 252 is the method of embodiment 251, wherein the luminescence data includes electrochemical luminescence data.

Embodiment 253 is the method of embodiment 251, the method further comprising: analyzing the luminescence data.

Embodiment 254 is the method of embodiment 251, wherein the luminescence data is captured during a duration of the voltage pulse.

Embodiment 255 is the method of embodiment 254, wherein the luminescence data is captured during at least 50 percent of the duration of the voltage pulse.

Embodiment 256 is the method of embodiment 254, wherein the luminescence data is captured during at least 75 percent of the duration of the voltage pulse.

Embodiment 257 is the method of embodiment 254, wherein the luminescence data is captured during at least 100 percent of the duration of the voltage pulse.

Embodiment 258 is the method of embodiment 251, wherein a duration of the voltage pulse is less than or equal to approximately 200 milliseconds (ms).

Embodiment 259 is the method of embodiment 258, wherein the duration of the voltage pulse is approximately 100 ms.

Embodiment 260 is the method of embodiment 258, wherein the duration of the voltage pulse is approximately 50 ms.

Embodiment 261 is the method of embodiment 251, wherein the voltage pulse is applied to the one or more working electrodes and the at least one auxiliary electrode concurrently.

Embodiment 262 is the method of embodiment 261, wherein a read time for capturing the luminescence data ranges and reporting the luminescence data for an entirety of the one or more working electrodes ranges from approximately 66 seconds to approximately 81 seconds.

Embodiment 263 is the method of embodiment 261, wherein a read time for capturing the luminescence data ranges and reporting the luminescence data for an entirety of the one or more working electrodes ranges from approximately 45 seconds to approximately 49 seconds.

Embodiment 264 is the method of embodiment 261, wherein a read time for capturing the luminescence data ranges and reporting the luminescence data for an entirety of the one or more working electrodes ranges from approximately 51 seconds to approximately 52 seconds.

Embodiment 265 is the method of embodiment 251, wherein the voltage pulse is applied to the one or more working electrodes and the at least one auxiliary electrode sequentially.

Embodiment 266 is the method of embodiment 265, wherein a read time for capturing the luminescence data ranges and reporting the luminescence data for an entirety of the one or more working electrodes ranges from approximately 114 seconds to approximately 258 seconds.

Embodiment 267 is the method of embodiment 265, wherein a read time for capturing the luminescence data ranges and reporting the luminescence data for an entirety of the one or more working electrodes ranges from approximately 57 seconds to approximately 93 seconds.

Embodiment 268 is the method of embodiment 265, wherein a read time for capturing the luminescence data ranges and reporting the luminescence data for an entirety of the one or more working electrodes ranges from approximately 54 seconds to approximately 63 seconds.

Embodiment 269 is the method of embodiment 251, wherein a read time for capturing the luminescence data and reporting the luminescence data increases with an increase of a duration of the voltage pulse.

Embodiment 270 is the method of any of embodiments 251-269, wherein the voltage pulse is applied to an addressable subset of the one or more working electrode zones.

Embodiment 271 is the method of any of embodiments 251-270, the method further comprising: selecting a magnitude of the voltage pulse based at least in part on a chemical composition of the at least one auxiliary electrode.

Embodiment 272 is a computer readable medium storing instructions that cause one or more processors to perform any one of the method of embodiments 251-271.

Embodiment 273 is a method for performing electrochemical analysis, the method comprising: applying a voltage pulse to one or more working electrode zones and an auxiliary electrode in an electrochemical cell, wherein: the one or more working electrode zones define a pattern on a surface of the electrochemical cell, the at least one auxiliary electrode is disposed on the surface and has a potential defined by a redox couple confined to its surface, wherein, during the voltage pulse, and a reaction of a species in the redox couple is a predominate redox reaction occurring at the auxiliary electrode; capturing luminescence over a period of time; and reporting the luminescence data.

Embodiment 274 is the method of embodiment 273, wherein the luminescence data includes electrochemical luminescence data.

Embodiment 275 is the method of embodiment 273, the method further comprising:
analyzing the luminescence data.

Embodiment 276 is the method of embodiment 273, wherein the luminescence data is captured during a duration of the voltage pulse.

Embodiment 277 is the method of embodiment 276, wherein the luminescence data is captured during at least 50 percent of the duration of the voltage pulse.

Embodiment 278 is the method of embodiment 276, wherein the luminescence data is captured during at least 75 percent of the duration of the voltage pulse.

Embodiment 279 is the method of embodiment 276, wherein the luminescence data is captured during at least 100 percent of the duration of the voltage pulse.

Embodiment 280 is the method of embodiment 273, wherein a duration of the voltage pulse is less than or equal to approximately 200 milliseconds (ms).

Embodiment 281 is the method of embodiment 280, wherein the duration of the voltage pulse is approximately 100 ms.

Embodiment 282 is the method of embodiment 280, wherein the duration of the voltage pulse is approximately 50 ms.

Embodiment 283 is the method of embodiment 273, wherein the voltage pulse is applied to the one or more working electrodes and the at least one auxiliary electrode concurrently.

Embodiment 284 is the method of embodiment 283, wherein a read time for capturing the luminescence data ranges and reporting the luminescence data for an entirety of the one or more working electrodes ranges from approximately 66 seconds to approximately 81 seconds.

Embodiment 285 is the method of embodiment 283, wherein a read time for capturing the luminescence data ranges and reporting the luminescence data for an entirety of the one or more working electrodes ranges from approximately 45 seconds to approximately 49 seconds.

Embodiment 286 is the method of embodiment 283, wherein a read time for capturing the luminescence data ranges and reporting the luminescence data for an entirety of the one or more working electrodes ranges from approximately 51 seconds to approximately 52 seconds.

Embodiment 287 is the method of embodiment 273, wherein the voltage pulse is applied to the one or more working electrodes and the at least one auxiliary electrode sequentially.

Embodiment 288 is the method of embodiment 287, wherein a read time for capturing the luminescence data ranges and reporting the luminescence data for an entirety of the one or more working electrodes ranges from approximately 114 seconds to approximately 258 seconds.

Embodiment 289 is the method of embodiment 287, wherein a read time for capturing the luminescence data ranges and reporting the luminescence data for an entirety of the one or more working electrodes ranges from approximately 57 seconds to approximately 93 seconds.

Embodiment 290 is the method of embodiment 287, wherein a read time for capturing the luminescence data ranges and reporting the luminescence data for an entirety of the one or more working electrodes ranges from approximately 54 seconds to approximately 63 seconds.

Embodiment 291 is the method of embodiment 273, wherein a read time for capturing the luminescence data and reporting the luminescence data increases with an increase of a duration of the voltage pulse.

Embodiment 292 is the method of any of embodiments 273-291, wherein the voltage pulse is applied to an addressable subset of the one or more working electrode zones.

Embodiment 293 is the method of any of embodiments 273-292, the method further comprising: selecting a magnitude of the voltage pulse based at least in part on a chemical composition of the at least one auxiliary electrode.

Embodiment 294 is a computer readable medium storing instructions that cause one or more processors to perform any one of the method of embodiments 273-293.

Embodiment 295 is a method for electrochemical analysis, the method comprising: applying a voltage pulse to one or more working electrode zones and at least one auxiliary electrode, wherein: the one or more working electrode zones define a pattern on a surface of the cell, the at least one auxiliary electrode is disposed on the surface and has a redox couple confined to its surface, and the redox couple is reduced at least during a period for which the voltage pulse is applied.

Embodiment 296 is the method of embodiment 295, wherein the luminescence data is captured during a duration of the voltage pulse.

Embodiment 297 is the method of embodiment 296, wherein the luminescence data is captured during at least 50 percent of the duration of the voltage pulse.

Embodiment 298 is the method of embodiment 296, wherein the luminescence data is captured during at least 75 percent of the duration of the voltage pulse.

Embodiment 299 is the method of embodiment 296, wherein the luminescence data is captured during at least 100 percent of the duration of the voltage pulse.

Embodiment 300 is the method of embodiment 295, wherein a duration of the voltage pulse is less than or equal to approximately 200 milliseconds (ms).

Embodiment 301 is the method of embodiment 300, wherein the duration of the voltage pulse is approximately 100 ms.

Embodiment 302 is the method of embodiment 300, wherein the duration of the voltage pulse is approximately 50 ms.

Embodiment 303 is the method of embodiment 295, wherein the voltage pulse is applied to the one or more working electrodes and the at least one auxiliary electrode concurrently.

Embodiment 304 is the method of embodiment 295, wherein the voltage pulse is applied to the one or more working electrodes and the at least one auxiliary electrode sequentially.

Embodiment 305 is the method of any of embodiments 295-304, wherein the voltage pulse is applied to an addressable subset of the one or more working electrode zones.

Embodiment 306 is the method of any of embodiments 295-305, the method further comprising: selecting a magnitude of the voltage pulse based at least in part on a chemical composition of the at least one auxiliary electrode.

Embodiment 307 is a computer readable medium storing instructions that cause one or more processors to perform any one of the method of embodiments 295-306.

Embodiment 308 is a method for electrochemical analysis, the method comprising: applying a voltage pulse to one or more working electrode zones and at least one auxiliary electrode, the one or more working electrode zones define a pattern, on a surface of the cell, the at least one auxiliary electrode is disposed on the surface, the auxiliary electrode has a redox couple confined to its surface with a standard redox potential, the redox couple provides a quantifiable amount of coulombs per unit of the at least one auxiliary electrode's surface area throughout a redox reaction of the redox couple, and the redox couple is reduced at least during a period for which the voltage pulse is applied.

Embodiment 309 is the method of embodiment 308, wherein the luminescence data is captured during a duration of the voltage pulse.

Embodiment 310 is the method of embodiment 309, wherein the luminescence data is captured during at least 50 percent of the duration of the voltage pulse.

Embodiment 311 is the method of embodiment 309, wherein the luminescence data is captured during at least 75 percent of the duration of the voltage pulse.

Embodiment 312 is the method of embodiment 309, wherein the luminescence data is captured during at least 100 percent of the duration of the voltage pulse.

Embodiment 313 is the method of embodiment 308, wherein a duration of the voltage pulse is less than or equal to approximately 200 milliseconds (ms).

Embodiment 314 is the method of embodiment 313, wherein the duration of the voltage pulse is approximately 100 ms.

Embodiment 315 is the method of embodiment 313, wherein the duration of the voltage pulse is approximately 50 ms.

Embodiment 316 is the method of embodiment 308, wherein the voltage pulse is applied to the one or more working electrodes and the at least one auxiliary electrode concurrently.

Embodiment 317 is the method of embodiment 308, wherein the voltage pulse is applied to the one or more working electrodes and the at least one auxiliary electrode sequentially.

Embodiment 318 is the method of any of embodiments 308-317, wherein the voltage pulse is applied to an addressable subset of the one or more working electrode zones.

Embodiment 319 is the method of any of embodiments 308-318, the method further comprising: selecting a magnitude of the voltage pulse based at least in part on a chemical composition of the at least one auxiliary electrode.

Embodiment 320 is a computer readable medium storing instructions that cause one or more processors to perform any one of the method of embodiments 308-319.

Embodiment 321 is a method for electrochemical analysis, the method comprising: applying a voltage pulse to one or more working electrode zones and at least one auxiliary electrode, wherein: the one or more working electrode zones define a pattern on a surface of the electrochemical cell, the at least one auxiliary electrode is disposed on the surface and is formed of a chemical mixture comprising an oxidizing agent, the at least one auxiliary electrode has a redox couple confined to its surface, during the voltage pulse, an amount of the oxidizing agent is sufficient to maintain a potential throughout an entire redox reaction of the redox couple, and the redox couple is reduced at least during a period for which the voltage pulse is applied.

Embodiment 322 is the method of embodiment 321, wherein the luminescence data is captured during a duration of the voltage pulse.

Embodiment 323 is the method of embodiment 322, wherein the luminescence data is captured during at least 50 percent of the duration of the voltage pulse.

Embodiment 324 is the method of embodiment 322, wherein the luminescence data is captured during at least 75 percent of the duration of the voltage pulse.

Embodiment 325 is the method of embodiment 322, wherein the luminescence data is captured during at least 100 percent of the duration of the voltage pulse.

Embodiment 326 is the method of embodiment 321, wherein a duration of the voltage pulse is less than or equal to approximately 200 milliseconds (ms).

Embodiment 327 is the method of embodiment 326, wherein the duration of the voltage pulse is approximately 100 ms.

Embodiment 328 is the method of embodiment 326, wherein the duration of the voltage pulse is approximately 50 ms.

Embodiment 329 is the method of embodiment 321, wherein the voltage pulse is applied to the one or more working electrodes and the at least one auxiliary electrode concurrently.

Embodiment 330 is the method of embodiment 321, wherein the voltage pulse is applied to the one or more working electrodes and the at least one auxiliary electrode sequentially.

Embodiment 331 is the method of any of embodiments 321-330, wherein the voltage pulse is applied to an addressable subset of the one or more working electrode zones.

Embodiment 332 is the method of any of embodiments 321-331, the method further comprising: selecting a magnitude of the voltage pulse based at least in part on a chemical composition of the at least one auxiliary electrode.

Embodiment 333 is a computer readable medium storing instructions that cause one or more processors to perform any one of the method of embodiments 321-332.

Embodiment 334 is a method for electrochemical analysis, the method comprising: applying a voltage pulse to one or more working electrode zones and at least one auxiliary electrode, wherein: the one or more working electrode zones define a pattern on a surface of the cell, the at least one auxiliary electrode is disposed on the surface, and the auxiliary electrode has a defined interfacial potential during the voltage pulse.

Embodiment 335 is the method of embodiment 334, wherein the luminescence data is captured during a duration of the voltage pulse.

Embodiment 336 is the method of embodiment 335, wherein the luminescence data is captured during at least 50 percent of the duration of the voltage pulse.

Embodiment 337 is the method of embodiment 335, wherein the luminescence data is captured during at least 75 percent of the duration of the voltage pulse.

Embodiment 338 is the method of embodiment 335, wherein the luminescence data is captured during at least 100 percent of the duration of the voltage pulse.

Embodiment 339 is the method of embodiment 334, wherein a duration of the voltage pulse is less than or equal to approximately 200 milliseconds (ms).

Embodiment 340 is the method of embodiment 339, wherein the duration of the voltage pulse is approximately 100 ms.

Embodiment 341 is the method of embodiment 339, wherein the duration of the voltage pulse is approximately 50 ms.

Embodiment 342 is the method of embodiment 334, wherein the voltage pulse is applied to the one or more working electrodes and the at least one auxiliary electrode concurrently.

Embodiment 343 is the method of embodiment 334, wherein the voltage pulse is applied to the one or more working electrodes and the at least one auxiliary electrode sequentially.

Embodiment 344 is the method of any of embodiments 334-343, wherein the voltage pulse is applied to an addressable subset of the one or more working electrode zones.

Embodiment 345 is the method of any of embodiments 334-344, the method further comprising: selecting a magnitude of the voltage pulse based at least in part on a chemical composition of the at least one auxiliary electrode.

Embodiment 346 is a computer readable medium storing instructions that cause one or more processors to perform any one of the method of embodiments 334-345.

Embodiment 347 is a method for electrochemical analysis, the method comprising: applying a voltage pulse to one or more working electrode zones and at least one auxiliary electrode, wherein: the one or more working electrode zones define a pattern on a surface of the electrochemical cell, the at least one auxiliary electrode is disposed on the surface and comprises a first substance and a second substance, the second substance is a redox couple of the first substance, and the redox couple is reduced at least during a period for which the voltage pulse is applied.

Embodiment 348 is the method of embodiment 347, wherein the luminescence data is captured during a duration of the voltage pulse.

Embodiment 349 is the method of embodiment 348, wherein the luminescence data is captured during at least 50 percent of the duration of the voltage pulse.

Embodiment 350 is the method of embodiment 348, wherein the luminescence data is captured during at least 75 percent of the duration of the voltage pulse.

Embodiment 351 is the method of embodiment 348, wherein the luminescence data is captured during at least 100 percent of the duration of the voltage pulse.

Embodiment 352 is the method of embodiment 347, wherein a duration of the voltage pulse is less than or equal to approximately 200 milliseconds (ms).

Embodiment 353 is the method of embodiment 352, wherein the duration of the voltage pulse is approximately 100 ms.

Embodiment 354 is the method of embodiment 352, wherein the duration of the voltage pulse is approximately 50 ms.

Embodiment 355 is the method of embodiment 347, wherein the voltage pulse is applied to the one or more working electrodes and the at least one auxiliary electrode concurrently.

Embodiment 356 is the method of embodiment 347, wherein the voltage pulse is applied to the one or more working electrodes and the at least one auxiliary electrode sequentially.

Embodiment 357 is the method of any of embodiments 347-356 wherein the voltage pulse is applied to an addressable subset of the one or more working electrode zones.

Embodiment 358 is the method of any of embodiments 347-357, the method further comprising: selecting a magnitude of the voltage pulse based at least in part on a chemical composition of the at least one auxiliary electrode.

Embodiment 359 is a computer readable medium storing instructions that cause one or more processors to perform any one of the method of embodiments 347-358.

Embodiment 360 is a method for electrochemical analysis, the method comprising: applying a voltage pulse to one or more working electrode zones and at least one auxiliary electrode, wherein: the one or more working electrode zones define a pattern on a surface of the electrochemical cell, the at least one auxiliary electrode is disposed on the surface and has a potential defined by a redox couple confined to its surface, wherein, during the voltage pulse, a reaction of a species in the redox couple is a predominate redox reaction occurring at the auxiliary electrode, and the redox couple is reduced at least during a period for which the voltage pulse is applied.

Embodiment 361 is the method of embodiment 347, wherein the luminescence data is captured during a duration of the voltage pulse.

Embodiment 362 is the method of embodiment 348, wherein the luminescence data is captured during at least 50 percent of the duration of the voltage pulse.

Embodiment 363 is the method of embodiment 348, wherein the luminescence data is captured during at least 75 percent of the duration of the voltage pulse.

Embodiment 364 is the method of embodiment 348, wherein the luminescence data is captured during at least 100 percent of the duration of the voltage pulse.

Embodiment 365 is the method of embodiment 347, wherein a duration of the voltage pulse is less than or equal to approximately 200 milliseconds (ms).

Embodiment 366 is the method of embodiment 352, wherein the duration of the voltage pulse is approximately 100 ms.

Embodiment 367 is the method of embodiment 352, wherein the duration of the voltage pulse is approximately 50 ms.

Embodiment 368 is the method of embodiment 347, wherein the voltage pulse is applied to the one or more working electrodes and the at least one auxiliary electrode concurrently.

Embodiment 369 is the method of embodiment 347, wherein the voltage pulse is applied to the one or more working electrodes and the at least one auxiliary electrode sequentially.

Embodiment 370 is the method of any of embodiments 347-356 wherein the voltage pulse is applied to an addressable subset of the one or more working electrode zones.

Embodiment 371 is the method of any of embodiments 347-357, the method further comprising: selecting a magnitude of the voltage pulse based at least in part on a chemical composition of the at least one auxiliary electrode.

Embodiment 372 is a computer readable medium storing instructions that cause one or more processors to perform any one of the method of embodiments 347-358.

Embodiment 373 is a kit comprising: at least one reagent; at least one read buffer; and an electrochemical cell, the electrochemical cell comprising: a plurality of working electrode zones disposed, and defining a pattern, on a surface of the cell, and at least one auxiliary electrode disposed on the surface, the at least one auxiliary electrode having a potential defined by a redox couple confined to its surface, wherein the at least one auxiliary electrode is disposed at an approximate equal distance from at least two of the plurality of working electrode zones.

Embodiment 374 is a kit comprising: at least one reagent; at least one read buffer; and an electrochemical cell, the electrochemical cell comprising: a plurality of working electrode zones disposed, and defining a pattern, on a surface of the cell, and at least one auxiliary electrode disposed on the surface, the auxiliary electrode having a redox couple confined to its surface with a standard redox potential, wherein the redox couple provides a quantifiable amount of coulombs per unit of the at least one auxiliary electrode's surface area throughout a redox reaction of the redox couple.

Embodiment 375 is a kit comprising: at least one reagent; at least one read buffer; and an electrochemical cell, the electrochemical cell comprising: a plurality of working electrode zones disposed, and defining a pattern, on a surface of the cell, and at least one auxiliary electrode disposed on the surface and formed of a chemical mixture comprising an oxidizing agent, the at least one auxiliary electrode having a potential defined by a redox couple confined to its surface, wherein an amount of the oxidizing agent is sufficient to maintain the defined potential throughout an entire redox reaction of the redox couple.

Embodiment 376 is a kit comprising: at least one reagent; at least one read buffer; and an electrochemical cell, the electrochemical cell comprising: a plurality of working electrode zones disposed, and defining a pattern, on a surface of the cell, and at least one auxiliary electrode disposed on the surface, the auxiliary electrode having a defined interfacial potential.

Embodiment 377 is a kit comprising: at least one reagent; at least one read buffer; and an electrochemical cell, the electrochemical cell comprising: a plurality of working electrode zones disposed, and defining a pattern, on a surface of the cell, and at least one auxiliary electrode disposed on the surface, the at least one auxiliary electrode comprising a first substance and a second substance, wherein the second substance is a redox couple of the first substance.

Embodiment 378 is a kit comprising: at least one reagent; at least one read buffer; and an electrochemical cell, the electrochemical cell comprising: a plurality of working electrode zones disposed, and defining a pattern, on a surface of the cell, and at least one auxiliary electrode disposed on the surface, the at least one auxiliary electrode having a potential defined by a redox couple confined to its surface, wherein when an applied potential is introduced to the at least one auxiliary electrode, the redox couple is a predominate redox reaction occurring in the cell.

Embodiment 379 is a multi-well plate comprising: a top plate having top plate openings and a base plate mated to said top plate to define wells of the multi-well plate, the base plate comprising: a substrate having a top surface with electrodes patterned thereon and a bottom surface with electrical contacts patterned thereon, the electrical contacts being positioned on the bottom surface between the wells of the multi-well plate, wherein said electrodes and contacts are patterned such that each well comprises: at least one working electrode on the top surface of the substrate, wherein the at least one working electrode is electrically connected to a first of the electrical contacts; and at least one auxiliary electrode on the top surface of the substrate, wherein: the at least one auxiliary electrode is electrically connected with a second of the electrical contacts and the at least one working and at least one counter electrode are electrically isolated, the at least one auxiliary electrode having a potential defined by a redox couple confined to its surface.

Embodiment 380 is the multi-well plate of embodiment 379, wherein the at least one working electrode comprises one or more working electrode zones formed thereon.

Embodiment 381 is the multi-well plate of embodiment 379, wherein the at least one auxiliary electrode is formed of a chemical mixture comprising an oxidizing agent that provides a defined potential during a reduction of the chemical mixture, wherein an amount of the oxidizing agent is sufficient to maintain the defined potential during an entire redox reaction.

Embodiment 382 is the multi-well plate of embodiment 381, wherein the amount of the oxidizing agent in the chemical mixture is greater than or equal to the amount of oxidizing agent required throughout the redox reactions in the at least one well during electrochemical reactions.

Embodiment 383 is the multi-well plate of embodiment 381, wherein the amount of the oxidizing agent in the chemical mixture is at least based in part on a ratio of an exposed surface area of the at least one working electrode zone to an exposed surface area of the at least one auxiliary electrode.

Embodiment 384 is the multi-well plate of embodiment 381, wherein the chemical mixture comprises a mixture of silver (Ag) and silver chloride (AgCl).

Embodiment 385 is the multi-well plate of embodiment 384, wherein the amount of oxidizing agent is at least based in part of the ratio of Ag to AgCl.

Embodiment 386 is the multi-well plate of embodiment 384, wherein the mixture of Ag and AgCl comprises approximately 50 percent or less AgCl.

Embodiment 387 is the multi-well plate of any of embodiments 379-386, wherein the multi-well plate is configured to be utilized in an electrochemiluminescence (ECL) device.

Embodiment 388 is a method of making the multi-well plate of embodiment 379, comprising: forming the at least one working electrode and the at least one auxiliary electrode in a defined pattern on the substrate.

Embodiment 389 is the multi-well plate of embodiment 379, wherein the potential is approximately 0.22 volts (V).

Embodiment 390 is a multi-well plate comprising: a top plate having top plate openings and a base plate mated to the top plate to define wells of the multi-well plate, the base plate comprising a substrate having a top surface with electrodes patterned thereon and a bottom surface with electrical contacts patterned thereon, wherein the electrodes and contacts are patterned to define one or more independently addressable sectors, each sector comprising one or more wells with: jointly addressable working electrodes on the top surface of the substrate, wherein each of the jointly addressable working electrodes is electrically connected with each other and connected to at least a first of the electrical contacts; and jointly addressable auxiliary electrodes on the top surface of the substrate, wherein each of the jointly addressable auxiliary electrodes is electrically connected with each other, but not with said working electrodes, and connected to at least a second of the electrical contacts, wherein: one or more of the jointly addressable auxiliary electrodes having a potential defined by a redox couple confined to its surface.

Embodiment 391 is the multi-well plate of embodiment 390, wherein the one or more of the jointly addressable working electrodes one or more working electrode zones.

Embodiment 392 is the multi-well plate of embodiment 390, wherein the one or more of the jointly addressable auxiliary electrodes are formed of a chemical mixture comprising an oxidizing agent that provides a defined potential during a reduction of the chemical mixture, wherein an amount of the oxidizing agent is sufficient to maintain the defined potential during an entire redox reaction.

Embodiment 393 is the multi-well plate of embodiment 392, wherein the amount of the oxidizing agent in the chemical mixture is greater than or equal to the amount of oxidizing agent required throughout the redox reactions in the at least one well during electrochemical reactions.

Embodiment 394 is the multi-well plate of embodiment 392, wherein the amount of the oxidizing agent in the chemical mixture is at least based in part on a ratio of an exposed surface area of each of the one or more of the jointly addressable working electrodes to an exposed surface area of the one or more of the jointly addressable auxiliary electrodes.

Embodiment 395 is the multi-well plate of embodiment 392, wherein the chemical mixture comprises a mixture of silver (Ag) and silver chloride (AgCl).

Embodiment 396 is the multi-well plate of embodiment 395, wherein the amount of oxidizing agent is at least based in part of the ratio of Ag to AgCl.

Embodiment 397 is the multi-well plate of embodiment 395, wherein the mixture of Ag and AgCl comprises approximately 50 percent or less AgCl.

Embodiment 398 is the multi-well plate of embodiment 390, wherein the potential is approximately 0.22 volts (V).

Embodiment 399 is the multi-well plate of any of embodiments 390-398, wherein the multi-well plate is configured to be utilized in an electrochemiluminescence (ECL) device.

Embodiment 400 is a method of making the multi-well plate of embodiment 390, comprising: forming the jointly addressable working electrodes and the jointly addressable auxiliary electrodes in a defined pattern on the substrate.

Embodiment 401 is an apparatus for performing electrochemical analysis, the apparatus comprising: a plate with a plurality of wells defined therein, at least one well from the plurality of wells comprising: a plurality of working electrode zones disposed on a bottom of the at least one well, wherein the plurality of working electrode zones define a pattern on a surface of the bottom of the at least one well; and at least one auxiliary electrode disposed on the surface, the at least one auxiliary electrode having a redox couple confined to its surface, wherein the at least one auxiliary electrode is disposed at an approximate equal distance from two or more of the plurality of working electrode zones.

Embodiment 402 is the apparatus of embodiment 401, wherein, during the electrochemical analysis, the auxiliary electrode has a standard reduction potential defined by the redox couple.

Embodiment 403 is the apparatus of embodiment 402, wherein the standard reduction potential ranges from approximately 0.1 volts (V) to approximately 3.0 V.

Embodiment 404 is the apparatus of embodiment 403, wherein the standard reduction potential is approximately 0.22 volts V.

Embodiment 405 is the apparatus of embodiment 401, wherein the electrochemical analysis involves the reduction or oxidation of an amount of one or more chemical moieties, and the at least one auxiliary electrode is configured to maintain a controlled interfacial potential until all of the chemical moieties have been oxidized or reduced.

Embodiment 406 is the apparatus of embodiment 401, wherein the plurality of working electrode zones have an aggregate exposed area, the at least one auxiliary electrode has an exposed surface area, and the aggregate exposed area of the plurality of working electrode zones divided by the exposed surface area of the at least one auxiliary electrode define an area ratio that has a value greater than 1.

Embodiment 407 is the apparatus of embodiment 401, wherein the pattern minimizes a number of working electrode zones that are adjacent to one another for each of the working electrode zones among the plurality of working electrode zones.

Embodiment 408 is the apparatus of embodiment 404, wherein the number of working electrode zones that are adjacent to one another is no greater than two.

Embodiment 409 is the apparatus of embodiment 401, wherein at least one of the plurality of working electrode zones is adjacent to three or more other working electrode zones among the plurality of working electrode zones.

Embodiment 410 is the apparatus of embodiment 401, wherein the pattern is configured to provide uniform mass transport of a substance to each of the plurality of working electrode zones under conditions of rotational shaking.

Embodiment 411 is the apparatus of embodiment 401, wherein the pattern does not include a working electrode zone from the plurality of working electrode zones in a center of the well.

Embodiment 412 is the apparatus of embodiment 401, wherein the pattern is configured to reduce differences, associated with the presence of a meniscus due to liquid in a well from the plurality of wells, in image distortion imaging each of the plurality of working electrode zones from the top of the well.

Embodiment 413 is the apparatus of embodiment 401, wherein each of the plurality of working electrode zones in at least one well from the plurality of wells is at an approximate equal distance from each sidewall of the at least one well.

Embodiment 414 is the apparatus of embodiment 406, wherein the conditions of rotational shaking comprise generating a vortex of liquid in the well.

Embodiment 415 is the apparatus of embodiment 401, wherein the plurality of working electrode zones comprises a plurality of electrically isolated zones formed on a single electrode.

Embodiment 416 is the apparatus of embodiment 401, wherein the pattern comprises a geometric pattern.

Embodiment 417 is the apparatus of embodiment 416, wherein the geometric pattern comprises the plurality of working electrode zones being disposed in a circle or a semi-circle, wherein, each of the plurality of working electrode zones is disposed at an approximate equal distance from a sidewall of the at least one well, and the auxiliary electrode is disposed within a perimeter of the circle or the semi-circle of the plurality of working electrode zones.

Embodiment 418 is the apparatus of any of embodiments 401-417, wherein each of the plurality of working electrode zones defines a circular shape having surface area that defines a circle.

Embodiment 419 is the apparatus of any of embodiments 401-418, wherein each of the plurality of working electrode zones define a wedge shape having a first blunt boundary and a sharp boundary that are connect by two side boundaries, where the first blunt boundary is adjacent to a sidewall of the at least one well and the second sharp boundary is adjacent to a center of the at least one well.

Embodiment 420 is the apparatus of any of embodiments 401-419, wherein the redox couple comprises a mixture of silver (Ag) and silver chloride (AgCl).

Embodiment 421 is the apparatus of embodiment 420, wherein the mixture of Ag and AgCl comprises approximately 50 percent or less AgCl.

Embodiment 422 is the apparatus of any of embodiments 401-421, wherein the electrochemical analysis comprises electrochemiluminescence (ECL) analysis.

Embodiment 423 is an apparatus for performing electrochemical analysis, the apparatus comprising: a plate with a plurality of wells defined therein, at least one well from the plurality of wells comprising: a plurality of working electrode zones disposed, and defining a pattern, on a surface of the cell; and at least one auxiliary electrode disposed on the surface, the auxiliary electrode having a redox couple confined to its surface, wherein the redox couple provides a quantifiable amount of coulombs per unit of the at least one auxiliary electrode's surface area throughout a redox reaction of the redox couple.

Embodiment 424 is the apparatus of embodiment 423, wherein, during the electrochemical analysis, the auxiliary electrode has a standard reduction potential defined by the redox couple.

Embodiment 425 is the apparatus of embodiment 424, wherein the standard reduction potential ranges from approximately 0.1 volts (V) to approximately 3.0 V.

Embodiment 426 is the apparatus of embodiment 425, wherein the standard reduction potential is approximately 0.22 V.

Embodiment 427 is the apparatus of embodiment 423, wherein an amount of an oxidizing agent in the redox couple is greater than or equal to an amount of charge required to pass through the auxiliary electrode to complete the electrochemical analysis.

Embodiment 428 is the apparatus of embodiment 427, wherein the at least one auxiliary electrode has between approximately 3.07×10⁻⁷ to 3.97×10⁻⁷ moles of oxidizing agent.

Embodiment 429 is the apparatus of embodiment 427, wherein the at least one auxiliary electrode has between approximately 1.80×10⁻⁷ to 2.32×10⁻⁷ moles of oxidizing agent per mm² of auxiliary electrode area.

Embodiment 430 is the apparatus of embodiment 427, wherein the at least one auxiliary electrode has at least approximately 3.7×10⁻⁹ moles of oxidizing agent per mm² of total working electrode area in the well.

Embodiment 431 is the apparatus of embodiment 427, wherein the at least one auxiliary electrode has at least approximately 5.7×10⁻⁹ moles of oxidizing agent per mm² of total working electrode area in the well.

Embodiment 432 is the apparatus of embodiment 423, wherein the redox couple passes approximately 0.5 to 4.0 mA of current throughout a redox reaction of the redox couple to generate electrochemiluminescence (ECL) at a range of approximately 1.4V to 2.6V.

Embodiment 433 is the apparatus of embodiment 423, wherein the redox couple passes an average current of approximately 2.39 mA throughout a redox reaction to generate electrochemiluminescence (ECL) at a range of approximately 1.4 to 2.6 V.

Embodiment 434 is the apparatus 1 of embodiment 423, wherein the redox couple maintains an interface potential of between −0.15 to −0.5 V while passing a charge of approximately 1.56×10⁻⁵ to 5.30×10⁻⁴ C/mm² of electrode surface area.

Embodiment 435 is the apparatus of embodiment 423, wherein the plurality of working electrode zones have an aggregate exposed area, the at least one auxiliary electrode has an exposed surface area, and the aggregate exposed area of the plurality of working electrode zones divided by the exposed surface area of the at least one auxiliary electrode define an area ratio that has a value greater than 1.

Embodiment 436 is the apparatus of embodiment 423, wherein the pattern minimizes a number of working electrode zones that are adjacent to one another for each of the working electrode zones among the plurality of working electrode zones.

Embodiment 437 is the apparatus of embodiment 423, wherein the number of working electrode zones that are adjacent to one another is no greater than two.

Embodiment 438 is the apparatus of embodiment 423, wherein at least one of the plurality of working electrode zones is adjacent to three or more other working electrode zones among the plurality of working electrode zones.

Embodiment 439 is the apparatus of embodiment 423, wherein the pattern is configured to provide uniform mass transport of a substance to each of the plurality of working electrode zones under conditions of rotational shaking.

Embodiment 440 is the apparatus of embodiment 423, wherein the pattern comprises a geometric pattern.

Embodiment 441 is the apparatus of any of embodiments 423-440, wherein each of the plurality of working electrode zones defines a circular shape having surface area that defines a circle.

Embodiment 442 is the apparatus of any of embodiments 423-441, wherein the plurality of working electrode zones comprises a plurality of electrically isolated zones formed on a single electrode.

Embodiment 443 is the apparatus of embodiment 423, wherein the redox couple comprises a mixture of silver (Ag) and silver chloride (AgCl).

Embodiment 444 is the apparatus of embodiment 443, wherein the mixture of Ag and AgCl comprises approximately 50 percent or less AgCl.

Embodiment 445 is the apparatus of embodiment 443, wherein the mixture has a molar ratio of Ag to AgCl within a specified range.

Embodiment 446 is the apparatus of embodiment 445, wherein the molar ratio is approximately equal to or greater than 1.

Embodiment 447 is the apparatus of embodiment 443, wherein during the electrochemical analysis, the auxiliary electrode has a standard reduction potential, and wherein the standard reduction potential is approximately 0.22 volts (V).

Embodiment 448 is the apparatus of any of embodiments 423-447, wherein the electrochemical analysis comprises electrochemiluminescence (ECL) analysis.

Embodiment 449 is the apparatus of any of embodiments 423-448, wherein the electrochemical analysis involves a reduction or oxidation of an amount of one or more chemical moieties, and the at least one auxiliary electrode is configured to maintain a controlled interfacial potential until all of the chemical moieties have been oxidized or reduced.

Embodiment 450 is an apparatus for performing electrochemical analysis, the apparatus comprising: a plate with a plurality of wells defined therein, at least one well from the plurality of wells comprising: a plurality of working electrode zones disposed, and defining a pattern, on a surface of the cell; and at least one auxiliary electrode disposed on the surface and formed of a chemical mixture comprising an oxidizing agent, the at least one auxiliary electrode having a redox couple confined to its surface, wherein an amount of the oxidizing agent is sufficient to maintain the defined potential throughout an entire redox reaction of the redox couple.

Embodiment 451 is the apparatus of embodiment 450, wherein, during the electrochemical analysis, the auxiliary electrode has a potential defined by the redox couple.

Embodiment 452 is the apparatus of embodiment 451, wherein the potential ranges from approximately 0.1 volts (V) to approximately 3.0 V.

Embodiment 453 is the apparatus of embodiment 452, wherein the potential is approximately 0.22 V.

Embodiment 454 is the apparatus of embodiment 450, wherein an amount of the oxidizing agent is greater than or equal to an amount of charge required to pass through the at least one auxiliary electrode to complete the electrochemical analysis.

Embodiment 455 is the apparatus of embodiment 450, wherein the at least one auxiliary electrode has between approximately 3.07×10⁻⁷ to 3.97×10⁻⁷ moles of oxidizing agent.

Embodiment 456 is the apparatus of embodiment 450, wherein the at least one auxiliary electrode has between approximately 1.80×10⁻⁷ to 2.32×10⁻⁷ moles of oxidizing agent per mm² of auxiliary electrode area.

Embodiment 457 is the apparatus of embodiment 450, wherein the at least one auxiliary electrode has at least approximately 3.7×10⁻⁹ moles of oxidizing agent per mm² of total working electrode area.

Embodiment 458 is the apparatus of embodiment 450, wherein the at least one auxiliary electrode has at least approximately 5.7×10⁻⁹ moles of oxidizing agent per mm² of total working electrode area 1.

Embodiment 459 is the apparatus of embodiment 450, wherein the redox couple passes approximately 0.5 to 4.0 mA of current throughout a redox reaction of the redox couple to generate electrochemiluminescence (ECL) at a range of approximately 1.4V to 2.6V.

Embodiment 460 is the apparatus of embodiment 450, wherein the redox couple passes an average current of approximately 2.39 mA throughout a redox reaction to generate electrochemiluminescence (ECL) at a range of approximately 1.4 to 2.6 V.

Embodiment 461 is the apparatus of embodiment 450, wherein the redox couple maintains an interface potential of between −0.15 to −0.5 V while passing a charge of approximately 1.56×10⁻⁵ to 5.30×10⁻⁴ C/mm² of electrode surface area.

Embodiment 462 is the apparatus of embodiment 450, wherein the plurality of working electrode zones have an aggregate exposed area, the at least one auxiliary electrode has an exposed surface area, and the aggregate exposed area of the plurality of working electrode zones divided by the exposed surface area of the at least one auxiliary electrode define an area ratio that has a value greater than 1.

Embodiment 463 is the apparatus of embodiment 450, wherein the pattern minimizes a number of working electrode zones that are adjacent to one another for each of the working electrode zones among the plurality of working electrode zones.

Embodiment 464 is the apparatus of embodiment 450, wherein the number of working electrode zones that are adjacent to one another is no greater than two.

Embodiment 465 is the apparatus of embodiment 450, wherein at least one of the plurality of working electrode zones is adjacent to three or more other working electrode zones among the plurality of working electrode zones.

Embodiment 466 is the apparatus of embodiment 450, wherein the pattern is configured to provide uniform mass transport of a substance to each of the plurality of working electrode zones under conditions of rotational shaking.

Embodiment 467 is the apparatus of embodiment 450, wherein the pattern comprises a geometric pattern.

Embodiment 468 is the apparatus of any of embodiments 450-467, wherein each of the plurality of working electrode zones defines a circular shape having surface area that defines a circle.

Embodiment 469 is the apparatus of any of embodiments 450-468, wherein the plurality of working electrode zones comprises a plurality of electrically isolated zones formed on a single electrode.

Embodiment 470 is the apparatus of embodiment 450, wherein the redox couple comprises a mixture of silver (Ag) and silver chloride (AgCl).

Embodiment 471 is the apparatus of embodiment 470, wherein the mixture of Ag and AgCl comprises approximately 50 percent or less AgCl.

Embodiment 472 is the apparatus of embodiment 470, wherein the mixture has a molar ratio of Ag to AgCl within a specified range.

Embodiment 473 is the apparatus of embodiment 472, wherein the molar ratio is approximately equal to or greater than 1.

Embodiment 474 is the apparatus of embodiment 470, wherein, during the electrochemical analysis, the auxiliary electrode has a potential defined by the redox couple, and wherein the potential is approximately 0.22 volts (V).

Embodiment 475 is the apparatus of any of embodiments 450-474, wherein the electrochemical analysis comprises electrochemiluminescence (ECL) analysis.

Embodiment 476 is the apparatus of any of embodiments 450-475, wherein the electrochemical analysis involves a reduction or oxidation of an amount of one or more chemical moieties, and the at least one auxiliary electrode is configured to maintain a controlled interfacial potential until all of the chemical moieties have been oxidized or reduced.

Embodiment 477 is an apparatus for performing electrochemical analysis, the apparatus comprising: a plate with a plurality of wells defined therein, at least one well from the plurality of wells comprising: a plurality of working electrode zones disposed, and defining a pattern, on a surface of the cell; and at least one auxiliary electrode disposed on the surface, the auxiliary electrode having a defined interfacial potential.

Embodiment 478 is the apparatus of embodiment 477, wherein, during the electrochemical analysis, the auxiliary electrode has a potential defined by a redox couple.

Embodiment 479 is the apparatus of embodiment 478, wherein the potential ranges from approximately 0.1 volts (V) to approximately 3.0 V.

Embodiment 480 is the apparatus of embodiment 479, wherein the potential is approximately 0.22 V.

Embodiment 481 is the apparatus of embodiment 477, wherein an amount of an oxidizing agent in the at least one auxiliary electrode is greater than or equal to an amount of charge required to pass through the at least one auxiliary electrode to complete the electrochemical analysis.

Embodiment 482 is the apparatus of embodiment 481, wherein the at least one auxiliary electrode has between approximately 3.07×10⁻⁷ to 3.97×10⁻⁷ moles of oxidizing agent.

Embodiment 483 is the apparatus of embodiment 481, wherein the at least one auxiliary electrode has between approximately 1.80×10⁻⁷ to 2.32×10⁻⁷ moles of oxidizing agent per mm² of auxiliary electrode area.

Embodiment 484 is the apparatus of embodiment 481, wherein the at least one auxiliary electrode has at least approximately 3.7×10⁻⁹ moles of oxidizing agent per mm² of total working electrode area in the well.

Embodiment 485 is the apparatus of embodiment 481, wherein the at least one auxiliary electrode has at least approximately 5.7×10⁻⁹ moles of oxidizing agent per mm² of total working electrode area in the well.

Embodiment 486 is the apparatus of embodiment 477, wherein the plurality of working electrode zones have an aggregate exposed area, the at least one auxiliary electrode has an exposed surface area, and the aggregate exposed area of the plurality of working electrode zones divided by the exposed surface area of the at least one auxiliary electrode define an area ratio that has a value greater than 1.

Embodiment 487 is the apparatus of embodiment 477, wherein the pattern minimizes a number of working electrode zones that are adjacent to one another for each of the working electrode zones among the plurality of working electrode zones.

Embodiment 488 is the apparatus of embodiment 477, wherein the number of working electrode zones that are adjacent to one another is no greater than two.

Embodiment 489 is the apparatus of embodiment 477, wherein at least one of the plurality of working electrode zones is adjacent to three or more other working electrode zones among the plurality of working electrode zones.

Embodiment 490 is the apparatus of embodiment 477, wherein the pattern is configured to provide uniform mass transport of a substance to each of the plurality of working electrode zones under conditions of rotational shaking.

Embodiment 491 is the apparatus of embodiment 477, wherein the pattern comprises a geometric pattern.

Embodiment 492 is the apparatus of any of embodiments 477-491, wherein each of the plurality of working electrode zones defines a circular shape having surface area that defines a circle.

Embodiment 493 is the apparatus of any of embodiments 477-492, wherein the plurality of working electrode zones comprises a plurality of electrically isolated zones formed on a single electrode.

Embodiment 494 is the apparatus of embodiment 477, wherein the at least one auxiliary electrode comprises a mixture of silver (Ag) and silver chloride (AgCl).

Embodiment 495 is the apparatus of embodiment 494, wherein the mixture of Ag and AgCl comprises approximately 50 percent or less AgCl.

Embodiment 496 is the apparatus of embodiment 494, wherein the mixture has a molar ratio of Ag to AgCl within a specified range.

Embodiment 497 is the apparatus of embodiment 496, wherein the molar ratio is approximately equal to or greater than 1.

Embodiment 498 is the apparatus of embodiment 494, wherein, during the electrochemical analysis, the auxiliary electrode has a potent defined by a redox couple, and wherein the defined interfacial potential is approximately 0.22 volts (V).

Embodiment 499 is the apparatus of any of embodiments 477-498, wherein the electrochemical analysis comprises electrochemiluminescence (ECL) analysis.

Embodiment 500 is the apparatus of any of embodiments 477-499, wherein the electrochemical analysis involves a reduction or oxidation of an amount of one or more chemical moieties, and the at least one auxiliary electrode is configured to maintain a controlled interfacial potential until all of the chemical moieties have been oxidized or reduced.

Embodiment 501 is an apparatus for performing electrochemical analysis, the apparatus comprising: a plate with a plurality of wells defined therein, at least one well from the plurality of wells comprising: a plurality of working electrode zones disposed, and defining a pattern, on a surface of the cell; and at least one auxiliary electrode disposed on the surface, the at least one auxiliary electrode comprising a first substance and a second substance, wherein the second substance is a redox couple of the first substance.

Embodiment 502 is the apparatus of embodiment 501, wherein, during the electrochemical analysis, the auxiliary electrode has a potential defined by the redox couple.

Embodiment 503 is the apparatus of embodiment 502, wherein the potential ranges from approximately 0.1 volts (V) to approximately 3.0 V.

Embodiment 504 is the apparatus of embodiment 502, wherein the potential is approximately 0.22 V.

Embodiment 505 is the apparatus of embodiment 501, wherein an amount of an oxidizing agent in the redox couple is greater than or equal to an amount of charge required to pass through the auxiliary electrode to complete the electrochemical analysis.

Embodiment 506 is the apparatus of embodiment 505, wherein the at least one auxiliary electrode has between approximately 3.07×10⁻⁷ to 3.97×10⁻⁷ moles of oxidizing agent.

Embodiment 507 is the apparatus of embodiment 505, wherein the at least one auxiliary electrode has between approximately 1.80×10⁻⁷ to 2.32×10⁻⁷ moles of oxidizing agent per mm² of auxiliary electrode area.

Embodiment 508 is the apparatus of embodiment 505, wherein the at least one auxiliary electrode has at least approximately 3.7×10⁻⁹ moles of oxidizing agent per mm² of total working electrode area in the well.

Embodiment 509 is the apparatus of embodiment 505, wherein the at least one auxiliary electrode has at least approximately 5.7×10⁻⁹ moles of oxidizing agent per mm² of total working electrode area in the well.

Embodiment 510 is the apparatus of embodiment 501, wherein the redox couple passes approximately 0.5 to 4.0 mA of current throughout a redox reaction of the redox couple to generate electrochemiluminescence (ECL) at a range of approximately 1.4V to 2.6V.

Embodiment 511 is the apparatus of embodiment 501, wherein the redox couple passes an average current of approximately 2.39 mA throughout a redox reaction to generate electrochemiluminescence (ECL) at a range of approximately 1.4 to 2.6 V.

Embodiment 512 is the apparatus of embodiment 501, wherein the redox couple maintains an interface potential of between −0.15 to −0.5 V while passing a charge of approximately 1.56×10⁻⁵ to 5.30×10⁻⁴ C/mm² of electrode surface area.

Embodiment 513 is the apparatus of embodiment 501, wherein the plurality of working electrode zones have an aggregate exposed area, the at least one auxiliary electrode has an exposed surface area, and the aggregate exposed area of the plurality of working electrode zones divided by the exposed surface area of the at least one auxiliary electrode define an area ratio that has a value greater than 1.

Embodiment 514 is the apparatus of embodiment 501, wherein the pattern minimizes a number of working electrode zones that are adjacent to one another for each of the working electrode zones among the plurality of working electrode zones.

Embodiment 515 is the apparatus of embodiment 501, wherein the number of working electrode zones that are adjacent to one another is no greater than two.

Embodiment 516 is the apparatus of embodiment 501, wherein at least one of the plurality of working electrode zones is adjacent to three or more other working electrode zones among the plurality of working electrode zones.

Embodiment 517 is the apparatus of embodiment 501, wherein the pattern is configured to provide uniform mass transport of a substance to each of the plurality of working electrode zones under conditions of rotational shaking.

Embodiment 518 is the apparatus of embodiment 501, wherein the pattern comprises a geometric pattern.

Embodiment 519 is the apparatus of any of embodiments 501-518, wherein each of the plurality of working electrode zones defines a circular shape having surface area that defines a circle.

Embodiment 520 is the apparatus of any of embodiments 501-519, wherein the plurality of working electrode zones comprises a plurality of electrically isolated zones formed on a single electrode.

Embodiment 521 is the apparatus of embodiment 501, wherein the first substance is silver (Ag) and the second substance is silver chloride (AgCl).

Embodiment 522 is the apparatus of embodiment 521, wherein the at least one auxiliary electrode comprises approximately 50 percent or less AgCl relative to Ag.

Embodiment 523 is the apparatus of embodiment 521, wherein the first substance has a molar ratio relative to the second substance within a specified range.

Embodiment 524 is the apparatus of embodiment 523, wherein the molar ratio is approximately equal to or greater than 50%.

Embodiment 525 is the apparatus of any of embodiments 501-524, wherein the electrochemical analysis comprises electrochemiluminescence (ECL) analysis.

Embodiment 526 is the apparatus of any of embodiments 501-524, wherein the electrochemical analysis involves a reduction or oxidation of an amount of one or more chemical moieties, and the at least one auxiliary electrode is configured to maintain a controlled interfacial potential until all of the chemical moieties have been oxidized or reduced.

Embodiment 527 is an apparatus for performing electrochemical analysis, the apparatus comprising: a plate with a plurality of wells defined therein, at least one well from the plurality of wells comprising: a plurality of working electrode zones disposed, and defining a pattern, on a surface of the cell; and at least one auxiliary electrode disposed on the surface, the at least one auxiliary electrode having a redox couple confined to its surface, wherein when an applied potential is introduced to the cell during the electrochemical analysis, a reaction of a species in the redox couple is a predominate redox reaction occurring at the auxiliary electrode.

Embodiment 528 is the apparatus of embodiment 527, wherein the applied potential is less than a defined potential required to reduce water or perform electrolysis of water.

Embodiment 529 is the apparatus of embodiment 528, wherein less than 1 percent of current is associated with the reduction of water.

Embodiment 530 is the apparatus of embodiment 528, wherein less than 1 of current per unit area of the auxiliary electrode is associated with the reduction of water.

Embodiment 531 is the apparatus of embodiment 527, wherein, during the electrochemical analysis, the auxiliary electrode has a potential defined by the redox couple.

Embodiment 532 is the apparatus of embodiment 531, wherein the potential ranges from approximately 0.1 volts (V) to approximately 3.0 V.

Embodiment 533 is the apparatus of embodiment 533, wherein the potential is approximately 0.22 V.

Embodiment 534 is the apparatus of embodiment 527, wherein the plurality of working electrode zones have an aggregate exposed area, the at least one auxiliary electrode has an exposed surface area, and the aggregate exposed area of the plurality of working electrode zones divided by the exposed surface area of the at least one auxiliary electrode define an area ratio that has a value greater than 1.

Embodiment 535 is the apparatus of embodiment 527, wherein the pattern minimizes a number of working electrode zones that are adjacent to one another for each of the working electrode zones among the plurality of working electrode zones.

Embodiment 536 is the apparatus of embodiment 527, wherein the number of working electrode zones that are adjacent to one another is no greater than two.

Embodiment 537 is the apparatus of embodiment 527, wherein at least one of the plurality of working electrode zones is adjacent to three or more other working electrode zones among the plurality of working electrode zones.

Embodiment 538 is the apparatus of embodiment 527, wherein the pattern is configured to provide uniform mass transport of a substance to each of the plurality of working electrode zones under conditions of rotational shaking.

Embodiment 539 is the apparatus of embodiment 527, wherein the pattern comprises a geometric pattern.

Embodiment 540 is the apparatus of any of embodiments 527-539, wherein each of the plurality of working electrode zones defines a circular shape having surface area that defines a circle.

Embodiment 541 is the apparatus of any of embodiments 527-540, wherein the plurality of working electrode zones comprises a plurality of electrically isolated zones formed on a single electrode.

Embodiment 542 is the apparatus of embodiment 527, wherein the redox couple comprises a mixture of silver (Ag) and silver chloride (AgCl).

Embodiment 543 is the apparatus of embodiment 542, wherein the mixture of Ag and AgCl comprises approximately 50 percent or less AgCl.

Embodiment 544 is the apparatus of embodiment 542, wherein the mixture has a molar ratio of Ag to AgCl within a specified range.

Embodiment 545 is the apparatus of embodiment 544, wherein the molar ratio is approximately equal to or greater than 1.

Embodiment 546 is the apparatus of any of embodiments 527-545, wherein the electrochemical analysis comprises electrochemiluminescence (ECL) analysis.

Embodiment 547 is the apparatus of any of embodiments 527-546, wherein the electrochemical analysis involves a reduction or oxidation of an amount of one or more chemical moieties, and the at least one auxiliary electrode is configured to maintain a controlled interfacial potential until all of the chemical moieties have been oxidized or reduced.

Embodiment 548 is a method for performing electrochemical analysis, the method comprising: applying a voltage pulse to one or more working electrode zones and at least one auxiliary electrode located in at least one well of a multi-well plate, wherein: the one or more working electrode zones define a pattern on a surface of the at least one well, the at least one auxiliary electrode is disposed on the surface and has a redox couple confined to its surface, the at least one auxiliary electrode is disposed at an approximate equal distance from at least two of the plurality of working electrode zones, and during the voltage pulse, a potential at the auxiliary electrode is defined by the redox couple; capturing luminescence data over a period of time; and reporting the luminescence data.

Embodiment 549 is the method of embodiment 548, wherein the luminescence data includes electrochemical luminescence data.

Embodiment 550 is the method of embodiment 548, the method further comprising: analyzing the luminescence data.

Embodiment 551 is the method of embodiment 548, wherein the luminescence data is captured during a duration of the voltage pulse.

Embodiment 552 is the method of embodiment 551, wherein the luminescence data is captured during at least 50 percent of the duration of the voltage pulse.

Embodiment 553 is the method of embodiment 551, wherein the luminescence data is captured during at least 75 percent of the duration of the voltage pulse.

Embodiment 554 is the method of embodiment 551, wherein the luminescence data is captured during at least 100 percent of the duration of the voltage pulse.

Embodiment 555 is the method of embodiment 548, wherein a duration of the voltage pulse is less than or equal to approximately 200 milliseconds (ms).

Embodiment 556 is the method of embodiment 555, wherein the duration of the voltage pulse is approximately 100 ms.

Embodiment 557 is the method of embodiment 555, wherein the duration of the voltage pulse is approximately 50 ms.

Embodiment 558 is the method of embodiment 548, wherein the voltage pulse is applied to the one or more working electrodes and the at least one auxiliary electrode concurrently.

Embodiment 559 is the method of embodiment 558, wherein a read time for capturing the luminescence data ranges and reporting the luminescence data for an entirety of the one or more working electrodes in the multi-well plate ranges from approximately 66 seconds to approximately 81 seconds.

Embodiment 560 is the method of embodiment 558, wherein a read time for capturing the luminescence data ranges and reporting the luminescence data for an entirety of the one or more working electrodes in the multi-well plate ranges from approximately 45 seconds to approximately 49 seconds.

Embodiment 561 is the method of embodiment 558, wherein a read time for capturing the luminescence data ranges and reporting the luminescence data for an entirety of the one or more working electrodes in the multi-well plate ranges from approximately 51 seconds to approximately 52 seconds.

Embodiment 562 is the method of embodiment 548, wherein the voltage pulse is applied to the one or more working electrodes and the at least one auxiliary electrode sequentially.

Embodiment 563 is the method of embodiment 562, wherein a read time for capturing the luminescence data ranges and reporting the luminescence data for an entirety of the one or more working electrodes in the multi-well plate ranges from approximately 114 seconds to approximately 258 seconds.

Embodiment 564 is the method of embodiment 563, wherein a read time for capturing the luminescence data ranges and reporting the luminescence data for an entirety of the one or more working electrodes in the multi-well plate ranges from approximately 57 seconds to approximately 93 seconds.

Embodiment 565 is the method of embodiment 564, wherein a read time for capturing the luminescence data ranges and reporting the luminescence data for an entirety of the one or more working electrodes in the multi-well plate ranges from approximately 54 seconds to approximately 63 seconds.

Embodiment 566 is the method of embodiment 548, wherein a read time for capturing the luminescence data and reporting the luminescence data increases with an increase of a duration of the voltage pulse.

Embodiment 567 is the method of any of embodiments 548-566, wherein the voltage pulse is applied to an addressable subset of the one or more working electrode zones.

Embodiment 568 is the method of any of embodiments 548-567, the method further comprising: selecting a magnitude of the voltage pulse based at least in part on a chemical composition of the at least one auxiliary electrode.

Embodiment 569 is a computer readable medium storing instructions that cause one or more processors to perform any one of the method of embodiments 548-568.

Embodiment 570 is a method for performing electrochemical analysis, the method comprising: applying a voltage pulse to one or more working electrode zones and at least one auxiliary electrode located in at least one well of a multi-well plate, wherein: the one or more working electrode zones define a pattern, on a surface of the at least one well, the at least one auxiliary electrode is disposed on the surface, the at least auxiliary electrode has a redox couple confined to its surface with a standard redox potential, and the redox couple provides a quantifiable amount of coulombs per unit of the at least one auxiliary electrode's surface area throughout a redox reaction of the redox couple; capturing luminescence data over a period of time; and reporting the luminescence data.

Embodiment 571 is the method of embodiment 570, wherein the luminescence data includes electrochemical luminescence data.

Embodiment 572 is the method of embodiment 570, the method further comprising:

analyzing the luminescence data.

Embodiment 573 is the method of embodiment 570, wherein the luminescence data is captured during a duration of the voltage pulse.

Embodiment 574 is the method of embodiment 573, wherein the luminescence data is captured during at least 50 percent of the duration of the voltage pulse.

Embodiment 575 is the method of embodiment 573, wherein the luminescence data is captured during at least 75 percent of the duration of the voltage pulse.

Embodiment 576 is the method of embodiment 573, wherein the luminescence data is captured during at least 100 percent of the duration of the voltage pulse.

Embodiment 577 is the method of embodiment 170, wherein a duration of the voltage pulse is less than or equal to approximately 200 milliseconds (ms).

Embodiment 578 is the method of embodiment 577, wherein the duration of the voltage pulse is approximately 100 ms.

Embodiment 579 is the method of embodiment 577, wherein the duration of the voltage pulse is approximately 50 ms.

Embodiment 580 is the method of embodiment 570, wherein the voltage pulse is applied to the one or more working electrodes and the at least one auxiliary electrode concurrently.

Embodiment 581 is the method of embodiment 580, wherein a read time for capturing the luminescence data ranges and reporting the luminescence data for an entirety of the one or more working electrodes in the multi-well plate ranges from approximately 66 seconds to approximately 81 seconds.

Embodiment 582 is the method of embodiment 580, wherein a read time for capturing the luminescence data ranges and reporting the luminescence data for an entirety of the one or more working electrodes in the multi-well plate ranges from approximately 45 seconds to approximately 49 seconds.

Embodiment 583 is the method of embodiment 580, wherein a read time for capturing the luminescence data ranges and reporting the luminescence data for an entirety of the one or more working electrodes in the multi-well plate ranges from approximately 51 seconds to approximately 52 seconds.

Embodiment 584 is the method of embodiment 570, wherein the voltage pulse is applied to the one or more working electrodes and the at least one auxiliary electrode sequentially.

Embodiment 585 is the method of embodiment 584, wherein a read time for capturing the luminescence data ranges and reporting the luminescence data for an entirety of the one or more working electrodes in the multi-well plate ranges from approximately 114 seconds to approximately 258 seconds.

Embodiment 586 is the method of embodiment 584, wherein a read time for capturing the luminescence data ranges and reporting the luminescence data for an entirety of the one or more working electrodes in the multi-well plate ranges from approximately 57 seconds to approximately 93 seconds.

Embodiment 587 is the method of embodiment 584, wherein a read time for capturing the luminescence data ranges and reporting the luminescence data for an entirety of the one or more working electrodes in the multi-well plate ranges from approximately 54 seconds to approximately 63 seconds.

Embodiment 588 is the method of embodiment 570, wherein a read time for capturing the luminescence data and reporting the luminescence data increases with an increase of a duration of the voltage pulse.

Embodiment 589 is the method of any of embodiments 570-588, wherein the voltage pulse is applied to an addressable subset of the one or more working electrode zones.

Embodiment 590 is the method of any of embodiments 570-589, the method further comprising: selecting a magnitude of the voltage pulse based at least in part on a chemical composition of the at least one auxiliary electrode.

Embodiment 591 is a computer readable medium storing instructions that cause one or more processors to perform any one of the method of embodiments 570-590.

Embodiment 592 is a method for performing electrochemical analysis, the method comprising: applying a voltage pulse to one or more working electrode zones and an auxiliary electrode located in at least one well of a multi-well plate, wherein: the one or more working electrode zones define a pattern on a surface of the at least one well, the at least one auxiliary electrode is disposed on the surface and is formed of a chemical mixture comprising an oxidizing agent, the at least one auxiliary electrode has a redox couple confined to its surface, and during the voltage pulse, an amount of the oxidizing agent is sufficient to maintain a potential throughout an entire redox reaction of the redox couple; capturing luminescence data over a period of time; and reporting the luminescence data.

Embodiment 593 is the method of embodiment 592, wherein the luminescence data includes electrochemical luminescence data.

Embodiment 594 is the method of embodiment 592, the method further comprising:

analyzing the luminescence data.

Embodiment 595 is the method of embodiment 592, wherein the luminescence data is captured during a duration of the voltage pulse.

Embodiment 596 is the method of embodiment 595, wherein the luminescence data is captured during at least 50 percent of the duration of the voltage pulse.

Embodiment 597 is the method of embodiment 595, wherein the luminescence data is captured during at least 75 percent of the duration of the voltage pulse.

Embodiment 598 is the method of embodiment 595, wherein the luminescence data is captured during at least 100 percent of the duration of the voltage pulse.

Embodiment 599 is the method of embodiment 592, wherein a duration of the voltage pulse is less than or equal to approximately 200 milliseconds (ms).

Embodiment 600 is the method of embodiment 599, wherein the duration of the voltage pulse is approximately 100 ms.

Embodiment 601 is the method of embodiment 599, wherein the duration of the voltage pulse is approximately 50 ms.

Embodiment 602 is the method of embodiment 592, wherein the voltage pulse is applied to the one or more working electrodes and the at least one auxiliary electrode concurrently.

Embodiment 603 is the method of embodiment 602, wherein a read time for capturing the luminescence data ranges and reporting the luminescence data for an entirety of the one or more working electrodes in the multi-well plate ranges from approximately 66 seconds to approximately 81 seconds.

Embodiment 604 is the method of embodiment 602, wherein a read time for capturing the luminescence data ranges and reporting the luminescence data for an entirety of the one or more working electrodes in the multi-well plate ranges from approximately 45 seconds to approximately 49 seconds.

Embodiment 605 is the method of embodiment 602, wherein a read time for capturing the luminescence data ranges and reporting the luminescence data for an entirety of the one or more working electrodes in the multi-well plate ranges from approximately 51 seconds to approximately 52 seconds.

Embodiment 606 is the method of embodiment 592, wherein the voltage pulse is applied to the one or more working electrodes and the at least one auxiliary electrode sequentially.

Embodiment 607 is the method of embodiment 606, wherein a read time for capturing the luminescence data ranges and reporting the luminescence data for an entirety of the one or more working electrodes in the multi-well plate ranges from approximately 114 seconds to approximately 258 seconds.

Embodiment 608 is the method of embodiment 606, wherein a read time for capturing the luminescence data ranges and reporting the luminescence data for an entirety of the one or more working electrodes in the multi-well plate ranges from approximately 57 seconds to approximately 93 seconds.

Embodiment 609 is the method of embodiment 606, wherein a read time for capturing the luminescence data ranges and reporting the luminescence data for an entirety of the one or more working electrodes in the multi-well plate ranges from approximately 54 seconds to approximately 63 seconds.

Embodiment 610 is the method of embodiment 592, wherein a read time for capturing the luminescence data and reporting the luminescence data increases with an increase of a duration of the voltage pulse.

Embodiment 611 is the method of any of embodiments 592-510, wherein the voltage pulse is applied to an addressable subset of the one or more working electrode zones.

Embodiment 612 is the method of any of embodiments 592-611, the method further comprising: selecting a magnitude of the voltage pulse based at least in part on a chemical composition of the at least one auxiliary electrode.

Embodiment 613 is a computer readable medium storing instructions that cause one or more processors to perform any one of the method of embodiments 592-612.

Embodiment 614 is a method for performing electrochemical analysis, the method comprising: applying a voltage pulse to one or more working electrode zones and at least one auxiliary electrode located in at least one well of a multi-well plate, wherein: the one or more working electrode zones define a pattern on a surface of the at least one well, the at least one auxiliary electrode is disposed on the surface, and the auxiliary electrode has a defined interfacial potential during the voltage pulse; capturing luminescence data over a period of time; and reporting the luminescence data.

Embodiment 615 is the method of embodiment 614, wherein the luminescence data includes electrochemical luminescence data.

Embodiment 616 is the method of embodiment 614, the method further comprising: analyzing the luminescence data.

Embodiment 617 is the method of embodiment 614, wherein the luminescence data is captured during a duration of the voltage pulse.

Embodiment 618 is the method of embodiment 617, wherein the luminescence data is captured during at least 50 percent of the duration of the voltage pulse.

Embodiment 619 is the method of embodiment 617, wherein the luminescence data is captured during at least 75 percent of the duration of the voltage pulse.

Embodiment 620 is the method of embodiment 617, wherein the luminescence data is captured during at least 100 percent of the duration of the voltage pulse.

Embodiment 621 is the method of embodiment 614, wherein a duration of the voltage pulse is less than or equal to approximately 200 milliseconds (ms).

Embodiment 622 is the method of embodiment 621, wherein the duration of the voltage pulse is approximately 100 ms.

Embodiment 623 is the method of embodiment 621, wherein the duration of the voltage pulse is approximately 50 ms.

Embodiment 624 is the method of embodiment 614, wherein the voltage pulse is applied to the one or more working electrodes and the at least one auxiliary electrode concurrently.

Embodiment 625 is the method of embodiment 624, wherein a read time for capturing the luminescence data ranges and reporting the luminescence data for an entirety of the one or more working electrodes in the multi-well plate ranges from approximately 66 seconds to approximately 81 seconds.

Embodiment 626 is the method of embodiment 624, wherein a read time for capturing the luminescence data ranges and reporting the luminescence data for an entirety of the one or more working electrodes in the multi-well plate ranges from approximately 45 seconds to approximately 49 seconds.

Embodiment 627 is the method of embodiment 624, wherein a read time for capturing the luminescence data ranges and reporting the luminescence data for an entirety of the one or more working electrodes in the multi-well plate ranges from approximately 51 seconds to approximately 52 seconds.

Embodiment 628 is the method of embodiment 614, wherein the voltage pulse is applied to the one or more working electrodes and the at least one auxiliary electrode sequentially.

Embodiment 629 is the method of embodiment 628, wherein a read time for capturing the luminescence data ranges and reporting the luminescence data for an entirety of the one or more working electrodes in the multi-well plate ranges from approximately 114 seconds to approximately 258 seconds.

Embodiment 630 is the method of embodiment 628, wherein a read time for capturing the luminescence data ranges and reporting the luminescence data for an entirety of the one or more working electrodes in the multi-well plate ranges from approximately 57 seconds to approximately 93 seconds.

Embodiment 631 is the method of embodiment 628, wherein a read time for capturing the luminescence data ranges and reporting the luminescence data for an entirety of the one or more working electrodes in the multi-well plate ranges from approximately 54 seconds to approximately 63 seconds.

Embodiment 632 is the method of embodiment 614, wherein a read time for capturing the luminescence data and reporting the luminescence data increases with an increase of a duration of the voltage pulse.

Embodiment 633 is the method of any of embodiments 614-632, wherein the voltage pulse is applied to an addressable subset of the one or more working electrode zones.

Embodiment 634 is the method of any of embodiments 614-633, the method further comprising: selecting a magnitude of the voltage pulse based at least in part on a chemical composition of the at least one auxiliary electrode.

Embodiment 635 is a computer readable medium storing instructions that cause one or more processors to perform any one of the method of embodiments 614-634.

Embodiment 636 is a method for performing electrochemical analysis, the method comprising: applying a voltage pulse to one or more working electrode zones and at least one auxiliary electrode located in at least one well of a multi-well plate, wherein: the one or more working electrode zones define a pattern on a surface of the at least one well, the at least one auxiliary electrode is disposed on the surface and comprises a first substance and a second substance, and the second substance is a redox couple of the first substance; capturing luminescence data over a period of time; and reporting the luminescence data.

Embodiment 637 is the method of embodiment 636, wherein the luminescence data includes electrochemical luminescence data.

Embodiment 638 is the method of embodiment 636, the method further comprising: analyzing the luminescence data.

Embodiment 639 is the method of embodiment 636, wherein the luminescence data is captured during a duration of the voltage pulse.

Embodiment 640 is the method of embodiment 639, wherein the luminescence data is captured during at least 50 percent of the duration of the voltage pulse.

Embodiment 641 is the method of embodiment 639, wherein the luminescence data is captured during at least 75 percent of the duration of the voltage pulse.

Embodiment 642 is the method of embodiment 639, wherein the luminescence data is captured during at least 100 percent of the duration of the voltage pulse.

Embodiment 643 is the method of embodiment 636, wherein a duration of the voltage pulse is less than or equal to approximately 200 milliseconds (ms).

Embodiment 644 is the method of embodiment 643, wherein the duration of the voltage pulse is approximately 100 ms.

Embodiment 645 is the method of embodiment 643, wherein the duration of the voltage pulse is approximately 50 ms.

Embodiment 646 is the method of embodiment 636, wherein the voltage pulse is applied to the one or more working electrodes and the at least one auxiliary electrode concurrently.

Embodiment 647 is the method of embodiment 646, wherein a read time for capturing the luminescence data ranges and reporting the luminescence data for an entirety of the one or more working electrodes in the multi-well plate ranges from approximately 66 seconds to approximately 81 seconds.

Embodiment 648 is the method of embodiment 646, wherein a read time for capturing the luminescence data ranges and reporting the luminescence data for an entirety of the one or more working electrodes in the multi-well plate ranges from approximately 45 seconds to approximately 49 seconds.

Embodiment 649 is the method of embodiment 646, wherein a read time for capturing the luminescence data ranges and reporting the luminescence data for an entirety of the one or more working electrodes in the multi-well plate ranges from approximately 51 seconds to approximately 52 seconds.

Embodiment 650 is the method of embodiment 636, wherein the voltage pulse is applied to the one or more working electrodes and the at least one auxiliary electrode sequentially.

Embodiment 651 is the method of embodiment 650, wherein a read time for capturing the luminescence data ranges and reporting the luminescence data for an entirety of the one or more working electrodes in the multi-well plate ranges from approximately 114 seconds to approximately 258 seconds.

Embodiment 652 is the method of embodiment 650, wherein a read time for capturing the luminescence data ranges and reporting the luminescence data for an entirety of the one or more working electrodes in the multi-well plate ranges from approximately 57 seconds to approximately 93 seconds.

Embodiment 653 is the method of embodiment 650, wherein a read time for capturing the luminescence data ranges and reporting the luminescence data for an entirety of the one or more working electrodes in the multi-well plate ranges from approximately 54 seconds to approximately 63 seconds.

Embodiment 654 is the method of embodiment 636, wherein a read time for capturing the luminescence data and reporting the luminescence data increases with an increase of a duration of the voltage pulse.

Embodiment 655 is the method of any of embodiments 636-654, wherein the voltage pulse is applied to an addressable subset of the one or more working electrode zones.

Embodiment 656 is the method of any of embodiments 636-655, the method further comprising: selecting a magnitude of the voltage pulse based at least in part on a chemical composition of the at least one auxiliary electrode.

Embodiment 657 is a computer readable medium storing instructions that cause one or more processors to perform any one of the method of embodiments 636-656.

Embodiment 658 is a method for performing electrochemical analysis, the method comprising: applying a voltage pulse to one or more working electrode zones and an auxiliary electrode in located in at least one well of a multi-well plate, wherein: the one or more working electrode zones define a pattern on a surface of the at least one well, the at least one auxiliary electrode is disposed on the surface and has a potential defined by a redox couple confined to its surface, wherein, during the voltage pulse, and a reaction of a species in the redox couple is a predominate redox reaction occurring at the auxiliary electrode; capturing luminescence over a period of time; and reporting the luminescence data.

Embodiment 659 is the method of embodiment 658, wherein the luminescence data includes electrochemical luminescence data.

Embodiment 660 is the method of embodiment 658, the method further comprising: analyzing the luminescence data.

Embodiment 661 is the method of embodiment 658, wherein the luminescence data is captured during a duration of the voltage pulse.

Embodiment 662 is the method of embodiment 661, wherein the luminescence data is captured during at least 50 percent of the duration of the voltage pulse.

Embodiment 663 is the method of embodiment 661, wherein the luminescence data is captured during at least 75 percent of the duration of the voltage pulse.

Embodiment 664 is the method of embodiment 661, wherein the luminescence data is captured during at least 100 percent of the duration of the voltage pulse.

Embodiment 665 is the method of embodiment 658, wherein a duration of the voltage pulse is less than or equal to approximately 200 milliseconds (ms).

Embodiment 666 is the method of embodiment 665, wherein the duration of the voltage pulse is approximately 100 ms.

Embodiment 667 is the method of embodiment 665, wherein the duration of the voltage pulse is approximately 50 ms.

Embodiment 668 is the method of embodiment 658, wherein the voltage pulse is applied to the one or more working electrodes and the at least one auxiliary electrode concurrently.

Embodiment 669 is the method of embodiment 668, wherein a read time for capturing the luminescence data ranges and reporting the luminescence data for an entirety of the one or more working electrodes in the multi-well plate ranges from approximately 66 seconds to approximately 81 seconds.

Embodiment 670 is the method of embodiment 668, wherein a read time for capturing the luminescence data ranges and reporting the luminescence data for an entirety of the one or more working electrodes in the multi-well plate ranges from approximately 45 seconds to approximately 49 seconds.

Embodiment 671 is the method of embodiment 668, wherein a read time for capturing the luminescence data ranges and reporting the luminescence data for an entirety of the one or more working electrodes in the multi-well plate ranges from approximately 51 seconds to approximately 52 seconds.

Embodiment 672 is the method of embodiment 658, wherein the voltage pulse is applied to the one or more working electrodes and the at least one auxiliary electrode sequentially.

Embodiment 673 is the method of embodiment 672, wherein a read time for capturing the luminescence data ranges and reporting the luminescence data for an entirety of the one or more working electrodes in the multi-well plate ranges from approximately 114 seconds to approximately 258 seconds.

Embodiment 674 is the method of embodiment 672, wherein a read time for capturing the luminescence data ranges and reporting the luminescence data for an entirety of the one or more working electrodes in the multi-well plate ranges from approximately 57 seconds to approximately 93 seconds.

Embodiment 675 is the method of embodiment 672, wherein a read time for capturing the luminescence data ranges and reporting the luminescence data for an entirety of the one or more working electrodes in the multi-well plate ranges from approximately 54 seconds to approximately 63 seconds.

Embodiment 676 is the method of embodiment 658, wherein a read time for capturing the luminescence data and reporting the luminescence data increases with an increase of a duration of the voltage pulse.

Embodiment 677 is the method of any of embodiments 658-676, wherein the voltage pulse is applied to an addressable subset of the one or more working electrode zones.

Embodiment is the method of any of embodiments 658-677, the method further comprising: selecting a magnitude of the voltage pulse based at least in part on a chemical composition of the at least one auxiliary electrode.

Embodiment 679 is a computer readable medium storing instructions that cause one or more processors to perform any one of the method of embodiments 658-678.

Embodiment 680 is a method for electrochemical analysis, the method comprising: applying a voltage pulse to one or more working electrode zones and at least one auxiliary electrode located in at least one well of a multi-well plate, wherein: the one or more working electrode zones define a pattern on a surface of the at least one well, the at least one auxiliary electrode is disposed on the surface and has a redox couple confined to its surface, and the redox couple is reduced at least during a period for which the voltage pulse is applied.

Embodiment 681 is the method of embodiment 680, wherein the luminescence data is captured during a duration of the voltage pulse.

Embodiment 682 is the method of embodiment 681, wherein the luminescence data is captured during at least 50 percent of the duration of the voltage pulse.

Embodiment 683 is the method of embodiment 681, wherein the luminescence data is captured during at least 75 percent of the duration of the voltage pulse.

Embodiment 684 is the method of embodiment 681, wherein the luminescence data is captured during at least 100 percent of the duration of the voltage pulse.

Embodiment 685 is the method of embodiment 680, wherein a duration of the voltage pulse is less than or equal to approximately 200 milliseconds (ms).

Embodiment 686 is the method of embodiment 685, wherein the duration of the voltage pulse is approximately 100 ms.

Embodiment 687 is the method of embodiment 685, wherein the duration of the voltage pulse is approximately 50 ms.

Embodiment 688 is the method of embodiment 680, wherein the voltage pulse is applied to the one or more working electrodes and the at least one auxiliary electrode concurrently.

Embodiment 689 is the method of embodiment 680, wherein the voltage pulse is applied to the one or more working electrodes and the at least one auxiliary electrode sequentially.

Embodiment 690 is the method of any of embodiments 680-698, wherein the voltage pulse is applied to an addressable subset of the one or more working electrode zones.

Embodiment 691 is the method of any of embodiments 680-698, the method further comprising: selecting a magnitude of the voltage pulse based at least in part on a chemical composition of the at least one auxiliary electrode.

Embodiment 692 is a computer readable medium storing instructions that cause one or more processors to perform any one of the method of embodiments 680-698.

Embodiment 693 is a method for electrochemical analysis, the method comprising: applying a voltage pulse to one or more working electrode zones and at least one auxiliary electrode located in at least one well of a multi-well plate, wherein: the one or more working electrode zones define a pattern, on a surface of the at least one well, the at least one auxiliary electrode is disposed on the surface, the auxiliary electrode has a redox couple confined to its surface with a standard redox potential, the redox couple provides a quantifiable amount of coulombs per unit of the at least one auxiliary electrode's surface area throughout a redox reaction of the redox couple, and the redox couple is reduced at least during a period for which the voltage pulse is applied.

Embodiment 694 is the method of embodiment 693, wherein the luminescence data is captured during a duration of the voltage pulse.

Embodiment 695 is the method of embodiment 694, wherein the luminescence data is captured during at least 50 percent of the duration of the voltage pulse.

Embodiment 696 is the method of embodiment 694, wherein the luminescence data is captured during at least 75 percent of the duration of the voltage pulse.

Embodiment 697 is the method of embodiment 694, wherein the luminescence data is captured during at least 100 percent of the duration of the voltage pulse.

Embodiment 698 is the method of embodiment 693, wherein a duration of the voltage pulse is less than or equal to approximately 200 milliseconds (ms).

Embodiment 699 is the method of embodiment 698, wherein the duration of the voltage pulse is approximately 100 ms.

Embodiment 700 is the method of embodiment 698, wherein the duration of the voltage pulse is approximately 50 ms.

Embodiment 701 is the method of embodiment 693, wherein the voltage pulse is applied to the one or more working electrodes and the at least one auxiliary electrode concurrently.

Embodiment 702 is the method of embodiment 693, wherein the voltage pulse is applied to the one or more working electrodes and the at least one auxiliary electrode sequentially.

Embodiment 703 is the method of any of embodiments 693-702, wherein the voltage pulse is applied to an addressable subset of the one or more working electrode zones.

Embodiment 704 is the method of any of embodiments 693-702, the method further comprising: selecting a magnitude of the voltage pulse based at least in part on a chemical composition of the at least one auxiliary electrode.

Embodiment 705 is a computer readable medium storing instructions that cause one or more processors to perform any one of the method of embodiments 693-702.

Embodiment 706 is a method for electrochemical analysis, the method comprising: applying a voltage pulse to one or more working electrode zones and at least one auxiliary electrode located in at least one well of a multi-well plate, wherein: the one or more working electrode zones define a pattern on a surface of the at least one well, the at least one auxiliary electrode is disposed on the surface and is formed of a chemical mixture comprising an oxidizing agent, the at least one auxiliary electrode has a redox couple confined to its surface, during the voltage pulse, an amount of the oxidizing agent is sufficient to maintain a potential throughout an entire redox reaction of the redox couple, and the redox couple is reduced at least during a period for which the voltage pulse is applied.

Embodiment 707 is the method of embodiment 706, wherein the luminescence data is captured during a duration of the voltage pulse.

Embodiment 708 is the method of embodiment 707, wherein the luminescence data is captured during at least 50 percent of the duration of the voltage pulse.

Embodiment 709 is the method of embodiment 707, wherein the luminescence data is captured during at least 75 percent of the duration of the voltage pulse.

Embodiment 710 is the method of embodiment 707, wherein the luminescence data is captured during at least 100 percent of the duration of the voltage pulse.

Embodiment 711 is the method of embodiment 706, wherein a duration of the voltage pulse is less than or equal to approximately 200 milliseconds (ms).

Embodiment 712 is the method of embodiment 711, wherein the duration of the voltage pulse is approximately 100 ms.

Embodiment 713 is the method of embodiment 711, wherein the duration of the voltage pulse is approximately 50 ms.

Embodiment 714 is the method of embodiment 706, wherein the voltage pulse is applied to the one or more working electrodes and the at least one auxiliary electrode concurrently.

Embodiment 715 is the method of embodiment 706, wherein the voltage pulse is applied to the one or more working electrodes and the at least one auxiliary electrode sequentially.

Embodiment 716 is the method of any of embodiments 706-715, wherein the voltage pulse is applied to an addressable subset of the one or more working electrode zones.

Embodiment 717 is the method of any of embodiments 706-715, the method further comprising: selecting a magnitude of the voltage pulse based at least in part on a chemical composition of the at least one auxiliary electrode.

Embodiment 718 is a computer readable medium storing instructions that cause one or more processors to perform any one of the method of embodiments 706-715.

Embodiment 719 is a method for electrochemical analysis, the method comprising: applying a voltage pulse to one or more working electrode zones and at least one auxiliary electrode located in at least one well of a multi-well plate, wherein: the one or more working electrode zones define a pattern on a surface of the at least one well, the at least one auxiliary electrode is disposed on the surface, and the auxiliary electrode has a defined interfacial potential during the voltage pulse.

Embodiment 720 is the method of embodiment 719, wherein the luminescence data is captured during a duration of the voltage pulse.

Embodiment 721 is the method of embodiment 720, wherein the luminescence data is captured during at least 50 percent of the duration of the voltage pulse.

Embodiment 722 is the method of embodiment 720, wherein the luminescence data is captured during at least 75 percent of the duration of the voltage pulse.

Embodiment 723 is the method of embodiment 720, wherein the luminescence data is captured during at least 100 percent of the duration of the voltage pulse.

Embodiment 724 is the method of embodiment 719, wherein a duration of the voltage pulse is less than or equal to approximately 200 milliseconds (ms).

Embodiment 725 is the method of embodiment 724, wherein the duration of the voltage pulse is approximately 100 ms.

Embodiment 726 is the method of embodiment 724, wherein the duration of the voltage pulse is approximately 50 ms.

Embodiment 727 is the method of embodiment 719, wherein the voltage pulse is applied to the one or more working electrodes and the at least one auxiliary electrode concurrently.

Embodiment 728 is the method of embodiment 719, wherein the voltage pulse is applied to the one or more working electrodes and the at least one auxiliary electrode sequentially.

Embodiment 729 is the method of any of embodiments 719-728, wherein the voltage pulse is applied to an addressable subset of the one or more working electrode zones.

Embodiment 730 is the method of any of embodiments 719-728, the method further comprising: selecting a magnitude of the voltage pulse based at least in part on a chemical composition of the at least one auxiliary electrode.

Embodiment 731 is a computer readable medium storing instructions that cause one or more processors to perform any one of the method of embodiments 719-728.

Embodiment 732 is a method for electrochemical analysis, the method comprising: applying a voltage pulse to one or more working electrode zones and at least one auxiliary electrode located in at least one well of a multi-well plate, wherein: the one or more working electrode zones define a pattern on a surface of the at least one well, the at least one auxiliary electrode is disposed on the surface and comprises a first substance and a second substance, the second substance is a redox couple of the first substance, and the redox couple is reduced at least during a period for which the voltage pulse is applied.

Embodiment 733 is the method of embodiment 732, wherein the luminescence data is captured during a duration of the voltage pulse.

Embodiment 734 is the method of embodiment 733, wherein the luminescence data is captured during at least 50 percent of the duration of the voltage pulse.

Embodiment 735 is the method of embodiment 733, wherein the luminescence data is captured during at least 75 percent of the duration of the voltage pulse.

Embodiment 736 is the method of embodiment 733, wherein the luminescence data is captured during at least 100 percent of the duration of the voltage pulse.

Embodiment 737 is the method of embodiment 732, wherein a duration of the voltage pulse is less than or equal to approximately 200 milliseconds (ms).

Embodiment 738 is the method of embodiment 737, wherein the duration of the voltage pulse is approximately 100 ms.

Embodiment 739 is the method of embodiment 737, wherein the duration of the voltage pulse is approximately 50 ms.

Embodiment 740 is the method of embodiment 732, wherein the voltage pulse is applied to the one or more working electrodes and the at least one auxiliary electrode concurrently.

Embodiment 741 is the method of embodiment 732, wherein the voltage pulse is applied to the one or more working electrodes and the at least one auxiliary electrode sequentially.

Embodiment 742 is the method of any of embodiments 732-741, wherein the voltage pulse is applied to an addressable subset of the one or more working electrode zones.

Embodiment 743 is the method of any of embodiments 732-742, the method further comprising: selecting a magnitude of the voltage pulse based at least in part on a chemical composition of the at least one auxiliary electrode.

Embodiment 744 is a computer readable medium storing instructions that cause one or more processors to perform any one of the method of embodiments 732-743.

Embodiment 745 is a method for electrochemical analysis, the method comprising: applying a voltage pulse to one or more working electrode zones and at least one auxiliary electrode located in at least one well of a multi-well plate, wherein: the one or more working electrode zones define a pattern on a surface of the at least one well, the at least one auxiliary electrode is disposed on the surface and has a potential defined by a redox couple confined to its surface, wherein, during the voltage pulse, a reaction of a species in the redox couple is a predominate redox reaction occurring at the auxiliary electrode, and the redox couple is reduced at least during a period for which the voltage pulse is applied.

Embodiment 746 is the method of embodiment 745, wherein the luminescence data is captured during a duration of the voltage pulse.

Embodiment 747 is the method of embodiment 746, wherein the luminescence data is captured during at least 50 percent of the duration of the voltage pulse.

Embodiment 748 is the method of embodiment 746, wherein the luminescence data is captured during at least 75 percent of the duration of the voltage pulse.

Embodiment 749 is the method of embodiment 746, wherein the luminescence data is captured during at least 100 percent of the duration of the voltage pulse.

Embodiment 750 is the method of embodiment 745, wherein a duration of the voltage pulse is less than or equal to approximately 200 milliseconds (ms).

Embodiment 751 is the method of embodiment 750, wherein the duration of the voltage pulse is approximately 100 ms.

Embodiment 752 is the method of embodiment 750, wherein the duration of the voltage pulse is approximately 50 ms.

Embodiment 753 is the method of embodiment 745, wherein the voltage pulse is applied to the one or more working electrodes and the at least one auxiliary electrode concurrently.

Embodiment 754 is the method of embodiment 745, wherein the voltage pulse is applied to the one or more working electrodes and the at least one auxiliary electrode sequentially.

Embodiment 755 is the method of any of embodiments 745-754 wherein the voltage pulse is applied to an addressable subset of the one or more working electrode zones.

Embodiment 756 is the method of any of embodiments 745-755, the method further comprising: selecting a magnitude of the voltage pulse based at least in part on a chemical composition of the at least one auxiliary electrode.

Embodiment 757 is a computer readable medium storing instructions that cause one or more processors to perform any one of the method of embodiments 745-756.

Embodiment 758 is a kit comprising: at least one reagent; at least one read buffer; and an electrochemical cell, the electrochemical cell comprising: a plurality of working electrode zones disposed, and defining a pattern, on a surface of the cell, and at least one auxiliary electrode disposed on the surface, the at least one auxiliary electrode having a potential defined by a redox couple confined to its surface, wherein the at least one auxiliary electrode is disposed at an approximate equal distance from at least two of the plurality of working electrode zones.

Embodiment 759 is a kit comprising: at least one reagent; at least one read buffer; and a plate with a plurality of wells defined therein, at least one well from the plurality of wells comprising: a plurality of working electrode zones disposed, and defining a pattern, on a surface of the cell, and at least one auxiliary electrode disposed on the surface, the auxiliary electrode having a redox couple confined to its surface with a standard redox potential, wherein the redox couple provides a quantifiable amount of coulombs per unit of the at least one auxiliary electrode's surface area throughout a redox reaction of the redox couple.

Embodiment 760 is a kit comprising: at least one reagent; at least one read buffer; and a plate with a plurality of wells defined therein, at least one well from the plurality of wells comprising: a plurality of working electrode zones disposed, and defining a pattern, on a surface of the cell, and at least one auxiliary electrode disposed on the surface and formed of a chemical mixture comprising an oxidizing agent, the at least one auxiliary electrode having a potential defined by a redox couple confined to its surface, wherein an amount of the oxidizing agent is sufficient to maintain the defined potential throughout an entire redox reaction of the redox couple.

Embodiment 761 is a kit comprising: at least one reagent; at least one read buffer; and a plate with a plurality of wells defined therein, at least one well from the plurality of wells comprising: a plurality of working electrode zones disposed, and defining a pattern, on a surface of the cell, and at least one auxiliary electrode disposed on the surface, the auxiliary electrode having a defined interfacial potential.

Embodiment 762 is a kit comprising: at least one reagent; at least one read buffer; and a plate with a plurality of wells defined therein, at least one well from the plurality of wells comprising: a plurality of working electrode zones disposed, and defining a pattern, on a surface of the cell, and at least one auxiliary electrode disposed on the surface, the at least one auxiliary electrode comprising a first substance and a second substance, wherein the second substance is a redox couple of the first substance.

Embodiment 763 is a kit comprising: at least one reagent; at least one read buffer; and a plate with a plurality of wells defined therein, at least one well from the plurality of wells comprising: a plurality of working electrode zones disposed, and defining a pattern, on a surface of the cell, and at least one auxiliary electrode disposed on the surface, the at least one auxiliary electrode having a potential defined by a redox couple confined to its surface, wherein when an applied potential is introduced to the at least one auxiliary electrode, the redox couple is a predominate redox reaction occurring in the cell.

Embodiment 765 is an apparatus for performing electrochemical analysis, the apparatus comprising: a plate with a plurality of wells defined therein, at least one well from the plurality of wells comprising: a plurality of working electrode zones disposed on a surface of a bottom of the at least one well, wherein the plurality of working electrode zones define a pattern on the bottom of the at least one well; and a single auxiliary electrode disposed on the surface of the bottom of the at least one well, the single auxiliary electrode having a potential defined by a redox couple confined to its surface, wherein the auxiliary electrode is disposed at an approximate equal distance from two or more of the plurality of working electrode zones.

Embodiment 766 is the apparatus of embodiment 765, wherein the plurality of working electrode zones comprises a plurality of electrically isolated zones formed on a single electrode.

Embodiment 767 is the apparatus of embodiment 765, wherein the electrochemical analysis comprises electrochemiluminescence (ECL) analysis.

Embodiment 768 is an apparatus for performing electrochemical analysis in a well, the apparatus comprising: a plurality of working electrode zones disposed on a surface adapted to form a bottom portion of the well; and an auxiliary electrode disposed on the surface, the auxiliary electrode having a potential defined by a redox couple confined to its surface, wherein one of the plurality of working electrode zones is disposed at an approximate equal distance from each sidewall of the well.

Embodiment 769 is the apparatus of embodiment 768, wherein the plurality of working electrode zones comprises a plurality of electrically isolated zones formed on a single electrode.

Embodiment 770 is the apparatus of embodiment 768, wherein the electrochemical analysis comprises electrochemiluminescence (ECL) analysis.

Embodiment 771 is a method for performing electrochemical analysis, the method comprising: applying a first voltage pulse to one or more working electrode zones or a counter electrode in a well of an apparatus, the first voltage pulse causing a first redox reaction to occur in the well; capturing first luminescence data from the first redox reaction over a first period of time; applying a second voltage pulse to the one or more working electrode zones or the counter electrode in the well, the second voltage pulse causing a second redox reaction to occur in the well; and capturing second luminescence data from the second redox reaction over a second period of time.

Embodiment 772 is the method of embodiment 771, the method further comprising: performing electrochemical luminescence analysis on the first luminescence data and the second luminescence data.

Embodiment 773 is the method of embodiment 771, the method further comprising: selecting at least one of a voltage level or pulse width for at least one of the first voltage pulse and the second voltage pulse to cause the first redox reaction to occur, wherein the first luminescence data corresponds to the first redox reaction that occurs.

Embodiment 774 is the method of embodiment 771, the method further comprising: selecting at least one of a voltage level or pulse width for at least one of the first voltage pulse and the second voltage pulse to cause the second redox reaction to occur, wherein the second luminescence data corresponds to the second redox reaction that occurs.

Embodiment 775 is the method of embodiment 771, wherein at least one of the first voltage pulse and the second voltage pulse is applied to an addressable subset of the one or more working electrode zones.

Embodiment 776 is the method of embodiment 771, the method further comprising: selecting a magnitude of at least one of the first voltage pulse and the second voltage pulse based at least in part on a chemical composition of the counter electrode, wherein the counter electrode is an auxiliary electrode.

Embodiment 777 is the method of embodiment 771, wherein a first duration of the first period time is not equal to a second duration of the second period of time.

Embodiment 778 is the method of embodiment 777, wherein the first duration is less than the second duration.

Embodiment 779 is the method of embodiment 777, wherein the first duration is greater than the second duration.

Embodiment 780 is the method of embodiment 777, wherein the first duration and the second duration are selected to improve a dynamic range of an electrochemical luminescence analysis performed on the first luminescence data and the second luminescence data.

Embodiment 781 is the method of embodiment 777, wherein the first luminescence data is captured during first duration of the first voltage pulse.

Embodiment 782 is the method of embodiment 781, wherein the first luminescence data is captured during at least 50 percent of the first duration of the first voltage pulse.

Embodiment 783 is the method of embodiment 781, the first luminescence data is captured during at least 75 percent of the first duration of the first voltage pulse.

Embodiment 784 is the method of embodiment 781, the first luminescence data is captured during at least 100 percent of the first duration of the first voltage pulse.

Embodiment 785 is the method of embodiment 777, wherein the second luminescence data is captured during the second duration of the second voltage pulse.

Embodiment 786 is the method of embodiment 785, wherein the second luminescence data is captured during at least 50 percent of the second duration of the second voltage pulse.

Embodiment 787 is the method of embodiment 785, the second luminescence data is captured during at least 75 percent of the first duration of the first voltage pulse.

Embodiment 788 is the method of embodiment 785, the second luminescence data is captured during at least 100 percent of the second duration of the second voltage pulse.

Embodiment 789 is the method of embodiment 777, wherein one of the first duration or the second duration is less than or equal to approximately 200 milliseconds (ms).

Embodiment 790 is the method of embodiment 789, wherein one of the first duration or the second duration is approximately 100 ms.

Embodiment 791 is the method of embodiment 789, wherein one of the first duration or the second duration is approximately 50 ms.

Embodiment 792 is the method of embodiment 771, wherein the first voltage pulse is applied prior to the second voltage pulse.

Embodiment 793 is the method of embodiment 771, wherein the second voltage pulse is applied prior to the first voltage pulse.

Embodiment 794 is the method of embodiment 771, wherein the counter electrode comprises an auxiliary electrode.

Embodiment 795 is a method for performing electrochemical analysis, the method comprising: applying a voltage pulse to one or more working electrode zones or a counter electrode in a well of an apparatus, the voltage pulse causing a redox reaction to occur in the well; capturing first luminescence data from the redox reaction over a first period of time; and capturing second luminescence data from the redox reaction over a second period of time, wherein the first period time is not of equal duration to the second period of time.

Embodiment 796 is the method of embodiment 795, the method comprising: performing electroluminescence analysis on the first luminescence data and the second luminescence data.

Embodiment 797 is the method of embodiment 795, wherein the first period time is not of equal duration to the second period of time.

Embodiment 798 is the method of embodiment 797, wherein the first duration is less than the second duration.

Embodiment 799 is the method of embodiment 797, wherein the first duration is greater than the second duration.

Embodiment 800 is the method of embodiment 797, wherein the first duration and the second duration are selected to improve a dynamic range of an electrochemical luminescence analysis performed on the first luminescence data and the second luminescence data.

Embodiment 801 is the method of embodiment 795, wherein the counter electrode comprises an auxiliary electrode.

Embodiment 802 is a method of making electrodes on a substrate, the method comprising: forming one or more working electrodes on the substrate, wherein the one or more working electrodes are comprised of a first material and a second material; forming one or more auxiliary electrodes on the substrate, wherein the one or more auxiliary electrodes are comprised of a third material; and applying an electrically insulating material to electrically insulate the one or more auxiliary electrodes from the one or more working electrodes.

Embodiment 803 is the method of embodiment 802, wherein the electrically insulating material is a dielectric.

Embodiment 804 is the method of embodiment 802, wherein the first material comprises silver and the second material comprises carbon.

Embodiment 805 is the method of embodiment 802, wherein the third material comprises a mixture of silver and silver chloride.

Embodiment 806 is the method of embodiment 802, the method further comprising: forming a plurality of electrical contacts on a bottom surface of the substrate, wherein the each of the plurality of electrical contacts is adapted to electrically couple one or more of the working electrodes and the one or more auxiliary electrodes.

Embodiment 807 is the method of embodiment 806, wherein the plurality of contacts comprises at least one pair of electrical contacts, further wherein one of the electrical contacts from a pair is adapted to electrically couple one or more of the working electrodes and the other electrical contact from that pair is adapted to electrically couple the one or more auxiliary electrodes.

Embodiment 808 is the method of embodiment 807, the method further comprising: creating one or more holes through the substrate; and at least partially filling the one or more holes with a conductive material, wherein the conductive material is adapted to provide electrical connectivity between the plurality of electrical contacts and the one or more working electrodes and/or the one or more auxiliary electrodes.

Embodiment 809 is the method of embodiment 808, the method further comprising: attaching the substrate to a plate top comprising a plurality of wells, wherein an inner perimeter of each of the plurality of wells circumscribes the one or more working electrodes and one or more auxiliary electrodes formed on a bottom of each well of the plurality of wells.

Embodiment 810 is the method of embodiment 802, the method further comprising: applying an electrically insulating material to the one or more working electrodes to define a plurality of working electrode zones.

Embodiment 811 is the method of embodiment 802, wherein the one or more working electrodes and the one or more auxiliary electrodes are screen-printed with one or more electrically conductive inks.

Embodiment 812 is a method of making electrodes on a substrate, the method comprising: (a) applying a first conductive layer of material; (b) applying a first electrically insulting material to define one or more auxiliary electrodes; (c) applying a second conductive layer of material; and (d) applying a second electrically insulting material to form one or more working electrode zones from among the one or more working electrodes.

Embodiment 813 is the method of embodiment, 812 further comprising the step of (e) applying a third conductive layer of material.

Embodiment 814 is the method of embodiment, 813 further comprising the step of (f) applying a fourth conductive layer of material, wherein the fourth conductive layer is formed in a pattern that at least partially defines one or more working electrodes.

Embodiment 815 is the method of embodiment 812, wherein the third and fourth conductive layers comprise silver.

Embodiment 816 is the method of embodiment 812, wherein the first conductive layer comprises a mixture of silver and silver chloride.

Embodiment 817 is the method of embodiment 812, wherein the first and second electrically insulting materials comprise a dielectric.

Embodiment 818 is the method of embodiment 812, wherein the second conductive layer comprises carbon.

Embodiment 819 is the method of embodiment 812, wherein the first electrically insulting material insulates the working electrode from the auxiliary electrode.

Embodiment 820 is the method of embodiment 812, wherein the fourth conductive layer is adapted to form one or more pairs of working electrodes, wherein each working electrode from a pair is electrically coupled with the other working electrode from the pair.

Embodiment 821 is the method of embodiment 814, wherein the steps are performed in order from (e), (a), (b), (f), (c), to (d).

Embodiment 822 is the method of embodiment 814, the method further comprising the step of (g) forming one or more holes through the substrate.

Embodiment 823 is the method of embodiment 814, wherein performing one or more steps of (a)-(g) causes the one or more auxiliary electrodes and one or more working electrodes to overlap one another on the substrate.

Embodiment 824 is the method of embodiment 823, wherein the one or more holes are formed in a portion of the substrate that does not include an overlapped auxiliary and working electrode.

Embodiment 825 is the method of embodiment 823, wherein the one or more holes are formed in a portion of the substrate that includes one and only one of the first conductive layer and the second conductive layer.

Embodiment 826 is the method of embodiment 824, wherein the step (e) of applying a third conductive layer causes the one or more holes to be at least partially filled with conductive ink.

Embodiment 827 is the method of embodiment 812, wherein the first layer is comprised of a different material than the third conductive layer.

Embodiment 828 is the method of embodiment 812, wherein the fourth conductive layer is comprised of the same material as the third conductive layer.

Embodiment 829 is the method of embodiment 812, wherein the second conductive layer is comprised of a different material than the third and fourth layers.

Embodiment 830 is the method of embodiment 812, wherein each of the conductive layers comprise screen-printable inks.

Embodiment 831 is the method of embodiment 812, the method further comprising: doping one or more of the first conductive layer or the second conductive layer.

Embodiment 832 is the method of embodiment 813, the method further comprising: doping one or more of the first conductive layer, the second conductive layer, or the third conductive layer.

Embodiment 833 is the method of embodiment 814, the method further comprising: doping one or more of the first conductive layer, the second conductive layer, the third conductive layer, or the fourth conducive layer.

Embodiment 834 is a method of making electrodes on a substrate, the method comprising: adding a first substance to form one or more auxiliary electrodes; and adding a second substance to the one or more auxiliary electrodes, wherein the first substance and the second substance form a redox couple.

Embodiment 835 is the method of embodiment 834, wherein the first substance is silver (Ag) and the second substance is silver chloride (AgCl).

Embodiment 836 is the method of embodiment 834, the first substance and the second substance are added to the one or more auxiliary electrodes in a molar ratio within a specified range.

Embodiment 837 is the method of embodiment 836, wherein the molar ratio is approximately equal to or greater than 1.

Embodiment 838 is the method of embodiment 834, wherein the first substance is doped to form at least one of an oxidizing agent or a reducing agent.

Embodiment 839 is the method of embodiment 834, wherein the second substance is doped to form at least one of an oxidizing agent or a reducing agent.

Embodiment 840 is a method for performing electrochemical analysis, the method comprising: coupling a plate comprising one or more auxiliary electrodes to an instrument adapted to perform scientific analysis, the one or more auxiliary electrodes having a redox couple confined to their surface; applying a potential to the one or more auxiliary electrodes; and in response to applying the potential, causing a redox reaction of the redox couple.

Embodiment 841 is the method of embodiment 840, the method further comprising: generating light throughout at least a portion of the time the potential is applied to the one or more auxiliary electrodes.

Embodiment 842 is the method of embodiment 840, wherein the potential is a voltage pulse.

Embodiment 843 is a method for performing electrochemical analysis, the method comprising: coupling a plate comprising one or more auxiliary electrodes to an instrument adapted to perform scientific analysis, the one or more auxiliary electrodes having a defined interfacial potential; applying a potential to the one or more auxiliary electrodes; and while applying the potential is applied to the one or more auxiliary electrodes, maintaining a controlled interfacial potential at the one or more auxiliary electrodes.

Embodiment 844 is the method of embodiment 843, the method further comprising: generating light throughout at least a portion of the time the potential is applied to the one or more auxiliary electrodes.

Embodiment 845 is the method of embodiment 843, wherein the potential is a voltage pulse.

Embodiment 846 is an apparatus for performing electrochemical analysis, the apparatus comprising: a plate with a plurality of wells defined therein, at least one well from the plurality of wells comprising: one or more auxiliary electrodes disposed on the bottom of the at least one well, the one or more auxiliary electrodes having a redox couple confined to their surface; wherein the one or more auxiliary electrodes are configured to be oxidized or reduced while a potential is applied to the one or more auxiliary electrodes.

Embodiment 847 is an apparatus for performing electrochemical analysis, the apparatus comprising: a plate with a plurality of wells defined therein, at least one well from the plurality of wells comprising: one or more auxiliary electrodes disposed on the bottom of the at least one well, the one or more auxiliary electrodes having a defined interfacial potential; wherein the one or more auxiliary electrodes are configured to maintain a controlled interfacial potential while a potential is applied to the one or more auxiliary electrodes.

Embodiment 848 is a method for performing electrochemical analysis, the method comprising: applying a potential to the one or more auxiliary electrodes, the one or more auxiliary electrodes having a redox couple confined to their surface; and measuring an electrochemical signal, wherein during the measurement, the applied potential of the one or more auxiliary electrodes is defined by the redox couple.

Embodiment 849 is the method of embodiment 848, wherein the electrochemical signal includes an electrochemiluminescence (ECL) signal.

Embodiment 850 is the method of embodiment 848, wherein, when the applied potential is introduced during electrochemical analysis, a reaction of a species in the redox couple is a predominate redox reaction occurring at the auxiliary electrode.

Embodiment 851 is the method of embodiment 848, wherein the potential is a voltage pulse.

Embodiment 852 is an assay apparatus comprising a housing, a plate electrical connector, one or more detectors configured to capture data associated with an electrochemical process, and a voltage or current source configured to initiate the electrochemical process.

Embodiment 853 is the apparatus of embodiment 852, wherein the one or more detectors includes a photo-detector.

Embodiment 854 is the apparatus of embodiment 852, wherein the photo-detector includes at least one of a photomultiplier tube, photodiode, avalanche photo diode, a CCD, and a CMOS device.

Embodiment 854 is the apparatus of embodiment 852, wherein the one or more detectors includes a first detector and a second detector.

Embodiment 855 is the apparatus of embodiment 854, wherein the first detector is configured with a high gain configuration to capture low output signals and the second detector is configured with a low gain configuration to capture high output signals.

Embodiment 856 is the apparatus of embodiment 855, further including a beam splitter configured to split a light beam into a first light beam directed at the first detector and a second light beam directed at the second detector.

Embodiment 857 is the apparatus of embodiment 856, wherein the first light beam includes at least 90% of light from the light beam, at least 95% of light from the light beam, or at least 99% of light from the light beam.

Embodiment 858 is the apparatus of embodiment 855, wherein the first detector has a higher sensitivity detector than the second detector.

Embodiment 859 is the apparatus of embodiment 852, wherein the one or more detectors is a detector having a first portion and a second portion, the apparatus further including a beam splitter configured to split a light beam into a first light beam directed at the first portion and a second light beam directed at the second portion.

Embodiment 860 is an electrochemical cell for performing electrochemical analysis, the electrochemical cell comprising: a plurality of working electrode zones disposed, and defining a pattern, on a surface of the cell; and at least one auxiliary electrode disposed on the surface, the at least one auxiliary electrode having a redox couple confined to its surface, wherein the at least one auxiliary electrode is disposed at an approximate equal distance from at least two of the plurality of working electrode zones.

Embodiment 861 is the electrochemical cell of embodiment 860, wherein an amount of an oxidizing agent in the redox couple is greater than or equal to an amount of charge required to pass through the auxiliary electrode to complete the electrochemical analysis.

Embodiment 863 is the electrochemical cell of embodiment 861, wherein the at least one auxiliary electrode has between approximately 0.507 to 20.543 moles of oxidizing agent per in³ of auxiliary electrode area.

Embodiment 864 is the electrochemical cell of embodiment 861, wherein the at least one auxiliary electrode has between approximately 0.993 to 14.266 moles of oxidizing agent per in³ of auxiliary electrode area.

Embodiment 865 is the electrochemical cell of embodiment 861, wherein the at least one auxiliary electrode has between approximately 11.032 to 57.063 moles of oxidizing agent per in³ of auxiliary electrode area.

Embodiment 866 is the electrochemical cell of embodiment 861, wherein the at least one auxiliary electrode has between approximately 1.477 to 14.266 moles of oxidizing agent per in³ of auxiliary electrode area.

Embodiment 867 is the electrochemical cell of embodiment 861, wherein the at least one auxiliary electrode has between approximately 4.309 to 16.376 moles of oxidizing agent per in³ of auxiliary electrode area.

Embodiment 868 is the electrochemical cell of embodiment 861, wherein the at least one auxiliary electrode has between approximately 0.736 to 3.253 moles of oxidizing agent per in³ of total working electrode area in the well.

Embodiment 869 is the electrochemical cell of embodiment 861, wherein the at least one auxiliary electrode has between approximately 0.494 to 0.885 moles of oxidizing agent per in³ of total working electrode area in the well.

Embodiment 870 is the electrochemical cell of embodiment 861, wherein the at least one auxiliary electrode has between approximately 0.563 to 0.728 moles of oxidizing agent per in³ of total working electrode area in the well.

Embodiment 871 is the electrochemical cell of embodiment 861, wherein the at least one auxiliary electrode has between approximately 0.356 to 0.554 moles of oxidizing agent per in³ of total working electrode area in the well.

Embodiment 872 is the electrochemical cell of embodiment 861, wherein the at least one auxiliary electrode has between approximately 0.595 to 2.017 moles of oxidizing agent per in³ of total working electrode area in the well.

In one embodiment, the present invention may be embodied as a computer program product that may include a computer readable storage medium (or media) and/or a computer readable storage device. Such computer readable storage medium or device may store computer readable program instructions for causing a processor to carry out one or more methodologies described here. In one embodiment, the computer readable storage medium or device includes a tangible device that can retain and store instructions for use by an instruction execution device. Examples of the computer readable storage medium or device may include, but is not limited to, an electronic storage device, a magnetic storage device, an optical storage device, an electromagnetic storage device, a semiconductor storage device, or any suitable combination thereof, for example, such as a computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, but not limited to only those examples. The computer readable medium can comprise both computer readable storage media (as described above) or computer readable transmission media, which can include, for example, coaxial cables, copper wire, and fiber optics. Computer readable transmission media may also take the form of acoustic or light waves, such as those generated during radio frequency, infrared, wireless, or other media including electric, magnetic, or electromagnetic waves.

The terms “computer system” as may be used in the present application may include a variety of combinations of fixed and/or portable computer hardware, software, peripherals, mobile, and storage devices. The computer system may include a plurality of individual components that are networked or otherwise linked to perform collaboratively or may include one or more stand-alone components. The hardware and software components of the computer system of the present application may include and may be included within fixed and portable devices such as desktop, laptop, and/or server. A module may be a component of a device, software, program, or system that implements some “functionality”, which can be embodied as software, hardware, firmware, electronic circuitry, or etc.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

The embodiments described above are illustrative examples and it should not be construed that the present invention is limited to these particular embodiments. It should be understood that various embodiments disclosed herein may be combined in different combinations than the combinations specifically presented in the description and accompanying drawings. It should also be understood that, depending on the example, certain acts or events of any of the processes or methods described herein may be performed in a different sequence, may be added, merged, or left out altogether (e.g., all described acts or events may not be necessary to carry out the methods or processes). In addition, while certain features of embodiments hereof are described as being performed by a single module or unit for purposes of clarity, it should be understood that the features and functions described herein may be performed by any combination of units or modules. Thus, various changes and modifications may be affected by one skilled in the art without departing from the spirit or scope of the invention as defined in the appended claims.

While various embodiments according to the present disclosure have been described above, it should be understood that they have been presented by way of illustration and example only, and not limitation. It will be apparent to persons skilled in the relevant art that various changes in form and detail may be made therein without departing from the spirit and scope of the present disclosure. Thus, the breadth and scope of the present disclosure should not be limited by any of the above-described exemplary embodiments but should be defined only in accordance with the appended claims and their equivalents. It will also be understood that each feature of each embodiment discussed herein, and of each reference cited herein, may be used in combination with the features of any other embodiment. Stated another way, aspects of the above multi-well plate may be used in any combination with other methods described herein or the methods may be used separately. All patents and publications discussed herein are incorporated by reference herein in their entirety.

What is claimed is:

1. An electrochemical cell for performing electrochemical analysis, the electrochemical cell comprising:
a plurality of working electrode zones disposed, and defining a pattern, on a surface of the cell; and
at least one auxiliary electrode disposed on the surface, the at least one auxiliary electrode having a redox couple confined to its surface,
wherein the at least one auxiliary electrode is disposed at an approximate equal distance from at least two of the plurality of working electrode zones.

2. The electrochemical cell of claim 1, wherein, during the electrochemical analysis, the auxiliary electrode has a potential defined by the redox couple.

3. The electrochemical cell of claim 2, wherein the potential ranges from approximately 0.1 volts (V) to approximately 3.0 V.

4. The electrochemical cell of claim 3, wherein the potential is approximately 0.22 V.

5. The electrochemical cell of claim 1, wherein the pattern minimizes a number of working electrode zones that are adjacent to one another for each of the working electrode zones among the plurality of working electrode zones.

6. The electrochemical cell of claim 1, wherein the pattern is configured to provide uniform mass transport of a substance to each of the plurality of working electrode zones under conditions of rotational shaking.

7. The electrochemical cell of claim 1, wherein each of the plurality of working electrode zones defines a circular shape having surface area that defines a circle.

8. The electrochemical cell of claim 7, wherein:
the at least one auxiliary electrode is disposed at an approximate center of the electrochemical cell,
the plurality of working electrode zones includes ten working electrode zones spaced approximately equidistant from the at least one auxiliary electrode, and
two working electrode zones have a greater pitch distance therebetween than a remainder of the working electrode zones.

9. The electrochemical cell of claim 1, wherein the redox couple comprises a mixture of silver (Ag) and silver chloride (AgCl).

10. The electrochemical cell of claim 9, wherein the mixture of Ag and AgCl comprises approximately 50 percent or less AgCl.

11. The electrochemical cell of claim 10, wherein the mixture has a molar ratio of Ag to AgCl within a specified range.

12. The electrochemical cell of claim 9, wherein, during the electrochemical analysis the auxiliary electrode has a potential defined by the redox couple, and
wherein the potential is approximately 0.22 volts (V).

13. The electrochemical cell of claim 1, wherein the electrochemical analysis comprises electrochemiluminescence (ECL) analysis.

14. An electrochemical cell for performing electrochemical analysis, the electrochemical cell comprising:
a plurality of working electrode zones disposed, and defining a pattern, on a surface of the cell; and
at least one auxiliary electrode disposed on the surface, the auxiliary electrode having a defined interfacial potential.

15. The electrochemical cell of claim 14, wherein an amount of an oxidizing agent in the at least one auxiliary electrode is greater than or equal to an amount of charge required to pass through the at least one auxiliary electrode to complete the electrochemical analysis.

16. The electrochemical cell of claim 15, wherein the at least one auxiliary electrode has between approximately 3.07×10⁻⁷ to 3.97×10⁻⁷ moles of oxidizing agent.

17. The electrochemical cell of claim 15, wherein the at least one auxiliary electrode has between approximately 1.80×10⁻⁷ to 2.32×10⁻⁷ moles of oxidizing agent per mm² of auxiliary electrode area.

18. The electrochemical cell of claim 15, wherein the at least one auxiliary electrode has at least approximately 3.7×10⁻⁹ moles of oxidizing agent per mm² of total working electrode area in the well.

19. The electrochemical cell of claim 14, wherein the plurality of working electrode zones have an aggregate exposed area, the at least one auxiliary electrode has an exposed surface area, and the aggregate exposed area of the plurality of working electrode zones divided by the exposed surface area of the at least one auxiliary electrode define an area ratio that has a value greater than 1.

20. The electrochemical cell of claim 14, wherein the at least one auxiliary electrode comprises a mixture of silver (Ag) and silver chloride (AgCl).

21. The electrochemical cell of claim 20, wherein the mixture of Ag and AgCl comprises approximately 50 percent or less AgCl.

22. The electrochemical cell of claim 20, wherein the mixture has a molar ratio of Ag to AgCl within a specified range.

23. The electrochemical cell of claim 22, wherein the molar ratio is approximately equal to or greater than 1.

24. The electrochemical cell of claim 14, wherein the electrochemical cell is part of a flow cell.

25. The electrochemical cell of claim 14, wherein the electrochemical cell is part of a plate.

26. The electrochemical cell of claim 14, wherein the electrochemical cell is part of a cartridge.

27. An apparatus for performing electrochemical analysis, the apparatus comprising:
a plate with a plurality of wells defined therein, at least one well from the plurality of wells comprising:
a plurality of working electrode zones disposed, and defining a pattern, on a surface of the cell; and
at least one auxiliary electrode disposed on the surface and formed of a chemical mixture comprising an oxidizing agent,
the at least one auxiliary electrode having a redox couple confined to its surface, wherein an amount of the oxidizing agent is sufficient to maintain the defined potential throughout an entire redox reaction of the redox couple.

28. The apparatus of claim 27, wherein the redox couple passes approximately 0.5 to 4.0 mA of current throughout a redox reaction of the redox couple to generate electrochemiluminescence (ECL) at a range of approximately 1.4V to 2.6V.

29. The apparatus of claim 27, wherein the redox couple passes an average current of approximately 2.39 mA throughout a redox reaction to generate electrochemiluminescence (ECL) at a range of approximately 1.4 to 2.6 V.

30. The apparatus of claim 27, wherein the redox couple maintains an interface potential of between −0.15 to −0.5 V while passing a charge of approximately 1.56×10⁻⁵ to 5.30×10⁻⁴ C/mm² of electrode surface area.

31. The apparatus of claim 27, wherein the number of working electrode zones that are adjacent to one another is no greater than two.

32. The apparatus of claim 27, wherein at least one of the plurality of working electrode zones is adjacent to three or more other working electrode zones among the plurality of working electrode zones.

33. The apparatus of claim 27, wherein the pattern comprises a geometric pattern.

34. A method for electrochemical analysis, the method comprising:
applying a voltage pulse to one or more working electrode zones and at least one auxiliary electrode located in at least one well of a multi-well plate, wherein:
the one or more working electrode zones define a pattern on a surface of the at least one well,
the at least one auxiliary electrode is disposed on the surface and has a redox couple confined to its surface, and
the redox couple is reduced at least during a period for which the voltage pulse is applied.

35. The method of claim 34, wherein the luminescence data is captured during a duration of the voltage pulse.

36. The method of claim 35, wherein the luminescence data is captured during at least 50 percent of the duration of the voltage pulse.

37. The method of claim 35, wherein the luminescence data is captured during at least 75 percent of the duration of the voltage pulse.

38. The method of claim 35, wherein the luminescence data is captured during at least 100 percent of the duration of the voltage pulse.

39. The method of claim 34, wherein a duration of the voltage pulse is less than or equal to approximately 200 milliseconds (ms).

40. The method of claim 39, wherein the duration of the voltage pulse is approximately 100 ms.

41. The method of claim 39, wherein the duration of the voltage pulse is approximately 50 ms.

42. The method of claim 34, wherein the voltage pulse is applied to the one or more working electrodes and the at least one auxiliary electrode concurrently.

43. The method of claim 34, wherein the voltage pulse is applied to the one or more working electrodes and the at least one auxiliary electrode sequentially.

44. The method of claim 34, wherein the voltage pulse is applied to an addressable subset of the one or more working electrode zones.

45. The method of claim 34, the method further comprising:
selecting a magnitude of the voltage pulse based at least in part on a chemical composition of the at least one auxiliary electrode.

46. A computer readable medium storing instructions that cause one or more processors to perform the method of claim 34.

47. An apparatus for performing electrochemical analysis in a well, the apparatus comprising:
a plurality of working electrode zones disposed on a surface adapted to form a bottom portion of the well; and
an auxiliary electrode disposed on the surface, the auxiliary electrode having a potential defined by a redox couple confined to its surface,
wherein one of the plurality of working electrode zones is disposed at an approximate equal distance from each sidewall of the well.

48. The apparatus of claim 47, wherein the plurality of working electrode zones comprises a plurality of electrically isolated zones formed on a single electrode.

49. The apparatus of claim 47, wherein the electrochemical analysis comprises electrochemiluminescence (ECL) analysis.

50. A method for performing electrochemical analysis, the method comprising:
applying a first voltage pulse to one or more working electrode zones or a counter electrode in a well of an apparatus, the first voltage pulse causing a first redox reaction to occur in the well;
capturing first luminescence data from the first redox reaction over a first period of time;
applying a second voltage pulse to the one or more working electrode zones or the counter electrode in the well, the second voltage pulse causing a second redox reaction to occur in the well; and
capturing second luminescence data from the second redox reaction over a second period of time.

51. The method of claim 50, the method further comprising:
performing electrochemical luminescence analysis on the first luminescence data and the second luminescence data.

52. The method of claim 50, wherein at least one of the first voltage pulse and the second voltage pulse is applied to an addressable subset of the one or more working electrode zones.

53. The method of claim 50, the method further comprising:
selecting a magnitude of at least one of the first voltage pulse and the second voltage pulse based at least in part on a chemical composition of the counter electrode, wherein the counter electrode is an auxiliary electrode.

54. The method of claim 50, wherein a first duration of the first period time is not equal to a second duration of the second period of time.

55. The method of claim 54, wherein the first duration and the second duration are selected to improve a dynamic range of an electrochemical luminescence analysis performed on the first luminescence data and the second luminescence data.

56. The method of claim 54, wherein the first luminescence data is captured during first duration of the first voltage pulse.

57. The method of claim 54, wherein one of the first duration or the second duration is less than or equal to approximately 200 milliseconds (ms).

58. The method of claim 57, wherein one of the first duration or the second duration is approximately 100 ms.

59. The method of claim 57, wherein one of the first duration or the second duration is approximately 50 ms.

60. The method of claim 50, wherein the counter electrode comprises an auxiliary electrode.
